(19) United States
(12) Patent Application Publication
(10) Pub. No.: US 2009/0326788 A1
(43) Pub. Date: Dec. 31, 2009

(54) FUEL INJECTION DEVICE

(75) Inventors: Hiroyuki YUASA, Saitama (JP); Hiroshi Akiyama, Saitama (JP); Mamoru Tokoro, Saitama (JP)

Correspondence Address: ARENT FOX LLP, 1050 CONNECTICUT AVENUE, N.W., SUITE 400, WASHINGTON, DC, 20036, US

(73) Assignee: HONDA MOTOR CO., LTD., Minato-ku (JP)

(21) Appl. No.: 12/489,918

(22) Filed: Jun. 23, 2009

(30) Foreign Application Priority Data
Jun. 25, 2008 (JP) 2008-165383
Oct. 23, 2008 (JP) 2008-272915
Oct. 30, 2008 (JP) 2008-279585
Oct. 30, 2008 (JP) 2008-279965

(51) Int. Cl. F02D 41/30; F02M 63/00

(52) U.S. Cl. 701/104; 123/447

(57) ABSTRACT

A fuel injection device 1A which includes a common rail 4 for accumulating fuel delivered by a high pressure pump 3B in a pressure-accumulated state, an injector for injecting in a cylinder of the diesel engine fuel supplied through a high pressure fuel supply passage 21 branched from the common rail 4, and an ECU 80A for outputting an injection command signal for injecting the fuel from the injector 5A. The fuel injection device 1A further includes an orifice 75 in the high pressure fuel supply passage 21 on the side of the common rail 4, and a differential pressure sensor S_{dP} for detecting the pressure difference of the pressures on the upstream and downstream sides of the orifice 75. The ECU 80A calculates an actual fuel supply amount that passes the orifice 75 based on a signal from the differential pressure sensor S_{dP}.

### CROSS REFERENCE TO RELATED APPLICATIONS

This application claims the foreign priority benefit under 35 U.S.C. § 119 of Japanese Patent Application No. 2008-165383 filed on Jun. 25, 2008, Japanese Patent Application No. 2008-279585 filed on Oct. 30, 2008, Japanese Patent Application No. 2008-279965 filed on Oct. 30, 2008, and Japanese Patent Application No. 2008-272915 filed on Oct. 23, 2008, the disclosures of which are incorporated herein by reference.

### BACKGROUND OF THE INVENTION

1. Field of the Invention

The present invention relates to a fuel injection device which feeds fuel accumulated in a fuel accumulation part in a pressure-accumulated state to each cylinder of an internal combustion engine from a fuel injector.

2. Description of Related Art

In conventional fuel injection to each cylinder, an engine controlling device (corresponding to a control unit in the present invention) calculates a fuel injection amount based on an operating condition of a vehicle, such as an engine rotation speed and an accelerator opening, which corresponds to the depression of an accelerator pedal, and outputs an injection command signal indicating the fuel injection amount to a fuel injector of each cylinder to inject fuel. However, the lift amount of a nozzle needle in the fuel injector or the area of a fuel injection port is varied due to manufacturing tolerance of the fuel injector, which varies the fuel injection amount. In addition, the air intake amount or dimension of each cylinder is also varied. Because of these factors, even if fuel injection signals which have the same wave forms are output to the fuel injector of each cylinder, there are variations in the generated torque among the cylinders.

The variations of the generated torque among the cylinders may be detected based on variations in the engine rotation angle speed or the crank angle speed. Conventionally, the variations of the generated torque, which is the combined result of factors such as those described above, are left unchanged, and the injection command signal to a fuel injector is modified to suppress the variations of the generated torque.

There has been also an increasing demand to improve the control accuracy of the actual fuel injection amount to the combustion chamber of each cylinder to conform to the exhaust emission controls.

Japanese Patent Publication No. 2003-184632 (FIGS. 4 and 12, and [0051] to [0058]) discloses a fuel injection device which includes a fuel accumulation part for accumulating fuel delivered by a fuel pump in a pressure-accumulated state, a fuel injection valve for supplying to each cylinder of an internal combustion engine fuel which is supplied through a fuel supply passage branched from the fuel accumulation part, and a control unit which outputs an injection command signal for injecting the fuel from the fuel injection valve. The fuel injection device further includes a differential pressure sensor for detecting the pressure difference at a venturi constriction provided in the fuel supply passage, and the control unit calculates the fuel supply amount which passes through the venturi constriction based on the signal from the differential, pressure sensor.

Japanese Patent No. 3542211 (see FIGS. 3A to 3D) discloses a fuel injection device which includes a fuel accumulation part for accumulating fuel delivered by a fuel pump in a pressure-accumulated state, a fuel injection valve for supplying to each cylinder of an internal combustion engine fuel which is supplied through a fuel supply passage branched from the fuel accumulation part, and a control unit which outputs an injection command signal for injecting the fuel from the fuel injection valve. The fuel injection device further includes an orifice in the vicinity of an end of the fuel supply passage on the side of the fuel accumulation part. The fuel injection device suppresses pulsations of the pressure of the fuel accumulation part by changing the opening diameter of the orifice, depending on the capacities of the fuel accumulation part and fuel supply passages for distributing fuel in each cylinder.

In order to reduce PM (Particulate Material) or combustion noise by premix combustion, a technique for multi-injection has been used which divides fuel injection from the fuel injection valve into separate phases. For example, a Pilot fuel injection is performed when a piston well advances from TDC (Top Dead Center) (during a compression stroke), and a Main fuel injection is performed around TDC in the technique. However, there has been a problem in the multi-injection that the fuel injection amount of the latter fuel injection can not be controlled accurately since the pressure of the fuel accumulation part at the time when the latter fuel injection starts is affected by the pressure fluctuations (pulsation wave is generated) caused by the former fuel injection.

If the Main fuel injection is performed at the three timings shown as the cases A, B, C after the Pilot fuel injection is performed as shown in FIG. 85A, the pressure of a high pressure fuel supply passage at the time when the Main fuel injection starts after the Pilot fuel injection is performed is significantly varied among the three cases A, B, C as shown in FIG. 85B. The pressure difference between the pressure behavior curves of the case A and the case C at the time when the Main fuel injection starts is 10 MPa. Therefore, it is obvious that the actual injection amounts differ between the two cases if the time for which the Main fuel injection is performed is the same. It is to be noted that the pressure behavior curve of the case D in FIG. 85B is a pressure behavior curve when only the Pilot fuel injection is performed.

In view of the above problem, the invention disclosed in Japanese Patent No. 3803521 (see FIG. 2) estimates the pressure variation of the fuel accumulation part caused by the former fuel injection based on experimental data which has been obtained in advance. Specifically, the invention of Japanese Patent No. 3803521 obtains effects of the pressure amplitude of the pulsation waves based on the injection time of the Pilot fuel injection, effects of the phase of the pulsation waves based on the time from the injection finishing timing of the Pilot fuel injection to the injection start timing of the Main fuel injection, the injection time of the Main fuel injection which has not been corrected, and a factor for modifying a pressure variation correction amount based on fuel temperature, and corrects the injection time of the Main fuel injection based on the effects of the pressure amplitude of the pulsation waves, effects of the phase of the pulsation waves and the factor for modifying a pressure variation correction amount.

However, in the fuel injection device disclosed in Japanese Unexamined Patent Publication No. 2003-184632, there is a limitation in forming the smallest diameter part of the venturi constriction by a draw forming, and it is difficult to smoothly and rapidly draw the venturi constriction in terms of a tube drawing technique. It is also difficult to form the venturi constriction with a high degree of accuracy. For example, it is difficult to form the smallest diameter part to be fully small. The pressure difference generated at the venturi constriction is also small, and thus it is difficult to accurately calculate a fuel supply amount at the time of fuel injection from the fuel injection valve based on the pressure difference at the venturi constriction.

Even if an orifice is provided in the fuel supply passage by the technique disclosed in Japanese Patent No. 354221 to suppress the pulsations of the pressure of the fuel accumulation part, the actual fuel injection amount is still varied due to manufacturing tolerance of the fuel injection valve.

In the technique disclosed in Japanese Patent No. 3803521 (see FIG. 2), the actual fuel injection amount is still varied due to manufacturing tolerance of the fuel injection valve. More specifically, even if a target fuel injection amount is determined based on an engine rotation speed and an accelerator opening, a target pilot fuel injection amount of the Pilot fuel injection is determined, and a target main fuel injection amount is determined to be the amount obtained by subtracting the target pilot fuel injection amount from the target fuel injection amount, actual fuel injection is not performed in accordance with the target pilot fuel injection amount and target main fuel injection amount due to manufacturing tolerance of the fuel injection valve, which makes the actual fuel injection amount to be different from the target fuel injection amount. Furthermore, the actual fuel injection amount becomes different from the target main fuel injection amount because of the estimation error of the pressure variation in the fuel accumulation part caused by the pressure variation of the Pilot fuel injection.

There has been also a problem that a secular change in the injection characteristic of each fuel injection valve has not been considered.

### SUMMARY OF THE INVENTION

The present invention has been made in view of the above problems, and an object thereof is to provide a fuel injection device that enables to accurately calculate a fuel injection amount which is actually injected and to more precisely inject fuel in accordance with a target fuel injection amount.

A first aspect of the present invention is to provide a fuel injection device including: a fuel accumulation part for accumulating fuel delivered by a fuel pump in a pressure-accumulated state; a fuel injection valve for supplying to a combustion chamber of a cylinder of an internal combustion engine the fuel which is supplied through one of a plurality of fuel supply passages branched from the fuel accumulation part to cylinders; a control unit which outputs an injection command signal for injecting the fuel from the fuel injection valve; an orifice provided in the fuel supply passage; and a differential pressure sensor for detecting a pressure difference between upstream and downstream sides of the orifice provided in the supply passages; the control unit calculating an actual fuel supply amount which passes the orifice based on a signal from the differential pressure sensor.

A second aspect of the present invention provides a fuel injection device including: a fuel accumulation part for accumulating fuel delivered by a fuel pump in a pressure-accumulated state; a fuel injection valve for supplying to a combustion chamber of a cylinder of an internal combustion engine the fuel which is supplied through one of a plurality of fuel supply passages branched from the fuel accumulation part to cylinders; a control unit which outputs an injection command signal for injecting the fuel from the fuel injection valve; an accumulation part pressure sensor for detecting a pressure of the fuel accumulation part; an orifice provided in the fuel supply passage; and a fuel supply passage pressure sensor for detecting a pressure on a downstream side of the orifice provided in the fuel supply passage, the control unit calculating an actual fuel supply amount which passes the orifice by calculating a pressure difference between upstream and downstream sides of the orifice based on signals from the accumulation part pressure sensor and the fuel supply passage pressure sensor.

A third aspect of the present invention provides a fuel injection device including: a fuel accumulation part for accumulating fuel delivered by a fuel pump in a pressure-accumulated state; a fuel injection valve for supplying to a combustion chamber of a cylinder of an internal combustion engine the fuel which is supplied through one of a plurality of fuel supply passages branched from the fuel accumulation part to cylinders; a control unit which outputs an injection command signal for injecting the fuel from the fuel injection valve; an orifice provided in the fuel supply passage; and a fuel supply passage pressure sensor for detecting a pressure on a downstream side of the orifice provided in the fuel supply passage, the control unit detecting an amount of pressure decrease on the downstream side of the orifice caused by fuel injection from the fuel injection valve based on a signal from the fuel supply passage pressure sensor and calculating an actual fuel supply amount which passes the orifice based on the detected amount of the pressure decrease.

In the aforementioned fuel injection device, the control unit may calculate the actual fuel supply amount based on the amount of the pressure decrease during a period from a first timing at which the pressure decrease on the downstream side of the orifice is detected after a rise of the injection command signal for the fuel, injection valve to a second timing at which the pressure on the downstream side of the orifice becomes equal to or more than a predetermined value after the first timing.

In the aforementioned fuel injection device, the control unit may store in advance data of a reference pressure reduction line of which value is simply decreased as the time lapses, obtain a first timing at which the pressure on the downstream side of the orifice is decreased to be equal, to or less than a threshold value after a rise of the injection command signal for the fuel injection valve, obtain the pressure on the downstream side of the orifice at the first timing, set the reference pressure reduction line by taking the pressure on the downstream side of the orifice at the first timing as an initial value of the reference pressure reduction line, obtain a second timing at which the pressure on the downstream side of the orifice is increased to be equal to or more than the set reference pressure reduction line after the first timing, and calculate the actual fuel supply amount based on the amount of the pressure decrease during a period from the first timing to the second timing.

In the aforementioned fuel injection device, the control unit may filtering process the signal from the fuel supply passage pressure sensor to remove a high frequency component, and detect the pressure decrease on the downstream side of the orifice based on the signal from which the high frequency component has been removed by the filtering-process.

In the aforementioned fuel injection device, a volume of a fuel passage from the orifice provided in the fuel supply passage to a fuel injection port of the fuel injection valve of the cylinder may be designed to be greater than the maximum actual fuel supply amount which is supplied at one time for the fuel, injection valve.

In the aforementioned fuel injection device, the fuel injection valve may supply all amount of fuel which is supplied through the fuel supply passage to the combustion chamber of the cylinder at the time of fuel injection, and the control unit calculates the actual fuel supply amount which passes the orifice as an actual fuel injection amount which is actually injected to the cylinder and controls the fuel injection based on the actual fuel, injection amount.

In the aforementioned fuel injection device, the fuel injection valve may return a part of the fuel which has been supplied through the fuel supply passage to a return fuel pipe to discharge the fuel to a low pressure part of a fuel supply system at the time of fuel injection, and the control unit may calculate, from the actual fuel supply amount that passes the orifice, an actual fuel injection amount which is actually supplied to the combustion chamber of the cylinder without returning to the return fuel pipe based on the actual fuel supply amount and a predetermined coefficient value, and controls the fuel injection based on the calculated actual fuel injection amount.

In the aforementioned fuel injection device, the control unit may store in advance the predetermined coefficient values that are associated with at least patterns of the injection command signal, and set an appropriate coefficient value from the stored predetermined coefficient values with reference to at least the patterns of the injection command signal.

In the aforementioned fuel injection device, at least one of the plurality of fuel supply passages may include an orifice and a fuel supply passage pressure sensor for detecting the pressure on the downstream side of the orifice and constitutes a first fuel supply passage for supplying the fuel, to a first cylinder through the fuel injection valve, and another fuel supply passage among the plurality of the fuel supply passages other than the first fuel supply passage includes an orifice and constitutes a second fuel supply passage for supplying the fuel to a second cylinder through the fuel injection valve, and the control unit may: calculate a pressure difference between upstream and downstream sides of the orifice in the first fuel supply passage based on signals from the accumulation part pressure sensor and the fuel supply passage pressure sensor; calculate an actual fuel supply amount to the fuel injection valve of the first cylinder through the first fuel supply passage by using the calculated pressure difference; detect, with the fuel supply passage pressure sensor, a pressure variation which is generated in the second fuel supply passage by supplying the fuel, to the fuel injection valve of the second cylinder through the second fuel supply passage and is propagated to the downstream side of the orifice of the first fuel supply passage through the fuel, accumulation part; calculate an amount of a pressure decrease on a downstream side of the orifice in the second fuel supply passage based on the detected pressure variation; and calculate an actual fuel supply amount to the fuel injection valve of the second cylinder through the second fuel supply passage based on the calculated amount of the pressure decrease on the downstream side of the orifice in the second fuel supply passage.

In the aforementioned fuel injection device, at least one of the plurality of fuel supply passages may include an orifice and a fuel supply passage pressure sensor for detecting the pressure on the downstream side of the orifice and constitutes a first fuel supply passage for supplying the fuel to a first cylinder through the fuel injection valve, and another fuel supply passage among the plurality of the fuel supply passages other than the first fuel supply passage includes an orifice and constitutes a second fuel supply passage for supplying the fuel to a second cylinder through the fuel injection valve, and the control unit: calculates an amount of pressure decrease on a downstream side of the orifice in the first fuel supply passage based on the signal from the fuel supply passage pressure sensor; calculates an actual fuel supply amount to the fuel injection valve of the first cylinder through the first fuel supply passage by using the calculated amount of the pressure decrease; detects, with the fuel supply passage pressure sensor, a pressure variation which is generated in the second fuel supply passage by supplying the fuel to the fuel injection valve of the second cylinder through the second fuel supply passage and is propagated to the downstream side of the orifice of the first fuel supply passage through the fuel accumulation part; calculates an amount of a pressure decrease on a downstream side of the orifice in the second fuel supply passage based on the detected pressure variation; and calculates an actual fuel supply amount to the fuel injection valve of the second cylinder through the second fuel supply passage based on the calculated amount of the pressure decrease on the downstream side of the orifice in the second fuel supply passage.

The aforementioned fuel injection device may further include an accumulation part pressure sensor for detecting a pressure of the fuel accumulation part and a storage unit for storing data of a Ti-Q characteristic which represents a correlation of a fuel injection amount (Q_{inject}) from the fuel injection valve and an injection time (Tᵢ), wherein the fuel injection valve supplies all amount of fuel which is supplied through the fuel supply passage to the combustion chamber of the cylinder at the time of fuel injection, and the Ti-Q characteristic is represented as a characteristic curve which is represented as a polynomial equation obtained by regression analyzing data discretely measuring the correlation of the fuel injection amount (Q_{inject}) and the injection time (Tᵢ) at a representative pressure value representing the pressure of the fuel accumulation part, and wherein the control unit sets a target injection amount of fuel to be injected from the fuel injection valve; obtains a target injection time that corresponds to the target injection amount with reference to the characteristic curve based on the pressure of the fuel accumulation part detected by the accumulation part pressure sensor and the target injection amount; calculates an actual fuel injection amount which is injected by the fuel injection valve during the target injection time based on the signal from the differential pressure sensor, and corrects the Ti-Q characteristic if the actual fuel injection amount is different from the target injection amount.

The aforementioned fuel injection device may further include a storage unit for storing data of a Ti-Q characteristic which represents a correlation of a fuel injection amount (Q_{inject}) from the fuel injection valve and an injection time (Tᵢ), wherein the fuel injection valve supplies all amount of fuel which is supplied through the fuel supply passage to the combustion chamber of the cylinder at the time of fuel injection, and the Ti-Q characteristic is represented as a characteristic curve which is represented as a polynomial, equation obtained by regression analyzing data discretely measuring the correlation of the fuel injection amount (Q_{inject}) and the injection time (Tᵢ) at a representative pressure value representing the pressure of the fuel accumulation part, and wherein the control unit sets a target injection amount of fuel to be injected from the fuel, injection valve; obtains a target injection time that corresponds to the target injection amount with reference to the characteristic curve based on the pressure of the fuel accumulation part detected by the accumulation part pressure sensor and the target injection amount; calculates a pressure difference between upstream and downstream sides of the orifice based on signals from the accumulation part pressure sensor and the fuel supply passage pressure sensor and calculates an actual fuel injection amount which is injected by the fuel injection valve during the target injection time based on the calculated pressure difference; and corrects the Ti-Q characteristic if the actual fuel injection amount is different from the target injection amount.

The aforementioned fuel injection device may further include an accumulation part pressure sensor for detecting a pressure of the fuel accumulation part and a storage unit for storing data of a Ti-Q characteristic which represents a correlation of a fuel injection amount (Q_{inject}) from the fuel injection valve and an injection time (Tᵢ), wherein the fuel injection valve supplies a total amount of fuel which is supplied through the fuel supply passage to the combustion chamber of the cylinder at the time of fuel injection, and the Ti-Q characteristic is represented as a characteristic curve which is represented as a polynomial equation obtained by regression analyzing data discretely measuring the correlation of the fuel injection amount (Q_{inject}) and the injection time (Tᵢ) at a representative pressure value representing the pressure of the fuel accumulation part, and wherein the control unit sets a target injection amount of fuel to be injected from the fuel injection valve; obtains a target injection time that corresponds to the target injection amount with reference to the characteristic curve based on the pressure of the fuel accumulation part detected by the accumulation part pressure sensor and the target injection amount, detects the amount of the pressure decrease on the downstream side of the orifice caused by the fuel injection based on the signal from the fuel supply passage pressure sensor and calculates an actual fuel injection amount which is injected by the fuel injection valve during the target injection time based on the amount of the pressure decrease; and corrects the Ti-Q characteristic if the actual fuel injection amount is different from the target injection amount.

The aforementioned fuel injection device may further include an accumulation part pressure sensor for detecting a pressure of the fuel accumulation part and a storage unit for storing data of a Ti-Q characteristic which represents a correlation of a fuel injection amount (Q_{inject}) from the fuel injection valve and an injection time (Tᵢ), wherein the fuel injection valve returns a part of the fuel which has been supplied through the fuel supply passage to a return fuel pipe to discharge the fuel to a low pressure part of a fuel supply system at the time of fuel injection, and the Ti-Q characteristic is represented as a characteristic curve which is represented as a polynomial equation obtained by regression analyzing data discretely measuring the correlation of the fuel injection amount (Q_{inject}) and the injection time (Tᵢ) at a representative pressure value representing the pressure of the fuel accumulation part, and wherein the control unit sets a target injection amount of fuel to be injected from the fuel injection valve; obtains a target injection time that corresponds to the target injection amount with reference to the characteristic curve based on the pressure of the fuel accumulation part detected by the accumulation part pressure sensor and the target injection amount; calculates an amount of fuel which has passed the orifice for the target injection time based on the signal from the differential pressure sensor and calculates, from the amount of fuel that has passed the orifice, an actual fuel injection amount which is actually supplied to the combustion chamber of the cylinder without returning to the return fuel pipe based on the amount of fuel that has passed the orifice and a predetermined coefficient value, and corrects the Ti-Q characteristic if the actual fuel injection amount is different from the target injection amount.

The aforementioned fuel injection device may further include a storage unit for storing data of a Ti-Q characteristic which represents a correlation of a fuel injection amount (Q_{inject}) from the fuel injection valve and an injection time (Tᵢ), wherein the fuel injection valve returns a part of the fuel which has been supplied through the fuel supply passage to a return fuel pipe to discharge the fuel to a low pressure part of a fuel supply system at the time of fuel injection, and the Ti-Q characteristic is represented as a characteristic, curve which is represented as a polynomial equation obtained by regression analyzing data discretely measuring the correlation of the fuel injection amount (Q_{inject}) and the injection time (Tᵢ) at a representative pressure value representing the pressure of the fuel accumulation part, and wherein the control unit sets a target injection amount of fuel to be injected from the fuel injection valve; obtains a target injection time that corresponds to the target injection amount with reference to the characteristic curve based on the pressure of the fuel, accumulation part detected by the accumulation part pressure sensor and the target injection amount; calculates a pressure difference between upstream and downstream sides of the orifice based on signals from the accumulation part pressure sensor and the fuel supply passage pressure sensor, calculates an amount of fuel which has passed the orifice for the target injection time based on the pressure difference, and calculates, from the amount of fuel that has passed the orifice, an actual fuel, injection amount which is actually supplied to the combustion chamber of the cylinder without returning to the return fuel pipe based on the amount of fuel that has passed the orifice and a predetermined coefficient value; and corrects the Ti-Q characteristic if the actual fuel injection amount is different from the target injection amount.

The aforementioned fuel injection device may further include an accumulation part pressure sensor for detecting a pressure of the fuel accumulation part and a storage unit; for storing data of a Ti-Q characteristic which represents a correlation of a fuel injection amount (Q_{inject}) from the fuel injection valve and an injection time (Tᵢ), wherein the fuel injection valve returns a part of the fuel, which has been supplied through the fuel supply passage to a return fuel, pipe to discharge the fuel to a low pressure part of a fuel supply system at the time of fuel injection, and the Ti-Q characteristic is represented as a characteristic curve which is represented as a polynomial equation obtained by regression analyzing data discretely measuring the correlation of the fuel injection amount (Q_{inject}) and the injection time (Tᵢ) at a representative pressure value representing the pressure of the fuel accumulation part, and wherein the control unit sets a target injection amount of fuel to be injected from the fuel injection valve; obtains a target injection time that corresponds to the target injection amount with reference to the characteristic curve based on the pressure of the fuel accumulation part detected by the accumulation part pressure sensor and the target injection amount; detects the amount of the pressure decrease on the downstream side of the orifice caused by the fuel injection based on the signal from the fuel supply passage pressure sensor, calculates an amount of the fuel which has passed the orifice for the target injection time based on the amount of the pressure decrease, and calculates, from the amount of the fuel that has passed the orifice, an actual fuel injection amount which is actually supplied to the combustion chamber of the cylinder without returning to the return fuel pipe based on the amount of the fuel that has passed the orifice and a predetermined coefficient value; and corrects the Ti-Q characteristic if the actual fuel injection amount is different from the target injection amount.

In the aforementioned fuel injection device, the fuel injection valve supplies all amount of fuel which is supplied through the fuel supply passage to the combustion chamber of the cylinder at the time of fuel injection, and the control unit: sets the injection command signal for injecting the fuel from the fuel injection valve based on an operation condition of the internal combustion engine; includes an actual fuel supply information detection unit for determining, based on the injection command signal, fuel injection information that includes at least an injection start timing and an injection finishing timing of the fuel injection valve, performing during a compression stroke or an expansion stroke of the cylinder of the internal combustion engine a multi-injection in which the fuel injection from the fuel injection valve is divided into a plurality of times of fuel injections, and for detecting actual fuel supply information on the fuel that has passed the orifice based on the signal from the differential pressure sensor, and an actual fuel injection information detection unit for detecting actual fuel injection information based on the detected actual fuel supply information; and determines the fuel injection information on a subsequent fuel injection that is performed later than a preceding fuel injection based on the actual fuel injection information of the preceding fuel injection which is performed relatively earlier than other fuel injections of the plurality of times of the fuel injections.

In the aforementioned fuel injection device, the fuel injection valve supplies all amount of fuel which is supplied through the fuel supply passage to the combustion chamber of the cylinder at the time of fuel injection, and the control unit: sets the injection command signal for injecting the fuel from the fuel injection valve based on an operation condition of the internal combustion engine; includes an actual fuel supply information defection unit for determining, based on the injection command signal, fuel injection information that includes at least an injection start timing and an injection finishing timing of the fuel injection valve, performing during a compression stroke or an expansion stroke of the cylinder of the internal combustion engine a multi-injection in which the fuel injection from the fuel injection valve is divided into a plurality of times of fuel injections, and for detecting the amount of the pressure decrease on the downstream side of the orifice caused by the fuel injection from the fuel injection valve based on the signal from the fuel supply passage pressure sensor, and calculates an actual fuel supply information on the fuel that has passed the orifice based on the amount of the pressure decrease, and an actual fuel injection information detection unit for detecting actual fuel injection information based on the detected actual fuel supply information; and determines the fuel injection information on a subsequent fuel injection that is performed later than a preceding fuel injection based on the actual fuel injection information of the preceding fuel injection which is performed relatively earlier than other fuel injections of the plurality of times of the fuel injections.

In the aforementioned fuel injection device, the fuel injection valve supplies all amount of fuel which is supplied through the fuel supply passage to the combustion chamber of the cylinder at the time of fuel injection, and the control unit: sets the injection command signal for injecting the fuel from the fuel injection valve based on an operation condition of the internal combustion engine; includes an actual fuel supply information detection unit for determining, based on the injection command signal, fuel injection information that includes at least an injection start timing and an injection finishing timing of the fuel injection valve, performing during a compression stroke or an expansion stroke of the cylinder of the infernal combustion engine a multi-injection in which the fuel injection from the fuel injection valve is divided into a plurality of times of fuel injections, and for detecting the amount of the pressure decrease on the downstream side of the orifice caused by the fuel injection from the fuel injection valve based on the signal from the fuel supply passage pressure sensor, and calculates an actual fuel supply information on the fuel that has passed the orifice based on the amount of the pressure decrease, and an actual fuel injection information detection unit for detecting actual fuel injection information based on the detected actual fuel supply information; and determines the fuel injection information on a subsequent fuel injection that is performed later than a preceding fuel injection based on the actual fuel injection information of the preceding fuel injection which is performed relatively earlier than other fuel injections of the plurality of times of the fuel injections.

In the aforementioned fuel injection device, the fuel injection valve returns, as a back flow, a part of the fuel which has been supplied through the fuel supply passage to a return fuel pipe to discharge the fuel to a low pressure part of a fuel supply system at the time of fuel injection, and the control unit: sets the injection command signal for injecting the fuel from the fuel injection valve based on an operation condition of the internal combustion engine; includes an actual fuel supply information detection unit for determining, based on the injection command signal, fuel injection information that includes at least an injection start timing and an injection finishing timing of the fuel injection valve, performing during a compression stroke or an expansion stroke of the cylinder of the internal combustion engine a multi-injection in which the fuel injection from the fuel injection valve is divided into a plurality of times of fuel injections, and for detecting actual fuel supply information on the fuel that has passed the orifice based on the signal from the differential pressure sensor, and an actual fuel injection information detection unit for detecting actual fuel injection information based on the detected actual fuel supply information and back flow information on the back flow which is stored in advance; and determines the fuel injection information on a subsequent fuel injection that is performed later than a preceding fuel injection based on the actual fuel injection information of the preceding fuel injection which is performed relatively earlier than other fuel injections of the plurality of times of the fuel injections.

In the aforementioned fuel injection device, the fuel injection valve returns, as a back flow, a part of the fuel which has been supplied through the fuel supply passage to a return fuel pipe to discharge the fuel to a low pressure part of a fuel supply system at the time of fuel injection, and the control unit: sets the injection command signal for injecting the fuel from the fuel injection valve based on an operation condition of the internal combustion engine; includes an actual fuel supply information detection unit for determining, based on the injection command signal, fuel injection information that includes at least an injection start timing and an injection finishing timing of the fuel injection valve, performing during a compression stroke or an expansion stroke of the cylinder of the internal combustion engine a multi-injection in which the fuel injection from the fuel injection valve is divided into a plurality of times of fuel injections, and for detecting actual fuel supply information on the fuel that has passed the orifice based on the signals from the accumulation part pressure sensor and the fuel supply passage pressure sensor, and an actual fuel injection information detection unit for detecting actual fuel injection information based on the detected actual fuel supply information and back flow information on the back flow which is stored in advance; and determines the fuel injection information on a subsequent fuel injection that is performed later than a preceding fuel injection based on the actual fuel injection information of the preceding fuel injection which is performed relatively earlier than other fuel injections of the plurality of times of the fuel injections.

In the aforementioned fuel injection device, the fuel injection valve returns, as a back flow, a part of the fuel which has been supplied through the fuel supply passage to a return fuel pipe to discharge the fuel to a low pressure part of a fuel supply system at the time of fuel injection, and the control unit: sets the injection command signal for injecting the fuel from the fuel injection valve based on an operation condition of the internal combustion engine; includes an actual fuel supply information detection unit for determining, based on the injection command signal, fuel, injection information that includes at least an injection start timing and an injection finishing timing of the fuel injection valve, performing during a compression stroke or an expansion stroke of the cylinder of the internal combustion engine a multi-injection in which the fuel injection from the fuel injection valve is divided into a plurality of times of fuel injections, and for detecting the amount of the pressure decrease on the downstream side of the orifice caused by the fuel injection from the fuel injection valve based on the signal from the fuel supply passage pressure sensor, and calculates an actual fuel supply information on the fuel that has passed the orifice based on the amount of the pressure decrease, and an actual fuel injection information detection unit for detecting actual fuel injection information based on the detected actual fuel supply information and back flow information on the back flow which is stored in advance; and determines the fuel injection information on a subsequent fuel injection that is performed later than a preceding fuel injection based on the actual fuel injection information of the preceding fuel injection which is performed relatively earlier than other fuel injections of the plurality of times of the fuel injections.

Other features and advantages of the present invention will become more apparent from the following detailed descriptions of the invention when taken in conjunction with the accompanying drawings.

### BRIEF DESCRIPTION OF THE DRAWINGS

FIG. 1 is an illustration showing an entire configuration of an accumulator fuel injection device according to a first embodiment of the present invention.

FIG. 2 is an illustration for showing a conceptual configuration of a direct acting fuel injection valve (injector) used in the accumulator fuel injection device according to the first embodiment.

FIG. 3A is a graph for showing an output pattern of the injection command signal for one cylinder.

FIG. 3B is a graph for showing the temporal variation of an actual fuel injection rate of the injector.

FIG. 3C is a graph for showing the temporal variation of the orifice passing flow rate of fuel.

FIG. 3D is a graph for showing the temporal variation of the pressures in the upstream and downstream sides of the orifice.

FIG. 4 is an illustration for showing an entire configuration of the accumulator fuel injection device according to the second embodiment.

FIG. 5 is an illustration for showing an entire configuration of the accumulator fuel injection device of the third embodiment.

FIG. 6 is a flowchart showing processing performed by the ECU 80C of the third embodiment for calculating the actual injection amount for one cylinder.

FIG. 7A is a graph for showing an output pattern of an injection command signal.

FIG. 7B is a graph for showing the temporal variation of the pressure Ps_{fil} on the downstream side of the orifice 75.

FIG. 8 is a flowchart showing a process performed by the ECU 80C of the modification of the third embodiment for calculating an orifice passing flow rate Q_{OR} for one cylinder.

FIG. 9A is a graph showing a reference pressure reduction line indicating the reduction of the pressure on the upstream side of the orifice 75 during fuel injection.

FIG. 9B is a graph for showing an output pattern of the injection command signal.

FIG. 9C is a graph for showing the temporal variation of the pressure Ps_{fil} on the downstream side of the orifice 75.

FIG. 10 is an illustration showing an entire configuration of an accumulator fuel injection device of a fourth embodiment.

FIG. 11 is a conceptional configuration drawing of a back pressure fuel injection valve (injector) which is used in the accumulator fuel injection device according to the fourth embodiment.

FIG. 12A is a graph for showing the output pattern of the injection command signal.

FIG. 12B is a graph for showing the temporal variations of an actual fuel injection rate and a back flow rate.

FIG. 12C is a graph for showing the temporal variation of an orifice passing flow rate of fuel.

FIG. 12D is a graph for showing the temporal variations of the pressures on the upstream and downs stream sides of the orifice.

FIG. 13 is a graph for showing an entire configuration of the accumulator fuel injection device of a fifth embodiment.

FIG. 14 is an illustration for showing an entire configuration of the accumulator fuel injection device of a sixth embodiment.

FIG. 15 is a flow chart showing a control flow performed by the ECU 80F of the sixth embodiment for calculating the orifice passing flow rate Q_{OR} and the actual injection amount for one cylinder.

FIG. 16A is a graph for showing an output pattern of the injection command signal.

FIG. 16B is a graph for showing the temporal variation of the pressure Ps_{fil} on the downstream side of the orifice.

FIG. 17 is a flowchart showing a process performed by the ECU 80F of the modification of the sixth embodiment for calculating an orifice passing flow rate Q_{OR} for one cylinder.

FIG. 18A is a graph for showing an output pattern of the injection command signal.

FIG. 18B is a graph for showing the temporal variation of the pressure Ps_{fil} on the downstream side of the orifice 75.

FIG. 19A is a graph showing the temporal variation of the common rail pressure Pc in the case where an orifice is provided.

FIG. 19B is a graph showing the temporal variation of the pressure (in the vicinity of the injector) of a high pressure fuel supply passage for own cylinder (#1 cylinder) in the case where an orifice is provided.

FIG. 19C is a graph showing is a graph showing the temporal variation of the pressure (in the vicinity of the common rail) of a high pressure fuel supply passage for own cylinder (#1 cylinder) in the case where an orifice is provided.

FIG. 19D is a graph showing the temporal variation of the common rail pressure Pc in the case where an orifice is not provided.

FIG. 19E is a graph showing the temporal variation of the pressure (in the vicinity of the injector) of a high pressure fuel supply passage for own cylinder (#1 cylinder) in the case where an orifice is not provided.

FIG. 19F is a graph showing the temporal variation of the pressure (in the vicinity of the common rail) of a high pressure fuel supply passage for own cylinder (#1 cylinder) in the case where an orifice is not provided.

FIG. 20 is an illustration showing an entire configuration of the accumulator fuel injection device in a seventh embodiment.

FIG. 21 is a functional block diagram of the engine controlling device used in the accumulator fuel injection device of a seventh embodiment.

FIG. 22 is a conceptual graph of a two dimensional map for determining the injection time Tᵢ that corresponds to the target injection amount Q_{T}.

FIG. 23 is a conceptual graph of a map of a correction factor K₁ for obtaining the correction factor of the injection time, where a target injection amount, an injection time and a common rail pressure are taken as parameters.

FIG. 24A is an illustration showing output timings of the injection command signals for each cylinder in a period from the fuel injection to the cylinder #1 to the next fuel injection to the cylinder #1 at the same crank angle.

FIG. 24B is an illustration for showing the pressure variation detected by the fuel supply passage pressure sensor S_{Ps}.

FIG. 25 is a flow chart for showing the operation of the ECU 80G for controlling a fuel injection to one cylinder, and acquiring an actual injection amount, which is the result of the fuel injection.

FIG. 26A is a graph showing a line indicating an average decrease of the common rail pressure caused by fuel injection.

FIG. 26B is a graph showing a first reference line indicating the pressure decrease on the upstream side of the orifice 75 caused by the pressure variation generated in the high pressure fuel supply passage 21B.

FIG. 26C is an illustration showing a second reference line indicating the pressure decrease on the upstream side of the orifice 75 caused by the pressure variation generated in the high pressure fuel supply passage 21A.

FIG. 27 is a flow chart of a control operation for calculating the actual fuel supply amount and the actual injection amount.

FIG. 28 is a flow chart of a control operation for calculating the actual fuel supply amount and the actual injection amount.

FIG. 29A is a graph for showing an output pattern of the injection command signal.

FIG. 29B is a graph for showing the temporal variation of the actual fuel injection rate of an injector.

FIG. 29C is a graph showing the temporal variation of the orifice passing flow rate of the high pressure fuel supply passage 21A.

FIG. 29D is a graph for showing the temporal variations of the pressures of the high pressure fuel supply passage 21A on the upstream and downstream sides of the orifice.

FIG. 30A is a graph for showing an output pattern of the injection command signal.

FIG. 30B is a graph for showing the temporal variation of the actual fuel injection rate of an injector.

FIG. 30C is a graph for showing the temporal variation of the orifice passing flow rate of the high pressure fuel supply passage 21B.

FIG. 30D is a graph for showing the temporal variations of the pressures of the high pressure fuel supply passage 21A on the upstream and downstream sides of the orifice.

FIG. 31 is a flow chart of the control operation in a first modification of the seventh embodiment for calculating the actual fuel supply amount and the actual injection amount.

FIG. 32 is an illustration for showing an entire configuration of the accumulator fuel injection device of an eighth embodiment.

FIG. 33 is a functional block diagram of an engine controlling device used in the accumulator fuel injection device of the eighth embodiment.

FIG. 34 is a flow chart showing a control flow performed by the ECU 80H of the eighth embodiment for calculating an actual fuel supply amount based on an orifice passing flow rate Q_{OR} of fuel for the first cylinder and converting the actual fuel supply amount to an actual injection amount.

FIG. 35A is an illustration showing an output pattern of the injection command signal.

FIG. 35B is an illustration showing the temporal variation of the actual fuel injection rate of the injector.

FIG. 35C is an illustration showing the temporal variation of the orifice passing flow rate of the high pressure fuel supply passage 21A.

FIG. 35D is an illustration showing the temporal variation of the pressure on the downstream side of the orifice.

FIG. 36 is a flow chart showing a control flow for calculating an actual fuel supply amount and obtaining a calculation correction factor K₂ in a modification of the eighth embodiment.

FIG. 37 is an illustration for showing an entire configuration of the accumulator fuel injection device of a ninth embodiment.

FIG. 38 is a functional block diagram of an engine controlling device used in the accumulator fuel injection device of the ninth embodiment.

FIG. 39A is a graph showing an output pattern of the injection command signal.

FIG. 39B is a graph showing the temporal variation of the actual fuel, injection rate and the back flow rate of the injector.

FIG. 39C is a graph showing the temporal variation of the orifice passing flow rate of the high pressure fuel supply passage 21A.

FIG. 39D is a graph showing the temporal variation of the pressures on the upstream and downstream sides of the orifice in the high pressure fuel supply passage 21A.

FIG. 40A is a graph showing an output pattern of the injection command signal.

FIG. 40B is a graph showing the temporal variation of the actual fuel injection rate and the back flow rate of the injector.

FIG. 40C is a graph showing the temporal variation of the orifice passing flow rate of the high pressure fuel supply passage 21B.

FIG. 40D is a graph showing the temporal variation of the pressure on the downstream side of the orifice in the first fuel supply passage.

FIG. 41 is an illustration for showing an entire configuration of the accumulator fuel injection device of a tenth embodiment.

FIG. 42 is a functional block diagram of an engine controlling device used in the accumulator fuel injection device of the tenth embodiment.

FIG. 43A is a graph showing an output pattern of the injection command signal.

FIG. 43B is a graph showing the temporal variations of the actual fuel injection rate and the back flow rate of an injector.

FIG. 43C is a graph showing the temporal variations of the orifice passing flow rate of the high pressure fuel supply passage 21A.

FIG. 43D is a graph showing the temporal variations of the pressure on the downstream side of the orifice in the high pressure fuel supply passage 21A.

FIG. 44 is an illustration showing an entire configuration of the accumulator fuel injection device of an eleventh embodiment.

FIG. 45A is a graph showing an example of a Ti-Q characteristic curve f_{Ti}.

FIG. 45B is a graph showing Ti-Q characteristics that corresponds to the common rail pressures.

FIG. 46A is a graph showing the characteristic curves of the Ti-Q characteristics of which common rail pressures are the representative pressure values Pc₁ and Pc₂.

FIG. 46B is a graph showing the correlation equation of the adjacent characteristic curves.

FIG. 47 is a conceptional graph for correcting the characteristic curve of the Ti-Q characteristic.

FIG. 48 is a conceptional graph for correcting the Ti-Q characteristics based on the correlation equation.

FIG. 49 is a flow chart showing an operation performed by the ECU to correct the Ti-Q characteristics.

FIG. 50 is an illustration for showing an entire configuration of the accumulator fuel injection device of a twelfth embodiment.

FIG. 51 is an illustration for showing an entire configuration of the accumulator fuel injection device of a thirteenth embodiment.

FIG. 52 is an illustration for showing an entire configuration of the accumulator fuel injection device of a fourteenth embodiment.

FIG. 53 is an illustration for showing an entire configuration of the accumulator fuel injection device of a fifteenth embodiment.

FIG. 54 is an illustration for showing an entire configuration of the accumulator fuel injection device of a sixteenth embodiment.

FIG. 55 is an illustration for showing an entire configuration of the accumulator fuel injection device of a seventeenth embodiment.

FIG. 56 is a functional block diagram of an engine controlling device used in the accumulator fuel injection device of the seventeenth embodiment.

FIG. 57 is a conceptual graph of a two-dimensional map for determining the injection time Tᵢ that corresponds to the target injection amount Qᵢ.

FIG. 58A is a conceptual graph of a three dimensional map of the correction factor for the Pilot fuel injection.

FIG. 58B is a conceptual graph of a three dimensional map of the correction factor for the Main fuel injection.

FIG. 59 is a flow chart performed by the injection control units 905A, 905B, 905C, 905D to control fuel injection.

FIG. 60 is a flow chart performed by the injection control units 905A, 905B, 905C, 905D to control fuel injection.

FIG. 61 is a flow chart performed by the injection control units 905A, 905B, 905C, 905D to control fuel injection.

FIG. 62 is a flow chart performed by the injection control units 905A, 905B, 905C, 905D to control fuel injection.

FIG. 68 is a flow chart performed by the injection control units 905A, 905B, 905C, 905D to control fuel injection.

FIG. 64A is a graph showing an output pattern of the injection command signals.

FIG. 64B is a graph showing the temporal variations of the actual fuel injection rate and the back flow rate of an injector.

FIG. 64C is a graph showing the temporal variations of the orifice passing flow rate of fuel.

FIG. 64D is a graph showing the temporal variations of the pressures on the upstream and downstream sides of the orifice

FIG. 65 is an illustration for showing an entire configuration of the accumulator fuel injection device of an eighteenth embodiment.

FIG. 66 is an illustration for showing an entire configuration of the accumulator fuel injection device of a nineteenth embodiment.

FIG. 67 is a flow chart showing a control operation performed by the ECU 80U to calculate the orifice passing flow rate Q_{OR} for one cylinder in the nineteenth embodiment.

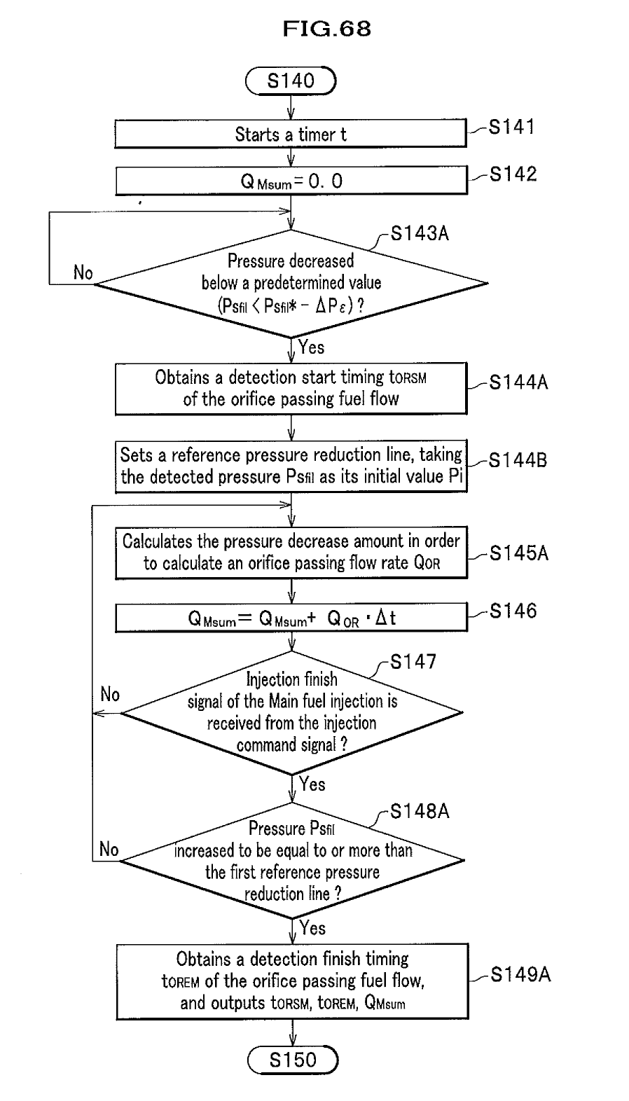

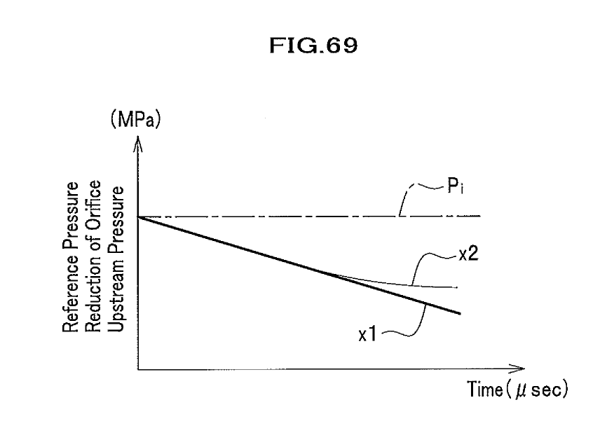

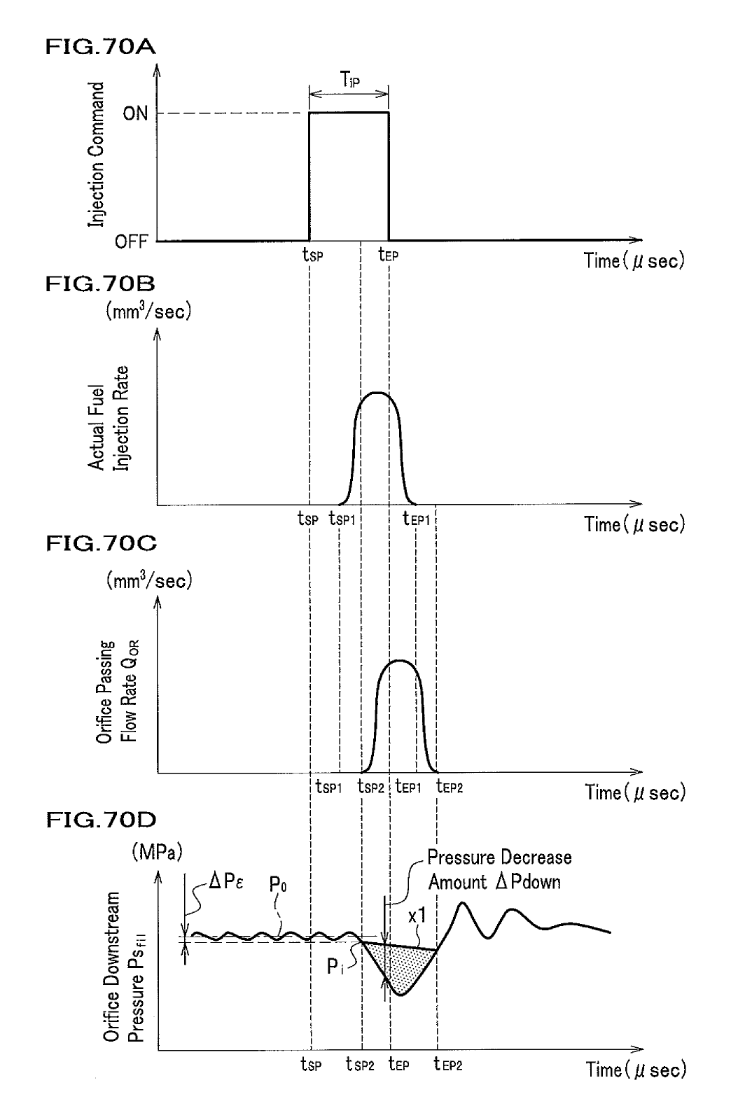

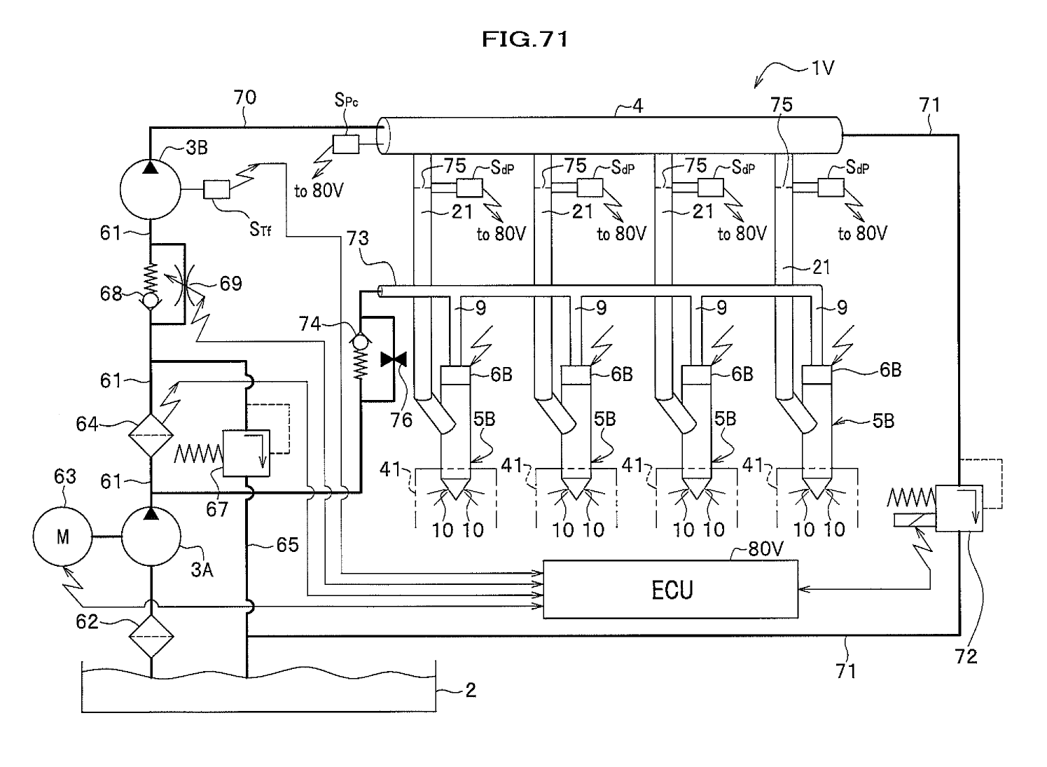

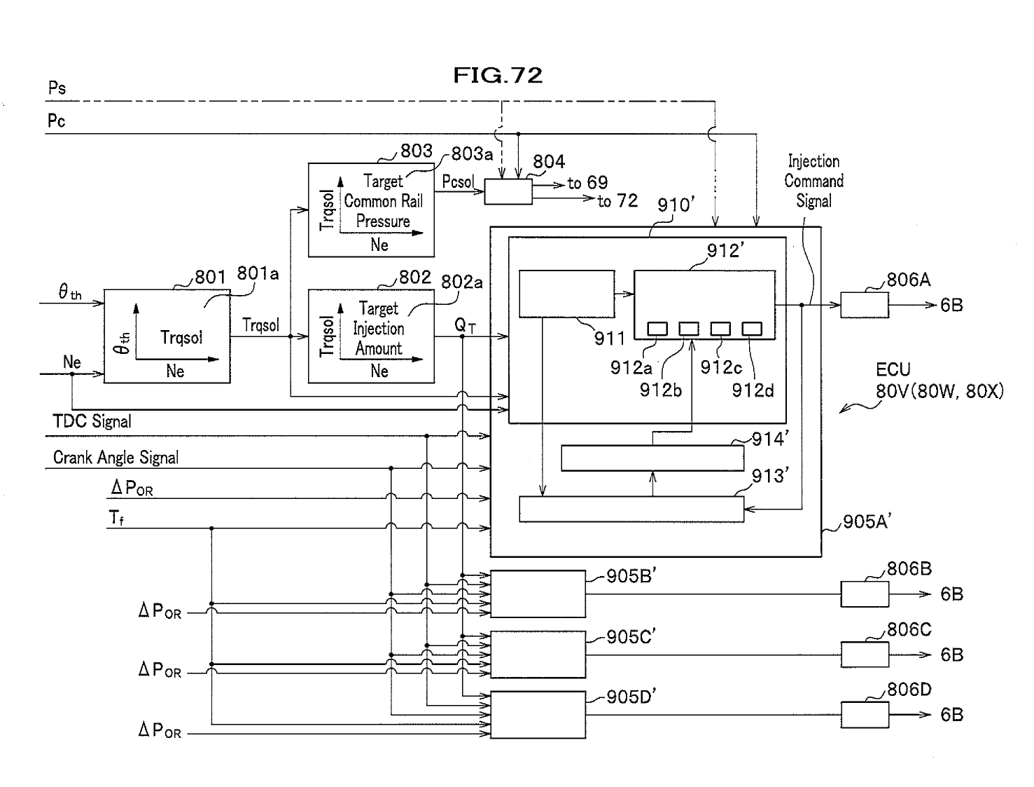

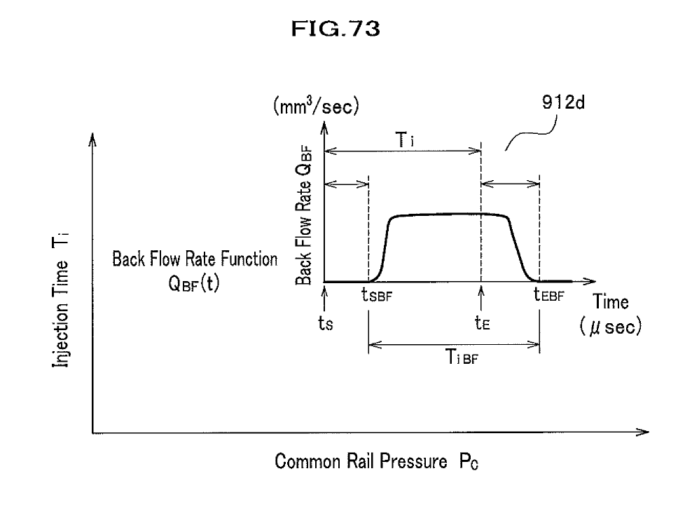

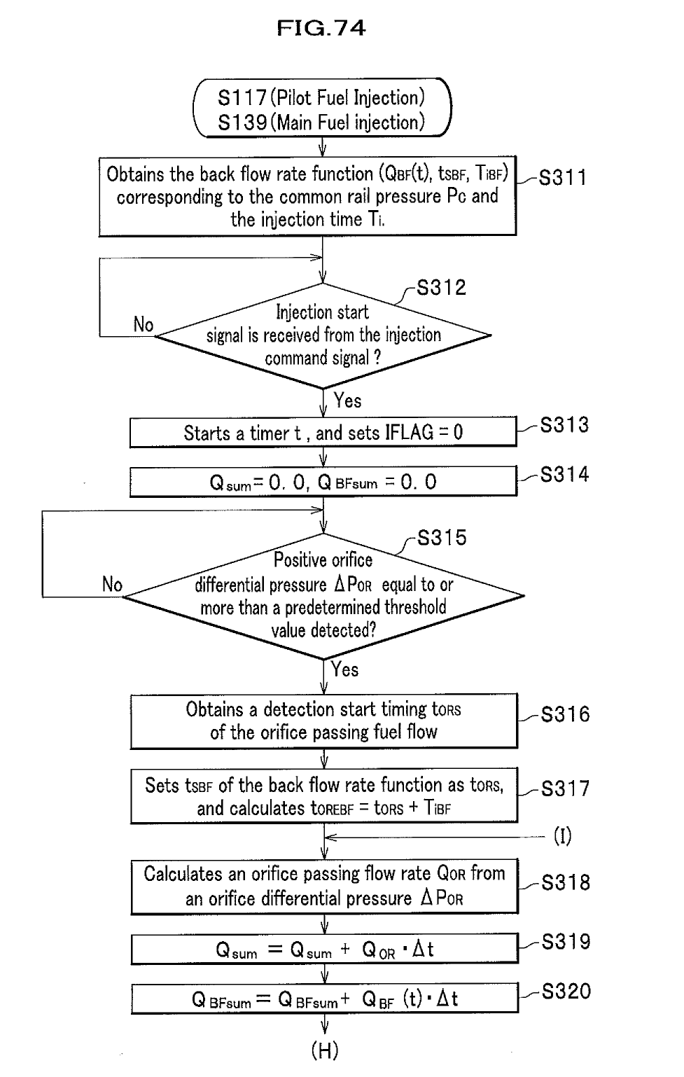

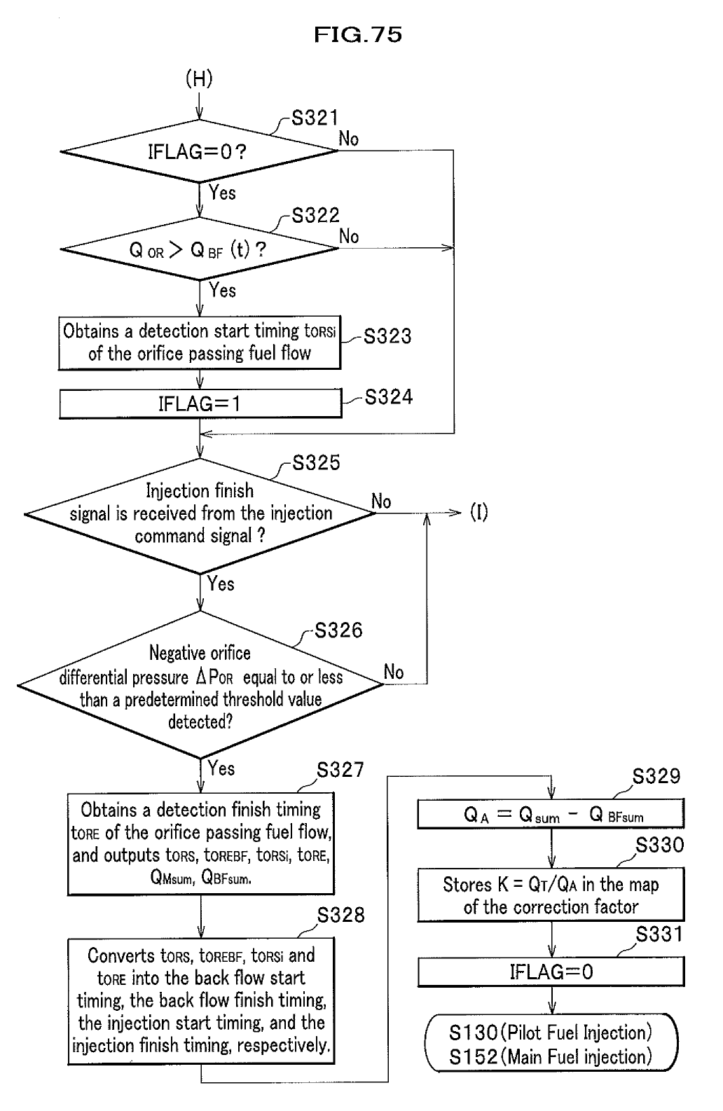

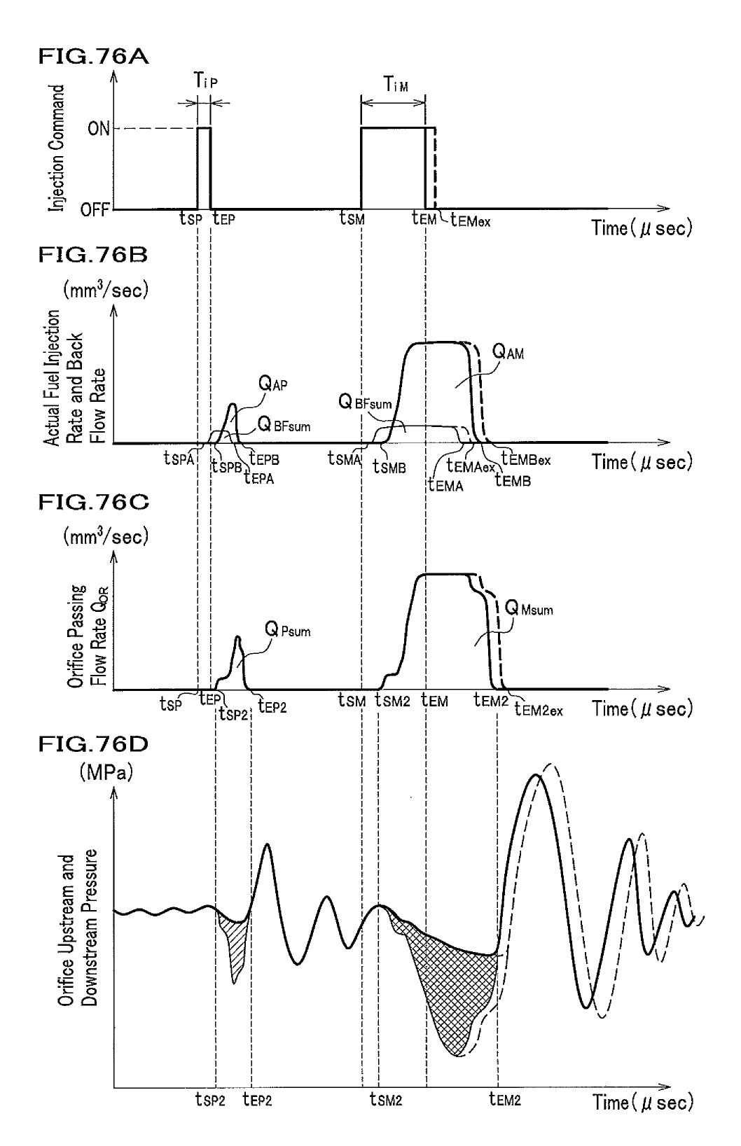

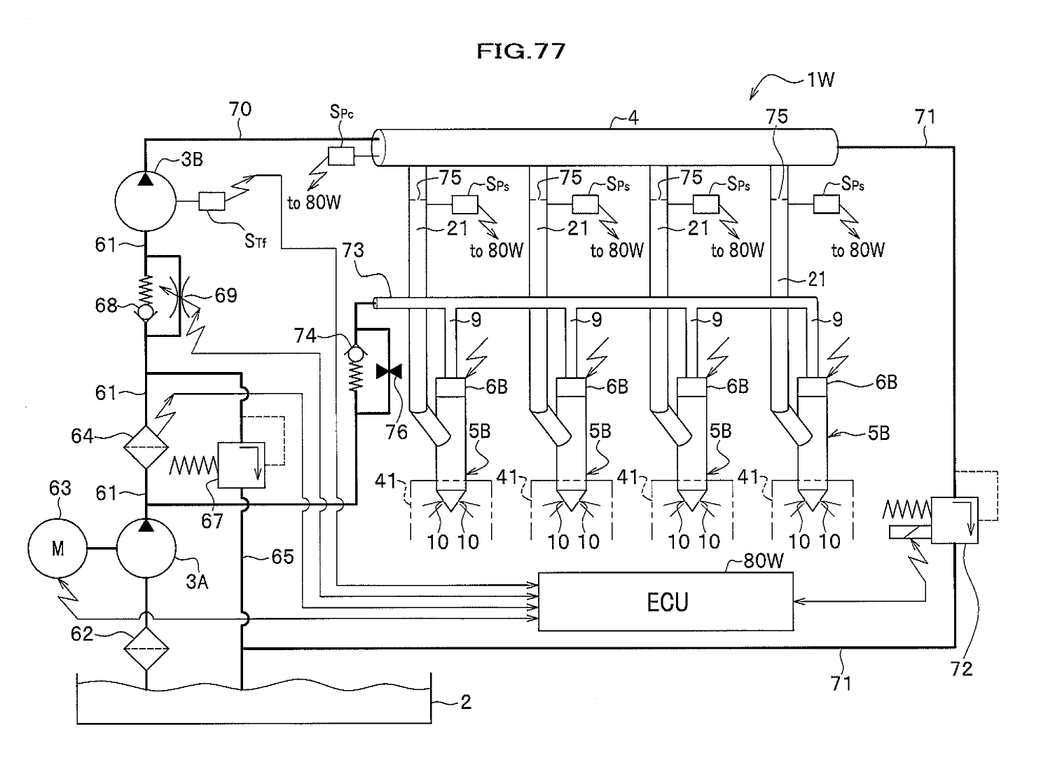

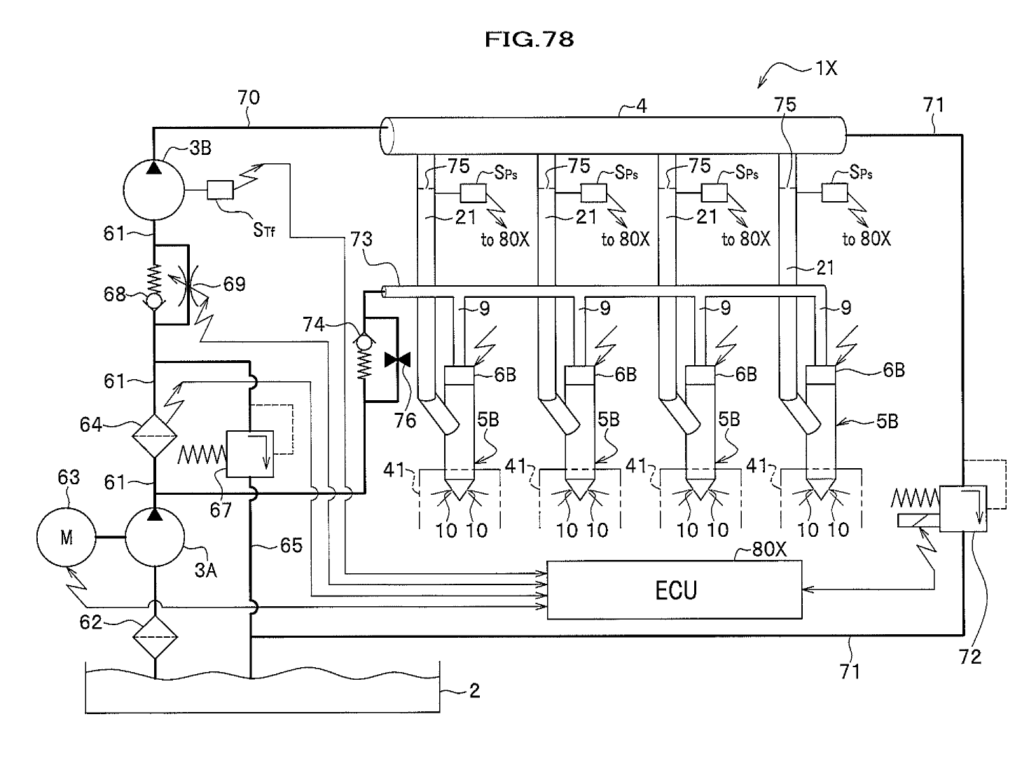

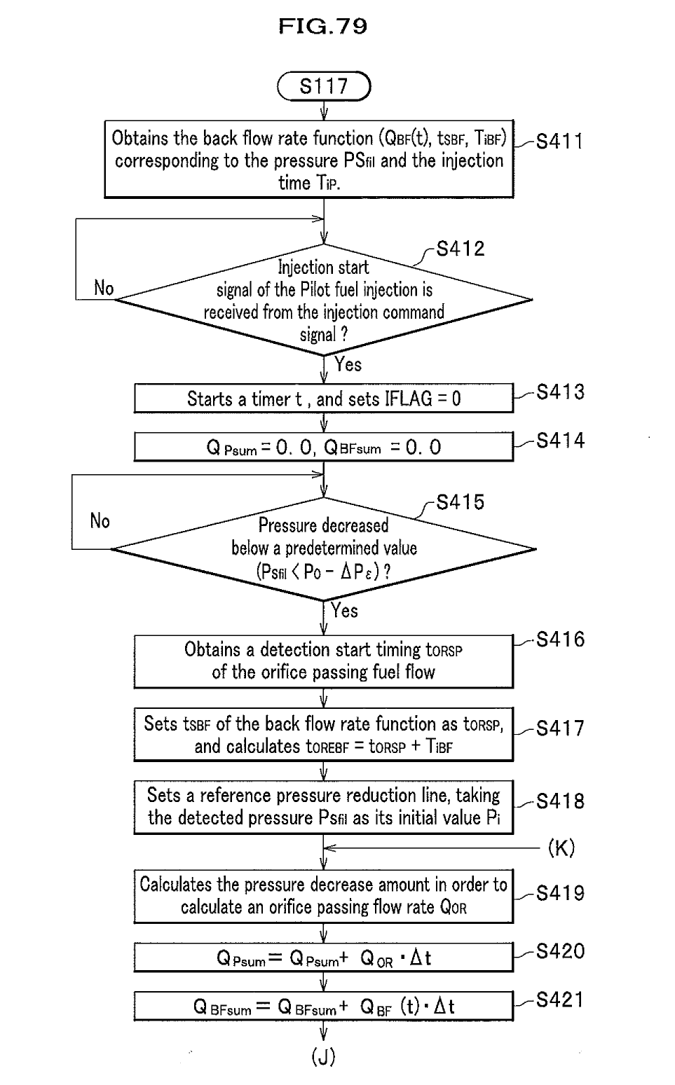

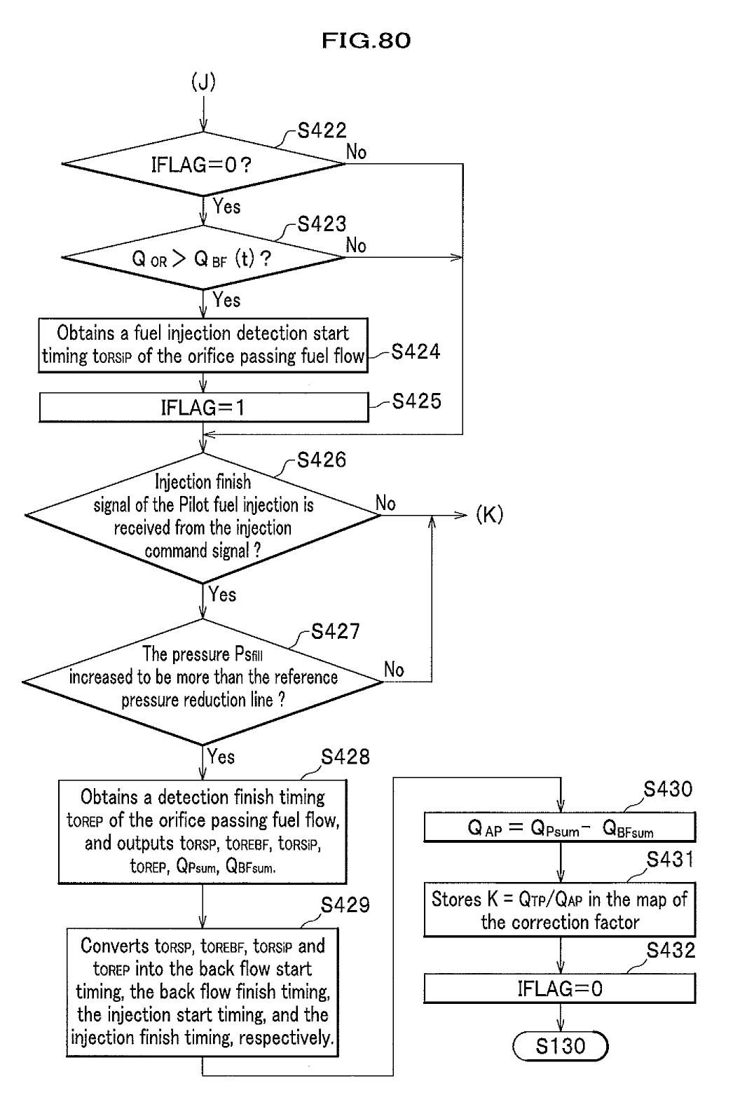

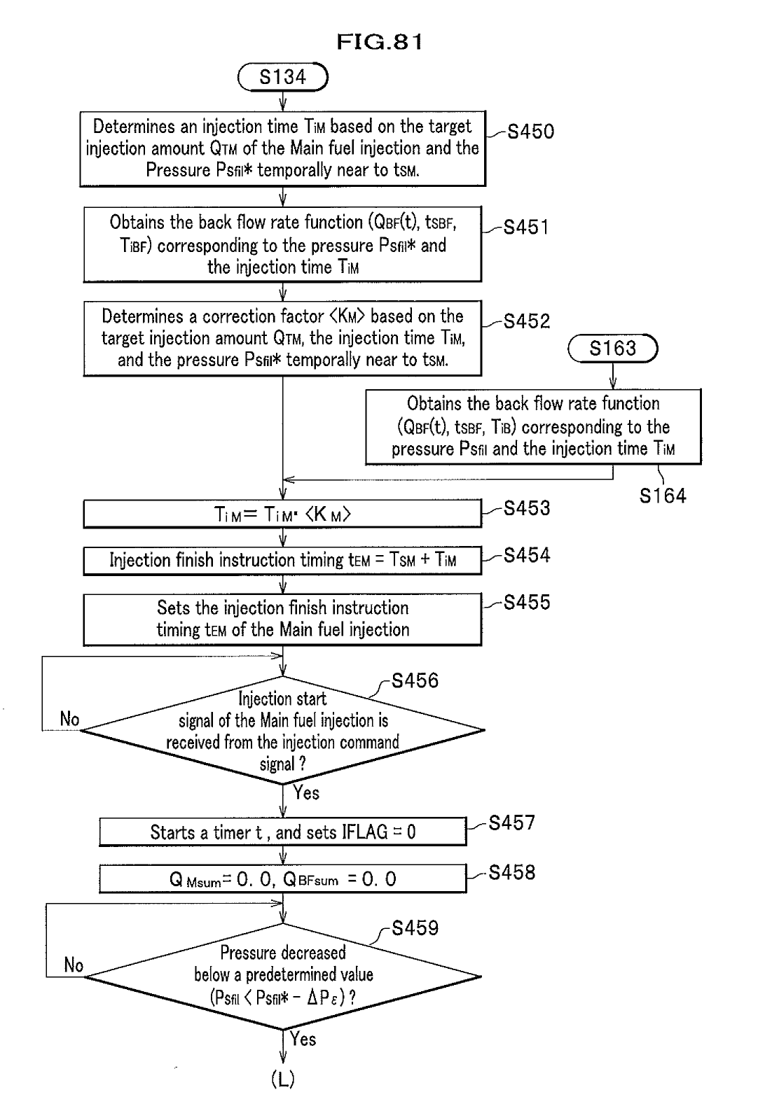

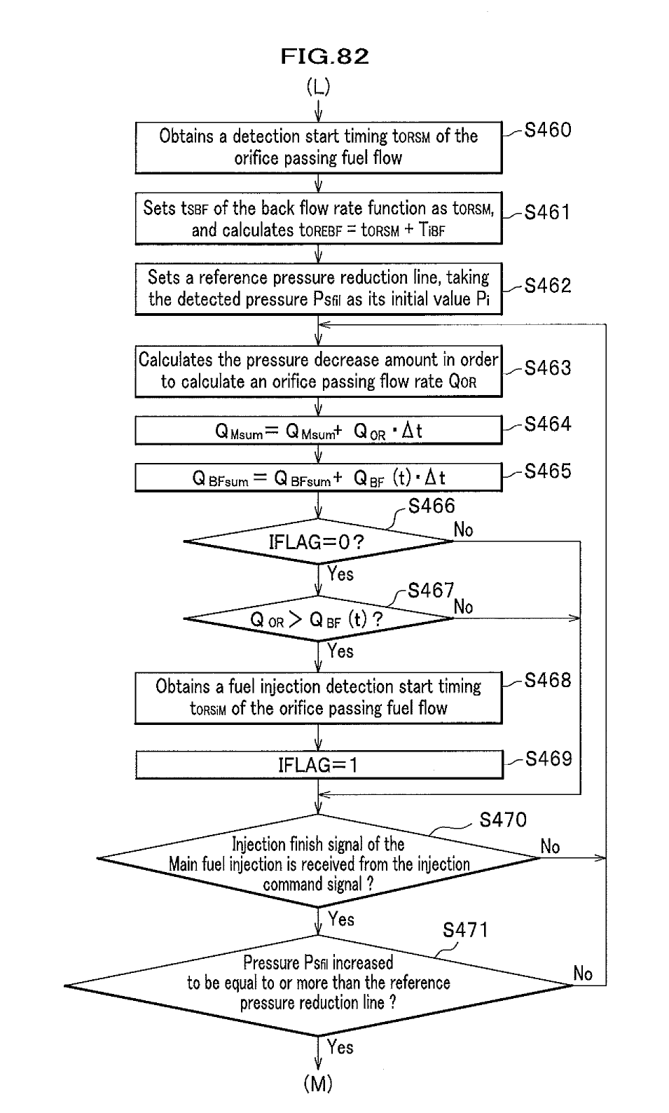

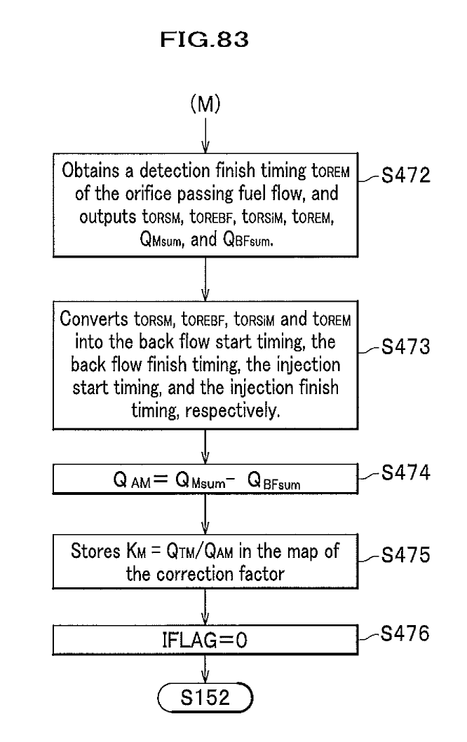

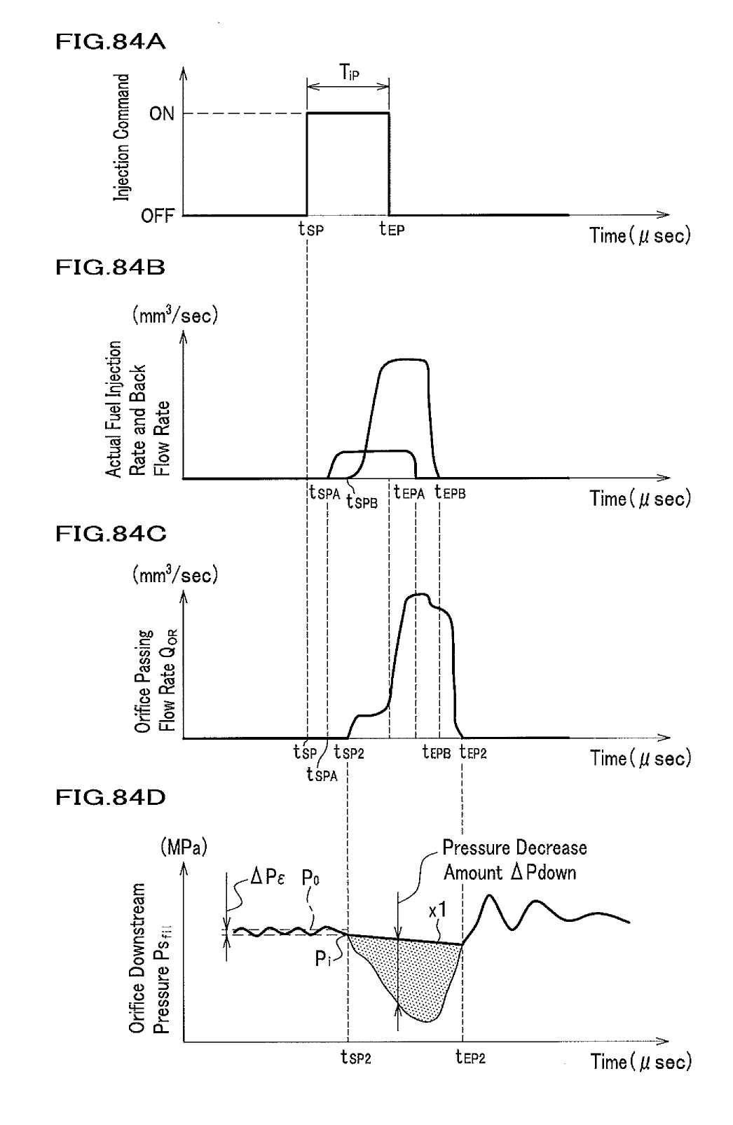

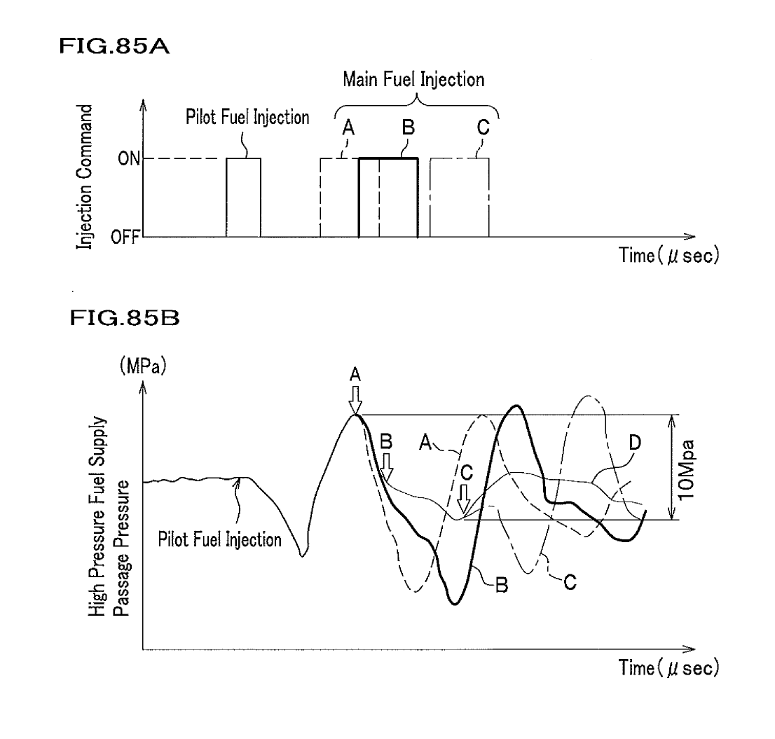

FIG. 68 is a flow chart showing a control operation performed by the ECU 80U to calculate the orifice passing flow rate Q_{OR} for one cylinder in the nineteenth embodiment.

FIG. 69 is a graph for explaining a reference pressure reduction line.

FIG. 70A is a graph for showing an output pattern of the injection command signal for one cylinder.

FIG. 70B is a graph for showing the temporal variation of an actual fuel injection rate of the injector.

FIG. 70C is a graph for showing the orifice passing flow rate of fuel.

FIG. 70D is a graph for showing the temporal variation of the pressure decrease amount of the pressure on the downstream side of the orifice.

FIG. 71 is an illustration for showing an entire configuration of the accumulator fuel injection device of a twentieth embodiment.

FIG. 72 is a functional block diagram of an engine controlling device used in the accumulator fuel injection device of the twentieth embodiment.

FIG. 73 is a conceptual graph of the map of the back flow rate of a back pressure injector.

FIG. 74 is a flow chart showing a control operation for calculating an actual injection amount from an orifice passing flow rate Q_{OR}.

FIG. 75 is a flow chart showing a control operation for calculating an actual injection amount from an orifice passing flow rate Q_{OR}.

FIG. 76A is a graph for showing an output pattern of the injection command signal.

FIG. 76B is a graph for showing the temporal variation of the actual fuel injection rate of an injector.

FIG. 76C is a graph for showing the temporal variation of the orifice passing flow rate.

FIG. 76D is a graph for showing the temporal variations of the pressures on the upstream and downstream sides of the orifice.

FIG. 77 is an illustration for showing an entire configuration of the accumulator fuel injection device of a twenty-first embodiment.

FIG. 78 is an illustration for showing an entire configuration of the accumulator fuel injection device of a twenty-second embodiment.

FIG. 79 is a flow chart showing a control operation executed by the ECU 80X of the twenty-second embodiment for calculating an actual injection amount from an orifice passing flow rate Q_{OR} of fuel for one cylinder.

FIG. 80 is a flow chart showing a control operation executed by the ECU 80X of the twenty-second embodiment for calculating an actual injection amount from an orifice passing flow rate Q_{OR} of fuel for one cylinder.

FIG. 81 is a flow chart showing a control operation executed by the ECU 80X of the twenty-second embodiment for calculating an actual injection amount from an orifice passing flow rate Q_{OR} of fuel for one cylinder.

FIG. 82 is a flow chart showing a control operation executed by the ECU 80X of the twenty-second embodiment for calculating an actual injection amount from an orifice passing flow rate Q_{OR} of fuel for one cylinder.

FIG. 83 is a flow chart showing a control operation executed by the ECU 80X of the twenty-second embodiment for calculating an actual injection amount from an orifice passing flow rate Q_{OR} of fuel for one cylinder.

FIG. 84A is a graph for showing an output pattern of the injection command signal for one cylinder.

FIG. 84B is a graph for showing the temporal variation of an actual fuel injection rate of the injector.

FIG. 84C is a graph for showing the orifice passing flow rate of fuel.

FIG. 84D is a graph for showing the temporal variation of the pressure decrease amount of the pressure on the downstream side of the orifice.

FIG. 85A is a graph showing three timings of injection instruction signal of the Main fuel injection after the Pilot fuel injection.

FIG. 85B is a graph showing the pressure variations of a high pressure fuel supply passage associated with the three timings of the injection instruction signal.

### DETAILED DESCRIPTION OF THE INVENTION

### First Embodiment

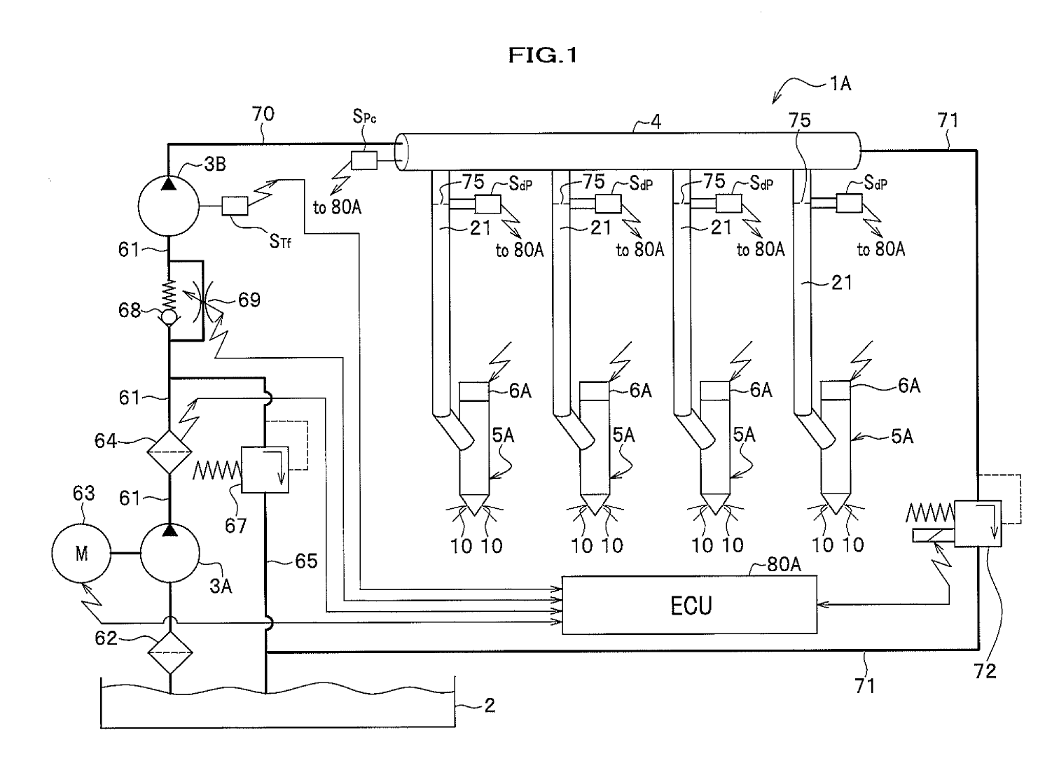

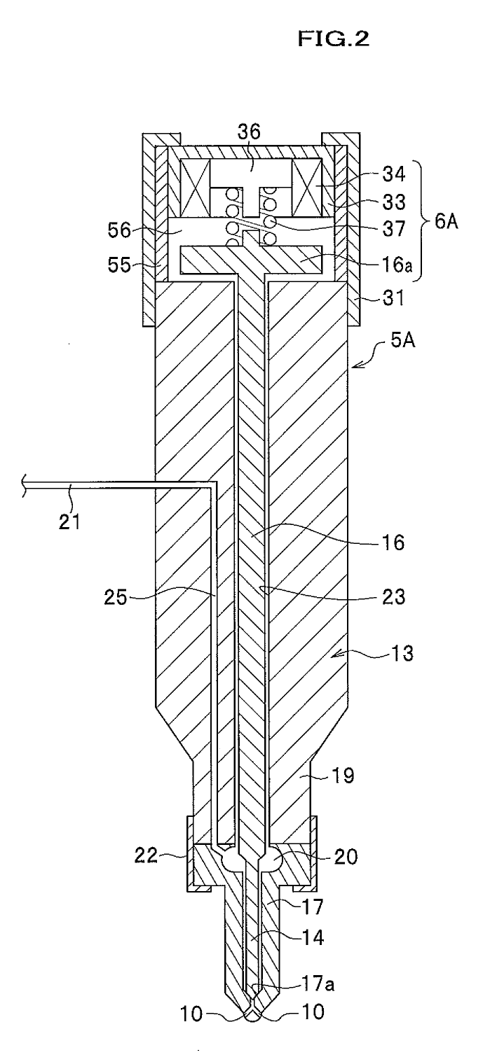

A fuel injection device according to a first embodiment of the present invention is described in detail below with reference to FIGS. 1 and 2.

FIG. 1 is an illustration showing an entire configuration of an accumulator fuel injection device according to a first embodiment of the present invention. FIG. 2 is an illustration for showing a conceptual configuration of a direct acting fuel injection valve (injector) used in the accumulator fuel injection device according to the first embodiment.

A fuel injection device 1A according to the first embodiment includes: a low pressure pump 3A (also called as a feed pump) driven by a motor 63 which is electronically controlled by an engine controlling device (control unit) 80A (hereinafter referred to as an ECU 80A); a high pressure pump 3B (also called as a supply pump) mechanically driven by driving force taken out from the engine crank shaft; a common rail (fuel accumulation part) 4 to which high pressure fuel is supplied from the high pressure pump 3B; an injector (fuel injection valve) 5A for injecting the high pressure fuel into a combustion chamber of an internal combustion engine, such as 4 cylinder diesel engine (hereinafter referred to as an engine); and an actuator 6A incorporated in the injector 5A which is electronically controlled by the ECU 80A.

The low pressure pump 3A and the high pressure pump 3B are also referred to as a fuel pump.

Hereinafter, a fuel injection amount, a target fuel injection amount, and an actual fuel injection amount are called an “injection amount”, a “target injection amount”, and an “actual injection amount”, respectively.

The ECU 80A includes a micro computer, an interface circuit, and an actuator driving circuit for driving the actuator 6A though they are not shown in FIG. 1. The micro computer electronically controls the actuator 6A by calculating an optimum fuel injection amount and an optimum injection timing based on signals from various sensors such as, an engine rotation speed sensor, a cylinder discriminating sensor, a crank angle sensor, a water temperature sensor, an intake air temperature sensor, an intake air pressure sensor, an accelerator (throttle) opening sensor, a fuel temperature sensor S_{Tf}, a pressure sensor (accumulation part pressure sensor) S_{Pc}, and a differential pressure sensor S_{dP}.

The ECU 80A may include a motor driving circuit for driving the motor 63, or the motor driving circuit may be provided outside of the ECU 80A.

Hereinafter, operations controlled by the micro computer of the ECU 80A are represented just as control of the ECU 80A. Hardware configurations of ECU 80B to 80F which are described later are the same as that of the ECU 80A.

The low pressure pump 3A and the motor 63 are incorporated in a fuel tank 2 together with a filter 62. The low pressure pump 3A and the motor 63 supplies fuel to the intake side of the high pressure pump 3B from the fuel tank 2 through the low pressure fuel supply passage 61. A strainer 64A and a flow regulating valve 69 incorporating a check valve 68 are arranged in series in the low pressure fuel supply passage 61 from the discharge side of the low pressure pump 3A to the intake side of the high pressure pump 3B. The strainer 64 includes a differential pressure sensor (not shown), and the signal of the differential pressure sensor is input to the ECU 80A so as to allow the ECU 80A to detect abnormalities of the low pressure pump 3A, the filter 62 and the strainer 64 (e.g. decrease in a low pressure fuel supply amount).

A return piping 65 which branches from a middle of the strainer 64 and the flow regulating valve 69 of the low pressure fuel supply passage 61 returns the excessive amount of fuel supply from the low pressure pump 3A to the fuel tank 2 via a pressure regulating valve 67.

The high pressure pump 3B is provided with a fuel temperature sensor S_{Tf} which detects the temperature of fuel to be discharged, and the signal of the fuel temperature sensor S_{Tf} is output to the ECU 80A.

The high pressure fuel that is discharged from the high pressure pump 3B to a discharge piping 70 is accumulated in the common rail 4, which is a kind of a surge tank for accumulating comparatively high pressure fuel. The common rail 4 is provided with a pressure sensor S_{Pc} for detecting the pressure Pc of the common rail 4 (hereinafter also referred to as a common rail pressure Pc). The detection signal from the pressure sensor S_{Pc} is output to the ECU 80A, and the ECU 80A controls the pressure of the common rail 4 to be a predetermined target pressure of from 30 MPa to 200 MPa in response to an operating condition of a vehicle, such as an engine rotation speed, by adjusting a pressure control valve 72 arranged in a return piping 71 which connects the common rail 4 and the fuel tank 2.

The common rail 4 is configured to be communicated with the injectors 5A through high pressure fuel supply passages (fuel supply passages) 21. An orifice 75 is provided to the common rail 4 side of each of the four high pressure fuel supply passages 21. Pressure detection pipes which are respectively taken from the upstream side of the orifice 75 (the common rail 4 side) and the downstream side (the side far from the common rail 4) are connected to the differential pressure sensor S_{dP}. The differential pressure sensors S_{dP} detect the orifice differential pressures of the four high pressure fuel supply passages 21, respectively, whereby the fuel flow amount which has passed the orifice 75 of each pressure fuel supply passages 21 can be detected.

It is to be noted that the volume of a fuel passage including the high pressure fuel supply passage 21 that is lower than the orifice 75 and the fuel passage to a fuel injection port 10 inside the injector 5A (a fuel passage 25 and an oil reservoir 20, which are described later (see FIG. 2) in the injector 5A) is designed to exceed the maximum actual fuel supply amount which is supplied through the high pressure fuel supply passage 21 for an explosion stroke among the cycles of aspiration, compression, explosion and exhaust in one cylinder, such as the maximum actual fuel supply amount required when the maximum torque is required by a fully-opened accelerator.

Here, the maximum actual fuel supply amount means summation of the fuel supply amount of each injection in the case of multi-injection.

It is obvious that the length of the high pressure fuel supply passages 21 to the injectors 5A of the cylinders of the engine is varied, and thus the position of the orifice 75 in the high pressure fuel supply passage 21 is determined in such a manner that the volume of each fuel passage including the high pressure fuel supply passage 21 that is lower than the orifice 75 and the fuel passage to the fuel injection port 10 inside the injector 5A is the same among cylinders with the enough volume of the fuel passage ensured as described above.

Next, a structure of the injector 5A according to the first embodiment is described with reference to FIGS. 1 and 2. The injector 5A is attached to each cylinder. The injector 5A includes an injector body 13 of which distal end has one or more fuel injection ports 10, a nozzle needle 14 which is slidably supported in the injector body 13, and a piston 16 which is connected to the upper side of the nozzle needle 14 to be integrally reciprocated and displaced with the nozzle needle 14.

The injector body 13 includes a nozzle body 17, a nozzle holder 19 and an actuator body 55. The oil reservoir 20 is formed inside of the nozzle body 17 so as to fill high pressure fuel around the nozzle needle 14. The oil reservoir 20 is always communicated with the common rail 4 via the fuel passage 25 and the high pressure fuel supply passage 21. The nozzle body 17 is fastened to the nozzle holder 19 with a retaining nut 22.

The nozzle holder 19 constitutes a cylinder which forms a long hole 23 in the longitudinal direction at its center part. The long hole 23 slidably supports the piston 16. Provided on the upper side of the long hole 23 is the operating chamber 56 which is provided to the actuator body 55. The diameter of the operating chamber 56 is larger than that of the long hole 23.

The nozzle needle 14 is disposed at the same axial center as the center axis of the actuator 6A, and is slidably supported in the inner circumference of the nozzle body 17. When the nozzle is opened, the nozzle needle 14 is lifted to form a fuel passage between the distal end of the nozzle needle 14 and the nozzle body 17. The fuel passage communicates the oil reservoir 20 with the fuel injection port 10 so that fuel is injected to the engine. When the nozzle is closed, the distal end of the nozzle needle 14 is seated on a seat surface 17a of the nozzle body 17 so that the injection of the high pressure fuel is finished.

Next, the actuator 6A is described with reference to FIG. 2. The actuator 6A includes: the actuator body 55 which is fastened to the upper end of the nozzle holder 19 of the injector 5A with a retaining nut 31 in a state where the actuator body 55 and the nozzle holder 19 liquid tightly come in contact with each other; an iron core 33 which is provided inside of the actuator body 55; an electromagnetic coil 34 wound around a housing part of the iron core 33; an operating chamber 56 which is provided in the actuator body 55 and of which diameter is larger than that of the long hole 23; a piston flange part 16a which is provided at the upper end of the piston 16; a stopper 36 for regulating the maximum lift amount of a piston flange part 16a; and a coil spring 37 for biasing the piston 16 in the valve closing direction.

Connected to the upper end of the retaining nut 31 is a connector (not shown) for supplying electricity to the electromagnetic coil 34.

The iron core 33 is magnetized to be an electric magnet when the electromagnetic coil 34 is energized. Thus, the iron core 33 attracts the piston flange part 16a upward, and the nozzle needle 14 which is coupled to the piston 16 is moved upward, whereby fuel is injected from the fuel injection port 10.

When the energization of the electromagnetic coil 34 is finished, the iron core 33 loses its magnet motive force. Then, the piston flange part 16a is pushed downward by the pushing force of the coil spring 37, and the nozzle needle 14 coupled with the piston 16 is seated on the seat surface 17a, which stops the fuel injection from the fuel injection port 10.

A method performed by the ECU 80A for calculating an actual injection amount of fuel to each cylinder is described with reference to FIGS. 1 to 3D.

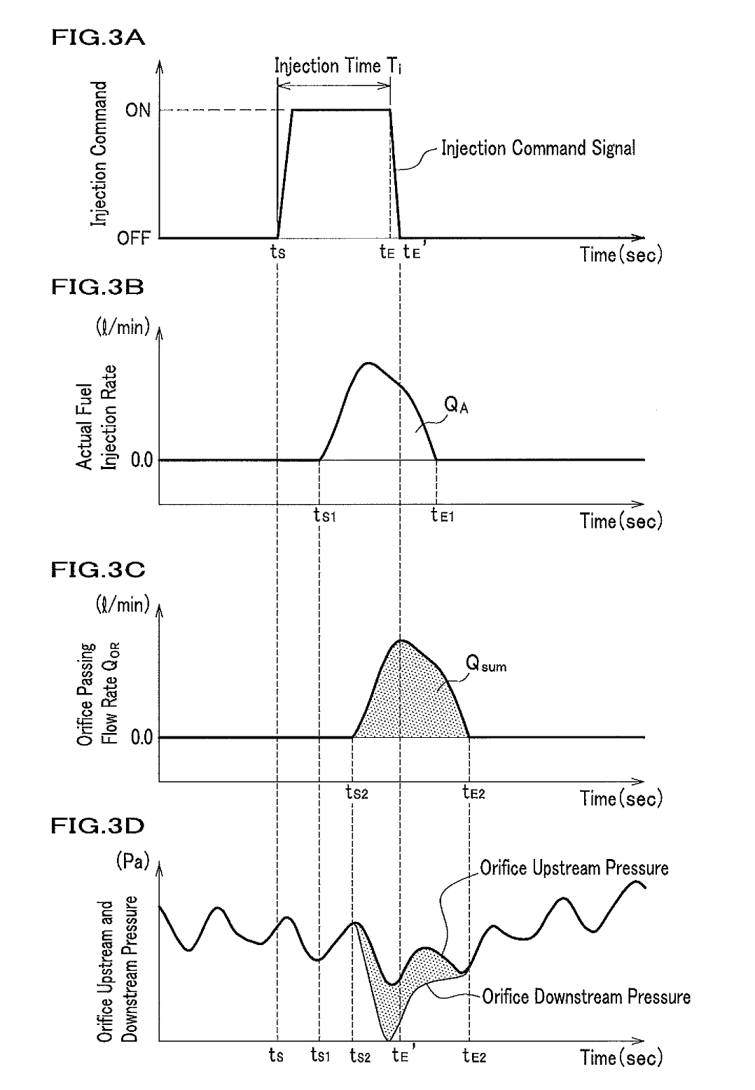

FIGS. 3A to 3D are graphs showing an output pattern of the injection command signal for one cylinder and the temporal variations of fuel flow in the high pressure fuel supply passage. FIG. 3A is a graph for showing an output pattern of the injection command signal for one cylinder. FIG. 3B is a graph for showing the temporal variation of an actual fuel injection rate of an injector. FIG. 3C is a graph for showing the orifice passing flow rate of fuel. FIG. 3D is a graph for showing the temporal variation of the pressure in the upstream and the downstream of the orifice.

With reference to FIGS. 1 to 3D, a method performed by the ECU 80A for calculating an actual injection amount Q_{A} for each cylinder is described.

In FIG. 3A, the injection command signal of fuel is conceptually represented as a wide pulse. The timing when the injection command signal, starts to rise (injection start timing) is represented as “t_{S}”. The timing when the injection command signal starts to fall (injection finishing timing) is represented as “t_{E}”, and the timing when the injection command signal has completed falling is represented as “t_{E}′”.

The injection command signal is, for example, an electric power which is output from the ECU 80A to be supplied to the electromagnetic coil 34 provided to the actuator 6A of the injector 5A, and is controlled to be ON or OFF by the ECU 80A.

The injector 5A (see FIG. 1) injects fuel from the fuel injection port 10 only when the injection command signal is ON.

Thus, the ECU 80A is allowed to control the total amount of fuel to be injected (actual injection amount Q_{A}) from the fuel injection port 10 of the injector 5A by controlling the time for which the injection command signal is ON (injection time Tᵢ).

The injection command signal has a rising characteristic that the injection command signal rises by a predetermined inclination from the injection start instruction timing t_{S}. Similarly, the injection command signal has a falling characteristic that the injection command signal falls by a predetermined inclination from the injection finish instruction timing t_{E}. The ECU 80A is configured to take the rising and falling characteristics into consideration when controlling the injection command signal.

In response to the injection command signal which is output as shown in FIG. 3A, the injector 5A which is a direct, acting fuel injection valve starts to inject fuel at, the timing t_{S1}, which is delayed a little from the fuel injection start, instruction timing t_{S}, and completes injection at the timing t_{E1}, which is delayed a little from the injection finish instruction timing t_{E} as shown in FIG. 3B.

The flow rate of the fuel which passes the orifice 75 (orifice passing flow rate Q_{OR}) rises at, the timing t_{S2}, which is delayed a little from the timing t_{S1} by the volume of the fuel passage 25 (see FIG. 2) and the high pressure fuel supply passage 21 (see FIG. 1) as shown in FIG. 3C. Similarly, the orifice passing flow rate Q_{OR} returns to 0 at the timing t_{E2} which is delayed from the timing t_{E1} by the volume of the fuel passage 25 and the high pressure fuel supply passage 21 as shown in FIG. 3C.

It is to be noted that the delays of the timings t_{S1} and t_{S2} from the injection start instruction timing t_{S} and the delays of the timings t_{E1} and t_{E2} from the injection finish instruction timing t_{E} are specific to the injection device 1A, and thus the delays can be obtained in advance by experiments. Therefore, the ECU 80A can take these delays into consideration when controlling the fuel injection device 1A, which allows to control the fuel injection device 1A without being affected by these delays.

Regarding the pressures of the upstream side and the down stream side of the orifice 75 corresponding to FIG. 3C, the orifice differential pressure ΔP_{OR} can be detected by the differential pressure sensor S_{dP} even if the pressure on the upstream side of the orifice is varied by the variation of the common rail pressure Pc as shown in FIG. 3D, which allows the ECU 80A to accurately calculate the orifice passing flow rate Q_{OR}. An orifice passing flow amount (actual fuel supply amount) Qₛᵤₘ, which corresponds to the dotted area encompassed by the orifice passing flow rate Q_{OR} shown in FIG. 3C is the same as the area of the actual injection amount Q_{A} shown in FIG. 3B in the case of the direct acting injector 5A.

The orifice passing flow rate Q_{OR} of fuel can be readily calculated based on the orifice differential pressure ΔP_{OR} by using the equation (1).

$${Q}_{OR} = C \times {A}_{OR} \sqrt{\frac{2 \times Δ {P}_{OR}}{ρ}} \qquad ( 1 )$$

where C is a constant value, A_{OR} is an opening cross sectional area of the orifice 75, ρ is a density of the fuel, which is determined by the function of the fuel temperature T_{f} detected by the fuel temperature sensor S_{Tf}

ρ=ƒ(T_{f})

In the actual calculation of the orifice passing flow rate Q_{OR} by the ECU 80A, the orifice passing flow rate Q_{OR} obtained by the equation (1) is varied in response to the temporal variation of the orifice differential pressure ΔP_{OR}. Thus, a high speed sampling of the orifice differential pressure ΔP_{OR} is performed in dozens of μ second order, and the orifice passing flow rate Q_{OR} in each sampling time period is calculated.

To simplify the calculation of the orifice passing flow rate Q_{OR}, the following calculation may be performed. The high speed sampling of the orifice differential pressure ΔP_{OR} is performed in dozens of μ seconds order, and the average value of the orifice differential pressures ΔP_{OR} and the time period of the orifice differential pressures ΔP_{OR} are calculated. Then, the calculated average orifice differential pressure ΔP_{OR} is substituted in the equation (1), and the orifice passing flow rate Q_{OR} is calculated by multiplying the time period of the orifice differential pressures ΔP_{OR} by the result of the equation (1).

In accordance with the first embodiment, it is easy to accurately form the diameter of the opening of the orifice 75, and the differential pressure ΔP_{OR} between the upstream side and the down stream side of the orifice 75 is greater than the differential pressure between the upstream side and the down stream side of the venturi constriction. Thus, the orifice passing flow rate Q_{OR} is easily calculated based on the orifice differential pressure ΔP_{OR} detected by the differential pressure sensor S_{dP} by using the equation (1).

Since the volume of the fuel passage from the orifice 75 to the fuel injection port of the fuel injection valve of each cylinder is designed to be greater than the maximum actual fuel supply amount of the fuel injection valve in one fuel injection, it is possible to suppress a pressure pulsation of the common rail caused by the fuel injection to the own cylinder and to prevent a pressure palsation of the common rail caused by the fuel injection to the other cylinder from propagating to the vicinity of the fuel injection valve of the own cylinder, together with the suppression of the propagation of the pressure pulsations by the orifice 75.

By calculating the orifice passing flow rate Q_{OR} based on the orifice differential pressure ΔP_{OR} and time-integrating the orifice passing flow rate Q_{OR}, it is possible to accurately calculate an actual fuel supply amount to the injector 5A. Even if the injectors 5A are varied due to manufacturing tolerance, it is possible to calculate an orifice passing flow amount of fuel (actual fuel supply amount) Qₛᵤₘ (i.e. an actual injection amount Q_{A}) from the orifice passing flow rate Q_{OR} that reflects the variation of the injectors 5A due to the manufacturing tolerance. Thus, by adjusting the injection time Tᵢ(see FIGS. 3A to 3D) of the injection command signal from the ECU 80A to the injector 5A based on the actual fuel supply amount, it is possible to make the actual fuel supply amount to each cylinder to be equal. It is to be noted that the injector 5A is so called a direct acting fuel injection valve, and thus the actual fuel supply amount corresponds to the actual injection amount.

As described above, it is possible to accurately calculate an actual injection amount for each cylinder, whereby the torque generated by each cylinder can be controlled more precisely.

The fuel injection of the injector 5A is generally multi-injection including “Pilot injection”, “Pre injection”, “After injection” and “Post injection” in order to reduce PM (particulate material), NOx and a combustion noise, to increase exhaust temperature or to activate catalyst by supplying a reducing agent.

If the actual injection amount of such a multi-injection is not equal to a target amount calculated based on the operating condition of the engine, a regulated value of an exhaust gas from the engine may not be kept. In the first embodiment, even if the actual injection amount is varied by aging, the ECU 80A can control the actual fuel supply amount to be equal to a target amount by adjusting the injection time Tᵢ of the injection command signal since the actual injection amount can be accurately calculated based on the orifice differential pressure ΔP_{OR}.

As a result, it becomes easier to keep the regulated value of an exhaust gas even if requirement on hardware specifications, such as dimension tolerance of each part of the engine system, is relaxed. Especially, requirement on the hardware specification for injectors can be relieved, which contributes to reduction of the manufacturing cost of the engine system.

### Second Embodiment

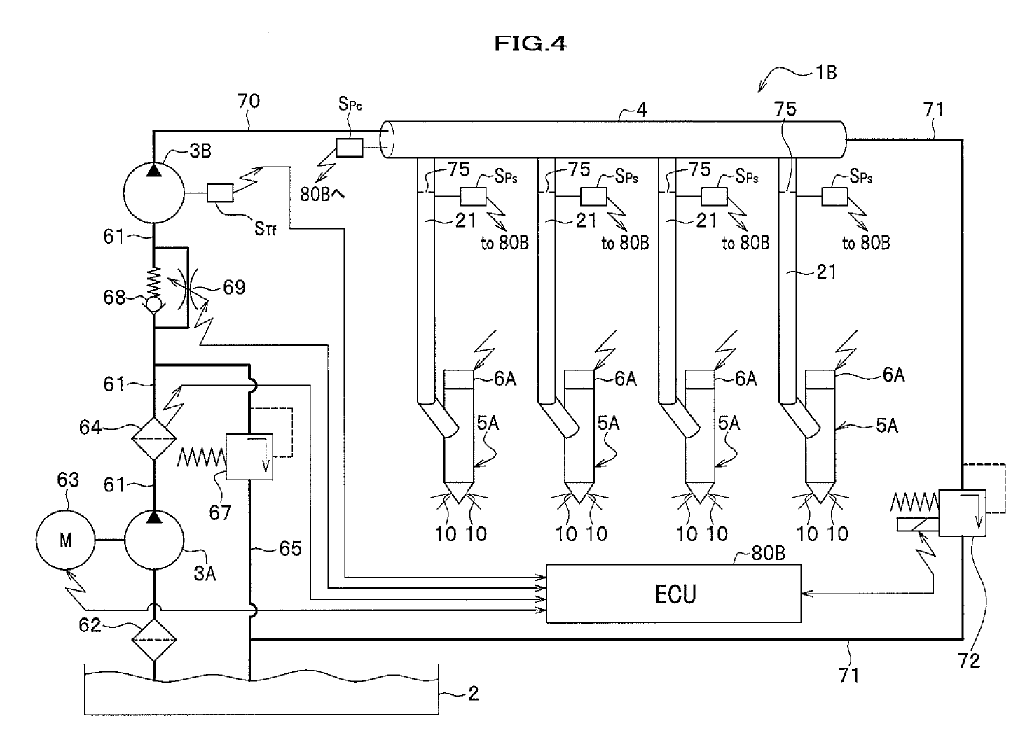

Next, a fuel injection device according to a second embodiment of the present invention is described in detail with reference to FIG. 4.

FIG. 4 is an illustration for showing an entire configuration of the accumulator fuel injection device according to the second embodiment.

A fuel injection device 1B according to the second embodiment is different from the fuel injection device 1A according to the first embodiment in the following points: (1) a pressure sensor (fuel supply passage pressure sensor) S_{Ps} for detecting the pressure of the downstream side of the orifice 75 is provided instead of the differential pressure sensor S_{dP} which is provided in the high pressure fuel supply passage 21 for supplying fuel to the injector 5A attached to each cylinder of the engine and detects the pressure difference between the upstream side and the downstream side of the orifice 75; (2) an ECU (control unit) 80B is provided instead of the ECU 80A; and (3) the definition of the orifice differential pressure ΔP_{OR} which is used for calculating the orifice passing flow rate Q_{OR} of fuel in the ECU 80B is changed.

Components of the second embodiment corresponding to those of the first embodiment are assigned like reference numerals, and descriptions thereof will be omitted.

As shown in FIG. 4, pressure signals detected by the four pressure sensors S_{Ps} are input to the ECU 80B.

The function of the ECU 80B according to the second embodiment is basically the same as that of the ECU 80A according to the first embodiment, however, signals used by the ECU 80B to calculate the orifice passing flow rate Q_{OR} are different from those used in the first embodiment.

In the first embodiment, the orifice passing flow rate Q_{OR} is calculated by using the equation (1). In the second embodiment, the orifice differential pressure ΔP_{OR} in the equation (1) is replaced by the pressure difference (Pc−Ps) between the common rail pressure Pc which is detected by the pressure sensor S_{Pc} and the pressure Ps on the downstream side of the orifice 75, which is detected by the pressure sensor S_{Ps}.

It is obvious that the pressure on the upstream side of the orifice 75 in the high pressure fuel supply passage 21 is substantially equal to the common rail pressure Pc. Thus, even if the orifice differential pressure ΔP_{OR} in the equation (1) is replaced with the pressure difference (Pc−Ps), an orifice passing flow rate Q_{OR} of fuel (i.e. an actual injection amount) can be accurately calculated for each cylinder and each injection command signal in the second embodiment, similarly to the first embodiment. As a result, the ECU 80B can control an actual injection amount to be equal to a target fuel injection amount by adjusting the injection time Tᵢ of the injection command signal, similarly to the first embodiment.

Similarly to the first embodiment, it becomes easier to keep the regulated value of an exhaust gas even if requirement on hardware specifications, such as dimension tolerance of each part of the engine system, is relaxed. Especially, requirement on the hardware specification for injectors can be relieved, which contributes to reduction of the manufacturing cost of the engine system.

Advantages of the second embodiment which are the same as those of the first embodiment are omitted, and thus refer to the advantages of the first embodiment for them.

### Third Embodiment

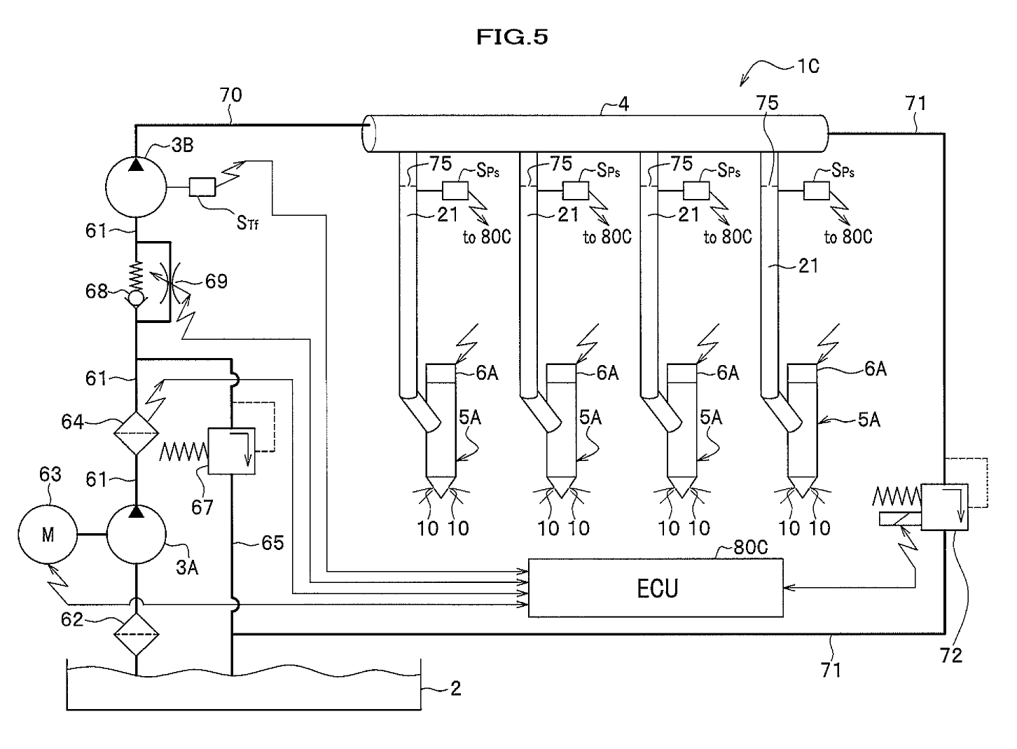

Next, a fuel injection device according to a third embodiment of the present invention is described in detail with reference to FIG. 5.

FIG. 5 is an illustration for showing an entire configuration of the accumulator fuel injection device of the third embodiment.

A fuel injection device 1C of the third embodiment is different from the fuel injection device 1B of the second embodiment in the following points: (1) the pressure sensor S_{Pc} for detecting the common rail pressure Pc is omitted; (2) an ECU (control unit) 80C is provided instead of the ECU 80B; (3) a pressure sensor S_{Ps} is provided instead of the pressure sensor S_{Pc} for controlling the common rail pressure Pc; and (4) a method performed by the ECU 80C for calculating the orifice passing flow rate Q_{OR} of fuel is changed from the method performed by the ECU 80B.

Components of the third embodiment, corresponding to those of the second embodiment are assigned like reference numerals, and descriptions thereof will be omitted.

As shown in FIG. 5, pressure signals detected by the four pressure sensors S_{Ps} are input to the ECU 80C.

The ECU 80C performs a filtering process on the pressure signals input from the pressure sensors S_{Ps} for cutting off a noise with a high frequency.

The pressure Ps on the downstream side of the orifice 75 on which the filtering process has been performed is refereed to as a pressure Ps_{fil}.

By filtering processing the pressure signal input from the pressure sensor S_{Ps} as described above, the pressure vibration of the pressure Ps_{fil} from the pressure sensor S_{Ps} is comparatively smaller at an “aspiration stroke” which follows an “explosion stroke” and “exhaust stroke” after a fuel injection is performed and completed in one cylinder based on signals from a crank angle sensor (not shown) and a cylinder discriminating sensor (not shown) and the injection command signal for the cylinder generated by the ECU 80C. The pressure Ps_{fil} from the pressure sensor S_{Ps} in the state where its pressure vibration is comparatively smaller is substantially equal to the common rail pressure Pc.

The ECU 80C samples the pressure Ps_{fil} in the above described state where its pressure vibration is comparatively smaller and controls the pressure control valve 72 so as to control the common rail pressure Pc within a predetermined range.

Only one pressure sensor S_{Ps} among the four pressure sensors S_{Ps} may be representatively used for controlling the common rail pressure Pc in the case of the 4 cylinder engine used in the third embodiment, or all of the four pressure sensors S_{Ps} may be used to generate four signals of which sampling timing is different, and the common rail pressure Pc may be set to be the average value of the four signals.

The function of the ECU 80C of the third embodiment is basically the same as that of the ECU 80B of the second embodiment except for the method for controlling the common rail pressure Pc. However, they are also different in that the orifice differential pressure used by the ECU 80C for calculating the orifice passing flow rate Q_{OR} of fuel is not based on the pressure difference detected by the differential pressure sensor S_{dP} or the pressure sensors S_{Pc}, S_{Ps} of the first or second embodiment, but based on a signal from the pressure sensor S_{Ps} provided on the downstream side of the orifice 75.

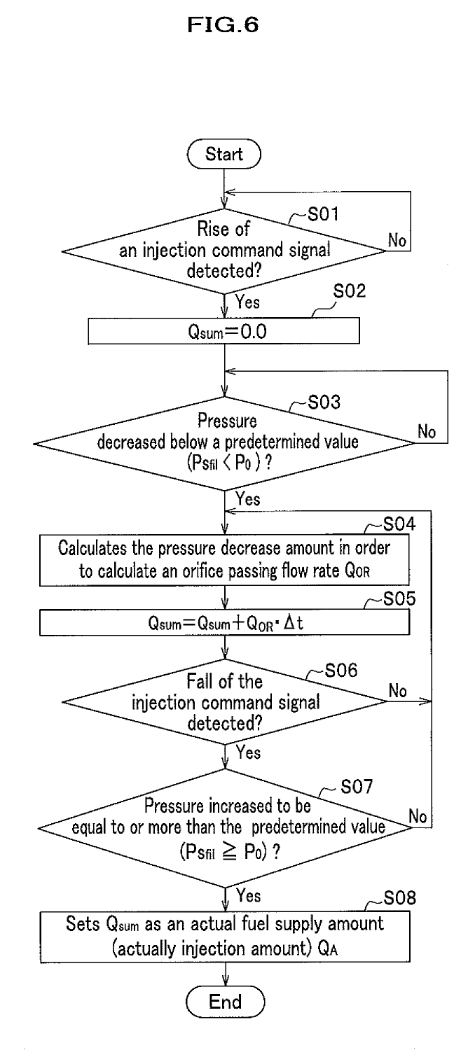

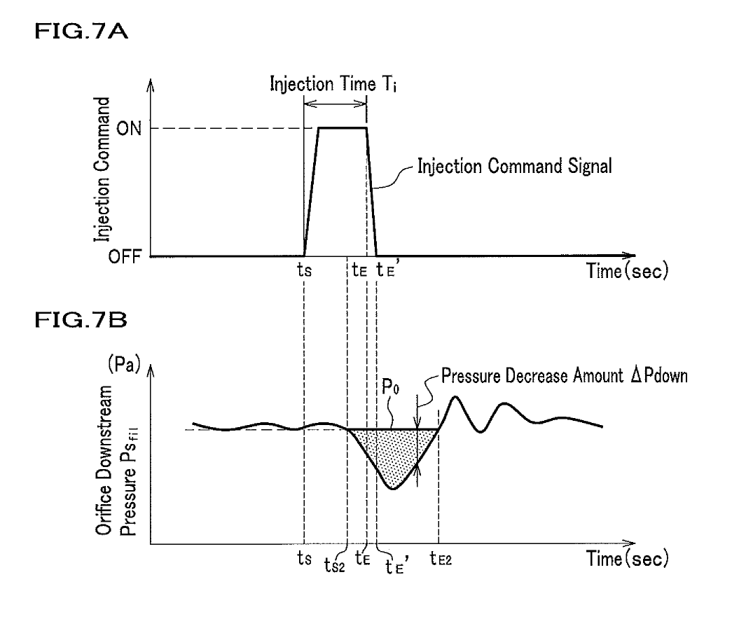

Next, referring to FIGS. 6, 7A and 7B, a method for calculating an actual injection amount calculated from an orifice passing flow rate Q_{OR} which is based on only the signal from the pressure sensor S_{Ps} provided on the downstream side of the orifice 75 according to the third embodiment is described.

FIG. 6 is a flowchart showing processing performed by the ECU 80C of the third embodiment for calculating an actual injection amount for one cylinder. FIGS. 7A and 7B are graphs showing an output pattern of the injection command signal for one cylinder and the temporal variations of fuel flow in the high pressure fuel supply passage FIG. 7A is an illustration for showing an output pattern of an injection command signal. FIG. 7B is an illustration for showing the temporal variation of the pressure Ps_{fil} on the downstream side of the orifice 75.

Processing of Steps 03 to 07 is performed at a period of dozens of μ sec, and Δt, which is described later, is a period at which the filtering-processed pressure Ps_{fil} is sampled, which is dozens of μ seconds.

In Step 01, the ECU 80C determines whether or not the rise of the injection command signal for instructing injection is detected. If the ECU 80C determines that the rise of the injection command signal is detected (Yes), the processing proceeds to Step 02. If the ECU 80C determines that it is not detected (No), the processing repeats Step 01.

In FIG. 7A, the rising start timing of the injection command signal is represented as “t_{S}”.

The rise of the injection command signal for instructing injection can be readily detected by time-differentiating the injection command signal.

In Step 02, the initial value of Qₛᵤₘ is reset to be 0.0. Here, Qₛᵤₘ corresponds to an orifice passing flow amount calculated by time-integrating the orifice passing flow rate Q_{OR} corresponding to one injection command signal.

In Step 03, the ECU 80C determines whether or not the pressure Ps_{fil} on the downstream side of the orifice 75 which has been detected by the pressure sensor S_{Ps} and filtering-processed decreases below a predetermined value P0 [symbol] (Ps_{fil}<P₀)? [symbol] . If the ECU 80C determines that the pressure Ps_{fil} on the downstream side of the orifice 75 decreases below the predetermined value P0 (Yes), the processing proceeds to Step 04. If the ECU 80C determines that it does not (No), the processing repeats Step 03.

In FIG. 7B, the timing when the pressure Ps_{fil} on the downstream side of the orifice 75 decreases below the predetermined value P0 is represented as “t_{S2}”.

The predetermined value P0 is set as follows: the pressure detected by the pressure sensor S_{Ps} is filtering processed to remove a noise with a high frequency, such as a pressure pulsation caused by the filling operation of the high pressure pump 3B, a pressure pulsation caused by the propagation of the pressure vibration resulted from the injection operation of the injector 5B of other cylinders, and a pressure pulsation caused by a reflection wave of the injection operation of the injector 5A of the own cylinder, and the lowest value in the variation of the pressure that has been filtering-processed is set to be the predetermined value P0. The predetermined value P0 can be obtained in advance by experiments.

In Step 04, a pressure decrease amount ΔPdown of the pressure Ps_{fil} from the predetermined value P0 is calculated in order to calculate an orifice passing flow rate Q_{OR}. The definition of ΔPdown is shown in FIG. 7B.

The orifice passing flow rate Q_{OR} can be readily calculated by using the equation (1) in which the pressure decrease amount ΔPdown is substituted for ΔP_{OR}.

In Step 05, Q_{OR} is time-integrated as shown in Qₛᵤₘ=Qₛᵤₘ+Q_{OR}·Δt.

In Step 06, the ECU 80C determines whether or not the fall of the injection command signal is detected. If the ECU 80C determines that the fall of the injection command signal is detected (Yes), the processing proceeds to Step 07. If the ECU 80C determines that the fall of the injection command signal is not detected (No), the processing returns to Step 04, and repeats Steps 04 and 05.

In FIG. 7A, the fall start timing of the injection command signal is represented as “t_{E}”, and the fail completion timing of the injection command signal is represented as “t_{E}′”.

The fall of the injection command signal can be easily detected, for example, by time-differentiating the injection command signal.

In Step 07, the ECU 80C determines whether or not the filtering-processed pressure Ps_{fil} on the downstream side of the orifice 75 increases to be equal to or more than the predetermined value P0 [symbol] (Ps_{fil}≧P₀)? [symbol] . If the ECU 80C determines that the filtering-processed pressure Ps_{fil} on the downstream side of the orifice 75 increases to be equal to or more than the predetermined value P0 (Yes), the processing proceeds to Step 08. If the ECU 80C determines that the filtering-processed pressure Ps_{fil} on the downstream side of the orifice 75 does not (No), the processing returns to Step 04 and repeats Steps 04 and 05.

In FIG. 7B, the timing when the pressure Ps_{fil} on the downstream side of the orifice 75 increases to be equal to or more than the predetermined value P0 is represented as “t_{E2}”.

In Step 08, Qₛᵤₘ is set to be an actual fuel supply amount (actual injection amount). In FIG. 7B, the dotted area encompassed by the line representing the predetermined value P0 and the curve representing the pressure Ps_{fil} corresponds to the actual fuel supply amount (actual injection amount).

In the third embodiment, the ECU 80B determines whether or not the fall of the fuel injection command signal is detected in Step 06, and after the fall of the fuel injection command signal is detected, the timing t_{E2} is detected at which the pressure Ps_{fil} on the downstream side of the orifice 75 increases to be equal to or more than the predetermined value P0. However, the timing t_{E} and the completion of the fuel flow through the orifice 75 may be detected even if Step 06 is omitted.

The timing t_{S2} in FIG. 7B is also referred to as a “first timing”, and the timing t_{E2} at which the pressure Ps_{fil} on the downstream side of the orifice 75 increases to be equal to or more than the predetermined value is also referred to as a “second timing”.

In accordance with the third embodiment, it is possible to easily control the common rail pressure Pc by using the pressure sensor S_{Ps} which detects the pressure Ps on the downstream side of the orifice 75 even if the pressure sensor S_{Pc} which detects the common rail pressure Pc is omitted. This allows to reduce the cost of the fuel injection system.

By using only the pressure sensor S_{Ps}, it is possible to accurately detect the start and end of the pressure decrease caused by actual fuel injection to the injector of each cylinder.

It is also possible to accurately calculate the orifice passing flow rate Q_{OR} (i.e. the actual injection amount) for each cylinder and each injection command signal, based on the equation (1) in which the pressure decrease amount ΔPdown (P₀−Ps_{fil}) is substituted for the orifice differential pressure ΔP_{OR} by using only the pressure signal from the pressure sensor S_{Ps} for detecting the pressure on the downstream side of the orifice 75. As a result, the ECU 80C is allowed to control the actual injection amount to be equal to a target fuel injection amount by adjusting the injection time Tᵢ of the injection command signal, similarly to the second embodiment.

Even if a pressure pulsation in the common rail is caused by the fuel pump 3B or is caused by fuel injection to the own or other cylinder, pressure difference of the upstream and downstream sides of the orifice can be accurately calculated by, for example, using an average value of signals from the fuel supply passage pressure sensor S_{Ps} in a period before the first timing (i.e. a period before the injection command signal is output) as an initial value of the upstream side of the orifice and detecting the decrease of the pressure Ps_{fil} after the first timing.

Similarly to the second embodiment, it becomes easier to keep the regulated value of an exhaust gas even if requirement on hardware specifications, such as dimension tolerance of each part of the engine system, is relaxed. Especially, requirement on the hardware specification for injectors can be relieved, which contributes to reduction of the manufacturing cost of the engine system.

Advantages of the third embodiment which are the same as those of the first embodiment are omitted, and thus refer to the advantages of the first embodiment for them.

### Modification of Third Embodiment

Next, a fuel injection device of a modification of the third embodiment is described with reference to FIGS. 5, 8 and 9A to 9C. A configuration of the modification is the same as that of the third embodiment except for a method for detecting the “second timing”.

Components of the modification of the third embodiment corresponding to those of the third embodiment are assigned like reference numerals, and descriptions thereof are omitted.

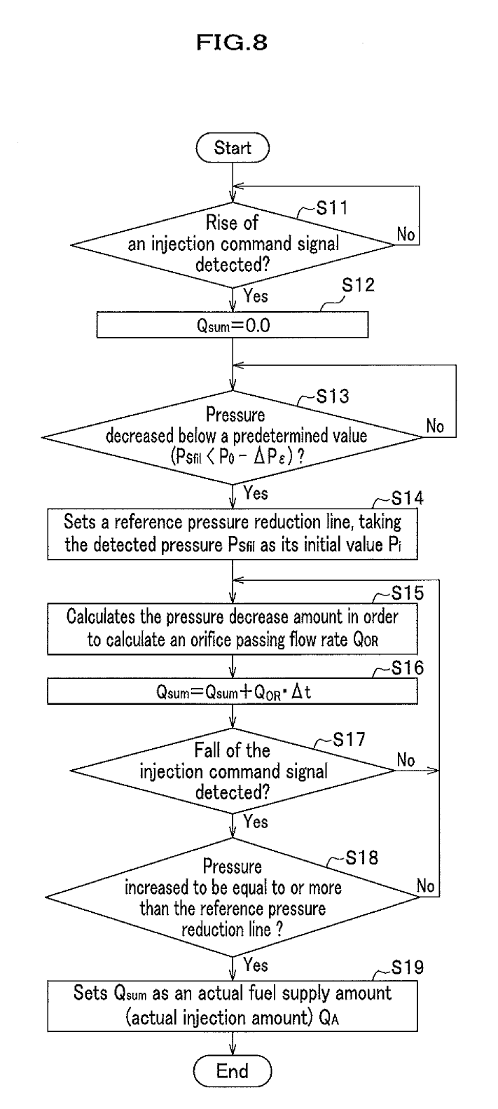

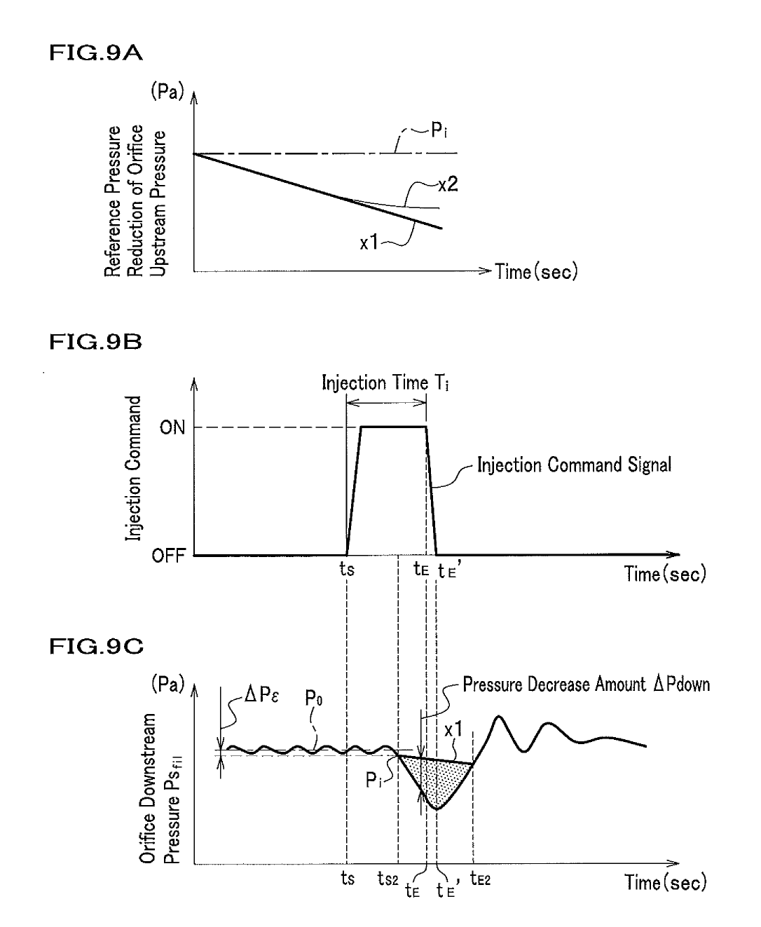

FIG. 8 is a flowchart showing a process performed by the ECU 80C of the modification of the third embodiment for calculating an orifice passing flow rate Q_{OR} for one cylinder. FIGS. 9A to 9C are graphs showing an output pattern of the injection command signal for one cylinder and the temporal variations of fuel, flow in the high pressure fuel supply passage. FIG. 9A is a graph showing a reference pressure reduction line indicating the reduction of the pressure on the upstream side of the orifice 75 during fuel injection. FIG. 9B is a graph for showing an output pattern of the injection command signal. FIG. 9C is a graph showing the temporal variation of the pressure Ps_{fil} on the downstream side of the orifice 75.

In this modification, the reference pressure reduction line indicating the pressure on the upstream side of the orifice 75 is set as shown in FIG. 9A based on the following experimental data which has been obtained in advance: the pressure on the upstream side of the orifice 75 at the time when the pressure difference ΔP_{OR} of the orifice 75 becomes 0, which is caused by fuel flow after completion of the fuel injection from the injector 5A, always becomes lower than the initial pressure before the fuel injection is started as shown in FIG. 3D; and the longer the injection time Tᵢ of fuel is, the greater the amount of the pressure reduction becomes.

FIG. 9A exemplary shows, as the reference pressure reduction line, a reference pressure reduction line x1 and a reference pressure reduction quadratic curve x2. Pi represents the initial pressure before the fuel injection starts, and is floating as described later.

As the injection time Tᵢ gets longer, the decrease amount of the initial pressure Pi becomes larger as shown in FIG. 9A.

Processing in the following flowchart is explained using an example in which the reference pressure reduction line x1 is employed.

The processing in Steps 13 to 18 is executed in a period of, for example, dozens of μ seconds. Δt, which is described later, is a period for sampling the filtering-processed pressure Ps_{fil}, which is dozens of μ seconds.

In Step 11, the ECU 80C determines whether or not the rise of the fuel injection command signal is detected. If the ECU 80C determines that the rise of the fuel injection command signal is detected (Yes), the processing proceeds to Step 12. If the ECU 80C determines that the rise of the fuel injection command signal is not detected (No), the processing repeats Step 11.

In FIG. 9B, the timing “t_{S}” represents the rise of the injection command signal.

In Step 12, Qₛᵤₘ is reset to be 0.0. At this time, Qₛᵤₘ corresponds to an orifice passing flow amount which is calculated by time integrating an orifice passing flow rate Q_{OR} corresponding to one fuel injection command signal. In Step 13, the ECU 80C determines whether or not the pressure Ps_{fil} on the downstream side of the orifice 75, which is detected by the pressure sensor S_{Ps} and is filtering-processed, decreases below a predetermined value [symbol] (Ps_{fil}<P₀−ΔPε)? [symbol] . If the ECU 80C determines that the pressure Ps_{fil} on the downstream side of the orifice 75 decreases below the predetermined value (P₀−ΔPε) (Yes), the processing proceeds to Step 14. If the ECU 80C determines that the pressure Ps_{fil} on the downstream side of the orifice 75 does not (No), the processing repeats Step 13.

In FIG. 9C, the timing “t_{S2}” represents a time when the pressure Ps_{fil} on the downstream side decreases below the predetermined value (P₀−ΔPε).

The predetermined value P0 is set as follows: the pressure signal detected by the pressure sensor S_{Ps} is filtering processed to remove a noise with a high frequency, such as a pressure pulsation caused by the filling operation of the high pressure pump 3B, a pressure pulsation caused by the propagation of the pressure vibration resulted from the injection operation of the injector 5A of other cylinders, and a pressure pulsation caused by a reflection wave of the injection operation of the injector 5A of the own cylinder, and the average value of the variation of the pressure Ps_{fil} that have been filtering-processed is set to be the predetermined value P0. ΔPε is a predetermined difference exceeding the difference between the predetermined pressure P0 and the lowest value of the filtering-processed pressure Ps_{fil} which may be reached by its vibration.

In Step 14, a reference pressure reduction line is set, taking the pressure Ps_{fil} in Step 13 (at the timing t_{S2}) as an initial value Pi as shown in FIG. 9C.

The initial value Pi may be equal to the predetermined value (P₀−ΔPε). The initial value Pi may not be equal to the predetermined value (P₀−ΔPε), since the pressure Ps_{fil} may be used in Step 14 which is sampled in the period next to the period in which the pressure Ps_{fil} used in Step 13 is sampled.

In Step 15, the amount of pressure decrease ΔPdown of the pressure Ps_{fil} from the reference pressure reduction line whose initial value is the initial value Pi, is calculated in order to calculate the orifice passing flow rate Q_{OR}. The definition of ΔPdown is shown in FIG. 9C.

The orifice passing flow rate Q_{OR} can be readily calculated by using the equation (1) in which the pressure decrease amount ΔPdown is substituted for ΔP_{OR}.

In Step 16, Q_{OR} is time-integrated as shown in the equation Qₛᵤₘ=Qₛᵤₘ+Q_{OR}·Δt.

In Step 17, the ECU 80C determines whether or not the fall, of the fuel injection command signal is detected. If the ECU 80C determines that the fall of the fuel injection command signal is detected (Yes), the processing proceeds to Step 18. If the ECU 80C determines that the fall of the fuel injection command signal is not detected (No), the processing repeats Steps 15 and 16.

In FIG. 9B, t_{E} represents the fall start timing of the injection command signal, and t_{E}′ represents the fall completion timing of the injection command signal.

In Step 18, the ECU 80C determines whether or not the filtering processed pressure Ps_{fil} on the downstream side of the orifice 75 increases to be equal to or more than the reference pressure reduction line reference pressure reduction. If the ECU 80C determines that the filtering processed pressure Ps_{fil} on the downstream side of the orifice 75 increases to be equal to or more than the reference pressure reduction line (Yes), the processing proceeds to Step 19. If the ECU 80C determines that it does not (No), the processing returns to Step 15, and repeats Steps 15 and 16.

In FIG. 9C, t_{E2} represents a time when the pressure Ps_{fil} on the downstream side of the orifice 75 increases to be equal to or more than the reference pressure reduction line.

In Step 19, Qₛᵤₘ is set as an actual fuel supply amount (actual injection amount). In FIG. 9C, the dotted area which is encompassed by the reference pressure reduction line x1 and the curve indicating the pressure Ps_{fil} corresponds to the actual fuel supply amount (actual injection amount).

The timing t_{S2} in FIG. 9C in the third embodiment is also referred to as a “first timing”, and the timing t_{E2} when the pressure Ps_{fil} on the downstream side of the orifice 75 increases to be equal to or more than the reference pressure reduction line is also referred to as a “second timing”.

In accordance with the modification of the third embodiment, by using only the pressure sensor S_{Ps}, it is possible to accurately detect the start and end of the pressure decrease caused by actual fuel injection to the injector of each cylinder. It is also possible to calculate the actual injection amount more accurately than the third embodiment by using only the pressure Ps_{fil} on the downstream side of the orifice 75.

As described above, in the first, to third embodiments and the modification of the third embodiment, the injector 5A, which is a direct acting fuel injection valve as shown in FIG. 2, is used, and the actuator 6A is a type of an actuator which directly moves the piston 16 by using the electromagnetic coil 34, however, an injector to be used is not limited to those described above. For example, an injector of the following configuration may be used: a stack formed by stacking piezoelectric elements in layers is provided on the lower side of the piston flange part 16a instead of the electromagnetic coil 34, and when voltage is applied to the stack of the piezoelectric elements, the stack lifts the piston 16 upward against the energizing force of the coil spring 37 for injecting fuel, and when the voltage is stopped being applied to the stack of the piezoelectric element, the piston 16 is pushed downward by the coil spring 37 so that the fuel injection is stopped.

### Fourth Embodiment

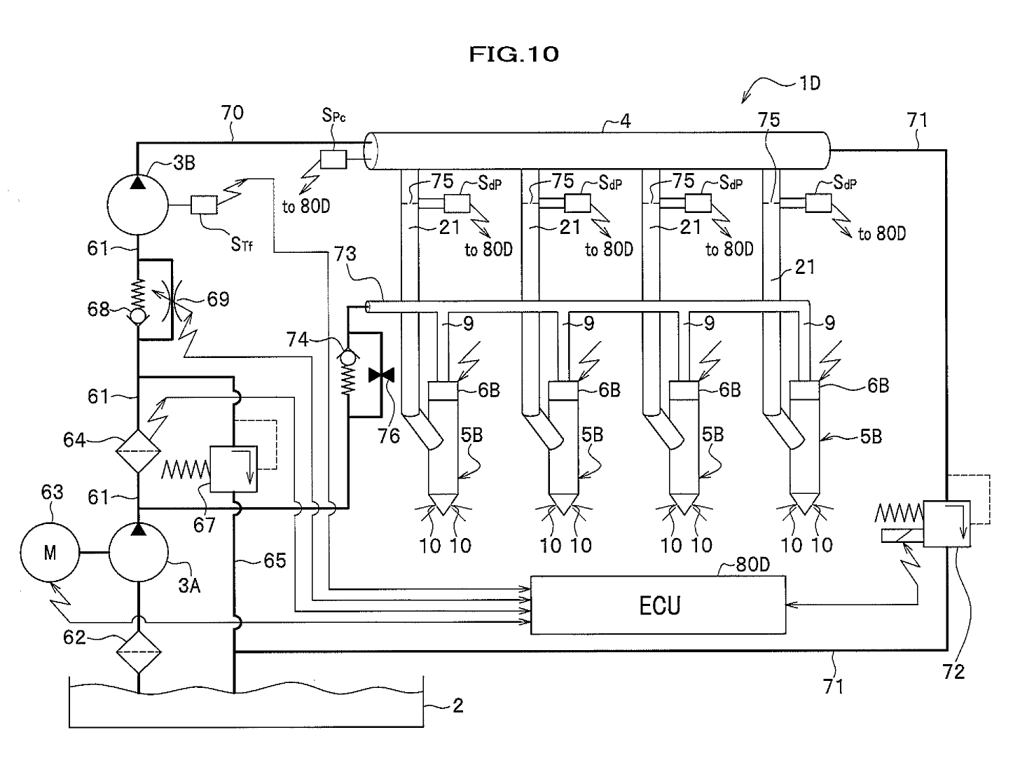

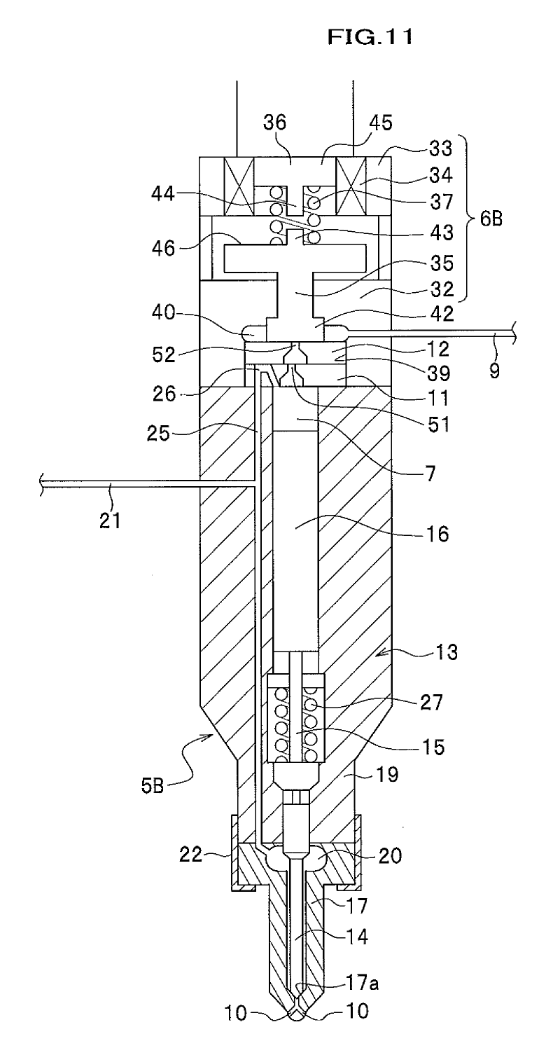

A fuel injection device of a fourth embodiment, of the present invention is described in detail below with reference to FIGS. 10 and 11.

FIG. 10 is an illustration showing an entire configuration of an accumulator fuel injection device of the fourth embodiment. FIG. 11 is a conceptional configuration drawing of a back pressure fuel injection valve (injector) which is used in the accumulator fuel injection device according to the fourth embodiment.

A fuel injection device 1D of the fourth embodiment differs from the fuel injection device 1A of the first embodiment in that: (1) an injector 5B including an actuator 6B, which is a back pressure fuel, injection valve, is used; (2) in accordance with (1), a drain passage 9 is connected to the injector 5B provided in each cylinder, and the drain passages 9 are further connected to a return fuel, pipe 73, which is connected to the low pressure fuel supply passage 61 on the discharge side of the low pressure pump 3A via a flow controller in which a check valve 74 and the orifice 76 is connected in parallel; (3) the fuel, injection device 1D in the fourth embodiment is controlled by the ECU (control unit) 80D.

Components of the fourth embodiment corresponding to those of the first embodiment are assigned like reference numerals, and descriptions thereof will be omitted.

Next, a configuration of the injector 5B according to the fourth embodiment is described with reference to FIGS. 10 and 11. The injector 5B is a well known injector, and is provided to each cylinder of the engine. The configuration of the injector 5B is briefly described below.

The injector 5B includes the injector body 13 of which distal end has one or more fuel injection ports 10, the nozzle needle 14 which is slidably supported in the injector body 13, and the piston 16 which is connected to the upper side of the nozzle needle 14 via a pressure pin 15 to be integrally reciprocated and displaced with the nozzle needle 14.

The injector body 13 includes the nozzle body 17, and the nozzle holder 19. The oil reservoir 20 is formed inside of the nozzle body 17 so as to fill high pressure fuel around the nozzle needle 14. The oil reservoir 20 is always communicated with the common rail 4 via the fuel passage 25 and the high pressure fuel supply passage 21. The nozzle body 17 is fastened to the nozzle holder 19 with a retaining nut 22.

The nozzle holder 19 constitutes a cylinder which forms a long hole 23 in the longitudinal direction at its center part. The long hole 23 slidably supports the piston 16. Provided between the upper side of the long hole 23 and the lower end surface of a first throttle forming member 11 is a back pressure chamber 7 which has an opening on the upper side of the nozzle holder 19. A fuel passage 25 which branches from a fuel passage communicated with the high pressure fuel supply passage 21 and the high pressure fuel supply passage 21 formed in the nozzle holder 19 is communicated with the back pressure chamber 7 via a communication passage 26 formed in the first throttle forming member 11.

The nozzle needle 14 is disposed at the same axial center as the center axis of the actuator 6B which uses a two-way solenoid valve, and is slidably supported in the inner circumference of the nozzle body 17. When the nozzle is opened, the nozzle needle 14 is lifted to form a fuel passage between the distal end of the nozzle needle 14 and the nozzle body 17. The fuel passage communicates the oil reservoir 20 with the fuel injection port 10 so that fuel is injected to the engine. When the nozzle is closed, the distal end of the nozzle needle 14 is seated on a seat surface 17a of the nozzle body 17 so that the injection of the high pressure fuel is finished.

A coil spring 27 for energizing the nozzle needle 14 in the valve closing direction is provided between the major diameter part of the pressure pin 15 and the nozzle holder 19. The piston 16 is disposed at the same axial center as the center axis of the actuator 6B, and is supported such that the piston 16 is slidable along the inner circumferential surface of the long hole 23 of the nozzle holder 19.

The actuator 6B includes: an iron core 33 which is disposed above the valve body 32; the electromagnetic coil 34 which is wound around a housing part of the iron core 33; a valve 35 which is slidably moved in the valve body 32; the stopper 36 for regulating the maximum lift amount of the valve 35; and the coil spring 37 for biasing the valve 35 in the valve closing direction as shown in FIG. 11.

The valve body 32, the iron core 33, the electromagnetic coil 34, the valve 35 and the stopper 36 are fastened to the upper end of the nozzle holder 19 of the injector 5B with a retaining nut (not shown) in a state where the lower end of the valve body 32 is liquid tightly in contact with the nozzle holder 19.

In the valve body 32, the first and second throttle forming members 11, 12 are liquid-tightly fit into a recessed part 39 which is opened for communicating with the back pressure chamber 7. A fuel chamber 40 whose internal diameter is larger than the recessed part 39 is provided inside of the valve body 32. The fuel chamber 40 is connected to the return fuel pipe 73 communicated with the fuel tank 2 via the drain passage 9 which is provided in the valve body 32, or the like.

The iron core 33 is magnetized to be an electric magnet and generates magnet motive force when the electromagnetic coil 34 is energized by the control of the ECU 80D. The valve 35 includes a plate-like sealing part 42 at its lower end and a stick-like part 43 at its upper end. When the iron core 33 generates the magnet motive force, the valve 35 is attracted and moved upward, and the stick-like part 43 of the valve 35 is seated on the lower end of the stopper 36. After the energization of the electromagnetic coil 34 is finished, the iron core 33 loses the magnet motive force, and the sealing part 42 of the valve 35 is seated on the upper end of the second throttle forming member 12 due to the downward energizing force of the coil spring 37.

The first and second throttle forming members 11, 12 are made, for example, of alloy steel or carbon steel, such as SCM 420. The first and second throttle forming members 11, 12 are formed to be disc shape whose center axis corresponds to the center axis of the valve 35 of the actuator 6B. The first throttle forming member 11 and the second throttle forming member 12 respectively includes orifices 51 and 52 of which internal diameter is smaller than that of the fuel passage 25 and the communication passage 26. The orifice 51 is arranged a little closer to the communication passage 26 with respect to the center axis of the first throttle forming member 11, and the orifice 52 is arranged at the same axial center as the center axis of the second throttle forming member 12. The orifice 51 throttles the passage section area of a first passage which communicates the back pressure chamber 7 with the orifice 52. The orifice 52 throttles the passage section area of a second passage which communicates the orifice 51 and the drain passage 9. The orifice 52 is a valve seat member and has an internal diameter 1.4 to 1.6 times larger than that of the orifice 51.

The lower side (not shown) of the orifices 51 and 52 is formed such that the inner diameters of the back pressure chamber 7 is larger than the diameter of the orifices 51 and 52 on their lower sides. The outlet of the orifice 51 is arranged to be opposed to a tapered passage wall surface of the inlet of the orifice 52.

Next, a method performed by the ECU 80D for calculating an actual injection amount for each cylinder is explained with reference to FIGS. 10 to 12D.

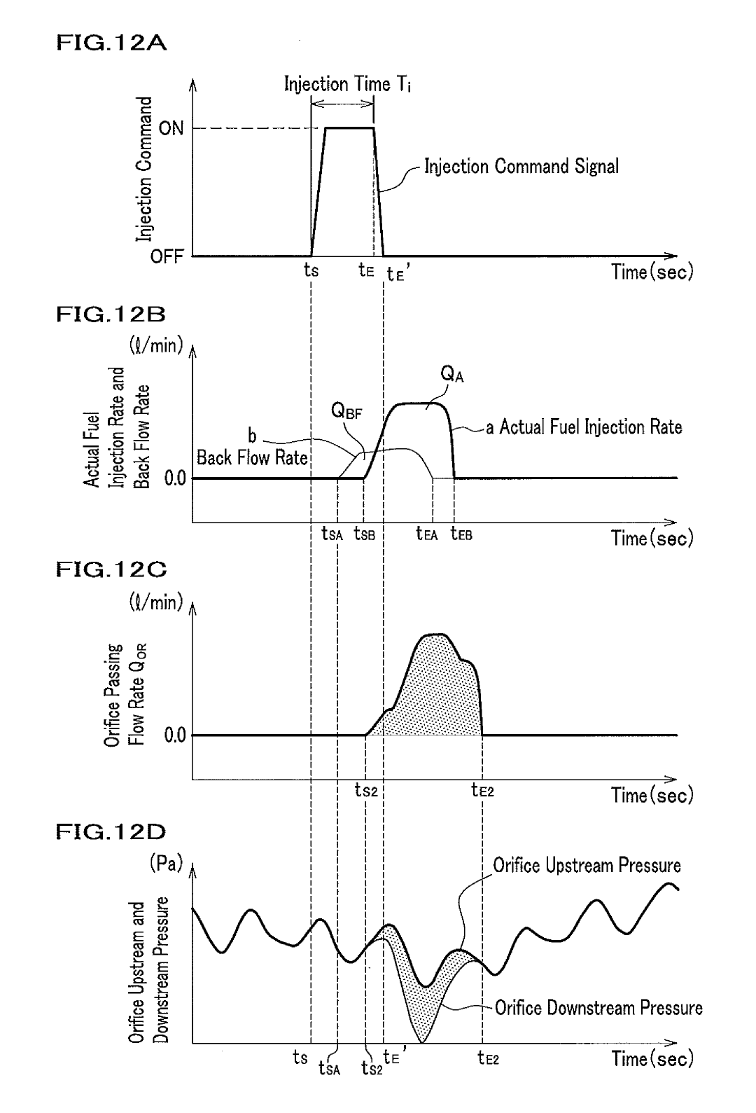

FIGS. 12A to 12D are graphs showing an output pattern of the injection command signal for one cylinder and the temporal variations of fuel flow in the high pressure fuel supply passage. FIG. 12A is a graph for showing an output pattern of the injection command signal. FIG. 12B is a graph for explaining the temporal variation of an actual fuel injection rate and a back flow rate. FIG. 12C is a graph for showing the temporal variation of an orifice passing flow rate of fuel. FIG. 12D is a graph for showing the temporal variation of the pressures on the upstream and downstream sides of the orifice 75.

In FIG. 12A, the injection command signal of fuel is conceptually represented as a wide pulse. The timing when the injection command signal starts to rise (injection start timing) is represented as “t_{S}”. The timing when the injection command signal starts to fall (injection finishing timing) is represented as “t_{E}”, and the timing when the injection command signal has completed falling is represented as “t_{E}′”.

In response to the injection command signal, a back flow of fuel is started by the lift up of the valve 35 (see FIG. 10) of the injector 5B, which is a back pressure fuel injection valve. The back flow of the fuel returns to the low pressure fuel supply passage 61 via the fuel passage 25, the communication passage 26, the back pressure chamber 7, the orifices 51, 52, the fuel chamber 40 and the drain passage 9. As shown in a curve b of FIG. 12B, the back flow starts at the timing t_{SA}. The start of the back flow is a little delayed from the rising start timing t_{S} of the injection command signal.

The back flow makes the pressure of the back pressure chamber 7 to be lower than that of the oil reservoir 20, whereby the piston 16 is moved upward. Thus, an actual fuel injection is started at the timing “t_{SB}” as shown by the curve a in FIG. 12B.

At the fall start timing (injection finish instruction timing) t_{E} of the injection command signal, the electromagnetic coil 34 (see FIG. 11) is stopped being energized, and the coil spring 37 pushes the valve 35 downward, whereby the flow passage for the back flow is closed, and the back flow is finished at the timing t_{EA} as shown by the curve b in FIG. 12B. As a result, the pressure of the back pressure chamber 7 (see FIG. 11) and that of the oil reservoir 20 are balanced, and the nozzle needle 14 is moved downward together with the piston 16 by the energizing force of the coil spring 27. Thus, the nozzle needle 14 is seated on the seat, surface 17a, whereby the fuel injection is finished at, the timing t_{EB} as shown by the curve a in FIG. 12B.

As shown in FIG. 12B, fuel flow which passes the orifice 75 (orifice passing flow rate Q_{OR}) starts at the timing t_{SB}, which is a little delayed from the back flow start timing t_{SA} by the volume of the fuel passage 25 (see FIG. 10) and the high pressure fuel supply passage 21 (see FIG. 10). Similarly, the orifice passing flow rate Q_{OR} becomes 0 at the timing t_{E2}, which is delayed from the fuel injection completion timing t_{EB} by the volume of the fuel passage 25 and the high pressure fuel supply passage 21

Since the difference between the pressures on the upstream and downstream sides of the orifice 75 corresponding to the orifice passing flow rate Q_{OR} in FIG. 12C can be detected by the differential pressure sensor S_{dP} as shown in FIG. 12D even if the pressure on the upstream side of the orifice 75 is varied by the vibration of the common rail pressure Pc, the orifice passing flow rate Q_{OR} can be calculated. In the case of the back pressure injector 5B, the dotted area of the orifice passing flow rate Q_{OR} shown in FIG. 12C is equal to the area which is calculated by adding the areas of the back flow amount Q_{BF} and the actual injection amount Q_{A} (actual fuel supply amount) shown in FIG. 12B.

The orifice passing flow rate Q_{OR} can be readily calculated based on the orifice differential pressure ΔP_{OR} by using the equation (1), similarly to the first, embodiment.

The ECU 80D stores in a memory in advance an actual injection amount conversion factor γ in the form of, for example, a correlation equation of signal parameters. The actual injection amount conversion factor γ is a factor which indicates the ratio between the calculated orifice passing flow amount Qₛᵤₘ and the actual injection amount depending on the output pattern of the fuel injection command signal.

The actual injection amount conversion factor γ, which depends on the output pattern of the injection command signal, is defined as the equation (2) by taking, for example, a signal waveform area Ap as the signal parameter. Specifically, the actual injection amount conversion factor γ is defined as the equation (2) in such a manner that the signal waveform area Ap corresponds to one signal waveform area of an independent injection command signal having the injection time Tᵢ if the injection command signal is the independent injection command signal which is temporally apart from another injection command signal by a predetermined period, and if the injection command signal is comprised of a plurality of injection command signals which are temporally close to one another in a predetermined period, the signal waveform area Ap corresponds to the summation of the signal waveform areas of the plurality of the injection command signals.

γ=F₇(A_{P},M_{P}) (2)

where M_{P}, is a parameter indicating an independent signal waveform or a plural proximity signal waveforms.

When such an injection command signal shown in FIG. 12A is generated, the ECU 80D determines whether or not the injection command signal is an independent signal waveform or a plural proximity signal waveforms based on its output pattern, and calculates the signal waveform area Ap so as to set the actual injection amount conversion factor γ by the equation (2).

It is to be noted that if a response speed of opening and closing the injector 5B is high, the determination of whether or not the injection command signal is an independent signal waveform or a plural proximity waveforms is not necessary.

Then, the calculated orifice passing flow amount Qₛᵤₘ is multiplied by the actual injection amount conversion factor γ to calculate the actual injection amount.

In accordance with the fourth embodiment, it is easy to accurately form the diameter of the opening of the orifice 75, and the differential pressure ΔP_{OR} between the upstream side and the down stream side of the orifice 75 is greater than the differential pressure between the upstream side and the downstream side of the venturi constriction. Thus, the orifice passing flow rate Q_{OR} is easily calculated based on the orifice differential pressure ΔP_{OR} detected by the differential pressure sensor S_{dP} by using the equation (1).

By calculating the orifice passing flow rate Q_{OR} based on the orifice differential pressure ΔP_{OR}, it is possible to accurately calculate an actual fuel supply amount to the injector 5B. Further, the actual injection amount can be calculated by multiplying the actual fuel supply amount by the actual injection amount conversion factor γ.

Since the ECU 80D sets the actual injection amount conversion factor γ in accordance with an output pattern of the fuel injection signal, it is possible to accurately calculate the actual fuel injection amount from the actual fuel supply amount.

Even if the actual fuel supply amount (orifice passing flow amount Qₛᵤₘ), which is the summation of the back flow amount and the actual injection amount, is varied among the injectors 5B for the same injection command signal waveform due to the manufacturing tolerance of the injectors 5B, it is possible to calculate the actual fuel supply amount that reflects the variation of the injectors 5B due to the manufacturing tolerance, whereby the actual injection amount can be calculated from the actual fuel supply amount. Thus, by adjusting the injection time Tᵢ (see FIGS. 3A to 3D) of the injection command signal from the ECU 80D to the injector 5B based on the actual injection amount, it is possible to make the actual injection amount to each cylinder to be equal.

As described above, it is possible to accurately calculate the actual injection amount for each cylinder, whereby the torque generated by each cylinder can be controlled more precisely.

The fuel injection of the injector 5B is generally multi-injection including “Pilot injection”, “Pre injection”, “After injection” and “Post injection” in order to reduce PM (particulate material), NOx and a combustion noise and to increase exhaust temperature or to activate catalyst by supplying a reducing agent.

If an actual injection amount of such a multi-injection is not equal to a target amount calculated based on the operating condition of the engine, a regulated value of an exhaust gas from the engine may not be kept. In the fourth embodiment, even if the actual injection amount is varied by aging, the ECU 80D can control the actual fuel supply amount to be equal to the target amount by adjusting the injection time Tᵢ of the injection command signal since the actual injection amount can be accurately calculated based on the orifice differential pressure ΔP_{OR}.

As a result, it becomes easier to keep the regulated value of an exhaust gas even if requirement on hardware specifications, such as dimension tolerance of each part of the engine system, is relaxed. Especially, requirement on the hardware specification for injectors can be relieved, which contributes to reduction of the manufacturing cost of the engine system.

In the fourth embodiment, the actual injection amount conversion factor γ which is used for calculating the actual fuel injection amount from the orifice passing flow amount (actual fuel supply amount) Qₛᵤₘ is variable, however, it may be an approximate fixed value.

### Fifth Embodiment

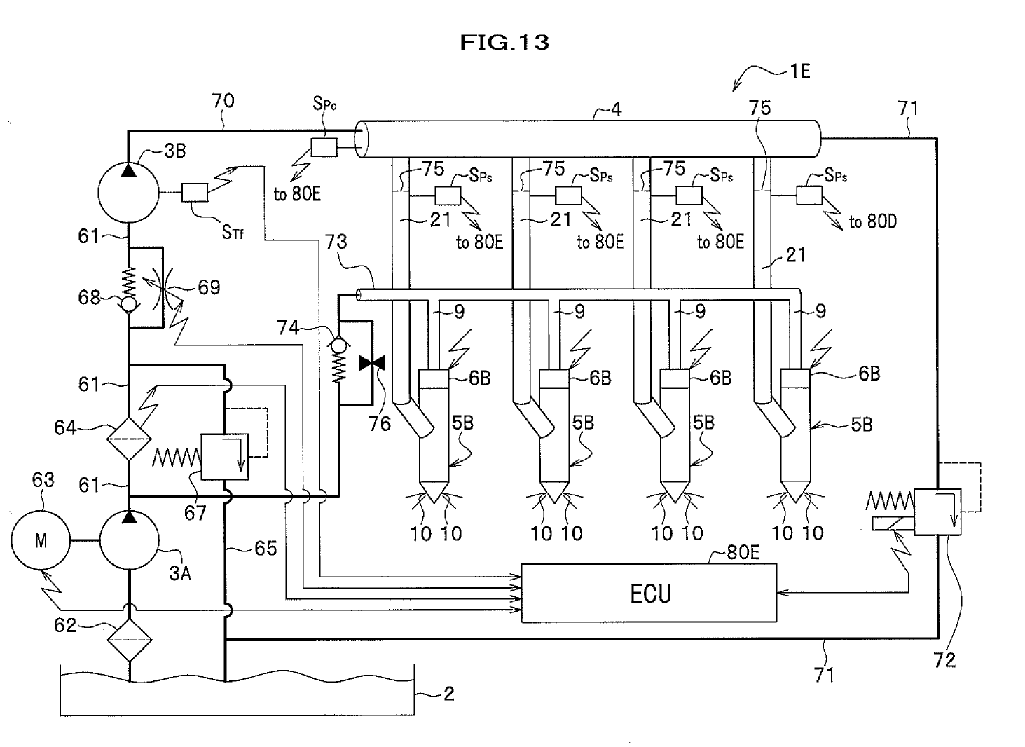

Next, a fuel injection device according to a fifth embodiment of the present invention is described in detail with reference to FIG. 13.

FIG. 13 is an illustration for showing an entire configuration of the accumulator fuel injection device of the fifth embodiment.

The fuel injection device 1E differs from the fuel injection device 1D of the fourth embodiment in that: (1) a pressure sensor S_{Ps} for detecting the pressure on the downstream side of the orifice 75 is provided instead of a differential pressure sensor S_{dP} for detecting the pressure difference between the upstream side and the downstream side of the orifice 75 which is provided in the high pressure fuel supply passage 21 for supplying fuel to the injector 5B attached to each cylinder of the engine; (2) an ECU (control unit) 80E is provided instead of the ECU 80D; (3) the definition of the orifice differential pressure ΔP_{OR} which is used for calculating the orifice passing flow rate Q_{OR} of fuel in the ECU 80E is changed.

In other words, the fifth embodiment uses the injector 5B, which is a back pressure fuel injection valve, instead of the injector 5A, which is a direct acting fuel injection valve, and is modified from the second embodiment to be adapted to the injector 5B.

Components of the fifth embodiment corresponding to those of the fourth embodiment are assigned like reference numerals, and descriptions thereof will be omitted.

As shown in FIG. 13, pressure signals detected by the four pressure sensors S_{Ps} are input to the ECU 80E.

The function of the ECU 80E according to the fifth embodiment is basically the same as that of the ECU 80D according to the fourth embodiment, however, signals used by the ECU 80E to calculate the orifice passing flow rate Q_{OR} are different from those used in the fourth embodiment.

In the fourth embodiment, the orifice passing flow rate Q_{OR} is calculated by using the equation (1). In the fifth embodiment, the orifice differential pressure ΔP_{OR} in the equation (1) is replaced by the pressure difference (Pc−Ps) between the common rail pressure Pc which is detected by the pressure sensor S_{Pc} and the pressure Ps on the downstream side of the orifice 75, which is detected by the pressure sensor S_{Ps}.

It is obvious that the pressure on the upstream side of the orifice 75 in each high pressure fuel supply passage 21 is substantially equal to the common rail pressure Pc. Thus, it is possible to accurately calculate an orifice passing flow rate Q_{OR} of fuel, by using the equation (1) in which the orifice differential pressure ΔP_{OR} is replaced by the pressure difference (Pc−Ps) in the fifth embodiment, similarly to the fourth embodiment. Furthermore, it is also possible to calculate the orifice passing flow amount Qₛᵤₘ by time-integrating the orifice passing flow rate Q_{OR}, and to calculate an actual injection amount for each cylinder and each injection command signal by multiplying the orifice passing flow amount Qₛᵤₘ by the actual injection amount conversion factor γ, which is calculated in accordance with an output pattern of the injection command signal.

As a result, the ECU 80E can control the actual injection amount to be equal to a target fuel injection amount by adjusting the injection time Tᵢ of the injection command signal, similarly to the first embodiment.

Similarly to the fourth embodiment, it becomes easier to keep the regulated value of an exhaust gas even if requirement on hardware specifications, such as dimension tolerance of each part of the engine system, is relaxed. Especially, requirement on the hardware specification for injectors can be relieved, which contributes to reduction of the manufacturing cost of the engine system.

### Sixth Embodiment

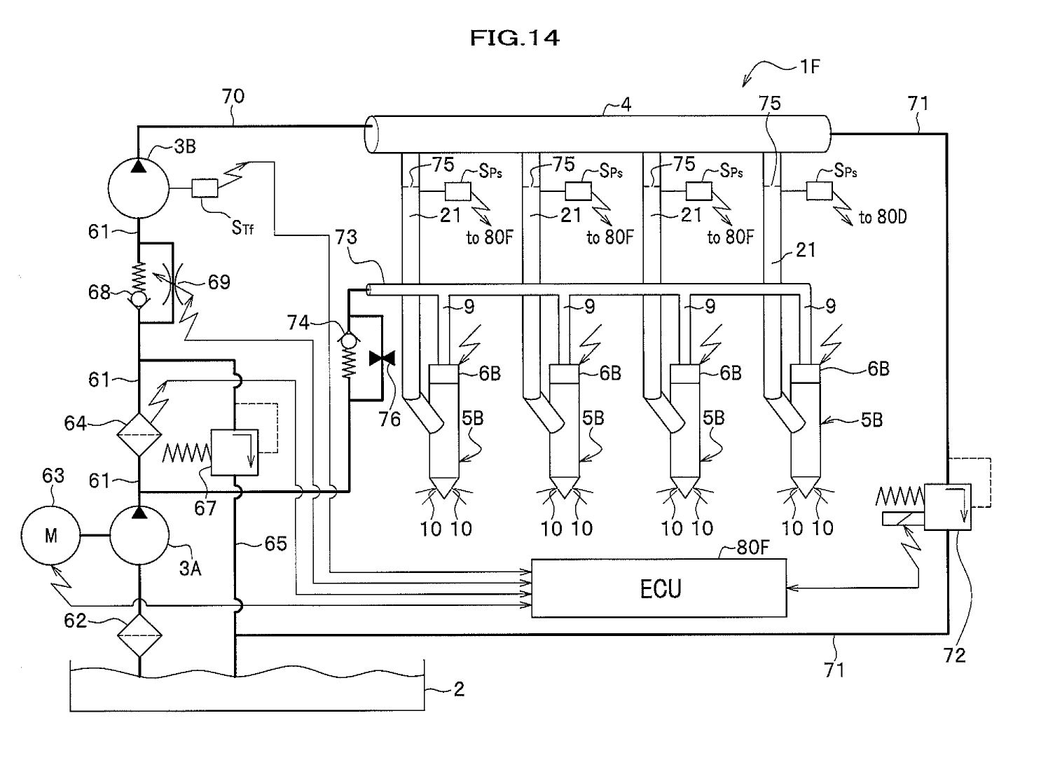

Next, a fuel injection device of a sixth embodiment of the present invention is described in detail with reference to FIG. 14.

FIG. 14 is an illustration for showing an entire configuration of the accumulator fuel injection device of the sixth embodiment.

A fuel injection device 1F of the sixth embodiment is different from the fuel injection device 1E of the fifth embodiment in the following points: (1) the pressure sensor S_{Pc} for detecting the common rail pressure Pc is omitted; (2) an ECU (control unit) 80F is provided instead of the ECU 80E; (3) a pressure sensor S_{Ps} is provided instead of the pressure sensor S_{Pc} for controlling the common rail pressure Pc; and (4) a method performed by the ECU 80F for calculating the orifice passing flow rate Q_{OR} of fuel is changed from the method performed by the ECU 80E.

In other words, the sixth embodiment uses the injector 5B, which is a back pressure fuel injection valve, instead of the injector 5A, which is a direct acting fuel injection valve, and is modified from the third embodiment to be adapted to the injector 5B.

Components of the sixth embodiment corresponding to those of the fifth embodiment are assigned like reference numerals, and descriptions thereof will be omitted.

As shown in FIG. 14, pressure signals detected by the four pressure sensors S_{Ps} are input to the ECU 80C.

The ECU 80F performs a filtering process on the pressure signals input from the pressure sensors S_{Ps} for cutting off a noise with a high frequency.

By filtering processing the pressure signal input from the fuel supply passage pressure sensor S_{Ps}, the pressure vibration of the pressure Ps_{fil} from the pressure sensor S_{Ps} becomes comparatively smaller at an “aspiration stroke” and “compression stroke” which follows the “explosion stroke” and “exhaust stroke” after a fuel injection is performed and completed in one cylinder based on signals from a crank angle sensor (not shown) and a cylinder discriminating sensor (not shown) and the injection command signal for each cylinder generated by the ECU 80F. The pressure Ps_{fil} from the fuel supply passage pressure sensor S_{Ps} in the state where its pressure vibration is comparatively smaller is substantially equal to the common rail pressure Pc.

The ECU 80F samples the pressure Ps_{fil} in the above described state where its pressure vibration is comparatively small and controls the pressure control valve 72 to control the common rail pressure Pc within a predetermined range.

Only one pressure sensor S_{Ps} among the four pressure sensors S_{Ps} may be representatively used for controlling the common rail pressure Pc in the case of the 4 cylinder engine used in the third embodiment, or all of the four pressure sensors S_{Ps} may be used to generate four signals of which sampling timing is different, and the common rail pressure Pc may be set to be the average value of the four signals.

The function of the ECU 80F of the sixth embodiment is basically the same as that of the ECU 80E of the fifth embodiment except for the method for controlling the common rail pressure Pc. However, they are also different in that the orifice differential pressure used by the ECU 80C for calculating the orifice passing flow rate Q_{OR} of fuel is not based on the pressure difference detected by the differential pressure sensor S_{dP} or the pressure sensors S_{Pc}, S_{Ps} as in the fourth or fifth embodiment, but is based on only the signal from the pressure sensor S_{Ps} provided on the downstream side of the orifice 75.

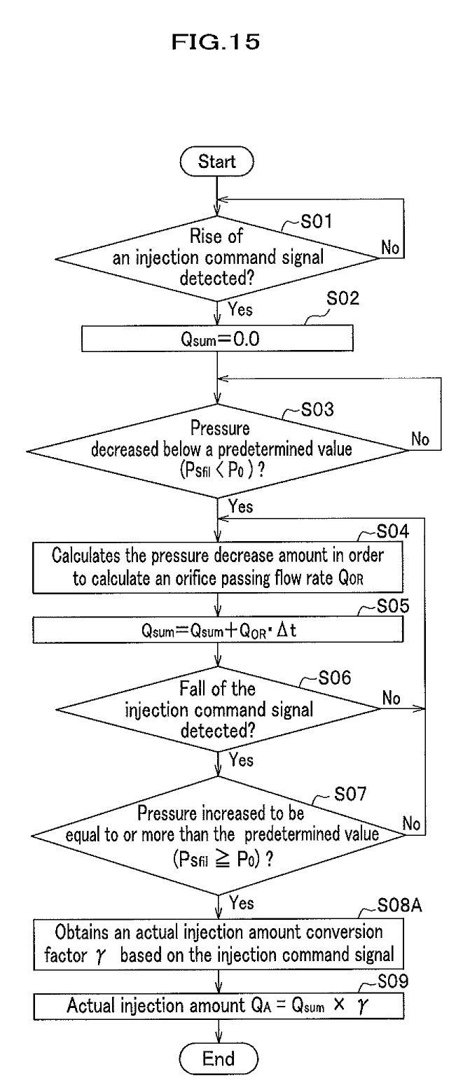

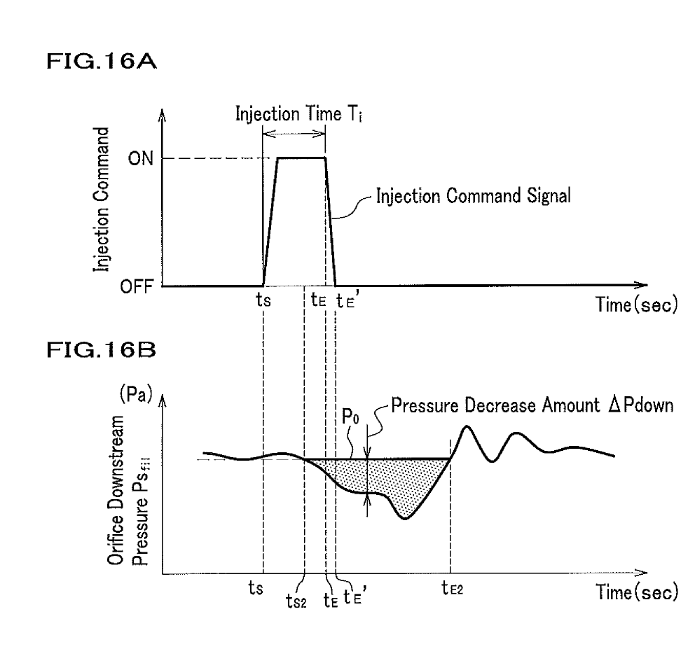

Next, a method for calculating an orifice passing flow rate Q_{OR} based on only the signal from the pressure sensor S_{Ps} provided on the downstream side of the orifice 75 and further calculating an actual injection amount is described with reference to FIGS. 15, 16A and 16B.

FIG. 15 is a flow chart, showing a control flow performed by the ECU 80F of the sixth embodiment for calculating the orifice passing flow rate Q_{OR} and the actual injection amount for one cylinder. FIGS. 16A and 16B are graphs showing an output pattern of the injection command signal for one cylinder and the temporal variations of fuel flow in the high pressure fuel supply passage. FIG. 16A is a graph for showing an output pattern of the injection command signal. FIG. 16B is a graph showing the temporal variation of the pressure Ps_{fil} on the downstream side of the orifice.

The processing of Steps 03 to 07 in the flowchart shown in FIG. 15 is the same as that of Steps 03 to 07 in the flowchart of the third embodiment shown in FIG. 6. The flowchart of the sixth embodiment is different from that, of the third embodiment only in that Step 08A is substituted for Step 08, and Step 09 is added. Thus, corresponding steps are assigned similar reference numerals, and descriptions thereof will be omitted. Note that “FIG. 7A”, “FIG. 7B” and “injector 5A” in the explanation of the flowchart shown in FIG. 6 should be read as “FIG. 16A”, “FIG. 16B” and “injector 5B”, respectively.

In Step 08A after Step 07, the actual injection amount conversion factor γ is obtained by referring to the injection command. Then, Qₛᵤₘ is multiplied by the actual injection amount conversion factor γ to calculate an actual injection amount (Step 09). In FIG. 16B, the dotted area encompassed by the line indicating the predetermined value P0 and the curve indicating the pressure Ps_{fil} corresponds to Qₛᵤₘ (i.e. actual fuel supply amount).

The timing t_{S2} in FIG. 16B is also referred to as the “first timing”, and the timing t_{E2} at which the pressure Ps_{fil} on the downstream side of the orifice 75 increases to be equal to or more than the predetermined value is also referred to as the “second timing”.

In accordance with the sixth embodiment, it is possible to easily control the common rail pressure Pc by using the pressure sensor S_{Ps} which detects the pressure Ps on the downstream side of the orifice 75 even if the pressure sensor S_{Pc} which detects the common rail pressure Pc is omitted. This allows to reduce the cost of the fuel injection system.

It is also possible to accurately calculate the orifice passing flow rate Q_{OR} based on the equation (1) in which the pressure decrease amount ΔPdown(P₀−Ps_{fil}) is substituted for the orifice differential pressure ΔP_{OR} by using only the pressure signal from the pressure sensor S_{Ps} for detecting the pressure on the downstream side of the orifice 75. Further, the actual injection amount can be calculated for each cylinder and each injection command signal by multiplying the orifice passing flow amount Qsum by the actual injection amount conversion factor γ which depends on the command signal. As a result, the ECU 80F is allowed to control the actual injection amount to be equal to a target fuel injection amount by adjusting the injection time Tᵢ of the injection command signal, similarly to the fifth embodiment.

Similarly to the fifth embodiment, it becomes easier to keep the regulated value of an exhaust gas even if requirement on hardware specifications, such as dimension tolerance of each part of the engine system, is relaxed. Especially, requirement on the hardware specification for injectors can be relieved, which contributes to reduction of the manufacturing cost of the engine system.

### Modification of Sixth Embodiment

Next, a fuel injection device of a modification of the sixth embodiment is described with reference to FIGS. 9A, 12A to 12D, 17 and 18A to 18B. A configuration of the modification is the same as that of the sixth embodiment except for the method for detecting the “second timing”.

The modification of the sixth embodiment uses the injector 5B, which is a back pressure fuel injection valve, instead of the injector 5A, which is a direct acting fuel injection valve, and is modified from the modification of the third embodiment to be adapted to the injector 5B.

Components of the modification of the sixth embodiment corresponding to those of the sixth embodiment are assigned like reference numerals, and descriptions thereof will be omitted.

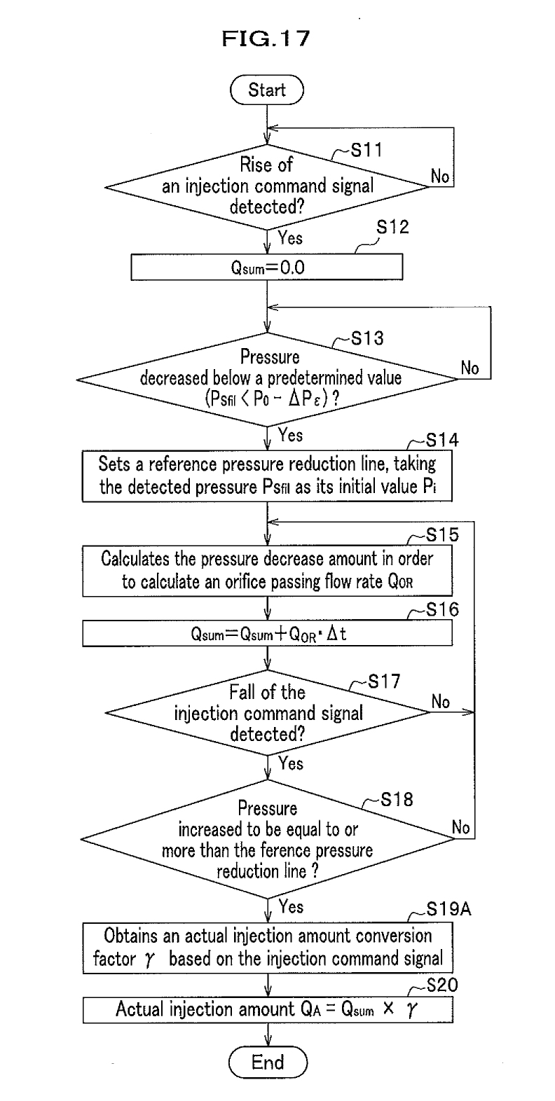

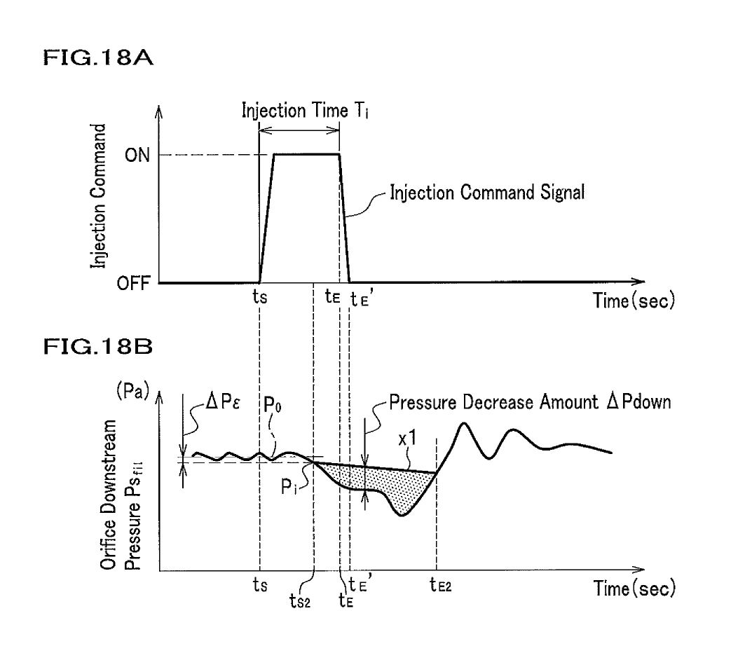

FIG. 17 is a flowchart, showing a process performed by the ECU 80F of the modification of the sixth embodiment for calculating an orifice passing flow rate Q_{OR} for one cylinder. FIGS. 18A and 18B are graphs showing an output pattern of the injection command signal for one cylinder and the temporal variations of fuel flow in the high pressure fuel supply passage. FIG. 18A is a graph for showing an output pattern of the injection command signal. FIG. 18B is a graph for showing the temporal variation of the pressure Ps_{fil} on the downstream side of the orifice 75.

In this modification, a reference pressure reduction line indicating the pressure on the upstream side of the orifice 75 is set in advance as shown in FIG. 9A based on the following experimental data: the pressure on the upstream side of the orifice 75 at the time when the pressure difference ΔP_{OR} of the orifice 75 becomes 0, which is caused by fuel flow after completion of the fuel injection from the injector 5B, always becomes lower than the initial pressure before the fuel injection is started as shown in FIG. 12D; and the longer the injection time Tᵢ of fuel is, the greater the amount of the pressure reduction becomes.

The processing of Steps 11 to 18 in the flowchart shown in FIG. 17 is the same as that of Steps 11 to 18 in the flowchart of the modification of the third embodiment shown in FIG. 8. The flowchart of the modification of the sixth embodiment is different from that of the modification of the third embodiment only in that Step 19A is substituted for Step 19 and Step 20 is added. Thus, corresponding steps are assigned similar reference numerals, and descriptions thereof will be omitted. Note that “FIG. 9B”, “FIG. 9C” and “injector 5A” in the explanation of the flowchart shown in FIG. 8 should be read as “FIG. 18A”, “FIG. 18B” and “injector 5B”, respectively.

In Step 19A after Step 18, the actual injection amount conversion factor γ is obtained by referring to the injection command. Then, Qₛᵤₘ is multiplied by the actual injection amount conversion factor γ to calculate an actual injection amount (Step 20). In FIG. 18B, the dotted area encompassed by the reference pressure reduction line x1 and the curve indicating the pressure Ps_{fil} corresponds to Qₛᵤₘ (i.e. actual fuel supply amount).

The timing t_{S2} of the modification of the sixth embodiment shown in FIG. 18B is also referred to as the “first timing”, and the timing t_{E2} at which the pressure Ps_{fil} on the downstream side of the orifice 75 increases to be equal to or more than the predetermined value is also referred to as the “second timing”.

In accordance with the modification of the sixth embodiment, the actual injection amount can be more accurately calculated than the third embodiment by using only the pressure Ps_{fil} on the downstream side of the orifice 75.

In the fourth to sixth embodiments and the modification of the sixth embodiment, the injector 5B, which is a back pressure fuel injection valve as shown in FIG. 11 is used, and the actuator 6B is a type of an actuator which moves the valve 35 by using the electromagnetic coil 34 to control the pressure of the back pressure chamber 7, however, an injector to be used is not limited to those described above. For example, an injector of the following configuration may be used: a control valve of a three-way valve structure is moved by using a piezoelectric stack to control the pressure of a back pressure chamber provided above a nozzle needle for injecting fuel or stopping the fuel injection.

In the first to sixth embodiments and the modifications of the third and sixth embodiments, the volume of a fuel passage including the high pressure fuel supply passage 21 in the fuel injection devices 1A to 1F that is lower than the orifice 75 and the fuel passage to a fuel injection port 10 inside the injector 5A or 5B (the fuel passage 25 and the oil reservoir 20 (see FIGS. 2 and 11)) is designed to exceed the maximum actual fuel supply amount which is supplied through the high pressure fuel supply passage 21 for an explosion stroke among the cycles of aspiration, compression, explosion and exhaust in one cylinder, such as the maximum actual fuel supply amount required when the maximum torque is required by a fully-opened accelerator. Therefore, the high pressure fuel which is accumulated in a part lower than the orifice 75 before fuel injection is enough for any required fuel injection in a cylinder

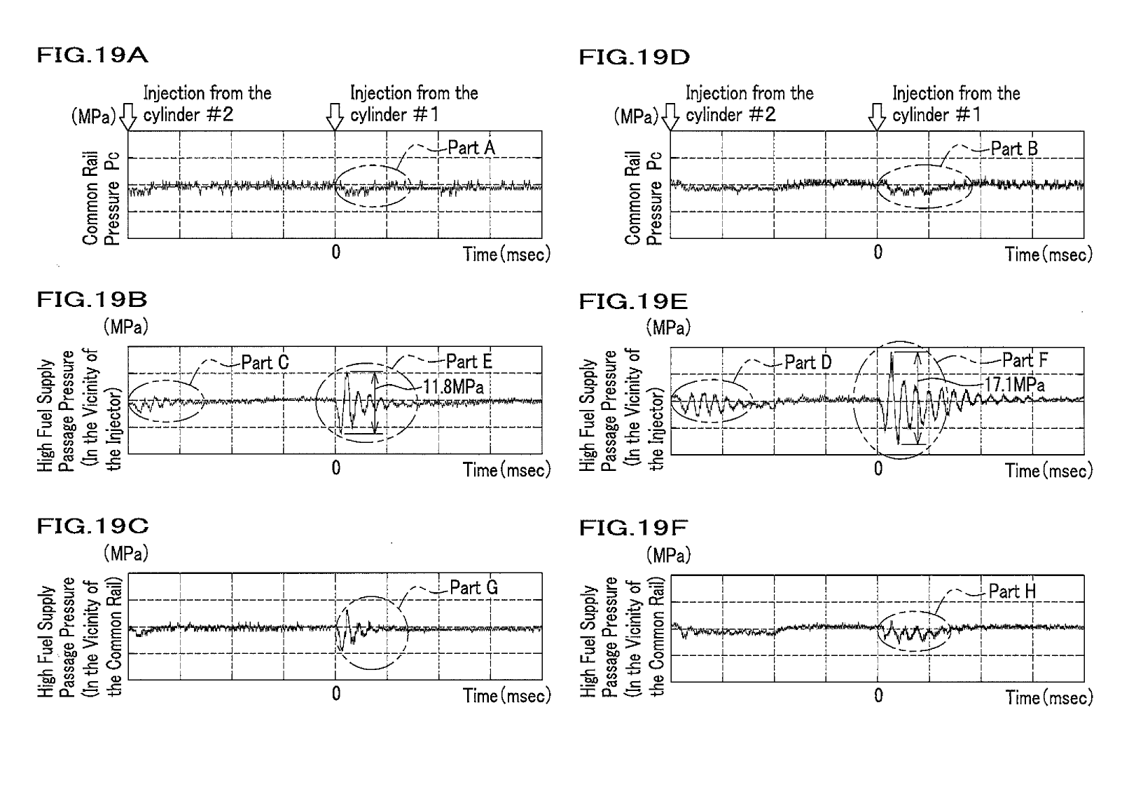

The temporal variations of the common rail pressure Pc (FIG. 19A), the pressure of the high pressure fuel supply passage in the vicinity of the injector for own cylinder (#1 cylinder) (FIG. 19B), and the pressure of the high pressure fuel supply passage in the vicinity of the common rail for the own cylinder (#1 cylinder) (FIG. 19C) in the case where the orifice 75 is provided in the high pressure fuel supply passage 21 on the side of the common rail 4 and the volume of the fuel passage is designed to be as described above are shown in FIGS. 19A to 19C. For comparison, the temporal variations of the common rail pressure Pc (FIG. 19D), the pressure of the high pressure fuel supply passage in the vicinity of the injector for own cylinder (#1 cylinder) (FIG. 19E), and the pressure of the high pressure fuel supply passage in the vicinity of the common rail for the own cylinder (#1 cylinder) (FIG. 19F) in the case where the orifice 75 is not provided in the high pressure fuel supply passage 21 on the side of the common rail 4 and the volume of the fuel passage is designed to be as described above are shown in FIGS. 19D to 19F. These temporal pressure variations shown in the figures are in the case whether a back pressure injector is used.

In FIGS. 19A to 19F, the left end of the time axis represents the timing at which an injection signal for other cylinder, #2 cylinder, is generated, and the center of the time axis which is indicated as “0” represents the timing at, which an injection signal for the own cylinder, #1 cylinder, is generated.

The temporal pressure variations shown in FIGS. 19A to 19F are obtained under the condition that the engine rotation speed is 1500 r PM, the common rail pressure Pc is 70 MPa and the actual injection amount is 20 mm³.

As will be understood by comparing the part A in FIG. 19A and the part, B in FIG. 19D, the pressure variation of the common rail pressure Pc at the time of fuel injection is reduced if the orifice 75 is provided.

Thus, the accuracy in controlling a fuel injection amount is improved because the variation of the common rail pressure Pc is reduced in the control of the ECU 80 (which represents the ECU 80A to 80F) for stabilizing the common rail pressure Pc to be substantially constant by controlling the pressure control valve 72.

As will be also understood by comparing the part C in FIG. 19B and the part D in FIG. 19E, the variation of the pressure of the high pressure fuel supply passage 21 in the vicinity of the injector for own cylinder (#1 cylinder) at the time of fuel injection in the other cylinder (#2 cylinder) is reduced and is stabilized rapidly if the orifice 75 is provided, if the number of cylinders of the engine is more than 4, the time interval between fuel injections for the other cylinder and the own cylinder may be shorter. In this case, the rapid stabilization of the pressure variation caused by the fuel injection in the other cylinder means that disturbance in controlling an actual injection amount for the own cylinder can be suppressed.

Next, as will be understood by comparing the part E in FIG. 19B and the part F in FIG. 19E, the variation of the pressure in the high pressure fuel supply passage 21 in the vicinity of the injector for the own cylinder (#1 cylinder) at the time of fuel injection in the own cylinder (#1 cylinder) is suppressed to be smaller if the orifice 75 is provided.

Because the fuel injection amount is equal, the initial pressure decrease is not different between the part E and the part F regardless of whether or not the orifice 75 is provided to the high pressure fuel supply passage 21. However, if the orifice 75 is provided, the pressure increase after the initial pressure decrease is smaller because fuel supply is restricted by a large resistance of the orifice 75 due to its narrowed flow passage when the amount of fuel corresponding to the amount of fuel injected from the injector is supplied from the common rail 4.

On the other hand, if the orifice 75 is not provided, the pressure increase after the initial pressure decrease is greater as shown in the part F because the fuel supply amount is larger due to the smaller resistance when the amount of fuel corresponding to that injected from the injector is supplied from the common rail 4. The pressure vibration also continues longer since the reflection wave of the pressure vibration is bigger and the effective volume of pressure propagation includes the volume of the common rail 4.

As will be understood by comparing the part A in FIG. 19A and the part B in FIG. 19D, the difference between the parts A and B in the pressure vibration caused by supplying fuel from the common rail 4 to the high pressure fuel supply passage 21 is obvious; the decrease amount of the common rail pressure Pc in the part B in the case where the orifice 75 is not provided is greater than that in the part A.

As will be also understood by comparing the part G in FIG. 19C and the part H in FIG. 19F, the variation of the pressure of the high pressure fuel supply passage 21 in the vicinity of the common rail (the down stream side of the orifice 75) for the own cylinder (#1 cylinder) is larger, but is more rapidly stabilized if the orifice 75 is provided.

As a general theory, a pressure change dP/dt caused when the volume of fluid is changed by ΔQ in a space of a predetermined volume V is represented as the equation (3).

$$\frac{d P}{d t} = \frac{K}{V} \cdot Δ Q \qquad ( 3 )$$

where K is a constant value, and the volume V corresponds to the summation of the volume of the high pressure fuel supply passage 21 and the volume of the fuel passage to the fuel injection port 10 in the injector if the orifice 75 is provided, while if the orifice 75 is not provided, the volume V corresponds to the volume which is obtained by adding the volume of the common rail 4 to the summation of the above volumes.

In the case where the orifice 75 is provided, if the fuel is injected from the injector by ΔQ, the pressure decrease of the high pressure fuel supply passage 21 in the vicinity of the common rail is greater than in the case where the orifice 75 is not provided as shown in the part G in FIG. 19C according to the equation (3), and the rebound of the pressure vibration (pressure increase) after the pressure decrease is also larger. However, the period for which the pressure vibration continues is shorter since the substantial volume of the pressure vibration does not include the common rail 4.

On the other hand, in the case where the orifice 75 is not provided, if the fuel is injected from the injector by ΔQ, the pressure decrease of the high pressure fuel supply passage 21 in the vicinity of the common rail is comparatively smaller than in the case where the orifice 75 is provided, as shown in the part H in FIG. 19F according to the equation (3), and the rebound of the pressure vibration (pressure increase) is also smaller. However, the period for which the pressure vibration continues is longer since the substantial volume of the pressure vibration includes the common rail 4.

As a summary, advantages of providing the orifice 75 in the high pressure fuel supply passage 21 on the side of the common rail 4 are described below. (1) If the orifice 75 is provided, the pressure variation of the high pressure fuel supply passage 21 in the vicinity of the injector can be made smaller than the case where the orifice 75 is not provided. (2) If the orifice 75 is provided, the pressure variation of the high pressure fuel supply passage 21 in the vicinity of the common rail 4 (downstream side of the orifice 75) can be made greater than the case where the orifice 75 is not provided. (3) A period for which the pressure variation of the high pressure fuel supply passage 21 after fuel injection continues can be made shorter.

Therefore, it is possible to enhance the detection accuracy of fuel flow amount by making the pressure variation in the vicinity of common rail 4 at the time of fuel injection to be larger with the orifice 75. If the orifice 75 is provided, the pressure variation in the vicinity of the injector at the time of fuel injection can be made smaller, and the pressure variation can be stabilized in a shorter time, which allows to accurately control each injection amount when plural injections are performed consecutively by the injector.

If the orifice 75 is provided, the orifice 75 becomes a resistance for fluid, and thus the impact pressure of the high pressure fuel supply passage 21 in the vicinity of the injector, which is caused by fuel supply at the time of the completion of the fuel injection becomes smaller. The reflection wave of the impact pressure is also smaller, and the effective volume of the pressure propagation is limited to the volume of the high pressure fuel supply passage 21 and does not include the volume of the common rail 4, whereby the pressure vibration is rapidly stabilized. This means that the pressure vibration propagated to the high pressure fuel supply passages 21 of other cylinders via the common rail 4 from the own cylinder (#1 cylinder) is smaller.

In the first to sixth embodiments including the modifications, the injection command signal generated by the ECU 80A to 80F for controlling the fuel injection amount for each cylinder controls the fuel injection amount based on the period of the injection command signal, however, in addition to the period of the injection command signal, the fuel injection amount may be controlled by the lift amount of the nozzle needle 14 of the injectors 5A, 5B, which is controlled by changing the height of the injection command signal.

Further, in the first to sixth embodiments including the modifications, the injectors 5A and 5B directly inject fuel into the combustion chamber of each cylinder, however, configurations of the present invention are not limited to this. The present invention also includes a configuration where the injectors 5A and 5B inject fuel in a subsidiary chamber (premixed space) which is formed adjacent to the combustion chamber of each cylinder, and a configuration where the injectors 5A and 5B inject fuel in the aspiration port of each cylinder. In these configurations, the advantages of the first to sixth embodiments including the modifications can be also obtained.

### Seventh Embodiment

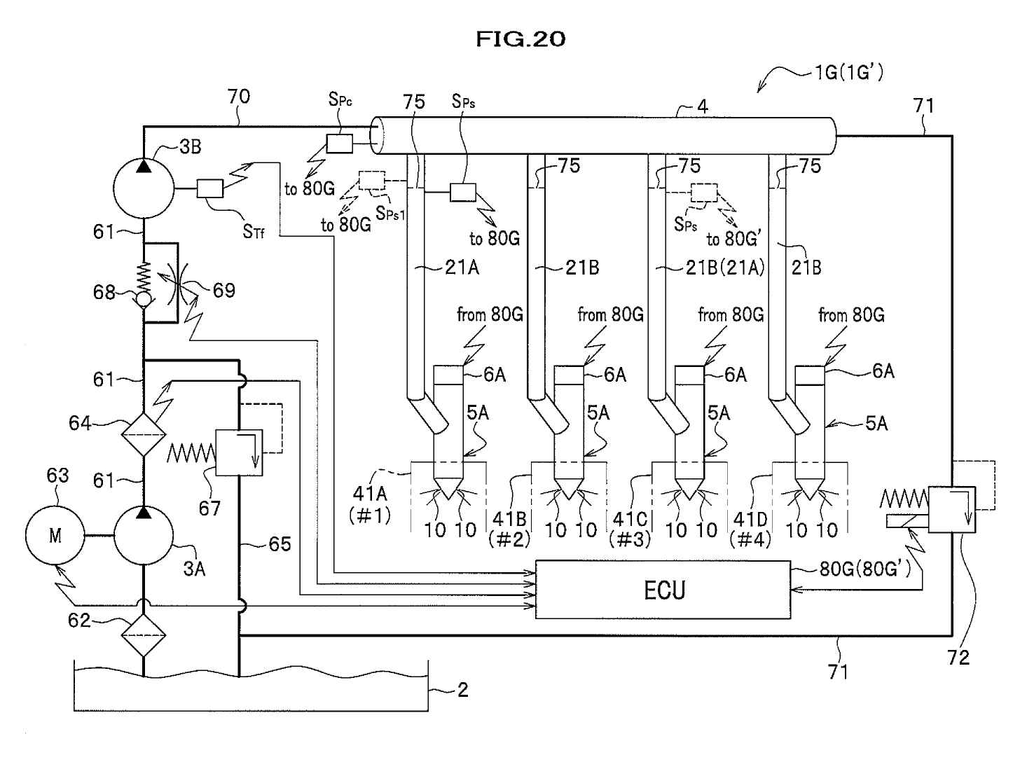

A fuel injection device according to a seventh embodiment of the present invention is described in detail with reference to FIG. 20.

FIG. 20 is an entire configuration of the accumulator fuel injection device in the seventh embodiment.

The seventh embodiment has a configuration which is based on that of the second embodiment, and is different therefrom only in that: (1) the pressure sensor S_{Ps} is provided only in the high pressure fuel supply passage (fuel supply passage) 21A of a representative cylinder, which is the cylinder 41A, on the downstream side of the orifice 75, and the pressure sensor S_{Ps} is not provided in the high pressure fuel supply passages (fuel supply passages) 21B, 21B, 21B for the other cylinders 41B, 41C, 41D; (2) an ECU (control unit) 80G is provided instead of the ECU 80B.

Components of the seventh embodiment corresponding to those of the second embodiment are assigned like reference numerals, and descriptions thereof will be omitted.

Each cylinder 41 of the 4 cylinder engine is represented as 41A, 41B, 41C, 41D, and is assigned the cylinder numbers “#1”, “#2”, “#3” and “#4”, respectively in FIG. 20).

The low pressure pump 3A and the high pressure pump 3B are also referred to as a “fuel pump”. The cylinder 41A is also referred to as a “first cylinder”, and the cylinders 41B, 41C, 41D are also referred to as a “second cylinder”.

It is to be noted that the injector 5A in the seventh embodiment is a direct acting injector as shown in FIG. 2.

The ECU 80G performs a filtering process on the signal indicating the fuel supply passage pressure Ps input from the pressure sensors S_{Ps} for cutting off a noise with a high frequency.

Hereinafter, the fuel supply passage pressure Ps which has been filtering-processed is called a fuel supply passage pressure Ps_{fil}, or just “pressure Ps_{fil}”.

By filtering processing the pressure signal input from the fuel supply passage pressure sensor S_{Ps}, the pressure vibration of the pressure Ps_{fil} from the pressure sensor S_{Ps} becomes comparatively smaller at an “aspiration stroke” and “compression stroke” which follows the “explosion stroke” and “exhaust stroke” after a fuel injection is performed and completed in one cylinder based on signals from a crank angle sensor (not shown) and a cylinder discriminating sensor (not shown) and the injection command signal for each cylinder generated by the ECU 80G. The pressure Ps_{fil} from the fuel supply passage pressure sensor S_{Ps} in the state where its pressure vibration is comparatively smaller is substantially equal to the common rail pressure Pc.

In the seventh embodiment, the common rail pressure Pc detected by the common rail pressure sensor S_{Pc} is also filtering-processed similarly to the pressure signal detected by the fuel supply passage pressure sensor S_{Ps}, however, the common rail pressure is just referred to as “Pc”.

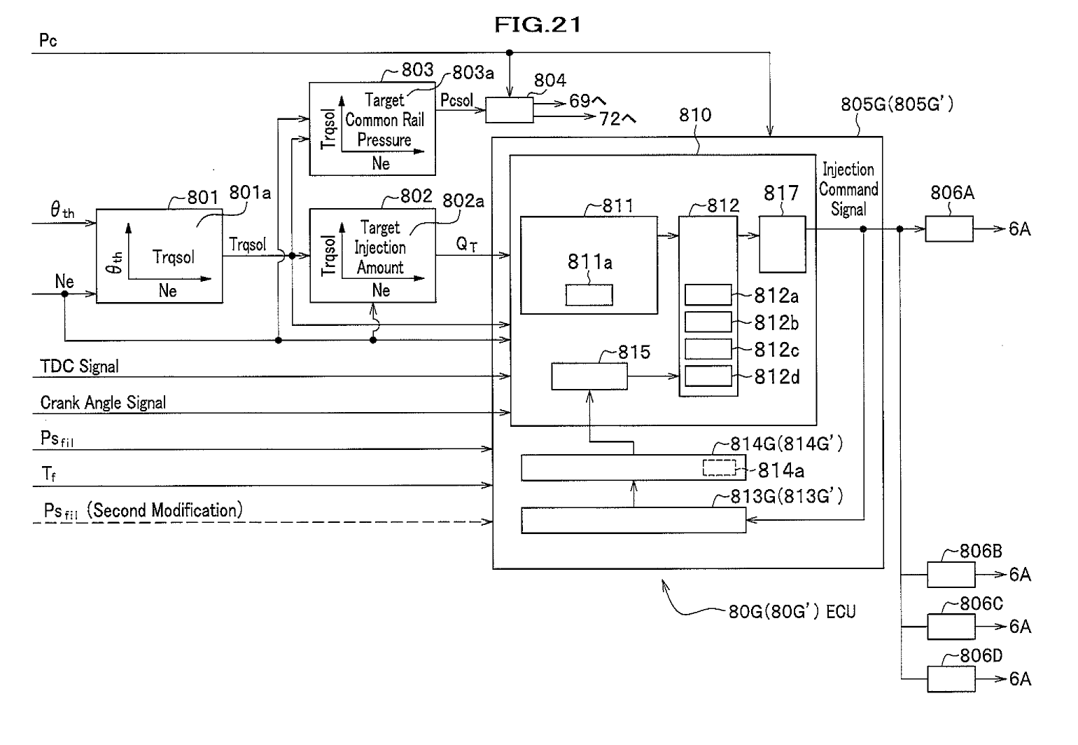

Next, an engine controlling device (ECU 80G) which is used in the accumulator fuel injection device of the seventh embodiment is described with reference to FIGS. 21 to 24B.

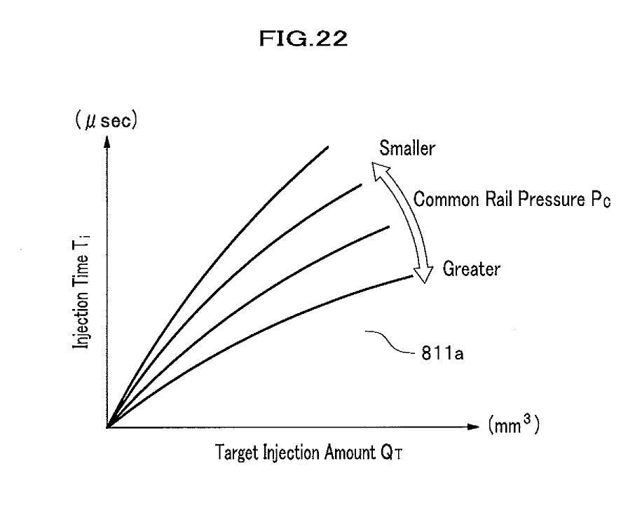

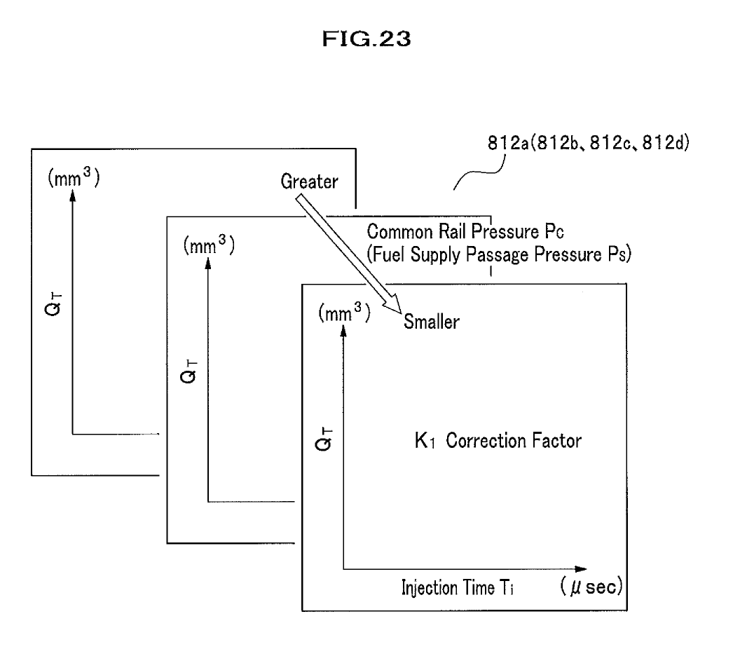

FIG. 21 is a functional block diagram of the engine controlling device used in the accumulator fuel injection device of the seventh embodiment. FIG. 22 is a conceptual graph of a two dimensional map for determining the injection time Tᵢ for obtaining the target injection amount Q_{T}. FIG. 23 is a conceptual graph of a map of a correction factor K₁ for obtaining the correction factor of the injection time, where a target injection amount, an injection time and a common rail, pressure are taken as parameters.

The ECU 80G includes a micro computer (including a CPU, ROM, RAM, non-volatile memory such as a flash memory) (not shown), an interface circuit (not shown), and an actuator driving circuit 806 (806A to 806D in FIG. 21) for driving the actuator 6A. The micro computer electronically controls the actuator 6A by calculating an optimum fuel injection amount and an optimum injection timing based on signals from various sensors such as, an engine rotation speed sensor, a cylinder discriminating sensor, a crank angle sensor, a water temperature sensor, an intake air temperature sensor, an intake air pressure sensor, an accelerator (throttle) opening sensor, a fuel, temperature sensor S_{Tf}, a common rail pressure sensor S_{Pc}, and a fuel supply passage pressure sensor S_{Ps}. A piezoelectric stack having a high response speed is used for the actuator 6A.

Preferably, a CPU of a high calculation speed, such as a multi core CPU is used as the CPU of the micro computer.

The ECU 80G may include a motor driving circuit for driving the motor 63, or the motor driving circuit may be provided outside of the ECU 80G.

Hereinafter, operations controlled by the micro computer of the ECU 80G are represented just as control of the ECU 80G. Hardware configurations of ECU 80G′, ECU 80H to 80K, ECU 80H′ to 80K′ in a modification of the seventh embodiment and eighth to tenth embodiments which are described later are the same as that of the ECU 80G.

(Outline of Control of ECU 80G)

An outline of a basic processing performed by the ECU 80G for controlling the engine is shown in the functional block diagram in FIG. 21. A required torque calculation unit 801 calculates a required torque Trqsol based on the accelerator opening θₜₕ and the engine rotation speed Ne. A target injection amount calculation unit 802 calculates a target injection amount Q_{T} based on the engine rotation speed Ne and the calculated required torque Trqsol. An injection control unit 805G determines an injection start instruction timing for fuel injection, a corrected injection time which corresponds to the target injection amount Q_{T}, and an injection finish instruction timing based on the engine rotation speed Ne, the calculated required torque Trqsol, the calculated target injection amount Q_{T}, a TDC signal, a crank angle signal, a common rail pressure Pc detected from the common rail pressure sensor S_{Ps} (see FIG. 20), and a fuel supply passage pressure Ps_{fil} detected by the fuel supply passage pressure sensor S_{Ps} provided in the high pressure fuel supply passage 21A. The ECU 80G sets the injection start instruction timing and the injection finish instruction timing, and outputs them to the actuator driving circuits 806A, 806B, 806C, and 806D as the injection command signal to drive the actuator 6A of each injector 5A.

The injection control unit 805G also calculates an actual fuel supply amount to the injector 5A of each cylinder 41. The injection control unit 805G stores the ratio of the target injection amount Q_{T} and the calculated actual injection amount as a correction factor since the calculated actual fuel supply amount corresponds to the actual injection amount of the injector 5A. The injection control unit 805G uses the correction factor to correct the injection time when determining the injection time.

The specific configuration and effects of the injection control unit 805G are described later.

A common rail pressure calculation unit 803 calculates a target common rail pressure Pcsol based on the required torque Trqsol which is calculated in the required torque calculation unit 801 in the ECU 80G and the engine rotation speed Ne with reference to a two dimensional map 803a of the common rail pressure. A common rail pressure control unit 804 compares the calculated target common rail pressure Pcsol with a signal from the common rail pressure Pc, and outputs a control signal to the flow regulating valve 69 and the pressure control valve 72 to control the common rail pressure Pc to be equal to the target common rail pressure Pcsol.

More specifically, the ECU 80G electronically stores in its ROM a two dimensional map 801a that stores the optimum required torque Trqsol which is experimentally determined with respect to the accelerator opening θₜₕ and the engine rotation speed Ne, and a two dimensional map 802a that stores the optimum target injection amount Q_{T} which is experimentally determined with respect to the engine rotation speed Ne and the required torque Trqsol.

Similarly, the ECU 80G electronically stores in its ROM a two dimensional map 803a of a common rail pressure that stores the optimum target common rail pressure Pcsol which is experimentally determined with respect to the engine rotation speed Ne and the required torque Trqsol.

(Injection Control Unit)

Next, the injection control unit 805G is described in detail with reference to FIG. 21.

As shown in FIG. 21, the injection control unit 805G includes an injection command signal setting unit 810, an actual fuel supply information detection unit 813G, and an actual fuel injection information detection unit 814G. The injection command signal, setting unit 810 further includes an injection information calculation unit 811, an individual injection information setting unit 812, a correction factor calculation unit 815 and an output control unit 817.

The injection information calculation unit 811 calculates an injection time Tᵢ based on the target injection amount Q_{T} from the target injection amount calculation unit 802 and the common rail pressure Pc.

The injection information calculation unit 811 includes a two dimensional map 811a as shown in FIG. 22 for determining the injection time Tᵢ of the ordinate which corresponds to the target injection amount Q_{T} of the abscissa, using the common rail pressure Pc as a parameter.

More specifically, the ECU 80G electronically stores in its ROM the two dimensional map 811a that stores the optimum injection time Tᵢ which is experimentally determined with respect to the target injection amount Q_{T} and the common rail pressure Pc.

The individual injection information setting unit 812 finally sets the injection start instruction timing t_{S} and the injection finish instruction timing t_{E} of fuel injection based on the TDC signal, the crank angle signal, the engine rotation speed Ne, the required torque Trqsol, and the injection time Tᵢ calculated in the injection information calculation unit 811, and outputs them to the output control unit 817.

The individual injection information setting unit 812 includes, as shown in FIG. 23, three dimensional maps (hereinafter, just referred to as the maps of the correction factor) 812a, 812b, 812c, 812d of a correction factor K₁ (described later) for correcting the injection time Tᵢ for the cylinders 41 (shown as 41A, 41B, 41C, 41D in FIG. 20), and the correction factor K₁ can be newly stored in the maps 812a, 812b, 812c, 812d of the correction factor K₁ to update the maps 812a, 812b, 812c, 812d. In the maps 812a, 812b, 812c, 812d of the correction factor K₁, the target injection amount Q_{T}, the injection time Tᵢ and the common rail pressure Pc are used as parameters.

More specifically, the ECU 80G electronically stores in its non-volatile memory the maps 812a, 812b, 812c, 812d of the correction factor that is initially set with respect to the injection time Tᵢ; the target injection amount Q_{T} and the common rail pressure Pc.

The maps 812a, 812b, 812c, 812d of the correction factor have the same data structure.

If a correction factor K₁ is included in a three dimensional unit space of a predetermined range of the target injection amount Q_{T}, a predetermined range of the injection time Tᵢ and a predetermined range of the common rail pressure Pc, the individual injection information setting unit 812 stores the correction factor K₁ in time series in the three dimensional unit space of one of the maps 812a, 812b, 812c, 812d of the correction factor for the relevant cylinder 41, by a predetermined number of correction factors. Specifically, the correction factor K₁ is stored so that the moving average <K₁> of the predetermined number of the correction factors K₁ can be calculated.

The individual injection information setting unit 812 refers to one of the maps 812a, 812b, 812c, 812d of the correction factor K1 and obtains moving average <K₁> of the correction factor K₁ (hereinafter, the moving average <K₁> of the correction factor K₁ is just referred to as a “correction factor <K₁>”) which corresponds to the injection time Tᵢ input from the injection information calculation unit 811, and multiplies the injection time Tᵢ by the correction factor <K₁> to obtain a corrected injection time Tᵢ (=Tᵢ×<K₁>).

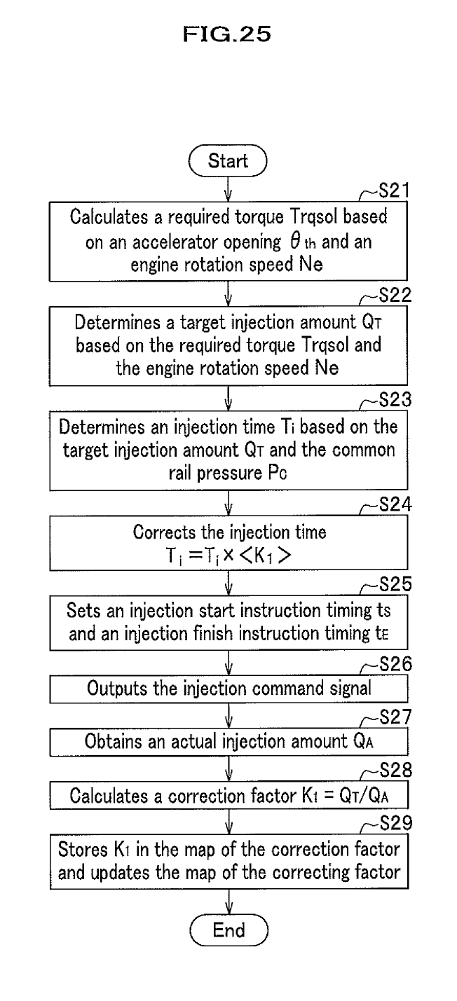

A method performed by the individual injection information setting unit 812 for updating the maps 812a, 812b, 812c, 812d of the correction factor is explained in the explanation of a flow chart shown in FIG. 25.

The correction factor calculation unit 815 calculates the correction factor K₁ for the relevant cylinder 41 based on the target injection amount Q_{T} that is input from the target injection amount calculation unit 802 and an actual injection amount Q_{A} (described later) that is input from the actual fuel injection information detection unit 814G, and stores the calculated correction factor K₁ in a map among the maps 812a, 812b, 812c, 812d of the correction factor, which corresponds to the relevant cylinder 41, and updates the map of the correction factor K₁.

The output control unit 817 outputs an injection command signal indicating the injection start instruction timing t_{S} and injection finish instruction timing t_{E} which are input from the individual injection information setting unit 812 to the actuator driving circuit 806 (806A, 806B, 806C, 806D shown in FIG. 21) of the relevant cylinder 41 and the actual fuel supply information detection unit 813G.

The actual fuel supply information detection unit 813G calculates the pressure difference (Pc−Ps) between the common rail pressure Pc which is detected by the common rail pressure sensor S_{Pc} and the fuel supply passage pressure Ps_{fil} detected by the fuel supply passage pressure sensor S_{Ps} provided in the high pressure fuel supply passage (first fuel supply passage) 21A (see FIG. 20) on the downstream side of the orifice 75 when fuel is injected to the cylinder (first cylinder) 41A (see FIG. 20). The pressure difference (Pc−Ps) corresponds to the orifice differential pressure ΔP_{OR} at the time when fuel passes through the orifice 75. The actual fuel supply information detection unit 813G calculates an orifice passing flow rate Q_{OR} based on a fuel temperature T_{f} from the fuel temperature sensor S_{Tf} and the pressure difference (Pc−Ps). The actual fuel supply information detection unit 813G finally calculates an actual fuel supply amount Qₛᵤₘ by time-integrating the orifice passing flow rate Q_{OR}. The calculated actual fuel supply amount Qₛᵤₘ is output to the actual fuel injection information detection unit 814G.

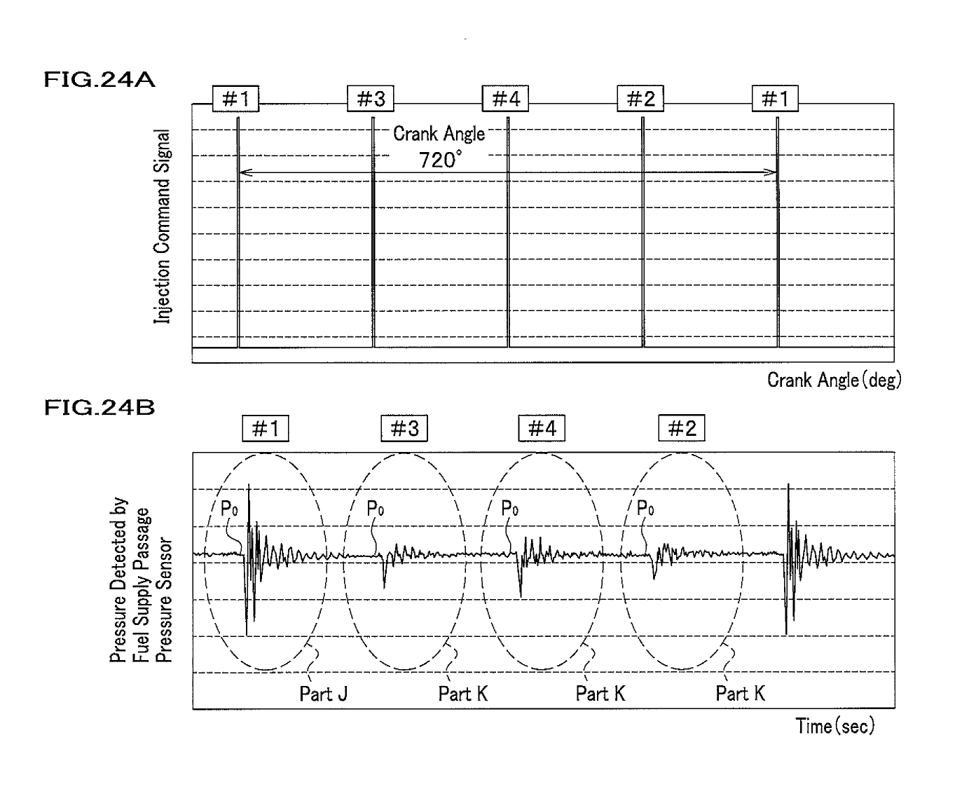

FIG. 24A is an illustration showing output timings of the injection command signals for each cylinder in a period from the fuel injection to the cylinder #1 to the next fuel injection to the cylinder #1 at the same crank angle. FIG. 24B is a graph for showing the pressure variation detected by the fuel supply passage pressure sensor S_{Ps}.

As shown in the part J surrounded by a broken line in FIG. 24B, the pressure decrease on the downstream side of the orifice 75 which is caused by the start of the fuel injection to the cylinder #1 (first cylinder) 41A (see FIG. 20) and the initial pressure decrease included in the pressure variation (also referred to as a pressure pulsation) caused by the reflective wave generated by stopping the fuel injection shows a behavior similar to the temporal variation of the orifice differential pressure ΔP_{OR} at the time when fuel passes through the orifice 75 of the high pressure fuel supply passage (first fuel supply passage) 21A (see FIG. 20).

A pressure variation similar to that shown in the part J is generated in the high pressure fuel supply passage 21B (second fuel supply passage) (see FIG. 20) by the pressure decrease on the downstream side of the orifice 75 which is caused by the start of the fuel injection to the cylinder #3 (second cylinder) 41C (see FIG. 20), the cylinder #4 (second cylinder) 41D (see FIG. 20), and the cylinder #2 (second cylinder) 41B (see FIG. 20) and a reflective wave caused by stopping the fuel injection. The pressure variation is propagated via the common rail 4 to the downstream side of the orifice 75 in the high pressure fuel supply passage 21A and is detected by the fuel supply passage pressure sensor S_{Ps} (see FIG. 20). The detected pressure variation is shown in the part K surrounded by the broken line in FIG. 24B. It is to be noted that the initial pressure decrease of the pressure variation shown in the part K exhibits, although it is damped, topologically same behavior as that shown in the part J, and is similar to that shown in the part J with different amplitude.

The pressure on the downstream side of the orifice 75 is stabilized to be approximately a pressure P0 (described later) immediately before the fuel injection as shown in the part J in FIG. 24B. The pressure variations shown in the parts K in FIG. 24B which are caused by the fuel injections to the #2˜#4 cylinders 41B, 41C, 41D are a little varied because of the variations in injection characteristics of the injectors 5A (see FIG. 20), and difference in distances from the injectors 5A, 5A, 5A of the #2˜#4 cylinders 41B, 41C, 41D to the fuel supply passage pressure sensor S_{Ps} via the high pressure fuel supply passages 21B and the common rail 4, even if the same injection command signal as that for the cylinder 41A is generated for the other cylinders 41B, 41C, 41D.

The actual fuel supply information detection unit 813G calculates the amount of the initial pressure decrease in the pressure variation, which is generated in the high pressure fuel supply passage 21B by the fuel injection to the cylinders (second cylinder) 41B, 41C, 41D and is propagated to the downstream side of the orifice 75 of the high pressure fuel supply passage 21A through the common rail 4, based on the fuel supply passage pressure Ps_{fil} detected by the fuel supply passage pressure sensor S_{Ps}.

The actual fuel supply information detection unit 813G calculates the orifice passing flow rate Q_{OR} of the high pressure fuel supply passage 21B based on the fuel temperature T_{f} from the fuel temperature sensor S_{Tf} and the amount of the pressure decrease, calculates the actual fuel supply amount Qₛᵤₘ* by time-integrating the orifice passing flow rate Q_{OR}, and corrects Qₛᵤₘ* by multiplying the Qₛᵤₘ* by the gain G for compensating the attenuation due to propagation. The corrected actual fuel supply amount Qₛᵤₘ* is output to the actual fuel injection information detection unit 814G.

The actual fuel injection information detection unit 814G inputs the actual fuel supply amount Qₛᵤₘ* to the correction factor calculation unit 815 as an actual injection amount Q_{A} of fuel.

(Control Flow of ECU 80G)

Next, the operation of the ECU 80G for controlling an injection is described with reference to FIGS. 21 and 25. FIG. 25 is a flow chart for showing the operation of the ECU 80G for controlling a fuel injection to one cylinder, and acquiring an actual injection amount, which is the result of the fuel injection.

In Step 21, the required torque calculation unit 801 calculates a required torque Trqsol with reference to the two dimensional map 801a based on the accelerator opening θₜₕ and the engine rotation speed Ne. In Step 22, the target injection amount calculation unit 802 determines a target injection amount Q_{T} with reference to the two dimensional map 802a based on the required torque Trqsol which is calculated in Step 21 and the engine rotation speed Ne. In Step 23, the injection information calculation unit 811 determines an injection time Tᵢ with reference to the two dimensional map 811a based on the target injection amount Q_{T} which is calculated in Step 22 and the common rail pressure Pc.

In Step 24, the individual injection information setting unit 812 determines the cylinder 41 for which the next fuel injection is performed (hereinafter, referred to as “relevant cylinder 41”) based on the TDC signal and the crank angle signal, and refers to the map of the correction factor <K₁> that corresponds to the relevant cylinder 41 among the maps 812a, 812b, 812c, 812d of the correction factor <K₁> to obtain the correction factor <K₁> based on the target injection amount Q_{T} calculated in Step 22, the injection time Ti calculated in Step 23, and the common rail pressure Pc and correct the injection time (Tᵢ=Tᵢ×<K₁>). In Step 25, the individual injection information setting unit 812 sets an injection start instruction timing t_{S} and an injection finish instruction timing t_{E} based on the required torque Trqsol calculated in Step 21, the engine rotation speed Ne, the crank angle signal and the injection time Tᵢ which is corrected in Step 24, and outputs them to the output control unit 817 as an injection command signal. It is to be understood that t_{E}=t_{S}+Tᵢ.

In Step 26, the output control unit 817 outputs the injection command signal to the actuator driving circuit 806 (shown as 806A, 806B, 806C, 806D in FIG. 2D for the relevant cylinder 41 and also to the actual fuel supply information detection unit 813G.

The injection start instruction timing t_{S} and the injection finish instruction timing t_{E}, which is the injection command signal output to the actuator driving circuit 806 and the actual fuel supply information detection unit 813G are assigned a cylinder discrimination signal indicating one of the cylinders 41, #1, #2, #3 and #4. With the cylinder discrimination signal, the actuator driving circuits 806A, 806B, 806C, 806D determine whether or not the received injection command signal is for own cylinder, and then drive the actuator 6A if it is appropriate to do so.

In Step 27, the correction factor calculation unit 815 obtains the actual injection amount Q_{A}, which is obtained by processing (described later) performed by the actual fuel supply information detection unit 813G and the actual fuel injection information detection unit 814G.

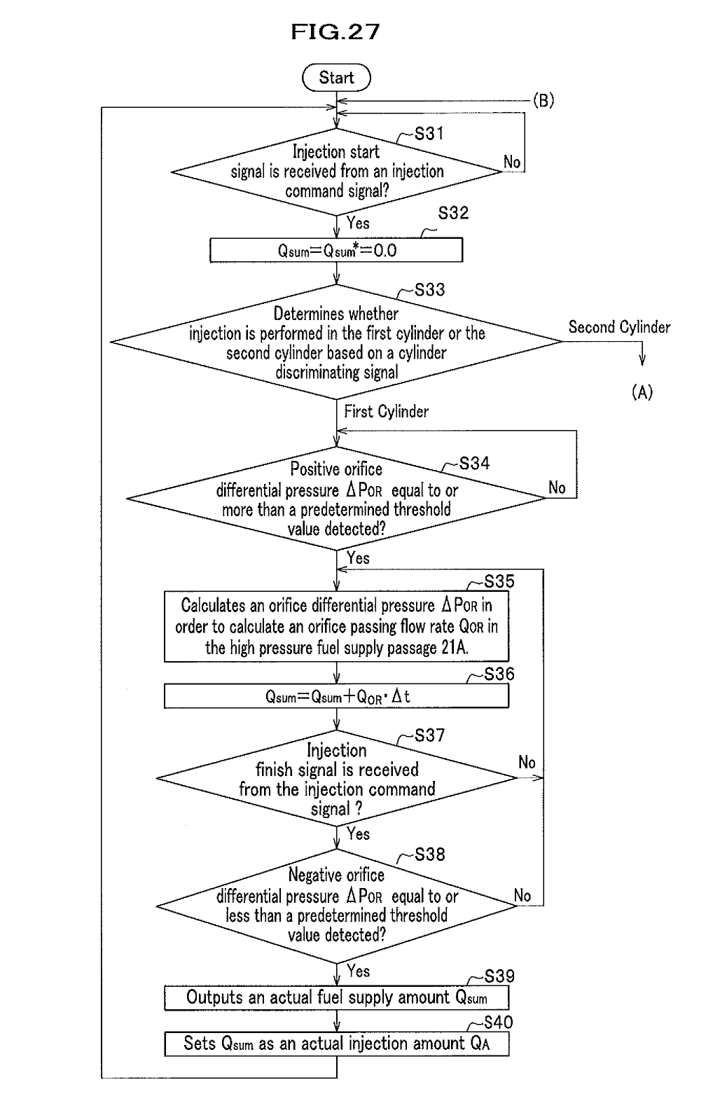

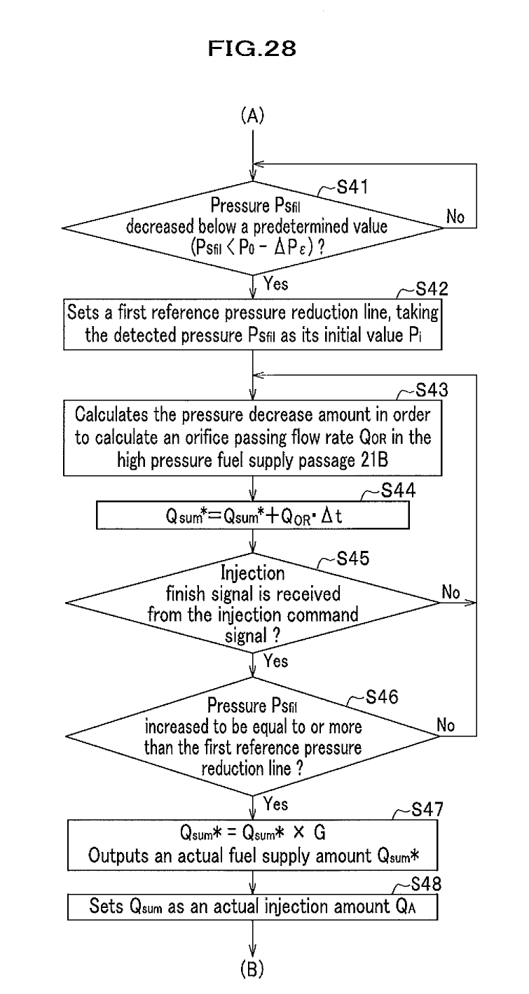

The processing performed by the actual fuel supply information detection unit 813G and the actual fuel injection information detection unit 814G is described in detail in the explanation of the flowcharts shown in FIGS. 27 and 28.

In Step 28, the correction factor calculation unit 815 calculates a correction factor K₁ as the ratio of the target injection amount Q_{T} calculated in Step 22 and the actual injection amount Q_{A} obtained in Step 27 (K₁=Q_{T}/Q_{A}). In Step 29, the correction factor calculation unit 815 stores the correction factor K₁ calculated in Step 28 in one of the maps 812a, 812b, 812c, 812d of the correction factor for the relevant cylinder 41 and updates the map of the correction factor. With the above described processing, a series of operations of the ECU 80G for controlling a fuel injection to one cylinder, and acquiring an actual injection amount, which is the result of the fuel injection is completed.

(Operation of Calculating Actual Fuel Supply Amount and Actual Injection Amount)

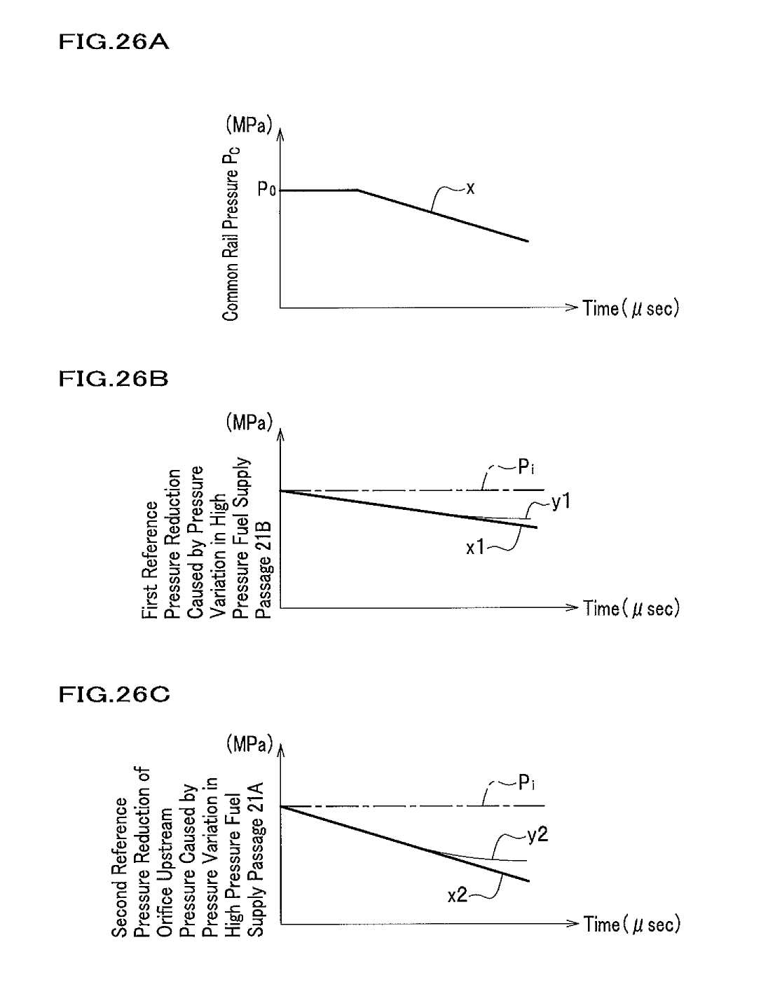

Next, with reference to FIGS. 20, 24A, 24B, 26A and 26B, the principle of calculating the actual fuel supply amount Qₛᵤₘ, Qₛᵤₘ* of the high pressure fuel supply passages 21A and 21B is explained. FIG. 26A is a graph showing a line indicating an average decrease of the common rail pressure caused by fuel injection. FIG. 26B is a graph showing a first reference line indicating the pressure decrease on the upstream side of the orifice 75 caused by the pressure variation generated in the high pressure fuel supply passage 21B. FIG. 26C is a graph showing a second reference line indicating the pressure decrease on the upstream side of the orifice 75 caused by the pressure variation generated in the high pressure fuel supply passage 21A.

The pressure Ps_{fil} detected by the fuel supply passage pressure sensor S_{Ps} provided in the high pressure fuel supply passage 21A (see FIG. 20) for supplying fuel to the cylinder 41A (see FIG. 20), which is shown as “#1”, is rapidly decreased by the start of the fuel injection from the injector 5A of the own cylinder (#1 cylinder 41A) and is then rapidly increased by a reflection wave generated by stopping the fuel injection as shown in the part J in FIG. 24B. This pressure variation of the high pressure fuel supply passage 21A is propagated to the common rail 4 on the upstream side of the orifice 75, generating the pressure variation in the common rail which is substantially equal to that of the high pressure fuel supply passage 21A. However, the seventh embodiment of the present invention allows to calculate the fuel flow which actually passes through the orifice 75 in the high pressure fuel supply passage 21A by obtaining the pressure difference (Pc−Ps_{fil}) between the common rail pressure Pc and the fuel supply passage pressure Ps_{fil}, which is substituted for the orifice differential pressure ΔP_{OR} in the equation (1).

A reference pressure reduction line on the upstream side of the orifice 75 can be set as shown in FIG. 26C based on the experimental data that the pressure on the upstream side of the orifice 75 at the time when the fuel flow is finished (i.e. when the orifice differential pressure ΔP_{OR} becomes 0) becomes always lower than the initial pressure before the fuel injection starts, and the longer the injection time is, the greater the amount of the pressure decrease becomes.

The above experimental data is also supported by the fact that the average pressure decrease of the common rail pressure Pc caused by the fuel injection can be represented in the equations (4) and (5).

$$\begin{matrix}Pc = {P}_{0} + \frac{d P}{d t} & ( 4 ) \\ \frac{d P}{d t} = \frac{{C}_{1}}{{V}_{1}} ( {Q}_{in} - {Q}_{inject} ) & ( 5 )\end{matrix}$$

where C₁ is a fixed value; V₁ is a total volume of the volumes of the common rail 4, the four high pressure fuel supply passages 21 and the fuel passages in the injector 5A; Qᵢₙ is a rate (mm³/sec) of fuel flowing to the common rail 4 from the high pressure pump 3B; and Q_{inject} is a fuel injection rate (mm³/sec) from the injector 5A to the combustion chamber.

The predetermined value P0 shown in FIG. 26A is set as follows: the fuel supply passage pressure Ps detected by the fuel supply passage pressure sensor S_{Ps} is filtering processed to remove a noise with a high frequency, such as a pressure pulsation caused by the filling operation of the high pressure pump 3B, a pressure pulsation caused by the propagation of the pressure vibration resulted from the injection operation of the injector 5A of other cylinders, and a pressure pulsation caused by a reflection wave of the injection operation of the injector 5A of the own cylinder, and the lowest value in the variation of the pressure that have been filtering-processed is set, to be the predetermined value P0.

The predetermined value P0 can be easily set by obtaining by experiments in advance a predetermined pressure fluctuation of the fuel supply passage pressure Ps_{fil} in the stabilized state where its pressure variation is attenuated and the fuel supply passage pressure Ps_{fil} is substantially equal to the common rail pressure Pc (hereinafter, also referred to as the pressure Ps_{fil} in the state where the pressure Ps_{fil} is substantially equal to the common rail pressure).

The initial value P0 may be preferably stored in a ROM in advance in such a manner that the actual fuel supply information detection unit 813G can refer to the initial value P0 as the function of the common rail pressure Pc.

The pressure decrease amount of the pressure Ps_{fil} from a reference pressure reduction line x2 or a reference pressure reduction curve y2, which is a quadric curve, shown in FIG. 26C as the pressure decrease on the upstream side of the orifice caused by the pressure variation in the high pressure fuel supply passage 21A may be used as the orifice differential pressure ΔP_{OR} in the high pressure fuel supply passage 21A, instead of the pressure difference (Pc−Ps_{fil}) when calculating an actual fuel supply amount Qₛᵤₘ. An embodiment using this method will be described later in the explanation of an eighth embodiment.

When fuel is supplied to the injectors 5A, 5A, 5A through the high pressure fuel supply passages 21B, 21B, 21B, and is injected into the combustion chambers of the cylinders 41B, 41C, 41D, the pressure variation shown in the part J in FIG. 24B is generated in each high pressure fuel supply passage 21B. The pressure variation propagates via the common rail 4 to the high pressure fuel supply passage 21A, and is detected by the fuel supply passage pressure sensor S_{Ps} provided on the downstream side of the orifice 75 as such a pressure variation shown in the part K in FIG. 24B.

As described in the explanation of FIG. 24B, although the amplitude of the pressure variation is damped, the pressure variation exhibits the behavior topologically same as that shown in the part J, and is similar to that shown in the part J. It is found out by this observation that the actual fuel supply amount Qₛᵤₘ* can be also calculated as follows: the first reference pressure reduction line is set based on the initial pressure decrease of the pressure variation as shown in FIG. 26B, similarly to the second reference pressure reduction line; and the pressure decrease amount of the pressure Ps_{fil} from the first reference pressure reduction line x1 or the first reference pressure reduction curve y1, which is a quadric curve, is used as if the pressure decrease amount were the orifice differential pressure ΔP_{OR} of the high pressure fuel supply passage 21A. It is to be noted that since the pressure variation generated by fuel injection in the high pressure fuel supply passage 21B is damped while it is propagating to the high pressure fuel supply passage 21A via the common rail 4, the pressure variation is multiplied by a gain G for compensation.

Hereinafter, an orifice passing flow amount Q_{OR} of the high pressure fuel supply passage 21B which is calculated by using the orifice differential pressure ΔP_{OR} of the high pressure fuel supply passage 21A is also called the orifice passing flow amount Q_{OR} of the high pressure fuel supply passage 21B.

It is preferable that the first reference pressure reduction line or curve and the gain G are set by referring to a data map storing in the ROM the first reference pressure reduction line or curve and the gain G as being dependent on the variation of the common rail pressure Pc or the fuel supply passage pressure Ps_{fil} in a state where the fuel supply passage pressure Ps_{fil} is substantially equal to the common rail pressure Pc.

Japanese Patent No. 2833210 discloses a technique which calculates an actual injection amount by detecting the average amount of the common rail pressure decrease caused by fuel injection during the time when fuel is stopped being discharged from the high pressure pump, and corrects the target injection amount based on the calculated actual injection amount. However, the technique has a disadvantage that the technique does not use a comparatively larger pressure variation which is associated with fuel injection, but uses the average amount of the comparatively smaller common rail pressure decrease, and thus the detection error of the common rail pressure is likely to affect the calculation of the actual injection amount greatly. In contrast, in the seventh embodiment, the amount of the initial pressure decrease of the pressure variation caused by the fuel injection to the combustion chambers of the cylinders 41B, 41C, 41D, which are the second cylinders, is used, which is advantageous in detecting the pressure variation.

Pi shown in FIGS. 26B and 26C indicates the initial value of the fuel supply passage pressure Ps_{fil} before fuel injection starts, and the initial value is floating as described later. As the fuel injection time gets longer, the decrease amount from the initial value Pi increases as shown in FIGS. 26B and 26C.

Next, a method performed by the actual fuel supply information detection unit 813G and the actual fuel injection information detection unit 814G for calculating an actual fuel supply amount and converting the actual fuel supply amount to an actual injection amount is described with reference to FIGS. 27 and 28.

FIGS. 27 and 28 are flow charts showing the operation of calculating the actual fuel supply amount and the actual injection amount.

The processing of Steps 31 to 39 of the flow chart in FIG. 27 and Steps 41 to 47 of the flow chart in FIG. 28 is executed by the actual fuel supply information detection unit 813G, and the processing of Steps 40 and 48 is executed by the actual fuel injection information detection unit 814G.

It is to be noted that the orifice passing flow rate Q_{OR} and the actual fuel supply amount Q_{Sum}* described in Steps 41 to 48 are the values that imitate the real orifice passing flow rate Q_{OR} and the real actual fuel supply amount Q_{Sum}, respectively.

In Step 31, the actual fuel supply information detection unit 813G determines whether or the actual fuel supply information detection unit 813G receives an injection start from the injection command signal output from the output control unit 817. If it receives the injection start (Yes), the processing proceeds to Step 32. If it does not (No), the processing repeats Step 31. In Step 32, an actual fuel supply amount Q_{Sum}, Q_{Sum}*, which corresponds to the amount of fuel flow passing through the orifice 75 for fuel injection, is reset to be 0.0. In Step 33, the actual fuel supply information detection unit 813G determines whether a cylinder discrimination signal attached to the injection command signal indicates the first cylinder (i.e. the cylinder 41A, which is shown as “#1” in FIG. 20) to which fuel is supplied from the high pressure fuel supply passage 21A provided with the fuel supply passage pressure sensor S_{Ps} on the downstream side of the orifice 75, or the second cylinder (i.e. any of the cylinders 41B, 41C, 41D, which are shown as “#2” to “#4” in FIG. 20) to which fuel is supplied from the high pressure fuel supply passage 21B which is not provided with the fuel supply passage pressure sensor S_{Ps} on the downstream side of the orifice 75. If it indicates the first cylinder, the processing proceeds to Step 34. If it indicates the second cylinder, the processing proceeds to Step 41, following the connector (A).

In Step 34, the pressure difference (Pc−Ps_{fil}) between the common rail pressure Pc and the fuel supply passage pressure Ps_{fil} is calculated as the orifice differential pressure ΔP_{OR}, and it is determined whether or not the orifice differential pressure ΔP_{OR} is positive and is equal to or more than a predetermined threshold value. If the calculated orifice differential pressure ΔP_{OR} is determined to be equal to or more than the predetermined threshold value (Yes), the processing proceeds to Step 35. If it is not (No), the processing repeats Step 34.

A positive orifice differential pressure ΔP_{OR} is an orifice differential pressure ΔP_{OR} generated when fuel is flowed from the side of the common rail 4 to the side of the injector 5A. An orifice differential pressure ΔP_{OR} generated when this fuel flow is reversed is a negative orifice differential pressure ΔP_{OR}.

The processing in Step 34 is to determine whether or not the calculated pressure difference (Pc−Ps_{fil}) is more than “fluctuation”, and is generated by the fuel flow passing through the orifice which is caused by fuel injection.

In Step 35, the orifice differential pressure ΔP_{OR} [symbol] i.e. the pressure difference (Pc−Ps_{fil}) [symbol] is calculated to calculate the orifice passing flow rate Q_{OR}(mm³/Sec) of the high pressure fuel supply passage 21A.

The orifice passing flow rate Q_{OR} of fuel can be readily calculated by using the equation (1) based on the orifice differential pressure ΔP_{OR}.

In Step 36, the orifice passing flow rate Q_{OR} is time-integrated as shown in Q_{Sum}=Q_{Sum}+Q_{OR}·Δt.

In Step 37, it is determined whether or not an injection finish signal is received from the injection command signal. If the injection finish signal is received (Yes), the processing proceeds to Step 38. If the injection finish signal is not received (No), the processing returns to Step 35 and repeats Steps 35 to 37. In Step 38, the orifice differential pressure ΔP_{OR} is calculated, and it is determined whether or not the calculated orifice differential pressure ΔP_{OR} is negative and is less than a predetermined threshold value. If the calculated orifice differential pressure ΔP_{OR} is negative and is less than the predetermined threshold value (Yes), the processing proceeds to Step 39. If it is not (No), the processing returns to Step 35, and repeats Steps 35 to 38.

The processing in Step 38 is to determine whether or not the calculated pressure difference (Pc−Ps_{fil}) is a negative pressure difference (Pc−Ps_{fil}) greater than “fluctuation”, and is generated by the reflective wave caused by the completion of fuel injection.

Processing of Steps 35 to 38 is performed at a period of, for example, from several to dozens of μ seconds, and Δt is a period at which the orifice differential pressure ΔP_{OR} is sampled, which is from several to dozens of μ seconds.

In Step 39, the actual fuel supply amount Q_{Sum} that is finally acquired by the repetition of Steps 35 to 38 is output to the actual fuel injection information detection unit 814G.

In Step 40, the actual fuel injection information detection unit 814G sets the actual fuel supply amount Q_{Sum} as an actual injection amount Q_{A} of the fuel injection. Then, the actual injection amount Q_{A} is input to the correction factor calculation unit 815. After that, the processing returns to Step 31, and repeats the calculation of the actual fuel supply amount Q_{Sum} for the next cylinder 41 and the conversion of the actual fuel supply amount Q_{Sum} to the actual injection amount Q_{A}.

The actual injection amount Q_{A} is also referred to as an “actual fuel injection amount”.

In Step 33, if it is determined that the cylinder discrimination signal attached to the injection command signal indicates any of the second cylinders (i.e. any of the cylinders 41B, 41C, 41D, which are shown as “#2” to “#4” in FIG. 20) to which fuel is supplied from the high pressure fuel supply passage 21B which is not provided with the fuel supply passage pressure sensor S_{Ps} on the downstream side of the orifice 75, the processing proceeds to Step 41 as indicated by the connector (A), and determines whether or not the pressure Ps_{fil} of the high pressure fuel supply passage 21A is decreased lower than a predetermined value [symbol] (Ps_{fil}<P₀−ΔP_{ε})? [symbol] .

If it is determined that the pressure Ps_{fil} of the high pressure fuel supply passage 21A is decreased to be lower than the predetermined value (Yes), the processing proceeds to Step 42. If it is not (No), the processing repeats Step 41.

A timing when the pressure Ps_{fil} of the high pressure fuel supply passage 21A is determined to be lower than the predetermined value in Step 41 is also referred to as the “first timing”.

In Step 42, a first reference pressure reduction line, such as the reference pressure reduction line x1 shown in FIG. 26B, is set by making the pressure Ps_{fil} to be the initial value Pi.

The initial value Pi may be equal to the predetermined value (P₀−ΔPε). The initial value Pi may not be equal to the predetermined value (P₀−ΔPε), since the pressure Ps_{fil} sampled in the period next to the period in which the pressure Ps_{fil} used in Step 13 is sampled may be used in Step 14.

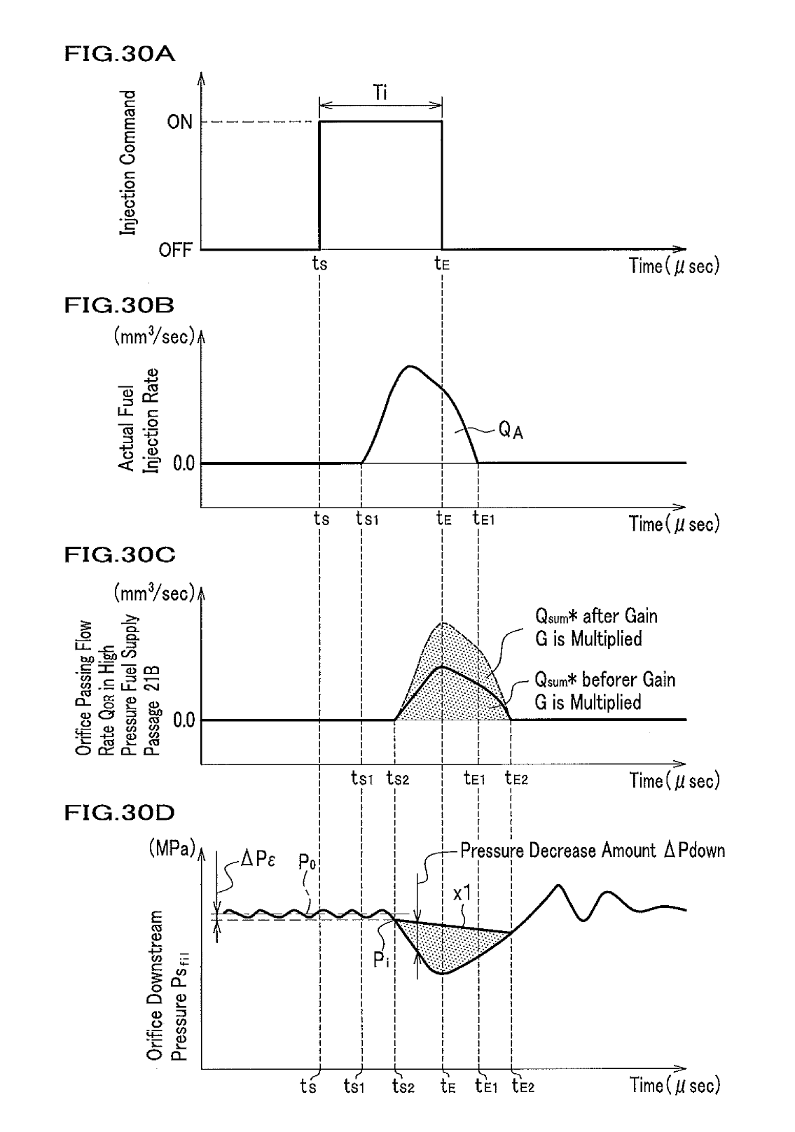

In Step 43, the amount of pressure decrease ΔPdown of the pressure Ps_{fil} from the first reference pressure reduction line whose initial value is the initial value Pi, is calculated in order to calculate the orifice passing flow rate Q_{OR}. The definition of ΔPdown is shown in FIG. 30D.

The orifice passing flow rate Q_{OR} can be readily calculated by using the equation (1) in which the pressure decrease amount ΔPdown is substituted for the ΔP_{OR}.

In Step 44, the orifice passing flow rate Q_{OR} is time-integrated as shown in the equation Qₛᵤₘ=Qₛᵤₘ+Q_{OR}*Δt.

In Step 45, the actual fuel supply information detection unit 813G determines whether or not the injection finish signal of the fuel injection command signal is detected. If the actual fuel supply information detection unit 813G determines that the injection finish signal of the fuel injection command signal is detected (Yes), the processing proceeds to Step 46. If the actual fuel supply information detection unit 813G determines that the injection finish signal of the fuel injection command signal is not detected (No), the processing returns to Step 43, and repeats Steps 43 to 45.

In Step 46, it is determined whether or not the pressure Ps_{fil} of the high pressure fuel supply passage 21A increases to exceed the first reference pressure reduction line. If it is determined that the pressure Ps_{fil} is increased to exceed the first reference pressure reduction line (Yes), the processing proceeds to Step 47. If it is not (No), the processing returns to Step 43, and repeats Steps 43 to 46.

A timing at which the pressure Ps_{fil} of the high pressure fuel supply passage 21A is determined to exceed the first reference pressure reduction line in Step 46 is also refereed to as the “second timing”.

In Step 47, the actual fuel supply amount Q_{Sum}* which is finally obtained in the repetition of Steps 43 to 46 is multiplied by the gain G (Qₛᵤₘ*=Qₛᵤₘ*×G), and the actual fuel supply amount Q_{Sum}* is output to the actual fuel injection information detection unit 814G. In Step 48, the actual fuel injection information detection unit 814G sets the actual fuel supply amount Q_{Sum}* which has been multiplied by the gain G in Step 47 as the actual injection amount Q_{A}. The actual injection amount Q_{A} is input to the correction factor calculation unit 815. The processing then returns to Step 31, following the connector B, and repeats the calculation of the actual fuel supply amount Q_{Sum} for the next cylinder 41 and the conversion of the actual fuel supply amount Q_{Sum} to the actual injection amount Q_{A}.

The actual fuel supply amount Q_{Sum}* which has been multiplied by the gain G in Step 47 is also referred to as an “actual fuel supply amount”, and the actual injection amount Q_{A} is also referred to as an “actual fuel injection amount”.

With reference to FIGS. 20, 21 and 29A to 29D, a method performed by the ECU 80G for correcting fuel injection based on detected actual fuel injection information of fuel injection to the cylinder (first cylinder) 41A.

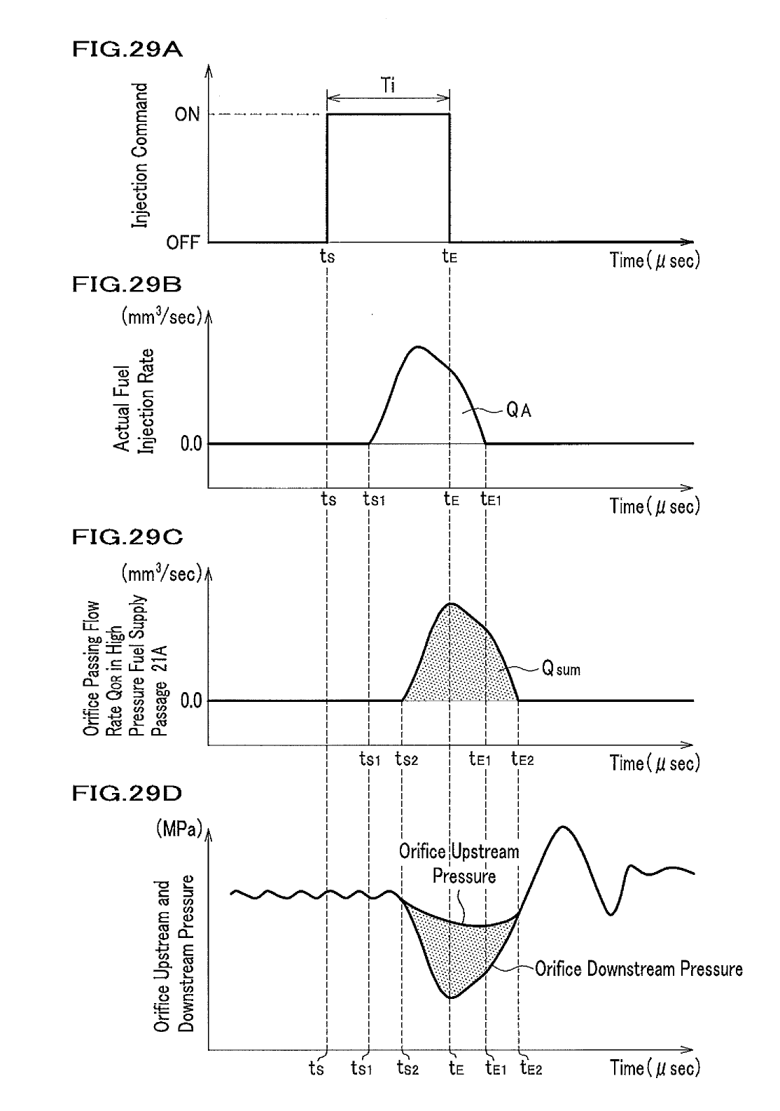

FIGS. 29A to 29D are graphs showing an output pattern of the injection command signal for a first cylinder and the temporal variations of fuel flow in the high pressure fuel supply passage. FIG. 29A is a graph for showing an output pattern of the injection command signal. FIG. 29B is a graph showing the temporal variation of the actual fuel injection rate of an injector. FIG. 29C is a graph showing the temporal variation of the orifice passing flow rate of the high pressure fuel supply passage 21A. FIG. 29D is a graph for showing the temporal variations of the pressures of the high pressure fuel supply passage 21A on the upstream and downstream sides of the orifice.

In FIG. 29A, an injection command signal having the timing “t_{S}” as an injection start instruction timing, “t_{E}” as an injection finish instruction timing and the injection time Tᵢ is generated.

In response to the injection command signal which is output as shown in FIG. 29A, the injector 5A which is a direct acting fuel injection valve starts to inject fuel at the timing t_{S1}, which is a little delayed from the fuel injection start instruction timing t_{S}, and completes injection at the timing t_{E1}, which is delayed a little from the injection finish instruction timing t_{E} as shown in FIG. 29B. The actual injection amount Q_{A} is calculated by time-integrating the actual fuel injection rates during the period from the injection start instruction timing t_{S1} to the injection finishing timing t_{E1}.

The flow rate of the fuel which passes the orifice 75 (orifice passing flow rate Q_{OR}) rises at the timing t_{S2}, which is delayed a little from the injection start instruction timing t_{S1} of the fuel injection by the volume of a fuel passage (not shown) in the injector 5A (see FIG. 20) and the high pressure fuel supply passage 21 (see FIG. 20) as shown in FIG. 29C. Similarly, the orifice passing flow rate Q_{OR} returns to 0 at the timing t_{E2} which is delayed from the timing t_{E1} by the volume of the fuel passage (not shown) in the injector 5A and the high pressure fuel supply passage 21 as shown in FIG. 29C.

Regarding the pressures of the upstream side and the down stream side of the orifice 75 corresponding to FIG. 29C, the orifice differential pressure ΔP_{OR} can be detected by the pressure difference (Pc−Ps_{fil}) even if the pressure on the upstream side of the orifice is varied by the variation of the common rail pressure Pc as shown in FIG. 29D, which allows to accurately calculate the orifice passing flow rate Q_{OR}. The area encompassed by the orifice passing flow rate Q_{OR} shown in FIG. 29C corresponds to the area of the actual injection amount Q_{A} shown in FIG. 29B and the dotted area shown in FIG. 29D in the case of the direct acting injector 5A.

In accordance with the seventh embodiment, it is possible to extend the injection time Tᵢ of the injection command signal shown in FIG. 29A by the processing of Step 04 in the flow chart if, for example, the actual injection amount Q_{A} to the combustion chamber of the cylinder 41A is less than the target injection amount Q_{T} and to shorten the injection time Tᵢ if the actual injection amount Q_{A} to the combustion chamber of the cylinder 41A is greater than the target injection amount Q, which allows to control the actual injection amount Q_{A} to be equal to the target injection amount Q_{T}.

Next, with reference to FIGS. 20, 21 and 30A to 30D, a method performed by the ECU 80G for correcting fuel injection based on detected actual fuel injection information of the fuel injection to the cylinders (second cylinder) 41B, 41C, 41D.

FIGS. 30A to 30D are graphs showing an output pattern of the injection command signal for a second cylinder and the temporal variations of fuel flow in the high pressure fuel supply passage. FIG. 30A is a graph for showing an output pattern of the injection command signal. FIG. 30B is a graph showing the temporal variation of the actual fuel injection rate of an injector. FIG. 30C is a graph showing the temporal variation of the orifice passing flow rate of the high pressure fuel supply passage 21B. FIG. 30D is a graph for showing the temporal variations of the pressures of the high pressure fuel supply passage 21A on the upstream and downstream sides of the orifice.

FIGS. 30A and 30B are the same as FIGS. 29A and 29B, and thus the description thereof will be omitted. As shown in FIG. 30C, the orifice passing flow rate Q_{OR} of the high pressure fuel supply passage 21B rises at the timing “t_{S2}” (first timing) at which the pressure Ps_{fil} detected by the fuel supply passage pressure sensor S_{Ps} in the high pressure fuel supply passage 21A is decreased to be lower than the predetermined initial value P0 by a threshold value ΔPε as shown in FIG. 30D. The timing t_{S2} is a little delayed from the actual injection start timing t_{S1} by the time it takes for the pressure variation to propagate through the fuel passage in the injector 5A, the high pressure fuel supply passage 21B and the common rail 4. The orifice passing flow rate Q_{OR} of the high pressure fuel supply passage 21B shown in FIG. 30C becomes 0 at the timing t_{E2} (second timing) when the pressure Ps_{fil} detected by the fuel supply passage pressure sensor S_{Ps} in the high pressure fuel supply passage 21A is increased to exceed the set first reference pressure reduction line x1 as shown in FIG. 30D.

The orifice passing flow rate Q_{OR} shown in FIG. 30C is the imitation of a real orifice passing flow rate Q_{OR} of the high pressure fuel supply passage 21B, and is not an orifice passing flow rate Q_{OR} which is actually measured by the orifice differential pressure.

A value obtained by time-integrating the imitation of the orifice passing flow rate Q_{OR} during the time from the timing t_{S2} to the timing t_{E2} which is indicated by a full line in FIG. 30C is an actual fuel supply amount Q_{Sum}* which has not been multiplied by the gain G yet. A value obtained by time-integrating the imitation of the orifice passing flow rate Q_{OR} which is indicated by a dashed line is the actual fuel supply amount Q_{Sum}* which has been multiplied by the gain G. As described above, it is found out that the actual fuel supply amount Q_{Sum}* which is supplied through the high pressure fuel supply passage 21B can be calculated by detecting the amount of the initial pressure decrease of the pressure variation which is generated in the high pressure fuel supply passage 21B and propagates to the high pressure fuel supply passage 21A through the common rail 4.

In accordance with the seventh embodiment described above, it is possible to calculate the actual injection amount Q_{A} of fuel injection for each cylinder 41, and to control the actual injection amount Q_{A} for each cylinder 41 to be closer to the target injection amount Q_{T}. Thus, the output control of the engine can be performed more accurately, and the vibration of the engine or engine noise can be suppressed.

The differential pressure sensors do not have to be provided to each high pressure fuel supply passage 21A, 21B, 21B, 21B as in the case of the invention disclosed in Japanese Unexamined Patent Publication No. 2003-184632, and it is enough to provide only one fuel supply passage pressure sensor S_{Ps} for a 4 cylinder diesel engine, which allows to reduce the number of parts of the fuel injection device and to reduce the cost thereof.

The target injection amount Q_{T} which is effectively corrected is used since the injection time Tᵢ is corrected by the correction factor K₁, which is the ratio between the target injection amount Q_{T} at the time of fuel, injection and the actual injection amount Q_{A}, as shown in Steps 24 and 25 of the flow chart. Thus, it is possible to correct the variations of the output torque among the cylinders, variations in the injection characteristics of the injector 5A or the actuator 6A due to manufacturing tolerance, and a secular change in the injection characteristics of the injector 5A or the actuator 6A, which allows to more accurately suppress the variations of the output torque among the cylinders.

As a result, it becomes easier to keep the regulated value of an exhaust gas even if requirement on hardware specifications, such as dimension tolerance of each part of the engine system, is relaxed. Especially, requirement on the hardware specification for injectors can be relieved, which contributes to reduction of the manufacturing cost of the engine system.

The orifice 75 is also provided to the high pressure fuel supply passage 21B, and the volume obtained by adding the volume of the high pressure fuel supply passage 21A or 21B that is lower than the orifice 75 and that of a fuel passage in the injector 5A is designed to exceed the maximum actual fuel supply amount, such as the maximum actual fuel supply amount required when the maximum torque is required by a fully-opened accelerator. Since the orifice 75 is a barrier against the flow to the common rail 4, the pressure decrease and the reflective wave in the high pressure fuel supply passage 21A or 21B generated by fuel injection becomes greater than the case where the orifice 75 is not provided. Since the pressure variation which is made greater in the high pressure fuel supply passage 21B is propagated through the common rail 4 to the high pressure fuel supply passage 21A, the pressure detection of the fuel supply passage pressure sensor S_{Ps} becomes also greater, which has an advantage that the detection accuracy of the actual, injection amount for the second cylinder is improved.

Advantages of the seventh embodiment which are the same as those of the second embodiment are omitted, and thus refer to the advantages of the second embodiment for them.

### First Modification of Seventh Embodiment

Next, the first modification of the seventh embodiment is explained. The first modification of the seventh embodiment differs from the seventh embodiment in the following points. (1) A first actual fuel supply amount Q_{Sum} which is calculated as an actual fuel supply amount supplied through the high pressure fuel supply passage 21A at the time of fuel injection of the injector 5A of the cylinder 41A, which is the first cylinder, based on the pressure difference (Pc−Ps_{fil}) corresponding to the orifice differential pressure ΔP_{OR} in the high pressure fuel supply passage 21A is obtained as well as a second actual fuel supply amount Q_{Sum}* calculated based on the common rail pressure Pc which is affected by the pressure variation generated in the high pressure fuel supply passage 21A of the cylinder 41A and is detected by the common rail pressure sensor S_{Pc}. (2) The first actual fuel supply amount Q_{Sum} and the second actual fuel supply amount Q_{Sum}* which have been obtained as above are converted into a first and second actual injection amounts, respectively, and the ratio K₂ of the first actual injection amount and the second actual injection amount is obtained as a calculation correction factor. (3) As an actual fuel supply amount Q_{Sum} which has been supplied for the fuel injection of the injector 5A to any of the cylinders 41B, 41C, 41D, which are the second cylinders, a third actual fuel supply amount Q_{Sum}* is obtained which is calculated based on the common rail pressure Pc affected by the pressure variation which is generated in the high pressure fuel supply passage 21B of the cylinder 41, propagated to the common rail 4 and is detected by the common rail pressure sensor S_{Pc}. (4) The obtained third actual fuel supply amount Q_{Sum}* is converted to be a third actual injection amount, and is further multiplied by the calculation correction factor K₂ to be a final actual injection amount of the second cylinder.

With these changes in the method for calculating the actual fuel supply amount and the actual injection amount, a fuel injection device 1. G′ is substituted for the fuel injection device 1G, and an ECU 80G′ is substituted for the ECU 80G in FIG. 20. In the functional block diagram of the engine controlling device in FIG. 21, the ECU 80G′ is substituted for the ECU 80G, and an injection control unit 805G′ is substituted for the injection control unit 805G. The modification of the seventh embodiment is basically the same as the seventh embodiment except that an actual fuel supply information detection unit 813G′ is substituted for the actual fuel supply information detection unit 813G, and an actual fuel injection information detection unit 814G′ is substituted for the actual fuel injection information detection unit 814G.

In response to the fuel injection to the cylinder (first cylinder) 41A (see FIG. 20), the actual fuel supply information detection unit 813G′ calculates the first actual fuel supply amount Q_{Sum} based on the pressure difference (Pc−Ps_{fil}) between the fuel supply passage pressure Ps_{fil} defected by the fuel supply passage pressure sensor S_{PS} provided on the downstream side of the orifice 75 in the high pressure fuel supply passage (first fuel supply passage) 21A (see FIG. 20) and the common rail pressure Pc detected by the common rail pressure sensor S_{Pc}, as well as the second actual fuel supply amount Q_{Sum}* by calculating a pressure decrease amount of the pressure variation which is generated in the high pressure fuel supply passage (first fuel supply passage) 21A by the fuel injection to the cylinder (first cylinder) 41A and is propagated to the common rail 4, based on the common rail pressure Pc detected by the common rail pressure sensor S_{Pc}. Then, the actual fuel supply information detection unit 813G′ inputs the calculated actual fuel supply amount Q_{Sum}, Q_{Sum}* into the actual fuel injection information detection unit 814G′.

The actual fuel supply information detection unit 813G′ calculates the third actual fuel supply amount Q_{Sum}* by calculating a pressure decrease amount of the pressure variation which is generated in the high pressure fuel supply passage (second fuel supply passage) 21B by the fuel injection to the cylinder (second cylinder) 41B, 41C, 41D (see FIG. 20) and is propagated to the common rail 4, based on the common rail pressure Pc detected by the common rail pressure sensor S_{Pc}. Then, the actual fuel supply information detection unit 813G′ inputs the third calculated actual fuel supply amount Q_{Sum}* into the actual fuel injection information detection unit 814G′.

The actual fuel injection information detection unit 814G′ calculates the ratio K₂ of the first and second actual fuel supply amounts Q_{Sum} and Q_{Sum}* which are obtained by the actual fuel supply information detection unit 813G′ for the fuel injection to the cylinder (first cylinder) 41A, and stores the ratio K₂ in the calculation correction factor map 814a (see FIG. 21) and sets the actual fuel supply amount Q_{Sum} as the actual injection amount Q_{A}.

The calculation correction factor map 814a is one dimension map whose parameter is, for example, the common rail pressure Pc, and is recordably stored in the non-volatile memory included in the ECU 80G′, electronically.

In response to the fuel injection to the cylinder (second cylinder) 41B, 41C, 41D, the actual fuel injection information detection unit 814G′ reads the calculation correction factor K₂ from the calculation correction factor map 814a, and multiplies the third actual fuel supply amount Q_{Sum}* which has been output from the actual fuel supply information detection unit 813G′ by the calculation correction factor K₂, and sets the third actual fuel supply amount Q_{Sum}* which has been multiplied by the calculation correction factor K₂ as the actual fuel supply amount Q_{Sum}. The actual fuel injection information detection unit 814G′ also sets the corrected actual fuel supply amount Q_{Sum} as the actual injection amount Q_{A}.

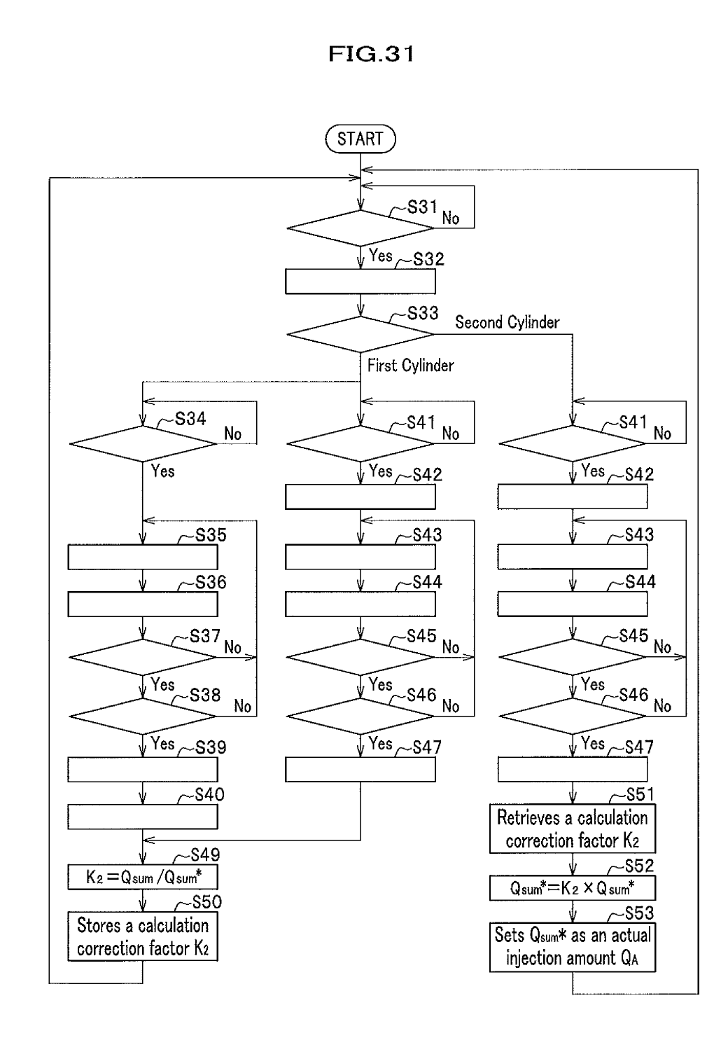

Next, a control flow for calculating an actual injection amount and obtaining the calculation correction factor K₂ in the modification of the seventh embodiment is described with reference to FIG. 31. FIG. 31 is a flow chart showing a control flow for calculating an actual fuel supply amount and an actual injection amount in the modification of the seventh embodiment.

Basically, the flow chart shown in FIG. 31 is a flow chart which combines the flow charts in FIGS. 27 and 28 in the seventh embodiment, and thus parts of the flow chart shown in FIG. 31 which are different from the flow charts in FIGS. 27 and 28 are explained, omitting repeated explanation of the common parts.

The actual fuel supply information detection unit 813G and the actual fuel injection information detection unit 814G in the explanation of the flow charts in FIGS. 27 and 28 are read as the actual fuel supply information detection unit 813G′ and the actual fuel injection information detection unit 814G′, respectively. “The pressure Ps_{fil} in the high pressure fuel supply passage 21A” in the explanation of Step 41 to 46 is read as “common rail pressure Pc”.

If it is determined that a cylinder to which fuel is injected is the first cylinder 41A in Step 33, the actual fuel supply information detection unit 813G′ simultaneously performs the processing of Steps 34 to 40 and the processing of Steps 41 to 47. After the first and second actual fuel supply amounts Q_{Sum}, Q_{Sum}* are obtained in Steps 40 and 47, the processing proceeds to Step 49 in which the actual fuel injection information detection unit 814G′ calculates the calculation correction factor K₂ (=Q_{Sum}/Q_{Sum}*). Then, the actual fuel injection information detection unit 814G′ associates the value Pi of the common rail pressure Pc in Step 42 with the calculation correction factor K₂ and stores in the calculation correction factor map 814a (see FIG. 20) the calculation correction factor K₂ (Step 50).

If it is determined that a cylinder to which fuel is injected is the second cylinders 41B, 41C, 41D in Step 33, the actual fuel supply information detection unit 813G′ obtains the third actual fuel supply amount Q_{Sum}* by the processing of Steps 41 to 47. The actual fuel supply information detection unit 813G′ then proceeds to Step 51 in which the actual fuel injection information detection unit 814G′ reads the calculation correction factor K₂ which is associated with the value Pi of the common rail pressure Pc in Step 42 from the calculation correction factor map 814a. The actual fuel supply information detection unit 813G′ then obtains an actual fuel supply amount Q_{Sum}* which is corrected by the calculation correction factor K₂ by multiplying the third actual fuel supply amount Q_{Sum}* by the calculation correction factor K₂ as shown in Q_{Sum}*=K₂×Q_{Sum}* (Step 52). At last, in Step 53, the actual fuel injection information detection unit 814G′ sets the corrected Qₛᵤₘ* as the actual injection amount Q_{A}, and outputs actual injection amount Q_{A} to the correction factor calculation unit 815, and the processing returns to Step 31.

The above described method enables to eliminate the calculation error included in the actual fuel supply amount Q_{Sum}* supplied to the injector 5A through the high pressure fuel supply passage 21B at the time of the fuel injection to the second cylinders 41B, 41C, 41D that is obtained by a method for calculating the actual fuel supply amount Q_{Sum}* based on the initial pressure decrease of the great pressure variation in the common rail pressure Pc without using an orifice differential pressure.

With this method, even if the gain G or the first reference pressure reduction line which is fixedly used in Step 47 needs to be adjusted by each fuel injection device due to manufacturing error, the calculation correction factor K₂ is automatically updated during the operation of the engine so that the gain G and the first reference pressure reduction line are learned and corrected.

### Second Modification of Seventh Embodiment

Embodiments of the present invention are not limited to the first modification of the seventh embodiment, and as the fuel injection device 1G′ shown in FIG. 20, the fuel supply passage pressures sensors S_{PS} may be provided on the downstream sides of the orifices 75, 75 in the high pressure fuel supply passages 21A, 21A for supplying fuel to the cylinders 41A, 41C, which are shown with “#1” and “#3” as the first cylinder so that the calculation correction factor K₂ can be obtained, similarly to the first modification.

The second modification of the seventh embodiment is different from the seventh embodiment in the following points. (1A) A first actual fuel supply amount Q_{Sum} which is calculated as an actual fuel supply amount supplied through the high pressure fuel supply passage 21A at the time of fuel injection of the injector 5A of the cylinder 41A, which is the first cylinder, based on the pressure difference (Pc−Ps_{fil}) corresponding to the orifice differential pressure ΔP_{OR} in the high pressure fuel supply passage 21A is obtained as well as a second actual fuel supply amount Q_{Sum}* calculated based on the fuel supply passage pressure Ps_{fil} affected by the pressure variation which is generated in the high pressure fuel supply passage 21A of the cylinder 41A, propagated through the common rail 4 to the high pressure fuel supply passage 21A for supplying fuel to the cylinder 41C and is detected by the fuel supply passage pressure sensor S_{Ps}. (1B) The first actual fuel supply amount Q_{Sum} which is calculated as an actual fuel supply amount supplied through the high pressure fuel supply passage 21A at the time of fuel, injection of the injector 5A of the cylinder 41C, which is the first cylinder, based on the pressure difference (Pc−Ps_{fil}) corresponding to the orifice differential pressure ΔP_{OR} in the high pressure fuel supply passage 21A is obtained as well as the second actual fuel supply amount Q_{Sum}* calculated based on the fuel supply passage pressure Ps_{fil} which is affected by the pressure variation generated in the high pressure fuel supply passage 21A of the cylinder 41C and is propagated through the common rail 4 to the high pressure fuel supply passage 21A for supplying fuel to the cylinder 41A and is detected by the fuel supply passage pressure sensor S_{Ps}. (2) The ratios K₂ of the first actual fuel supply amount Q_{Sum} and the second actual fuel supply amount Q_{Sum}* which have been obtained in (1A) and (1B) are obtained as the calculation correction factor, and the first actual fuel supply amounts Q_{Sum} which have been obtained in (1A) and (1B) are converted to the actual injection amounts. (3) As an actual fuel supply amount Q_{Sum} which has been supplied for the fuel injection of the injector 5A to either of the cylinders 41B, 41D, which are the second cylinders, a third actual fuel supply amount Q_{Sum}* is obtained which is calculated based on the fuel supply passage pressure Ps_{fil} affected by the pressure variation which is generated in the high pressure fuel supply passage 21B of the cylinder 41, propagated via the common rail 4 to the high pressure fuel supply passage 21A and is detected by the fuel supply passage pressure sensor S_{Ps}. (4) The third actual fuel supply amount, Q_{Sum}* is multiplied by the calculation correction factor K₁ to obtain a corrected actual fuel supply amount Q_{Sum}* of the second cylinder, and sets the corrected actual fuel supply amount Q_{Sum}* as the actual injection amount Q_{A}.

In the second modification, in response to the fuel, injection to the cylinder (first cylinder) 41A or 41C (see FIG. 20), the actual fuel supply information detection unit 813G′ calculates the first actual fuel supply amount Q_{Sum} based on the pressure difference (Pc−PS), as well as the second actual fuel supply amount Q_{Sum}* by calculating a pressure decrease amount of the pressure variation which is generated in the high pressure fuel supply passage (first fuel supply passage) 21A of one of the cylinders 41A or 41C by the fuel injection to the one of the cylinders (first cylinder) 41A or 41C and is propagated via the common rail 4 to the high pressure fuel supply passage 21A of the other of the cylinders (first cylinder) 41A or 41C, based on the fuel supply passage pressure Ps_{fil} which is detected by the fuel supply passage pressure sensor S_{Ps}.

Then, the actual fuel supply information detection unit 813G′ inputs the calculated actual fuel supply amounts Q_{Sum}, Q_{Sum}* into the actual fuel injection information detection unit 814G′.

The actual fuel supply information detection unit 813G′ calculates the third actual fuel supply amount Q_{Sum}* by calculating an initial pressure decrease amount of the pressure variation which is generated in the high pressure fuel supply passage (first fuel supply passage) 21B of one of the cylinders 41B or 41D by the fuel, injection to the one of the cylinders (first cylinder) 41B or 41D and is propagated via the common rail 4 to the high pressure fuel supply passage 21A, based on the fuel supply passage pressure Ps_{fil} which is detected by the fuel supply passage pressure sensor S_{Ps}. The actual fuel supply information detection unit 813G′ then inputs the calculated third actual fuel supply amount Q_{Sum}* to the actual fuel injection information detection unit 814G′.

The actual fuel injection information detection unit 814G′ calculates the ratio K₂ of the actual fuel supply amounts Q_{Sum} and Q_{Sum}* which are obtained by the actual fuel supply information detection unit 813G′ for the fuel injection to the cylinder (first cylinder) 41A or 41C, and stores the ratio K₂ in the calculation correction factor map 814a (see FIG. 21) and sets the actual fuel supply amount. Q_{Sum} as the actual injection amount Q_{A}.

In response to the fuel injection to the cylinders (second cylinder) 41B or 41D, the actual fuel injection information detection unit 814G′ retrieves the calculation correction factor K₂ with reference to the initial value Pi set in Step 42 from the calculation correction factor map 814a, and multiplies the actual fuel supply amount Q_{Sum}* that has been input from the actual fuel supply information detection unit 813G′ by the calculation correction factor K₁ to obtain a corrected actual fuel supply amount Q_{Sum}, and sets the corrected actual fuel supply amount Q_{Sum} as an actual injection amount Q_{A}.

In the second modification of the seventh embodiment, the “pressure Ps_{fil} in the high pressure fuel supply passage 21A” in the explanation of Steps 41 to 46 in FIG. 31 does not have to be read as “common rail pressure Pc”.

Similarly to the first modification, the second modification enables to eliminate the calculation error included in an actual fuel supply amount Q_{Sum}* supplied to the injector 5A through the high pressure fuel supply passage 21B at the time of the fuel injection to the second cylinders 41B or 41D that is obtained by a method for calculating the actual fuel supply amount Q_{Sum}* based on the initial pressure decrease in the great pressure variation which is propagated via the common rail 4 to the high pressure fuel supply passage 21A without using an orifice differential pressure.

In the seventh embodiment and the first and second modifications of the seventh embodiment, a fuel supply passage pressure sensor S_{PS1} shown by the dashed line in FIG. 20 may be provided on the upstream side of the orifice 75 in the high pressure fuel supply passage 21A for supplying fuel to the cylinder 41A, which is shown as “#1”, instead of the common rail pressure sensor S_{Pc} for detecting the common rail pressure Pc.

### Eighth Embodiment

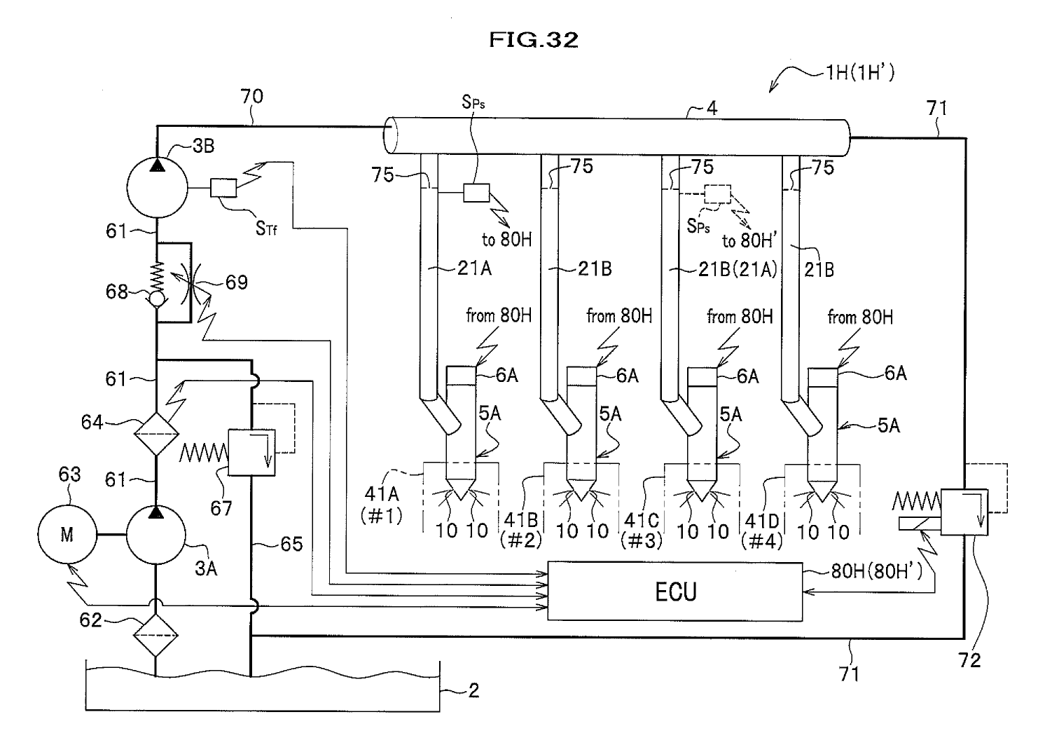

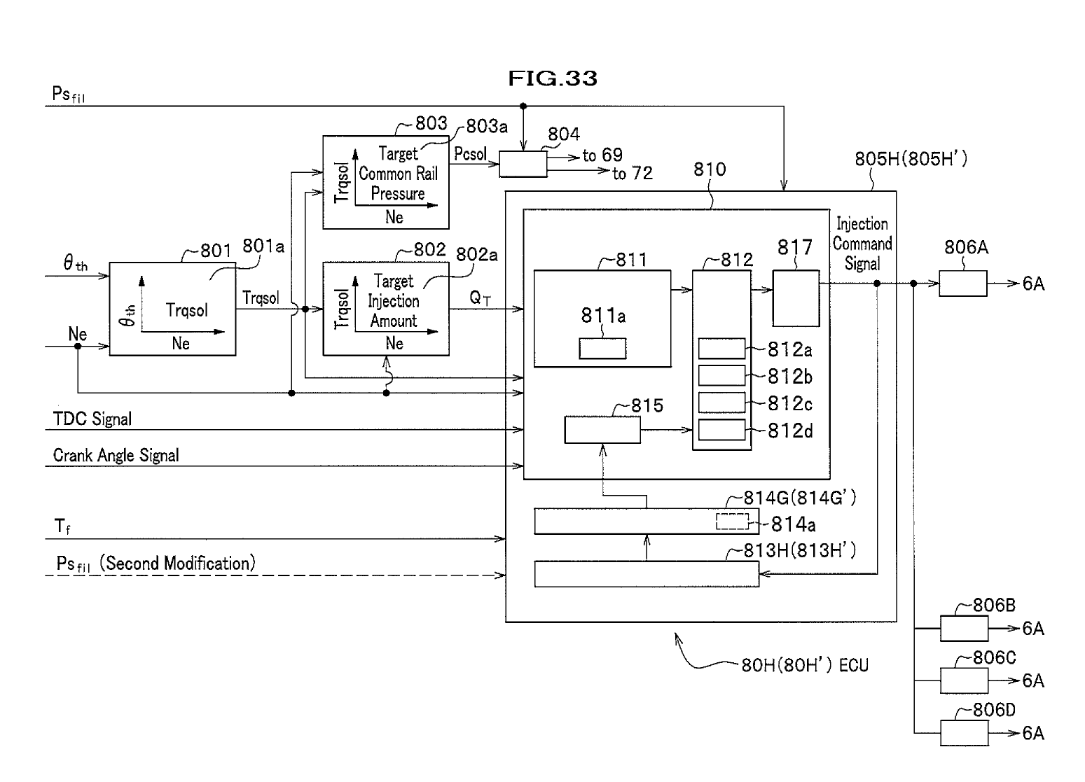

Next, a fuel injection device according to an eighth embodiment of the present invention is described in detail with reference to FIGS. 32 and 33.

FIG. 32 is an illustration for showing an entire configuration of the accumulator fuel injection device of the eighth embodiment. FIG. 33 is a functional block diagram of an engine controlling device used in the accumulator fuel injection device of the eighth embodiment.

A fuel injection device 1H is different from the fuel injection device 1G of the seventh embodiment in the following points. (1) The common rail pressure sensor S_{Pc} for detecting the common rail pressure Pc is omitted. (2) An ECU (control unit) 80H is provided instead of the ECU 80G. (3) The fuel supply passage pressure sensor S_{PS} is provided instead of the common rail pressure sensor S_{Pc} for controlling the common rail pressure Pc. (4) In the ECU 80H, parts of the method for calculating the actual fuel supply amount and the actual injection amount are changed.

Components of the eighth embodiment corresponding to those of the seventh embodiment are assigned like reference numerals, and descriptions thereof will be omitted.

As shown in FIG. 32, the pressure signal detected by the fuel supply passage pressure sensor S_{Ps} is input to the ECU 80H.

In ECU 80H, the signal of the fuel supply passage pressure PS input from the fuel supply passage pressure sensor S_{Ps} is filtering processed to cut a noise with a high frequency. Here, the fuel supply passage pressure PS which has been filtering-processed is called a fuel supply passage pressure Ps_{fil} or a pressure Ps_{fil}.

By filtering processing the pressure signal input from the fuel supply passage pressure sensor S_{Ps}, the pressure vibration of the pressure Ps_{fil} from the pressure sensor S_{Ps} becomes comparatively smaller at an “aspiration stroke” and “compression stroke” which follows the “explosion stroke” and “exhaust stroke” after a fuel injection is performed and completed in one cylinder based on signals from a crank angle sensor (not shown) and a cylinder discriminating sensor (not shown) and the injection command signal for the cylinder generated by the ECU 80J. The pressure Ps_{fil} from the fuel supply passage pressure sensor S_{Ps} in the state where its pressure vibration is comparatively smaller is substantially equal to the common rail pressure Pc.

The ECU 80H samples the pressure Ps_{fil} in the above described state where its pressure vibration is comparatively smaller and controls the pressure control valve 72 to control the common rail pressure Pc within a predetermined range.

Compared to the seventh embodiment, a fuel injection device 1H is used instead of the fuel injection device 1G in FIG. 82; the ECU 80H is provided instead of the ECU 80G; the ECU 80H is substituted for the ECU 80G and an injection control unit 805H is substituted for the injection control unit 805G in the functional block diagram of the engine controlling device in FIG. 33 to adapt to the change in the method for calculating the actual fuel supply amount and the actual injection amount. The eighth embodiment is basically the same as the seventh embodiment except that the eighth embodiment is provided with the actual fuel supply information detection unit 813H instead of the actual fuel supply information detection unit 813G.

The function of the ECU 80H of the eighth embodiment is basically the same as that of the ECU 80G of the seventh embodiment except for a method for controlling the common rail pressure Pc. However, the orifice differential pressure ΔP_{OR} used in the eighth embodiment when the actual fuel supply information detection unit 813H calculates the orifice passing flow rate Q_{OR} of the high pressure fuel supply passage 21A which supplies fuel to the first cylinder 41A is different from that used in the seventh embodiment.

The orifice differential pressure ΔP_{OR} of the high pressure fuel supply passage 21A for supplying fuel to the first cylinder 41A is calculated based on only the fuel supply passage pressure Ps_{fil} on the downstream side of the orifice 75 in the eighth embodiment while in the seventh embodiment the orifice differential pressure ΔP_{OR} is calculated based on the pressure difference (Pc−Ps_{fil}) between the two pressure signals detected by the common rail pressure sensor S_{Pc} and the fuel supply passage pressure sensor S_{Ps}.

Similarly to the seventh embodiment, the amount of the initial pressure decrease of the pressure variation propagated to the fuel supply passage pressure Ps_{fil} of the high pressure fuel supply passage 21A for supplying fuel to the first cylinder 41A is calculated to obtain the fuel supply amount supplied through the high pressure fuel supply passage 21B for supplying fuel to the second cylinders 41B, 41C, 41D in the eighth embodiment.

Next, a method for calculating the actual fuel supply amount and the actual injection amount based on only the fuel supply passage pressure sensor S_{Ps} according to the eighth embodiment is described with reference to FIGS. 28, 32, 33 and 34.

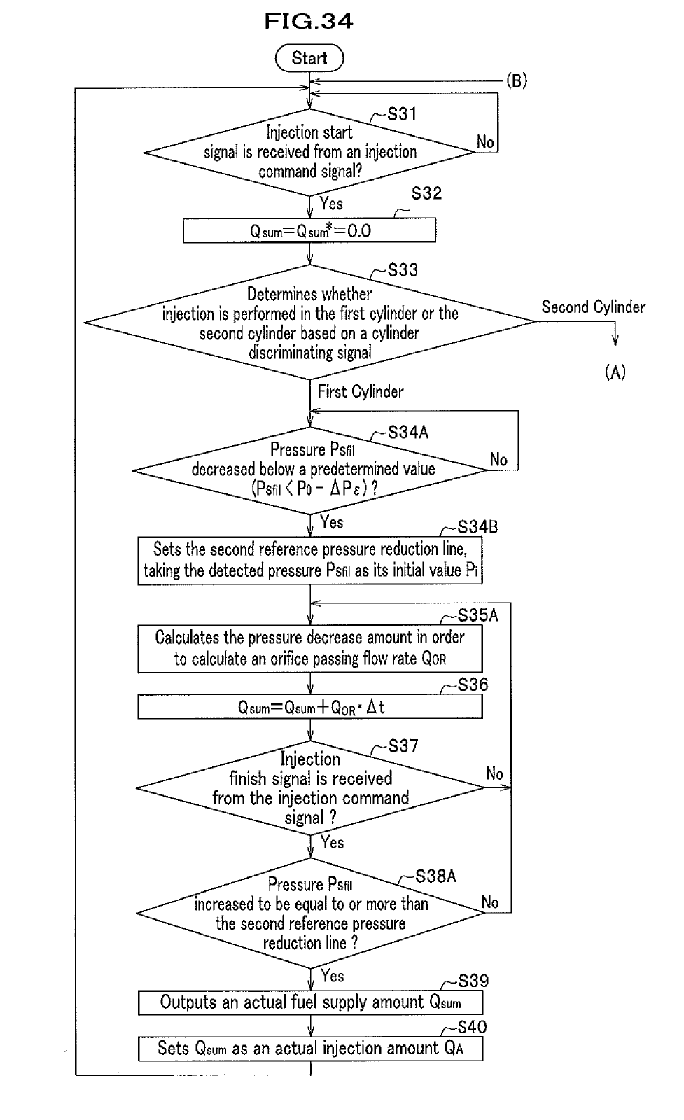

FIG. 34 is a flow chart showing a control flow performed by the ECU 80H of the eighth embodiment for calculating an actual fuel supply amount based on an orifice passing flow rate Q_{OR} of fuel for the first cylinder and coverting the actual fuel supply amount to an actual injection amount. The flow chart in FIG. 34 shows parts changed from the flow chart of the seventh embodiment shown in FIG. 27 (i.e. processing for calculating the orifice passing flow rate Q_{OR}, the actual fuel supply amount Q_{Sum} and the actual injection amount (actual fuel injection amount) QA based on a variation of the fuel supply passage pressure Ps_{fil} on the downstream side of the orifice 75 without using the orifice differential pressure ΔP_{OR}).

The processing of Steps 31 to 33, 34A, 34B, 35A, 36, 37, 38A, 39 in the flow chart of FIG. 34, and the processing of Steps 41 to 47 in FIG. 28 are performed by the actual fuel supply information detection unit 813H, and the processing of Steps 40 and 48 is performed by the actual fuel injection information detection unit 814G.

It is to be noted that the orifice passing flow rate Q_{OR} and the actual fuel supply amount Q_{Sum}* in Steps 41 to 48 are imitations of the real values as described before.

The processing of Steps 41 to 48 shown in FIG. 28 is the same as that of the seventh embodiment as long as the “actual fuel supply information detection unit 813G” is read as an “actual fuel supply information detection unit 813H”, and thus repeated explanation will be omitted.

In Step 31, the actual fuel supply information detection unit 813H determines whether or not an injection start signal is received from the injection command signal output from the output control unit 817. If the injection start signal is received (Yes), the processing proceeds to Step 32. If the injection start signal is not received (No), the processing repeats Step 31. In Step 32, an actual fuel supply amount Q_{Sum}, Q_{Sum}* for fuel injection is reset to be 0.0. In Step 33, the actual fuel supply information detection unit 813G determines whether a cylinder discrimination signal attached to the injection command signal indicates the first cylinder (i.e. the cylinder 41A, which is shown as “#1” in FIG. 31) to which fuel is supplied from the high pressure fuel supply passage 21A provided with the fuel supply passage pressure sensor S_{Ps} on the downstream side of the orifice 75, or the second cylinder (i.e. any of the cylinders 41B, 41C, 41D, which are shown as “#2” to “#4” in FIG. 31) to which fuel is supplied from the high pressure fuel supply passage 21B which is not provided with the fuel supply passage pressure sensor S_{Ps} on the downstream side of the orifice 75. If it indicates the first cylinder, the processing proceeds to Step 34A. If it indicates the second cylinder, the processing proceeds to Step 41, following the connector (A).

In Step 34A, the actual fuel supply information detection unit 813H determines whether or not the pressure Ps_{fil} of the high pressure fuel supply passage 21A is decreased to be lower than a predetermined value [symbol] (Ps_{fil}<P₀−ΔPε)? [symbol] . If the pressure Ps_{fil} of the high pressure fuel supply passage 21 A is decreased to be lower than the predetermined value (Yes), the processing proceeds to Step 34B. If it is not (No), the processing repeats Step 34A.

The timing at which the pressure Ps_{fil} of the high pressure fuel supply passage 21A is decreased to be lower than the predetermined value in Step 34A is also referred to as a “third timing”.

In Step 34B, the second reference pressure reduction line, such as the reference pressure reduction line x2 shown in FIG. 26C, is set taking the pressure Ps_{fil} as the initial value Pi.

The initial value Pi may be equal to the predetermined value (P₀−ΔPε). The initial value Pi may not be equal to the predetermined value (P₀−ΔPε), since the pressure Ps_{fil} sampled in the period next to the period in which the pressure Ps_{fil} used in Step 13 is sampled may be used in Step 14.

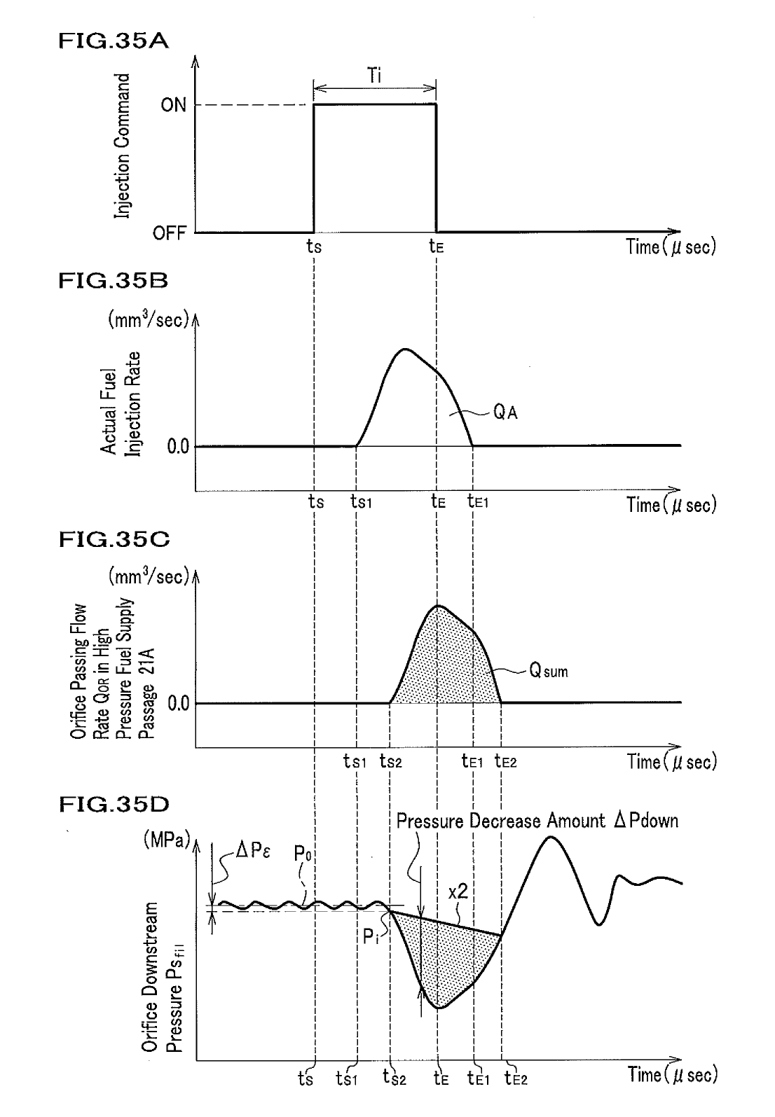

In Step 35A, the amount of pressure decrease ΔPdown of the pressure Ps_{fil} from the second reference pressure reduction line whose initial value is the initial value Pi, is calculated in order to calculate the orifice passing flow rate Q_{OR}. The definition of ΔPdown is shown in FIG. 35D.

The orifice passing flow rate Q_{OR} can be readily calculated by using the equation (1) in which the pressure decrease amount ΔPdown is substituted for ΔP_{OR}.

The orifice passing flow rate Q_{OR} can be easily calculated in the equation (1) in which the pressure decrease amount ΔPdown is substituted for ΔP_{OR}.

In Step 36, the orifice passing flow rate Q_{OR} is time-integrated as shown in Q_{Sum}=Q_{Sum}+Q_{OR}·Δt.

In Step 37, it is determined whether or not an injection finish signal is received from the injection command signal. If the injection finish signal is received (Yes), the processing proceeds to Step 38. If the injection finish signal is not received (No), the processing returns to Step 35A and repeats Steps 35A to 37. In Step 38A, it is determined whether or not the pressure Ps_{fil} of the high pressure fuel supply passage 21A exceeds the second reference pressure reduction line. If the pressure Ps_{fil} of the high pressure fuel supply passage 21A exceeds the second reference pressure reduction line (Yes), the processing proceeds to Step 39. If it does not (No), the processing returns to Step 35, and repeats Steps 35A to 38A.

The timing at which the pressure Ps_{fil} of the high pressure fuel supply passage 21A is determined to exceed the second reference pressure reduction line in Step 38 is also referred to as a “forth timing”.

In Step 39, the actual fuel supply amount Q_{Sum} that is finally acquired by the repetition of Steps 35 to 38 is output to the actual fuel injection information detection unit 814G. In Step 40, the actual fuel injection information detection unit 814G sets the actual fuel supply amount Q_{Sum} as an actual injection amount Q_{A} of the fuel injection. Then, the actual injection amount Q_{A} is input to the correction factor calculation unit 815. After that, the processing returns to Step 31, and repeats the calculation of the actual fuel supply amount Q_{Sum} for the next cylinder 41 and the conversion of the actual fuel supply amount Q_{Sum} to the actual injection amount Q_{A}.

The actual fuel supply amount Q_{Sum} and the actual injection amount Q_{A} are also referred to as an “actual fuel supply amount” and “actual fuel injection amount”, respectively.

In Step 33, if it is determined that the cylinder discrimination signal attached to the injection command signal indicates any of the second cylinders (i.e. any of the cylinders 41B, 41C, 41D), which are shown as “#2” to “#4” in FIG. 32) to which fuel is supplied from the high pressure fuel supply passage 21B which is not provided with the fuel supply passage pressure sensor S_{Ps} on the downstream side of the orifice 75, the processing proceeds to Step 41 shown in FIG. 28 as indicated by the connector (A), and calculates the actual fuel supply amount Q_{Sum}* and the actual injection amount Q_{A} as described in the flow chart of the seventh embodiment.

The actual fuel supply information detection unit 813G in the explanation of the flow chart of the seventh embodiment is read as an “actual fuel supply information detection unit 813H”.

With reference to FIGS. 32, 33, and 35A to 35D, a method performed by the ECU 80H for calculating an actual fuel supply amount and an actual injection amount of the fuel injection to the first cylinder 41A is described. The method performed by the ECU 80H for calculating the actual fuel supply amount and the actual injection amount of the fuel injection to the second cylinders 41B, 41C, 41D is the same as that of the seventh embodiment shown in FIGS. 30A to 30D, and thus the description thereof will be omitted.

FIGS. 35A to 35D are graphs showing an output pattern of the injection command signal for a first cylinder and the temporal, variations of fuel flow in the high pressure fuel supply passage. FIG. 35A is a graph showing an output pattern of the injection command signal. FIG. 35B is a graph showing the temporal variation of the actual fuel injection rate of the injector. FIG. 35C is a graph showing the temporal variation of the orifice passing flow rate of the high pressure fuel supply passage 21A. FIG. 35D is a graph showing the temporal variation of the pressure on the downstream side of the orifice.

In FIG. 35A, an injection command signal is shown having the injection time Tᵢ of which injection start instruction timing and injection finish instruction timing are “t_{S}” and “t_{E}”, respectively.

In response to the injection command signal which is output as shown in FIG. 35A, the injector 5A which is a direct acting fuel injection valve starts to inject fuel at the timing t_{S1}, which is a little delayed from the fuel injection start instruction timing t_{S}, and completes the injection at the timing t_{E1}, which is delayed a little from the injection finish instruction timing t_{E} as shown in FIG. 35B. The actual injection amount Q_{A} is calculated by time-integrating the actual fuel injection rates during the period from the injection start instruction timing t_{S1} to the injection finishing timing t_{E1}.

The flow rate of the fuel which passes the orifice 75 (the orifice passing flow rate Q_{OR}) rises at the timing t_{S2}, which is delayed a little from the injection start instruction timing t_{S1} of the fuel injection by the volumes of a fuel passage (not shown) in the injector 5A (see FIG. 32) and the high pressure fuel supply passage 21 (see FIG. 32) as shown in FIG. 35C. Similarly, the orifice passing flow rate Q_{OR} returns to 0 at the timing t_{E2} which is delayed from the timing t_{E1} by the volumes of the fuel passage (not shown) in the injector 5A and the high pressure fuel supply passage 21 as shown in FIG. 35C.

Since the pressure variation on the upstream side of the orifice shown in FIG. 29D can be approximated with the second reference pressure reduction curve x2 as shown in FIG. 26C and the orifice differential pressure ΔP_{OR} can be detected by the pressure decrease amount ΔPdown, it is possible to calculate the orifice passing flow rate Q_{OR}. The dotted area encompassed by the orifice passing flow rate shown in FIG. 35C corresponds to the area of the actual injection amount Q_{A} shown in FIG. 35B and the dotted area shown in FIG. 35D in the case of the direct acting injector 5A.

In accordance with the eighth embodiment described above, it is possible to calculate the actual injection amount Q_{A} of fuel, injection for each cylinder 41, and to control the actual injection amount Q_{A} for each cylinder 41 to be closer to the target injection amount Q_{T}. Thus, the output control of the engine can be performed more accurately, and the vibration of the engine or engine noise can be suppressed.

The differential pressure sensors do not have to be provided to each high pressure fuel supply passage 21A, 21B, 21B, 21B as in the case of the invention disclosed in Japanese Unexamined Patent Publication No. 2003-184632, and it is enough to provide only one fuel supply passage pressure sensor S_{PS} for a 4 cylinder diesel engine, which allows to reduce the number of parts of the fuel injection device and to reduce the cost thereof.

Since the injection time Tᵢ is corrected by the correction factor K₁, which is the ratio between the target injection amount Q_{T} at the time of fuel injection and the actual injection amount Q_{A}, as shown in Steps 24 and 25 of the flow chart, a target injection amount Q_{T} which is effectively corrected is used. Thus, it is possible to correct the variations of the output torque among the cylinders, variation in the injection characteristics of the injector 5A or the actuator 6A due to its manufacturing tolerance, and a secular change in the injection characteristics of the injector 5A or the actuator 6A, which allows to more accurately suppress the variations of the output torque among the cylinders.

As a result, it becomes easier to keep the regulated value of an exhaust gas even if requirement on hardware specifications, such as dimension tolerance of each part, of the engine system, is relaxed. Especially, requirement on the hardware specification for injectors can be relieved, which contributes to reduction of the manufacturing cost of the engine system.

The orifice 75 is also provided to the high pressure fuel supply passage 21B, and the volume obtained by adding the volume of the high pressure fuel supply passage 21A or 21B that is lower than the orifices 75 and that of a fuel passage in the injector 5A is designed to exceed the maximum actual fuel supply amount, such as the maximum actual fuel supply amount required when the maximum torque is required by a fully-opened accelerator. Since the orifice 75 is a barrier against the flow to the common rail 4, the pressure decrease and the reflective wave in the high pressure fuel supply passage 21A or 21B generated by fuel injection becomes greater than the case where the orifice 75 is not provided. Since the pressure variation which is made greater in the high pressure fuel supply passage 21B is propagated through the common rail 4 to the high pressure fuel supply passage 21A, the pressure detection of the fuel supply passage pressure sensor S_{PS} becomes also greater, which has an advantage that the detection accuracy of the actual injection amount for the second cylinder is improved.

Advantages of the eighth embodiment which are the same as those of the third embodiment are omitted, and thus refer to the advantages of the third embodiment for them.

### Modification of Eighth Embodiment

The eighth embodiment of the present invention is not limited to the embodiment described above. As shown in the fuel injection device 1H′ in FIG. 32, the fuel supply passage pressures sensors S_{Ps} may be provided on the downstream sides of the orifices 75, 75 in the high pressure fuel supply passages 21A, 21A for supplying fuel to the cylinders 41A, 41C, which are shown with “#1” and “#3” as the first cylinder, so that the calculation correction factor K₂ can be obtained, similarly to the second modification of the seventh embodiment.

In accordance with such a change from the eighth embodiment, the fuel injection device 1H′ is substituted for the fuel injection device 1H, and an ECU 80H′ is substituted for the ECU 80H in FIG. 32. In the functional block diagram of the engine controlling device in FIG. 33, the ECU 80H′ is substituted for the ECU 80H, and an injection control unit 805H′ is substituted for the injection control unit 805H. The modification of the eighth embodiment is essentially the same as the eighth embodiment except that an actual fuel supply information detection unit 813H′ is substituted for the actual fuel supply information detection unit 813H, and an actual fuel injection information detection unit 814H′ is substituted for the actual fuel injection information detection unit 814H.

The modification of the eighth embodiment differs from the second modification of the seventh embodiment in the following points. (1) A first actual fuel supply amount Q_{Sum} which is calculated as an actual fuel supply amount supplied through the high pressure fuel supply passage 21A at the time of fuel injection of the injector 5A of the cylinder 41A, which is the first cylinder, based on the pressure decrease amount ΔPdown of the pressure Ps_{fil} on the downstream side of the orifice 75 from the second reference pressure reduction line, which corresponds to the orifice differential pressure ΔP_{OR} in the high pressure fuel supply passage 21A, is obtained as well as a second actual fuel supply amount Q_{Sum}* calculated based on the fuel supply passage pressure Ps_{fil} affected by the pressure variation which is generated in the high pressure fuel supply passage 21A of the cylinder 41A, propagated via the common rail 4 to the high pressure fuel supply passage 21A of the cylinder 41C, and is detected by the pressure sensor S_{Ps}. (2) The first actual fuel supply amount Q_{Sum} which is calculated as an actual fuel supply amount supplied through the high pressure fuel supply passage 21A at the time of fuel injection of the injector 5A of the cylinder 41C, which is the first cylinder, based on the pressure decrease amount ΔPdown of the pressure Ps_{fil} on the downstream side of the orifice 75 from the second reference pressure reduction line, which corresponds to the orifice differential pressure ΔP_{OR} in the high pressure fuel supply passage 21A is obtained as well as a second actual fuel supply amount Q_{Sum}* calculated based on the fuel supply passage pressure Ps_{fil} affected by the pressure variation which is generated in the high pressure fuel supply passage 21A of the cylinder 41C, propagated via the common rail 4 to the high pressure fuel supply passage 21A of the cylinder 41A, and is detected by the pressure sensor S_{Ps}.

In response to the fuel injection to the cylinder 41A or 41C (first cylinder) (see FIG. 20), the actual fuel supply information detection unit 813H′ calculates the first actual fuel supply amount Q_{Sum} based on the pressure decrease amount ΔPdown of the pressure Ps_{fil} on the downstream side of the orifice 75 from the second reference pressure reduction line, as well as a second actual fuel supply amount Q_{Sum}* by calculating the pressure decrease amount from the first reference pressure reduction line ΔPdown of the pressure variation which is generated in the high pressure fuel supply passage (first fuel supply passage) 21A of one of the cylinder (first cylinder) 41A or 41C by the fuel injection to the one of the cylinder (first cylinder) 41A or 41C, and is propagated via the common rail 4 to the high pressure fuel supply passage (first fuel supply passage) 21A of the other of the cylinder (first cylinder) 41A or 41C, based on the fuel supply passage pressure Ps_{fil} detected by the fuel supply passage pressure sensor S_{Ps}. Then, the actual fuel supply information detection unit 813G′ inputs the calculated actual fuel supply amounts Q_{Sum}, Q_{Sum}* into the actual fuel injection information detection unit 814G′.

The actual fuel supply information detection unit 813H′ calculates a third actual fuel supply amount Q_{Sum}* by calculating the pressure decrease amount from the first reference pressure reduction line ΔPdown of the pressure variation which is generated in the high pressure fuel supply passage (second fuel supply passage) 21B by the fuel injection to the cylinder (second cylinder) 41B or 41D (see FIG. 20) and is propagated via the common rail 4 to the high pressure fuel supply passage (first fuel supply passage) 21A, based on the fuel supply passage pressure Ps_{fil} detected by the fuel supply passage pressure sensor S_{Ps}. Then, the actual fuel supply information detection unit 813G′ inputs the third calculated actual fuel supply amount Q_{Sum}* into the actual fuel injection information detection unit 814G′.

The actual fuel injection information detection unit 814G′ calculates the ratio K₂ of the first and second actual fuel supply amounts Q_{Sum} and Q_{Sum}* which are obtained by the actual fuel supply information detection unit 813H′ for the fuel injection to the cylinder (first cylinder) 41A or 41C, and stores the ratio K₂ in the calculation correction factor map 814a and sets the actual fuel supply amount Q_{Sum} as the actual injection amount Q_{A}.

In response to the fuel injection to the cylinder (second cylinder) 41B or 41D, the actual fuel injection information detection unit 814G′ reads the calculation correction factor K₂ from the calculation correction factor map 814a with reference to the predetermined initial value Pi set in Step 42, and multiplies the third actual fuel supply amount Q_{Sum}* which has been output from the actual fuel supply information detection unit 813H′ by the calculation correction factor K₂, and sets the third actual fuel supply amount Q_{Sum}* which has been multiplied by the calculation correction factor K₂ as the actual fuel supply amount Q_{Sum}. The actual fuel injection information detection unit 814G′ also sets the corrected actual fuel supply amount Q_{Sum} as the actual injection amount Q_{A}.

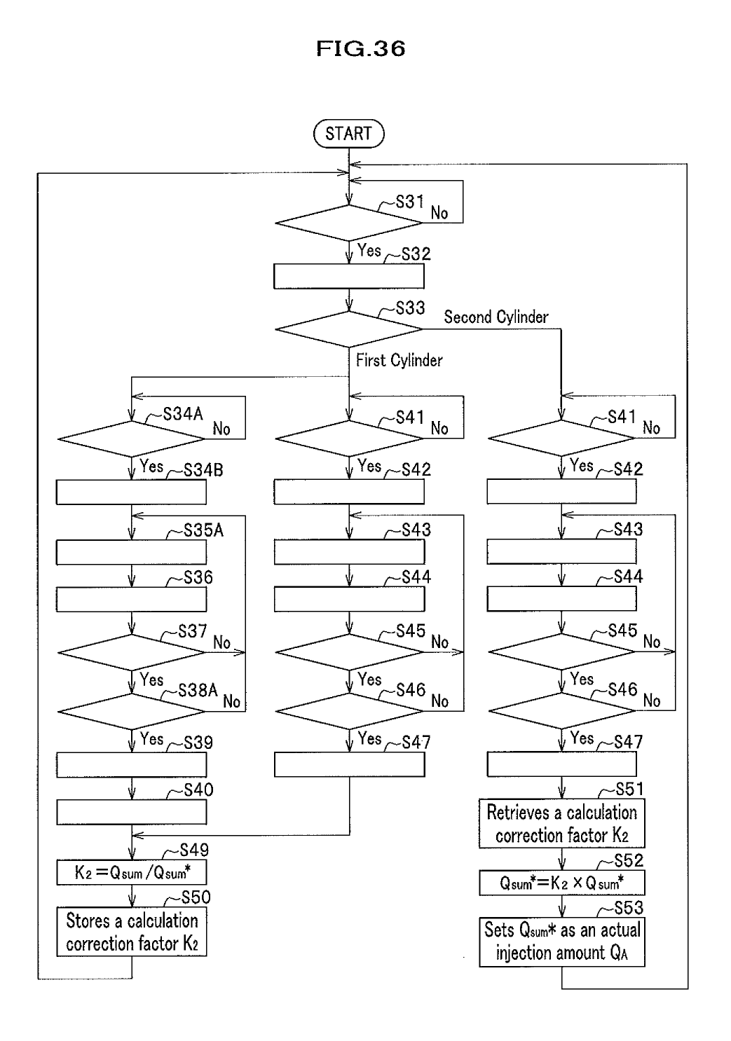

Next, a control flow for calculating an actual injection amount and obtaining the calculation correction factor K₂ in the modification of the eighth embodiment is described with reference to FIG. 36. FIG. 36 is a flow chart showing a control flow for calculating the actual fuel supply amount and the actual injection amount in the modification of the eighth embodiment.

Basically, the flow chart shown in FIG. 36 is a flow chart which combines the flow charts in FIGS. 28 and 34 in the eighth embodiment, and thus only parts of the flow chart in FIG. 36 which are different from the flow charts in FIGS. 27 and 28 are explained, omitting repeated explanation of the common parts.

If it is determined that a cylinder to which fuel is injected is the first cylinder 41A in Step 33, the actual fuel supply information detection unit 813H′ simultaneously performs the processing of Step 34 to 40 and the processing of Step 41 to 47. After the first and second actual fuel supply amounts Q_{Sum}, Q_{Sum}* are obtained in Steps 40 and 47, the processing proceeds to Step 49 in which the actual fuel injection information detection unit 814G′ calculates the calculation correction factor K₂ (=Qₛᵤₘ/Qₛᵤₘ*). Then, the actual fuel, injection information detection unit 814G′ associates the value Pi of the pressure Ps_{fil} in Step 42 with the calculation correction factor K₂ and stores in the calculation correction factor map 814a the calculation correction factor K₂ (Step 50).

If it is determined that a cylinder to which fuel is injected is the second cylinders 41B or 41D in Step 33, the actual fuel supply information detection unit 813G′ obtains the third actual fuel supply amount Q_{Sum}* by the processing of Steps 41 to 47. The actual fuel supply information detection unit 813G′ then proceeds to Step 51 in which the actual fuel injection information detection unit 814G′ reads the calculation correction factor K₂ which is associated with the value Pi of the pressure Ps_{fil} set in Step 42 from the calculation correction factor map 814a. The actual fuel supply information detection unit 813G′ then obtains an actual fuel supply amount Q_{Sum}* which is corrected by the calculation correction factor K₂ by multiplying the third actual fuel supply amount Q_{Sum}* by the calculation correction factor K₂ as shown in Q_{Sum}*=K₂×Q_{Sum}* (Step 52). At last, in Step 53, the actual fuel injection information detection unit 814G′ sets the corrected Q_{Sum}* as the actual injection amount Q_{A}, and outputs the actual injection amount Q_{A} to the correction factor calculation unit 815, and the processing returns to Step 31.

The above described method enables to eliminate the calculation error included in the actual fuel supply amount Q_{Sum}* supplied to the injector 5A through the high pressure fuel supply passage 21B to the second cylinder 41B or 41D at the time of the fuel injection that is obtained by the method for calculating the actual fuel supply amount Q_{Sum}* based on the initial pressure decrease of the great pressure variation in the fuel supply passage pressure Ps_{fil} without using an orifice differential pressure.

With this method, even if the gain G which is fixedly used in Step 47 or the first reference pressure reduction line which is set in Step 42 needs to be adjusted by each fuel injection device due to manufacturing error, the calculation correction factor K₂ is automatically updated during the operation of the engine so that the gain G or the first reference pressure reduction line is learned and corrected.

Similarly to the second modification of the seventh embodiment, the modification of the eighth embodiment enables to eliminate the calculation error included in an actual fuel supply amount Q_{Sum}* supplied to the injector 5A through the high pressure fuel supply passage 21B at the time of the fuel injection to the second cylinder 41B or 41D that is obtained by a method for calculating an actual fuel supply amount Q_{Sum}* based on the initial pressure decrease of the great pressure variation in the common rail pressure Pc without using an orifice differential pressure.

### Ninth Embodiment

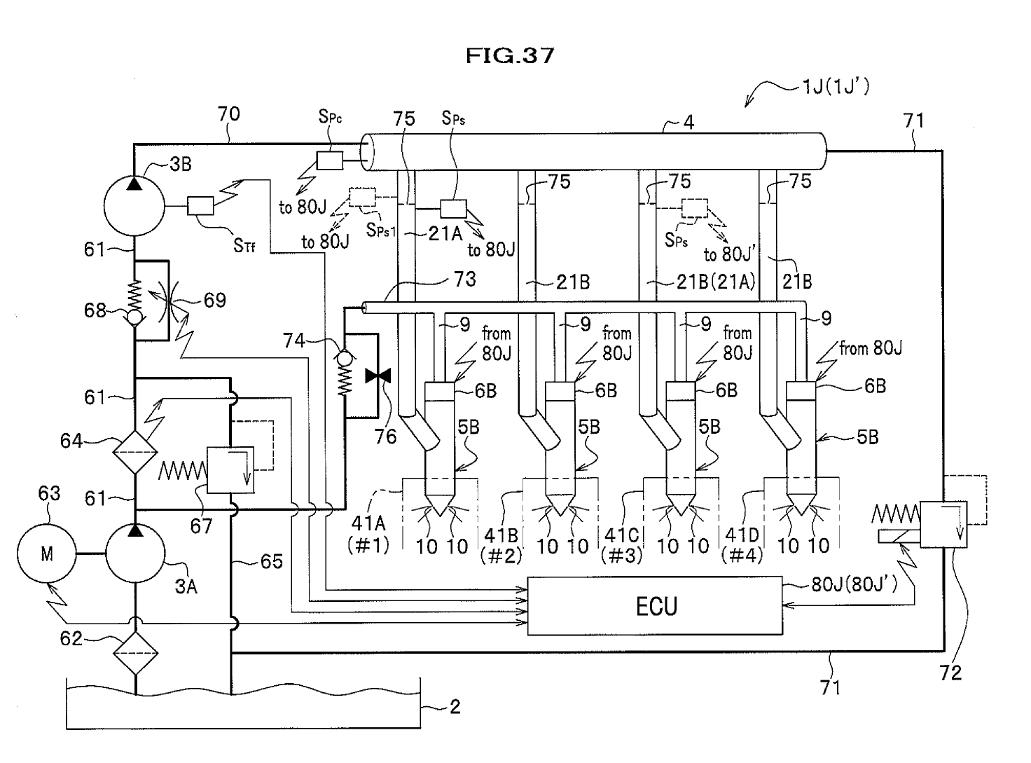

A fuel injection device of a ninth embodiment of the present invention is described in detail with reference to FIGS. 37 to 40D.

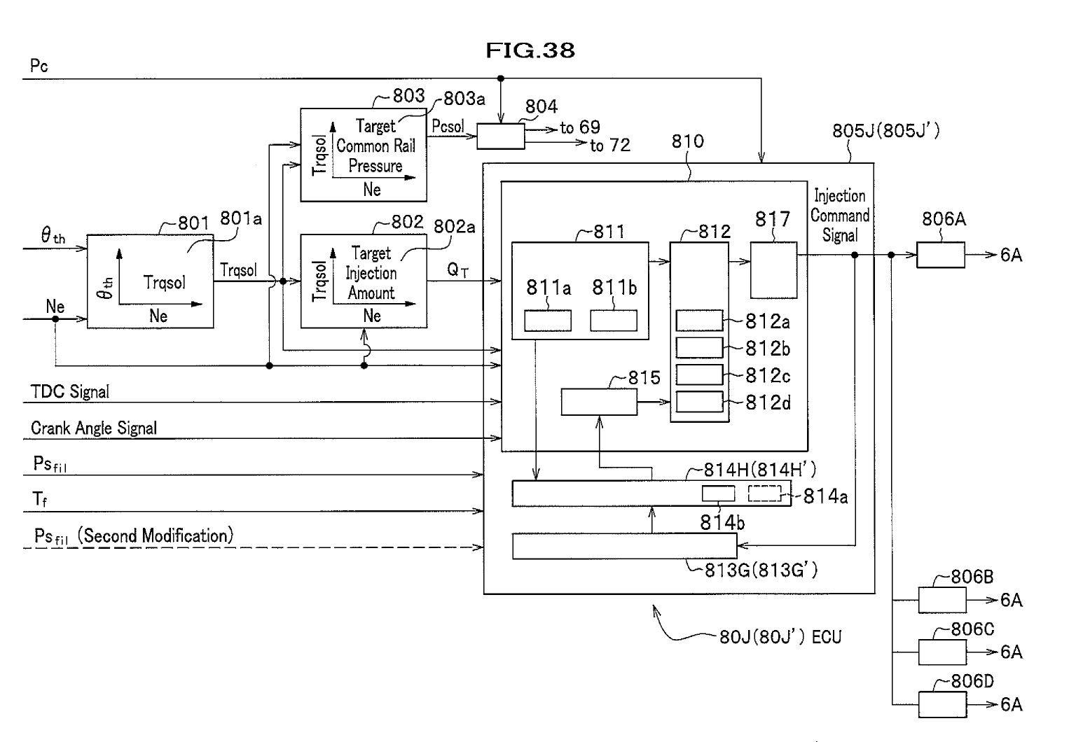

FIG. 37 is an illustration for showing an entire configuration of the accumulator fuel injection device of the ninth embodiment. FIG. 38 is a functional block diagram of an engine controlling device used in the accumulator fuel injection device of the ninth embodiment.

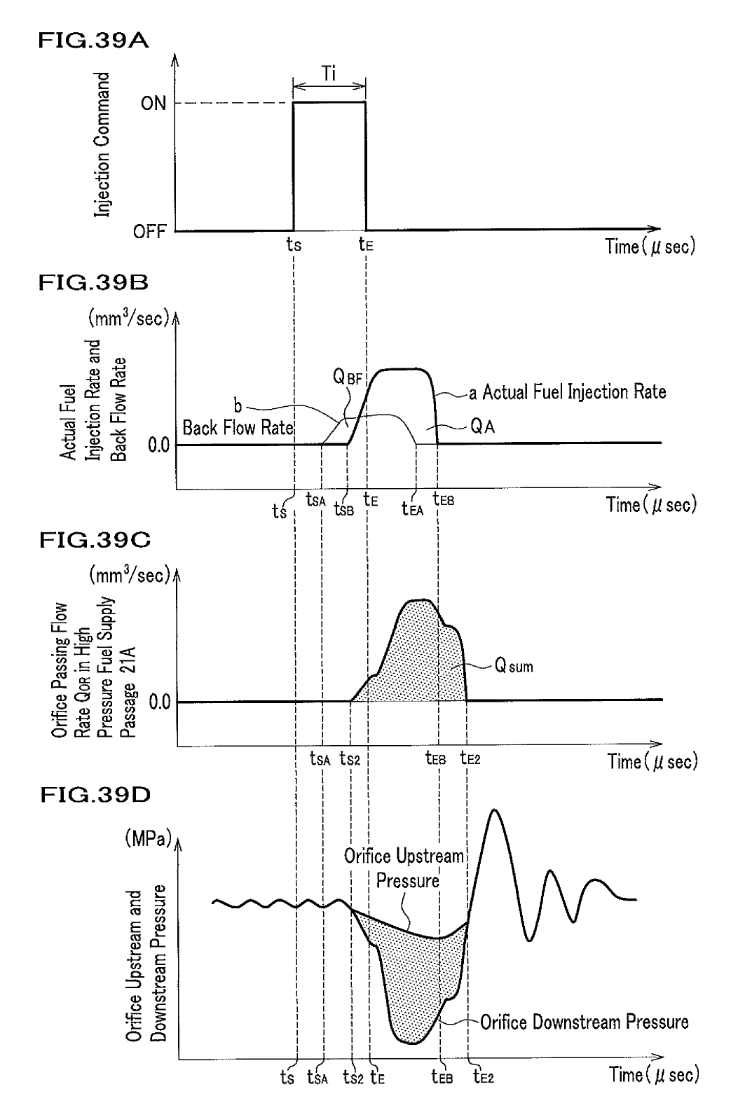

FIGS. 39A to 39D are graphs showing an output pattern of the injection command signal for the first cylinder and the temporal variation of the fuel flow in the first high pressure fuel supply passage 21A. FIG. 39A is a graph showing an output pattern of the injection command signal. FIG. 39B is a graph showing the temporal variation of the actual fuel injection rate and the back flow rate of the injector. FIG. 39C is a graph showing the temporal variation of the orifice passing flow rate of the high pressure fuel supply passage 21A. FIG. 39D is a graph showing the temporal variation of the pressures on the upstream and downstream sides of the orifice in the high pressure fuel supply passage 21A.

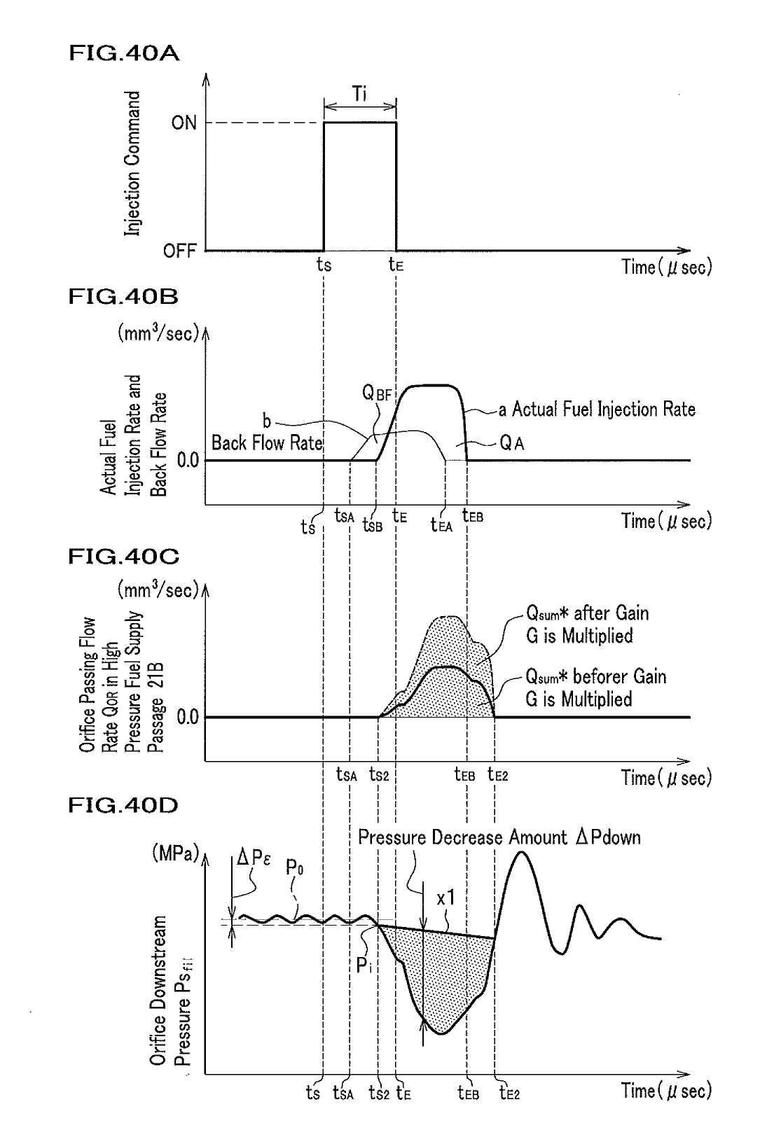

FIGS. 40A to 40D are graphs showing an output pattern of the injection command signal for the second cylinder and the temporal variation of the fuel flow in the high pressure fuel supply passage. FIG. 40A is a graph showing an output pattern of the injection command signal. FIG. 40B is a graph showing the temporal variation of the actual fuel injection rate and the back flow rate of the injector. FIG. 40C is a graph showing the temporal variation of the orifice passing flow rate of the high pressure fuel supply passage 21B. FIG. 40D is a graph showing the temporal variation of the pressure on the downstream side of the orifice in the first fuel supply passage.

A fuel injection device 1J of the ninth embodiment differs from the fuel injection device 1G of the seventh embodiment in that: (1) an injector 5B including an actuator 6B, which is a back pressure fuel injection valve, is used; (2) in accordance with (1), a drain passage 9 is connected to the injector 5B provided in each cylinder, and the drain passages 9 are further connected to a return fuel pipe 73, which is connected to the low pressure fuel supply passage 61 on the discharge side of the low pressure pump 3A via a flow controller in which a check valve 74 and the orifice 76 is connected in parallel (3) the fuel injection device 1J in the ninth embodiment is controlled by the ECU (control unit) 80J.

In other words, the ninth embodiment uses the injector 5B, which is a back pressure fuel injection valve, instead of the injector 5A, which is a direct acting fuel injection valve, and is modified from the seventh embodiment to be adapted to the injector 5B.

Components of the ninth embodiment corresponding to those of the seventh embodiment are assigned like reference numerals, and descriptions thereof will be omitted.

In accordance with such a change from the seventh embodiment, a fuel injection device 1J is substituted for the fuel injection device 1G, and an ECU 80J is substituted for the ECU 80G in FIG. 37. In the functional block diagram of the engine controlling device in FIG. 38, the ECU 80J is substituted for the ECU 80G, and an injection control unit 805J is substituted for the injection control unit 805G. The ninth embodiment is essentially the same as the seventh embodiment except that an actual fuel injection information detection unit 814H is substituted for the actual fuel injection information detection unit 814G.

In the ninth embodiment, in response to the fuel injection to the cylinder (first cylinder) 41A (see FIG. 37), the actual fuel supply information detection unit 813G calculates the first actual fuel supply amount Q_{Sum}, based on the pressure difference (Pc−Ps_{fil}). Then, the actual fuel supply information detection unit 813G inputs the calculated actual fuel supply amount Q_{Sum} into the actual fuel injection information detection unit 814H.

The actual fuel supply information detection unit 813G calculates an actual fuel supply amount, Q_{Sum}* by calculating a pressure decrease amount of the pressure variation which is generated in the high pressure fuel supply passage (second fuel supply passage) 21B by the fuel injection to the cylinder (second cylinder) 41B, 41C or 41D (see FIG. 20) and is propagated via the common rail 1 to the high pressure fuel supply passage (first fuel supply passage) 21A based on the fuel supply passage pressure Ps_{fil} detected by the fuel supply passage pressure sensor S_{PS}. Then, the actual fuel supply information detection unit 813G inputs the calculated actual fuel supply amount Q_{Sum}* into the actual fuel injection information detection unit 814H.

The actual fuel injection information detection unit 814H includes in advance an actual injection amount conversion factor map 814b storing an actual injection amount conversion factor γ for calculating an actual, injection amount Q_{A} which has been actually injected to a combustion chamber from the fuel injection port 10 from the actual fuel supply amount, to the injector 5B including the back flow amount.

The actual fuel injection information detection unit 814H obtains the actual injection amount conversion factor γ with reference to the actual injection amount conversion factor map 814b and multiplies the first and second actual fuel supply amounts Q_{Sum} and Q_{Sum}* which are obtained by the actual fuel supply information detection unit 813G for the fuel injection to the cylinder (first cylinder) 41A for converting the actual fuel supply amounts Q_{Sum} and Q_{Sum}* to the actual injection amount Q_{A}.

The actual fuel injection information detection unit 814H then inputs the converted actual, injection amount Q_{A} to a correction factor calculation unit 815.

The actual injection amount conversion factor γ is preferably determined from the two-dimensional actual injection amount conversion factor map 814b whose parameters are the common rail pressure Pc and the target injection amount Q_{T} rather than a fixed value, since the back flow amount, depends on the common rail pressure Pc and the injection time Tᵢ.

In accordance with the above configuration, Steps 40A and 40B, which are described below, are substituted for Step 40 of the seventh embodiment shown in FIG. 27. Step 40A: the actual injection amount conversion factor γ is obtained with reference to the actual injection amount conversion factor map 814b based on the common rail pressure Pc and the target injection amount Q_{T}. Step 40B: the actual fuel supply amount Q_{Sum} is multiplied by the actual injection amount conversion factor γ to obtain the actual injection amount Q_{A}.

Similarly, Steps 47A and 47B, which are described below, are substituted for Step 47 of the seventh embodiment shown in FIG. 28. Step 47A: the actual injection amount conversion factor γ is obtained with reference to the actual injection amount conversion factor map 814b based on the common rail pressure Pc and the target injection amount Q_{T}. Step 47R: the actual fuel supply amount Q_{Sum} is multiplied by the actual injection amount conversion factor γ to obtain the actual injection amount Q_{A}.

Next, a method performed by the ECU 80J for correcting fuel injection based on detected actual fuel injection information on the fuel injection to the first cylinder 41A or the second cylinder 41B, 41C or 41D is explained with reference to FIGS. 39A to 39D and 40A to 40D.

In response to the injection command signal shown in FIG. 39A, a back flow of fuel is started by the lift up of the valve, which communicates the back pressure chamber of the injector 5B, which is a back pressure fuel injection valve, with the drain passage 9, at the timing t_{SA} as shown in the curve b of FIG. 39B. The start of the back flow is a little delayed from the injection start instruction timing t_{S} of the injection command signal.

The back flow makes the pressure of the back pressure chamber (not shown) of injector 5B to be lower than that of the oil reservoir, whereby the piston (not shown) of the injector 5B is moved upward. Thus, an actual fuel injection is started at the timing “t_{SB}” as shown by the curve a in FIG. 39B.

At the injection finish instruction timing t_{E}, the valve which communicates the back pressure chamber to the drain passage 9 is closed, and then the back flow is finished at the timing t_{EA} as shown by the curve b in FIG. 39B.

As a result, the pressure of the back pressure chamber and that of the oil reservoir are balanced, and the nozzle needle is moved downward together with the piston by the energizing force of the coil spring (not shown) of the injector 5B. Thus, the nozzle needle is seated on the seat surface, whereby the fuel injection is finished at the timing t_{EB} as shown by the curve a in FIG. 39B.

As shown in FIG. 39C, the rate of fuel flow which passes the orifice 75 (orifice passing flow rate Q_{OR}) starts to be calculated at the timing t_{S2}, which is a little delayed from the back flow start timing t_{SA} by the volume of the fuel passage in the injector 5B and the high pressure fuel supply passage 21A (see FIG. 38).

Similarly, the orifice passing flow rate Q_{OR} becomes 0 at the timing t_{E2}, which is delayed from the fuel injection completion timing t_{EB} by the volume of the fuel passage and the high pressure fuel supply passage 21A.

An orifice differential pressure can be detected by the pressure difference (Pc−Ps_{fil}) between the common rail pressure Pc and the fuel supply passage pressure Ps_{fil} even if the pressure on the upstream side of the orifice 75 is varied by the vibration of the common rail pressure Pc as shown in FIG. 39D. Thus, the orifice passing flow rate Q_{OR} can be calculated.

In the case of the back pressure injector 5B, the dotted area of the orifice passing flow rate Q_{OR} shown in FIG. 39C is equal to the area which is calculated by adding the areas of the back flow amount Q_{BF} and the actual injection amount Q_{A} (actual fuel supply amount) shown in FIG. 39B.

Similarly to the seventh embodiment, the orifice passing flow rate Q_{OR} of fuel can be readily calculated from the equation (1) in which the pressure difference (Pc−Ps_{fil}) is substituted for the orifice differential pressure ΔP_{OR}.

Then, an actual fuel supply amount Q_{Sum}, which is obtained by time-integrating the calculated orifice passing flow rate Q_{OR}, is multiplied by the actual injection amount conversion factor γ to calculate an actual injection amount Q_{A}.

Similarly to the seventh embodiment, in response to the fuel injection to the second cylinder 41B, 41C or 41D, the pressure decrease amount ΔPdown from the first reference pressure reduction line in the initial pressure decrease part of the pressure variation of each high pressure fuel supply passage 21B, 21B, 21B which is propagated via the common rail 4 to the high pressure fuel supply passage 21A of the first cylinder can be imitated as an orifice differential pressure, based on the pressure signal detected by the fuel supply passage pressure sensor S_{Ps} as shown in FIG. 40D. Thus, the actual fuel supply amount Q_{Sum}* for the fuel injection to the second cylinder 41B, 41C or 41D can be calculated. Then, the actual fuel supply amount Q_{Sum}* is multiplied by the actual injection amount conversion factor γ so that an actual injection amount Q_{A} is calculated which removes the back flow amount Q_{BF} from the actual fuel supply amount Q_{Sum}*.

In accordance with the ninth embodiment described above, it is possible to calculate the actual injection amount Q_{A} of fuel injection for each cylinder 41, and to control the actual injection amount Q_{A} for each cylinder 41 to be closer to the target injection amount Q_{T} even in the case of the back pressure injector 5B. Thus, the output control of the engine can be performed more accurately, and the vibration of the engine or engine noise can be suppressed.

The differential pressure sensors S_{dP} do not have to be provided to each high pressure fuel supply passage 21A, 21B, 21B, 21B as in the case of Japanese Unexamined Patent Publication No. 2003-184632, and it is enough to provide only one fuel supply passage pressure sensor S_{Ps} for a 4 cylinder diesel engine, which allows to reduce the number of parts of the fuel injection device and to reduce the cost thereof.

Similarly to the first and second modifications of the seventh embodiment, the ninth embodiment may also be modified.

In modifications of the ninth embodiment, a fuel injection device 1J′ and the ECU 80J′ are substituted for the fuel injection device 1J and the ECU 80J, respectively in FIG. 37. An injection control unit 805J′, an actual fuel supply information detection unit 813G′ and an actual fuel injection information detection unit 814H′ are substituted for the injection control unit 805J, the actual fuel supply information detection unit 813G, and the actual fuel injection information detection unit 814H, respectively, in FIG. 38

The actual fuel injection information detection unit 814H′ includes the calculation correction factor map 814a.

The two steps of Steps 40A and 40B are substituted for Step 40 of the flow chart shown in FIG. 31, and the two steps of Steps 47A and 47B are substituted for Step 47 of the flow chart shown in FIG. 31. The actual fuel injection information detection unit 814G′ in the flow chart shown in FIG. 31 is replaced with the actual fuel injection information defection unit 814H′.

### Tenth Embodiment

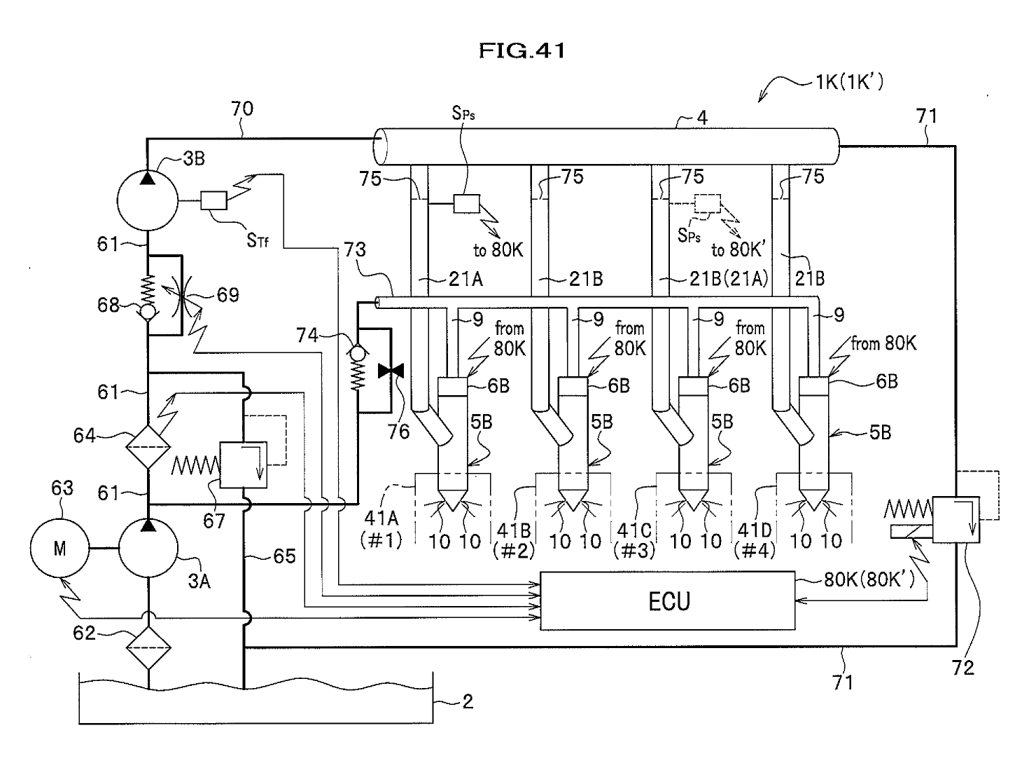

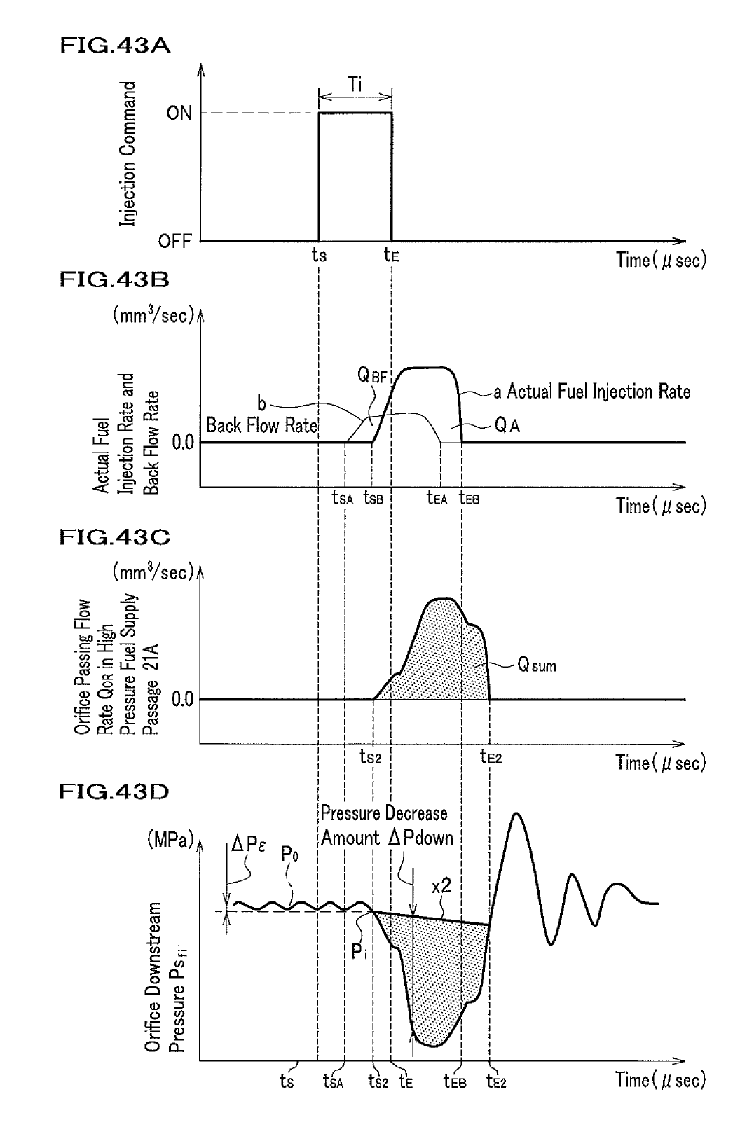

Next, a fuel injection device of a tenth embodiment of the present invention is described in detail with reference to FIGS. 41 and 43A to 43D.

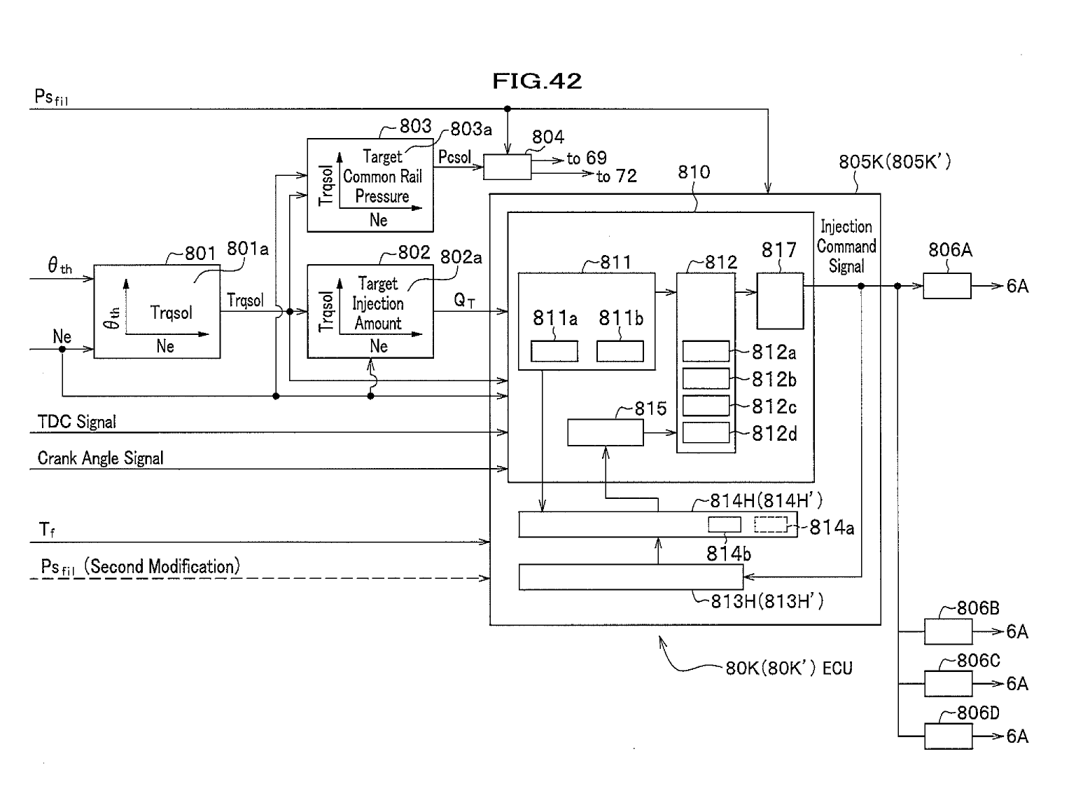

FIG. 41 is an illustration for showing an entire configuration of the accumulator fuel injection device of the tenth embodiment. FIG. 42 is a functional block diagram of an engine controlling device used in the accumulator fuel injection device of the tenth embodiment.

FIGS. 43A to 43D are graphs showing an output pattern of the injection command signal for the first cylinder and the temporal variations of fuel flow in the first high pressure fuel supply passage. FIGS. 43A to 43D are graphs showing an output pattern of the injection command signal for the first cylinder and the temporal variations of fuel flow in the first high pressure fuel supply passage. FIG. 43A is a graph showing an output pattern of the injection command signal. FIG. 43B is a graph showing the temporal variations of the actual fuel injection rate and the back flow rate of an injector. FIG. 43C is a graph showing the temporal variations of the orifice passing flow rate of the high pressure fuel supply passage 21A. FIG. 43D is a graph showing the temporal variations of the pressure on the downstream side of the orifice in the high pressure fuel supply passage 21A.

A fuel injection device 1K of the tenth embodiment is different from the fuel injection device 1J of the ninth embodiment in the following points. (1) The common rail, pressure sensor S_{Pc} for detecting the common rail, pressure Pc is omitted. (2) An ECU (control unit) 80K is provided instead of the ECU 80J. (3) The fuel supply passage pressure sensor S_{PS} is provided instead of the common rail pressure sensor S_{Pc} for controlling the common rail, pressure Pc. (4) In the ECU 80K, the method for calculating the actual fuel supply amount Q_{Sum} of a first fuel supply passage is changed.

In other words, the tenth embodiment uses the injector 5B, which is a back pressure fuel injection valve, instead of the injector 5A, which is a direct acting fuel injection valve, and is modified from the ninth embodiment to be adapted to the injector 5B.

Components of the tenth embodiment corresponding to those of the ninth embodiment are assigned like reference numerals, and descriptions thereof will be omitted.

The ECU 80K samples the pressure Ps_{fil} in the state where its pressure vibration is comparatively small and controls the flow regulating valve 69 and the pressure control valve 72 in order to control the common rail pressure Pc within a predetermined range.

The function of the ECU 80K of the tenth embodiment is basically the same as that of the ECU 80J of the ninth embodiment except for the method for controlling the common rail pressure Pc. However, they are also different in that the orifice differential pressure used by the ECU 80K for calculating the fuel supply amount Q_{Sum} to the first cylinder 41A is not based on the pressure difference detected by the common rail pressure sensor S_{PC} and the fuel supply passage pressure sensor S_{PS} as in the first or ninth embodiment, but is based on only the signal from the pressure sensor S_{Ps} provided on the downstream side of the orifice 75.

With these changes in the method for calculating the actual fuel supply amount and the actual injection amount, the fuel injection device 1K is substituted for the fuel injection device 1J, and the ECU 80K is substituted for the ECU 80J in FIG. 41, compared to the ninth embodiment. In the functional block diagram of the engine controlling device in FIG. 42, the ECU 80K is substituted for the ECU 80J, and an injection control unit 805K is substituted for the injection control unit 805J. The tenth embodiment is basically the same as the ninth embodiment except that an actual fuel supply information detection unit 813H is substituted for the actual fuel supply information detection unit 813G.

The function of the ECU 80K of the tenth embodiment is basically the same as that of the ECU 80J of the ninth embodiment except for the method for controlling the common rail pressure Pc. However, the orifice differential pressure ΔP_{OR} used in the tenth embodiment when the actual fuel supply information detection unit 813H calculates the orifice passing flow rate Q_{OR} of the high pressure fuel supply passage 21A for supplying the fuel to the first cylinder 41A is different from that used in the ninth embodiment.

The orifice differential pressure ΔP_{OR} of the high pressure fuel supply passage 21A which supplies fuel to the first cylinder 41A is not based on the pressure difference (Pc−Ps_{fil}) between the pressure signals which are detected by the common rail pressure sensor S_{Pc} and the fuel supply passage pressure sensor S_{PS} as in the ninth embodiment, but is based on only the fuel supply passage pressure Ps_{fil} from the pressure sensor S_{Ps} provided on the downstream side of the orifice 75 in the tenth embodiment.

Similarly to the eighth embodiment, the amount of the initial pressure decrease of the pressure variation propagated to the fuel supply passage pressure Ps_{fil} of the high pressure fuel supply passage 21A which supplies fuel to the first cylinder 41A is calculated to obtain the fuel supply amount supplied through the high pressure fuel supply passage 21B for supplying fuel to the second cylinders 41B, 41C, 41D in the tenth embodiment.

FIGS. 43A to 43D show a method for calculating the actual fuel supply amount Q_{Sum} and the actual injection amount Q_{A} based on only the signal from the fuel supply passage pressure sensor S_{PS} provided on the downstream side of the orifice 75 in the first fuel supply passage when the injection command signal for the first cylinder is generated.

The difference from the eighth embodiment shown in FIGS. 35A to 35D is that the actual fuel supply amount Q_{Sum} in FIG. 43C is the summation of the back flow amount Q_{BF} and the actual injection amount. Q_{A}, and the actual fuel injection information detection unit 814H calculates the actual injection amount Q_{A} by multiplying the actual fuel supply amount Q_{Sum} by the actual injection amount conversion factor γ after the actual fuel supply amount Q_{Sum} is calculated.

In accordance with the tenth embodiment described above, it is possible to calculate the actual injection amount Q_{A} of fuel injection for each cylinder 41, and to control the actual injection amount Q_{A} for each cylinder 41 to be closer to the target injection amount Q_{T}. Thus, the output control of the engine can be performed more accurately, and the vibration of the engine or engine noise can be suppressed.

The fuel supply passage pressure sensor S_{PS} does not have to be provided to each high pressure fuel supply passage 21A, 21B, 21B, 21B as in the case of the invention disclosed in Japanese Unexamined Patent Publication No. 2003-184632, and it is enough to provide only one fuel supply passage pressure sensor S_{PS} for a 4 cylinder diesel engine, which allows to reduce the number of parts of the fuel injection device and to reduce the cost thereof.

The tenth embodiment may be modified similarly to the modification of the eighth embodiment.

In the modification of the tenth embodiment, the fuel injection device 1K is replaced with a fuel injection device 1K′ and the ECU 80K is replaced with an ECU 80K′ in FIG. 41. The injection control unit 805K is replaced with an injection control unit 805K′, the actual fuel supply information detection unit 813H is replaced with an actual fuel supply information detection unit 813H′, and the actual fuel, injection information detection unit 814H is replaced with an actual fuel injection information detection unit 814H′ in FIG. 42.

The actual fuel injection information detection unit 814H′ also includes the calculation correction factor map 814a.

The two steps of Steps 40A and 40B are substituted for Step 40 of the flow chart shown in FIG. 36, and the two steps of Steps 47A and 47B are substituted for Step 47 of the flow chart shown in FIG. 36. The actual fuel injection information detection unit 814H in the explanation of the flow chart shown in FIG. 36 is replaced with an actual fuel injection information detection unit 814H′.

Similarly to the modification of the eighth embodiment, the modification of the tenth embodiment enables to eliminate the calculation error included in the actual fuel supply amount Q_{Sum}* supplied to the injector 5A through the high pressure fuel supply passage 21B at the time of the fuel injection to the second cylinder 41B or 41D that is obtained by the method for calculating the actual fuel supply amount Q_{Sum}* based on the initial pressure decrease of the great pressure variation in the common rail pressure Pc without using an orifice differential pressure.

### Another Modification of Tenth Embodiment

In the seventh to tenth embodiments and the modifications of the seventh to tenth embodiments, the fuel supply passage pressures sensors S_{PS} are provided in one or a few of the four high pressure fuel supply passages 21A on the downstream side of the orifice 75, however, embodiments are not limited to these embodiments, and the fuel supply passage pressure sensors S_{PS} may be provided in all of the four high pressure fuel supply passages 21 on the downstream side of the orifice 75.

In this case, the actual fuel supply amount Q_{Sum} can be calculated by the method shown in the flow charts in FIG. 27 or 34 (including the modification of the flow charts shown in FIG. 27 or 34 that are adapted to the back pressure injector 5B).

When fuel is injected to the cylinder 41, the orifice passing flow rate ΔQ_{OR} is calculated based on the fuel supply passage pressure Ps_{fil} of the high pressure fuel supply passage 21 which supplies fuel to the injector 5A or 5B of the cylinder 41 and the common rail pressure Pc, or on only the fuel supply passage pressure Ps_{fil}, and the orifice passing flow rate ΔQ_{OR} is time-integrated to obtain the actual fuel supply amount Q_{Sum}. The actual fuel supply amount Q_{Sum}* may be also calculated based on the pressure variation detected by the fuel supply passage pressure Ps_{fil} of the high pressure fuel supply passage 21 which supplies fuel to the injector 5A or 5B of another cylinder 41 that is different from the above cylinder 41, by the same method as the method shown in the flow chart in FIG. 28 (including the modification of the flow chart shown in FIG. 28 that is adapted to the back pressure injector 5B).

The calculated actual fuel supply amounts Q_{Sum} and the actual fuel supply amount Q_{Sum}* may be compared to detect the abnormality of the fuel supply passage pressures sensor S_{PS}.

### Eleventh Embodiment

A fuel injection device according to an eleventh embodiment of the present invention is described in detail with reference to FIGS. 2, 3A to 3D, and 44 to 49.

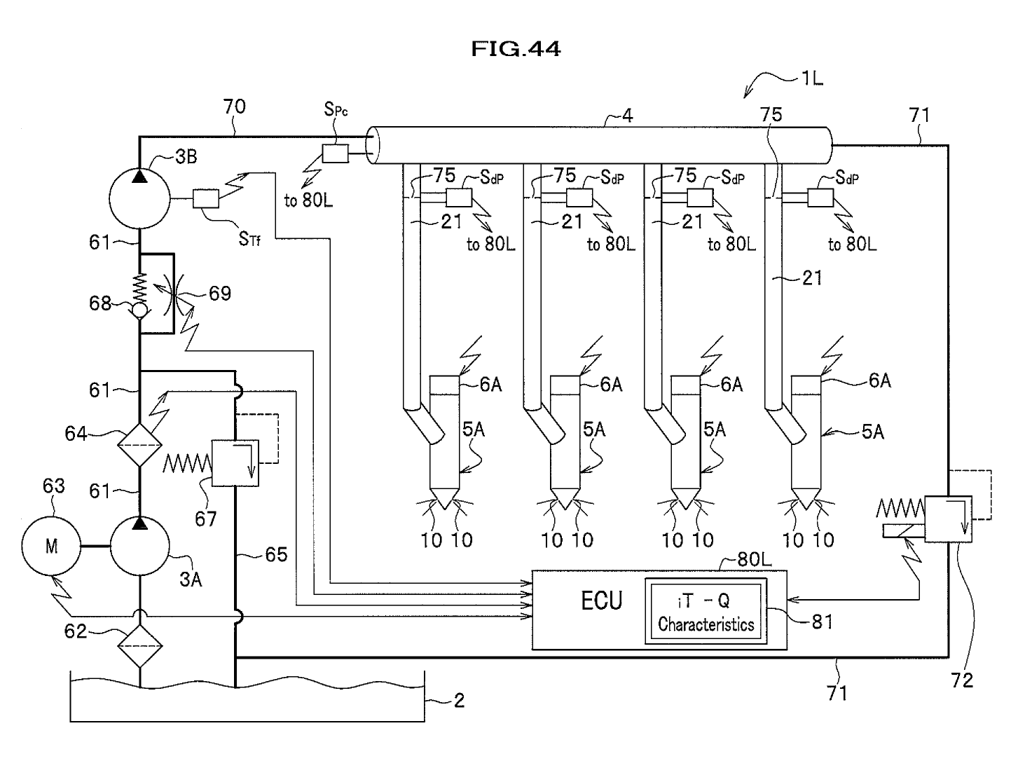

FIG. 44 is an illustration showing an entire configuration of the accumulator fuel injection device of the eleventh embodiment.

The configuration of a fuel injection device 1L according to the eleventh embodiment is based on that of the fuel injection device 1A of the first embodiment, and is different therefrom only in that the ECU 80A is replaced with an ECU 80L.

Components of the eleventh embodiment corresponding to those of the first embodiment are assigned like reference numerals, and descriptions thereof will be omitted.

The ECU 80L (see FIG. 44) of the eleventh embodiment calculates a torque required for the engine (not shown) based on the degree of throttle opening, and an engine rotation speed, etc. Then, the ECU 80L calculates a target injection amount Q_{T} as an injection amount needed to generate the torque required for the engine. The ECU 80L then calculates an injection time Tᵢ for which the injector 5A injects fuel by the target injection amount Q_{T}.

Thus, it is preferable to experimentally obtain the correlation of the target injection amount Q_{T} and the injection time Tᵢ (hereinafter, referred to as “Ti-Q characteristic”) in advance, and store it in a storage unit 81 of the ECU 80L, for example (see FIG. 44). With this configuration, the ECU 80L is allowed to obtain the injection time Tᵢ that corresponds to the calculated target, injection amount Q_{T}, by refereeing to the Ti-Q characteristic based on the calculated target injection amount Q_{T}.

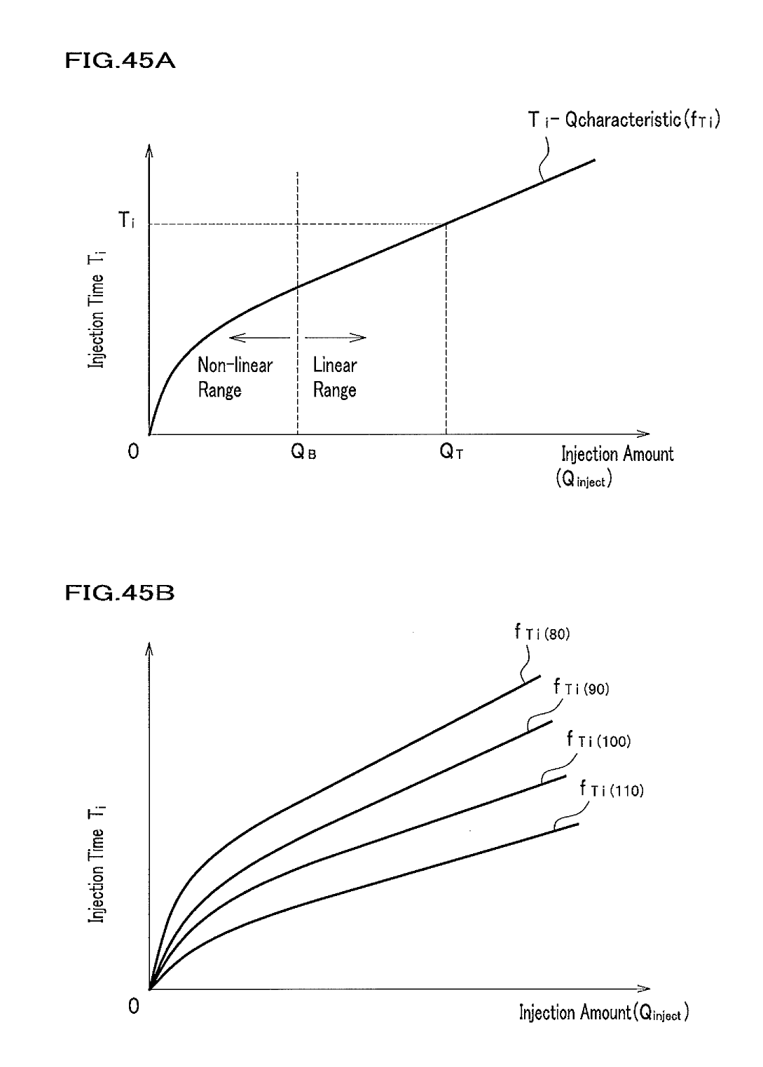

FIG. 45A is a graph showing an example of a Ti-Q characteristic curve f_{Ti}. The Ti-Q characteristic such as shown in FIG. 45A is based on the characteristic of the injector 5A, and can be obtained by experiments.

For example, the injection time Tᵢ which is needed to inject a predetermined target injection amount Q_{T} is measured by each injection amount Q_{inject}, and data representing the relationship between the injection amount Q_{inject} and the injection time Tᵢ is obtained discretely. Then, the obtained data is regression analyzed by a method such as the least-squire method to obtain a polynomial expression. Thus, the characteristic curve f_{Ti} which represents the Ti-Q characteristic can be obtained.

As described above, the Ti-Q characteristic according to the eleventh embodiment can be obtained with small measure data, which contributes to reduce the measuring man-hours.

The Ti-Q characteristic of the fuel injection device 1L according to the eleventh embodiment has a characteristic that the injection time Tᵢ is increased as the target injection amount Q_{T} increases as shown in FIG. 45A.

Further, it is found out that the polynomial expression representing the relationship of the target injection amount Q_{T} and the injection time Tᵢ is nonlinear, however, in a range where the injection amount Q_{inject} is great, the polynomial expression can be proximated to be a linear expression (linear polynomial). Thus, the Ti-Q characteristic in the eleventh embodiment, is represented as a linear polynomial in the range where the injection amount, Q_{inject} is great.

Hereinafter, in the Ti-Q characteristic the range where the relationship of the injection time Tᵢ and the Ti-Q characteristic injection amount Q_{inject} is represented as the linear polynomial is referred to as a “linear range”, and a range other than the “linear range” (i.e. the range where the polynomial expression is non-linear) is referred to as an “non-linear range”.

The injection amount Q_{B} which is the boundary of the “linear range” and the “non-linear range” can be obtained by experiments, for example.

The Ti-Q characteristic is varied corresponding to the common rail pressure Pc. FIG. 45B is a graph showing Ti-Q characteristics that correspond to common rail pressures.

It is preferable to obtain the Ti-Q characteristics of the injector 5A (see FIG. 44) by each discrete value of the common rail pressures Pc as shown in FIG. 45B. For example, representative pressure values of the common rail pressures Pc are set by 10 MPa, and the Ti-Q characteristic in each representative pressure value is experimentally obtained so that, the Ti-Q characteristic in each representative pressure value is represented as a polynomial expression.

The Ti-Q characteristic determined as described above is the regular injection amount, Q_{inject} of the injector 5A at, the representative pressure value.

Since the common rail pressure Pc is controlled by the ECU 80L to be a predetermined target pressure which is in a range of from 30 MPa to 200 MPa as described above, the Ti-Q characteristics are represented by a plurality of characteristic curves that corresponds to the common rail pressures Pc of from 30 MPa to 200 MPa. In FIG. 45B, characteristic curves f_{Ti (110)} to f_{Ti (80)} that correspond to the common rail pressures Pc of from 80 MPa to 110 MPa are described for explanation.

When obtaining the injection time Tᵢ that corresponds to the calculated target injection amount Q_{T}, the ECU 80L (see FIG. 44) refers to the characteristic curve f_{Ti} shown in FIG. 45B based on the calculated target injection amount Q_{T} and the common rail pressure Pc detected by the pressure sensor S_{Pc}. At this time, if the common rail pressure Pc is any of the representative pressure values taken by, for example, every 10 MPa, the injection time Tᵢ can be obtained by using the characteristic curve f_{Ti} indicating the common rail pressure Pc.

More specifically, the injection time Tᵢ is determined which corresponds to the intersection of the target injection amount Q_{T} and the characteristic curve f_{Ti}.

Even if the common rail pressure Pc is not any of the representative pressure values, the ECU 80L can obtain the injection time Tᵢ that corresponds to the common rail pressure Pc by interpolating the characteristic curve f_{Ti} of the representative pressure value which is close to the common rail pressure Pc.

As described above, the ECU 80L can obtain the injection time Tᵢ which corresponds to the target injection amount Q_{T} and the common rail pressure Pc by referring to the characteristic curve f_{Ti} of the Ti-Q characteristic.

However, if, for example, the seat surface 17a of the injector 5A (see FIG. 2) is time degraded and worn, the characteristic of the injector 5A (see FIG. 44) is changed, which may cause the regular injection amount Q_{inject} of the injector 5A of each representative pressure value to be shifted from the value indicated by the characteristic curve f_{Ti} of each representative pressure value of the Ti-Q characteristic. As a result, if the ECU 80L controls on/off of the injection command signal in accordance with the injection time Tᵢ obtained by the Ti-Q characteristic, the injector 5A may not inject fuel of the target injection amount Q_{T}, which may result in the increase of PM (particulate material), NOx or combustion noise.

In view of this problem, the ECU 80L of the eleventh embodiment is configured to calculate an actual injection amount Q_{A} based on an orifice differential pressure ΔP_{OR}, and correct the Ti-Q characteristic based on the calculated actual injection amount Q_{A} as needed.

A method for calculating an actual injection amount Q_{A} based on an orifice differential pressure ΔP_{OR} is the same as the method performed by the fuel injection device 1A of the first embodiment, which is explained by referring to FIGS. 3A to 3D.

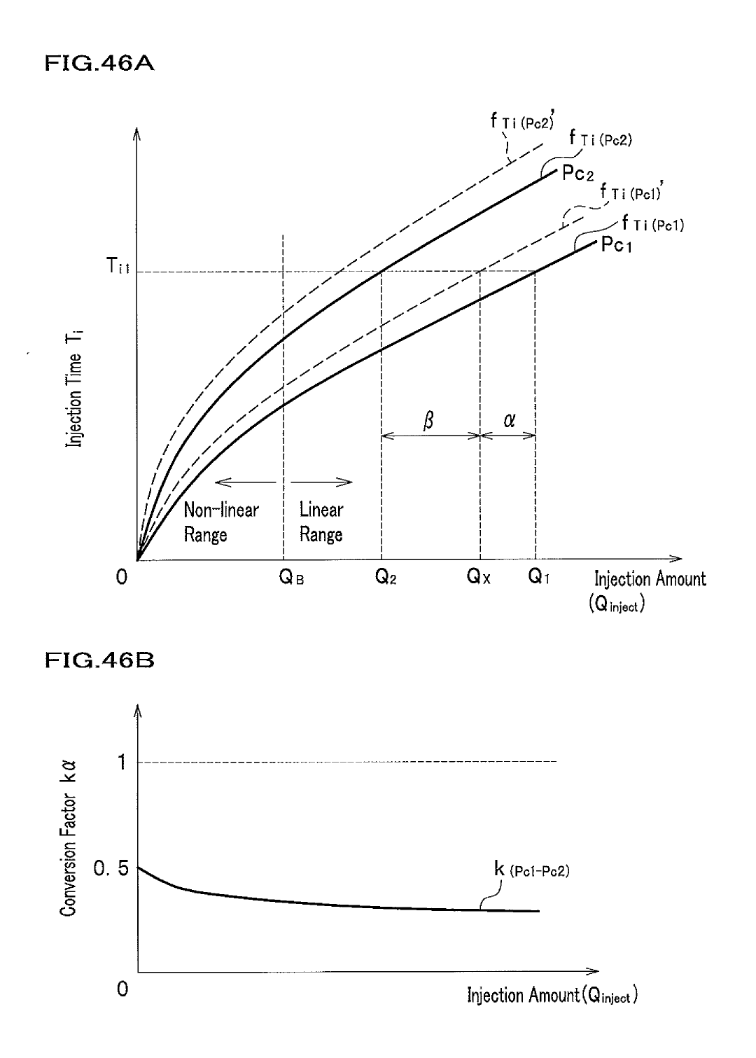

FIG. 46A is a graph showing characteristic curves showing the Ti-Q characteristic of which common rail pressures are the representative pressure values Pc₁ and Pc₂. FIG. 46B is a graph showing the correlation of the adjacent characteristic curves.

Among a plurality of the characteristic curves f_{Ti} showing the Ti-Q characteristic in FIG. 45B, characteristic curves of which representative pressure values are adjacent (e.g. 100 MPa and 110 MPa) are referred to as the adjacent characteristic curves, such as the characteristic curve f_{Ti (100)} and the characteristic curve f_{Ti(110)}.

Correlation equation representing the correlation of polynomial expressions of the adjacent characteristic curves is referred to as “the correlation equation representing the correlation of the characteristic curves”

In the eleventh embodiment, as for the characteristic curve f_{Ti (Pc1)} showing the Ti-Q characteristic of the common rail pressure Pc, and the characteristic curve f_{Ti (Pc2)} showing the Ti-Q characteristic of the common rail pressure Pc2 shown in FIG. 46A, a correlation equation k_{(Pc1-Pc2)} representing the correlation of the characteristic curve f_{Ti (Pc1)} and the characteristic curve f_{Ti (Pc2)} is calculated as the function of the injection amount Q_{inject} in advance as shown in FIG. 46B, and the correlation equation k_{(Pc1-Pc2)} is stored in the storage unit 81 (see FIG. 44) of the ECU 80L.

Such a correlation equation k_{(Pc1-Pc2)} is the ratio of the characteristic curve f_{Ti (Pc1)} and the characteristic curve f_{Ti (Pc2)} by each injection amount Q_{inject} in the eleventh embodiment. More specifically, the correlation equation k_{(Pc1-Pc2)} can be obtained by calculating the ratio of the characteristic curve f_{Ti (Pc1)} and the characteristic curve f_{Ti (Pc2)} by each injection amount Q_{inject}, and mathematizing the calculated ratios.

The eleventh embodiment is configured to calculate in advance all the correlation equation k showing correlations of all adjacent characteristic curves.

The conversion factor kα shown in FIG. 46B is the value showing the ratio of the adjacent characteristic curves f_{Ti}, and is calculated by the correlation equation k.

If the regular injection amount of the injector 5A is Q₁ at the time when the common rail pressure is the representative pressure value Pc₁ and the injection time is the injection time Tᵢ₁, and an actual injection amount, which is obtained by time-integrating the orifice passing flow rate Q_{OR} calculated by the ECU 80L (see FIG. 44) based on the orifice differential pressure ΔP_{OR} is Q_{X} as shown in FIG. 46A, the injection amount of the injector 5A (see FIG. 44) is decreased by (Q₁−Q_{X}), which means the decrease of fuel injected to the cylinder of the engine (not shown).

In view of the problem, the ECU 80L (see FIG. 44) of the eleventh embodiment is configured to calculate the orifice passing flow rate Q_{OR} based on the orifice differential pressure ΔP_{OR} by using the equation (1), and to correct the Ti-Q characteristic based on the value Q_{X} of the actual injection amount Q_{A} which is calculated from the orifice passing flow rate Q_{OR}.

For example, the ECU 80L (see FIG. 44) obtains Q_{X} as the actual injection amount Q_{A}, which corresponds to the regular injection amount Q₁ calculated under the condition of the representative pressure value Pc₁ and the injection time Tᵢ₁.

Furthermore, the ECU 80L calculates the regular injection amount Q₂ under the condition that the common rail pressure is the representative pressure value Pc₂ and the injection time is the injection time Tᵢ₁ based on the characteristic curve f_{Ti (Pc2)} of which representative pressure value Pc₂ is adjacent to the common rail pressure Pc₁. The ECU 80L then calculates a correction amount Δf by the following equation (6).

$$Δ f = \frac{α}{α + β} \qquad ( 6 )$$

where α represents the difference (Q₁−Q_{X}) between the regular injection amount Q₁ determined by the condition of the common rail pressure Pc₁ and the injection time Tᵢ₁ and the value Q_{X} of the actual injection amount Q_{A}, and β represents the difference (Q_{X}−Q₂) between the value Q_{X} of the actual injection amount Q_{A} injected for the injection time Tᵢ₁ and the regular injection amount Q₂ determined by the condition that the common rail pressure is the representative pressure value Pc₂ and the injection time is the injection time Tᵢ₁.

The ECU 80L (see FIG. 44) multiplies the injection amounts Q_{inject} of all the injection times Tᵢ of the characteristic curve f_{Ti (Pc1)} by the correction amount Δf to obtain a characteristic curve f_{Ti (Pc1)}′, which is corrected from the characteristic curve f_{Ti (Pc1)}.

As for the characteristic curve f_{Ti (Pc2)} which is adjacent to the characteristic curve f_{Ti (Pc1)}, the injection amounts Q_{inject} of all the injection times Tᵢ are also multiplied by the correction amount Δf to obtain a characteristic curve f_{Ti (Pc2)}′ which is corrected from the characteristic curve f_{Ti (Pc2)}.

Similarly, as for the other characteristic curves f_{Ti}, each injection amount Q_{inject} is multiplied by the correction amount Δf to obtain corrected characteristic curves f_{Ti}′. Thus the Ti-Q characteristic can be corrected.

As described above, by obtaining the value Q_{X} of the actual injection amount Q_{A} for one representative pressure value Pc₁, it is possible to correct all ranges of the Ti-Q characteristics. To be more specific, the ECU 80L is allowed to correct all ranges of the Ti-Q characteristics based on the correction of the characteristic curve f_{Ti}.

For example, if the common rail pressure Pc is not the representative pressure value when the injection amount Q_{X} is calculated, the ECU 80L (see FIG. 44) can correct the Ti-Q characteristic as follows based on the value Q_{X} of the actual injection amount Q_{A}.

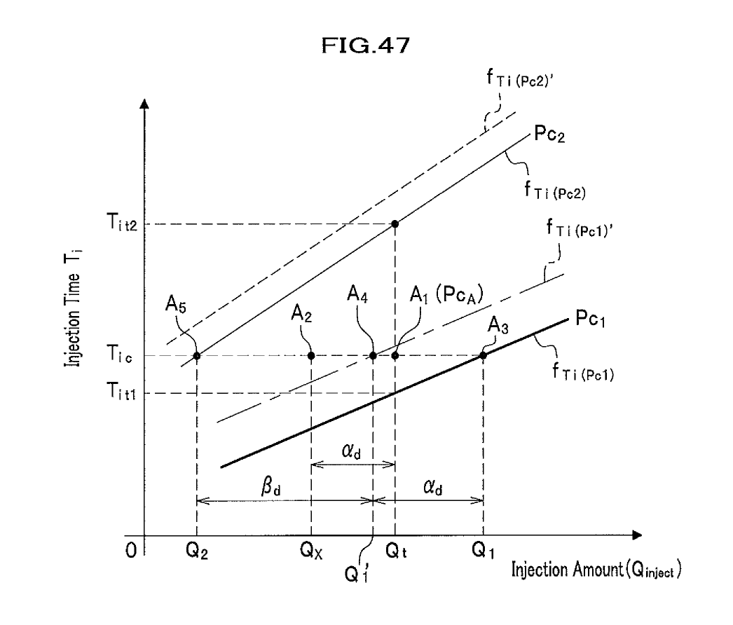

FIG. 47 is a graph for correcting the characteristic curve of the Ti-Q characteristic.

As shown in FIG. 47, if the common rail pressure detected by the pressure sensor S_{Pc} (see FIG. 44) is Pc_{A} (shown as the point A₁) which is between the two representative pressure values Pc₁ and Pc₂, the ECU 80L (see FIG. 44) calculates the injection time T_{iC} which corresponds to the target injection amount Q_{T} at the time when the common rail pressure is Pc_{A}, by, for example, prorating the injection times Tᵢₜ₁ and Tᵢₜ₂, which are obtained by the characteristic curves f_{Ti (Pc1)} and f_{Ti (Pc2)} of the representative pressure values Pc₁ and Pc₂.

In other words, the characteristic curve f_{Ti (Pc1)} and the characteristic curve f_{Ti (Pc2)} are interpolated to obtain the injection time T_{iC} at the common rail pressure Pc_{A}.

When the ECU 80L (see FIG. 44) controls ON/OFF of the injection command signal to inject fuel from the injector 5A (see FIG. 44) in accordance with the injection time T_{iC} obtained as above, if the value Q_{X} of the actual injection amount Q_{A} calculated based on the orifice passing flow rate Q_{OR} is different from the target injection amount Q_{T} and is decreased by the decrease amount α_{d}, which is represented as “Q_{T}−Q_{X}” (shown as “point A₂”), the ECU 80L corrects the characteristic curve f_{Ti (Pc1)}.

Specifically, the ECU 80L (see FIG. 44) calculates the decrease amount α_{d} of the injection amount. Furthermore, the ECU 80L calculates, as shown in FIG. 47, the regular injection amount Q₁ of the injector 5A (see FIG. 44) at the time when the common rail pressure is the representative pressure value Pc₁ and the injection time is the injection time T_{iC}, based on the characteristic curve f_{Ti (Pc1)}. In short, the ECU 80L calculates the injection amount Q₁ at the point A₃.

The ECU 80L assumes that the regular injection amount Q₁ at the point A₃ is also decreased by the decrease amount α_{d}, and calculates the injection amount Q₁′ (shown as the point A₄), which is decreased from the regular injection amount Q₁′ at the injection time T_{iC} by the decrease amount α_{d}.

Furthermore, the ECU 80L calculates the regular injection amount Q₂ at the time when the common rail pressure is the representative pressure value Pc₂ and the injection time is the injection time T_{iC} (i.e. the regular injection amount Q₂ at the point A₅) based on the characteristic curve f_{Ti (Pc2)} of which representative pressure value Pc₂ is adjacent to the representative pressure value Pc₁.

The ECU 80L then calculates the correction amount Δf_{d} by the following equation (7).

$$Δ {f}_{d} = \frac{{α}_{d}}{{α}_{d} + {β}_{d}} \qquad ( 7 )$$

where α_{d} is the decrease amount described above, and β_{d} is the difference (Q₁′−Q₂) between the injection amount Q₁′ which is decreased by the decrease amount α_{d} from the regular injection amount Q₁ at the injection time T_{iC} on the characteristic curve f_{Ti (Pc1)} and the regular injection amount Q₂ determined under the condition that the injection time is the injection time T_{iC} and the common rail pressure is the representative pressure value Pc₂.

The ECU 80L (see FIG. 44) multiplies the injection amounts Q_{inject} of all the injection times Tᵢ on the characteristic curve f_{Ti (Pc1)} by the correction amount Δf_{d} to obtain the characteristic curve f_{Ti (Pc1)}′ which is corrected from the characteristic curve f_{Ti (Pc1)}.

As for the characteristic curve f_{Ti (Pc2)} which is adjacent to the characteristic curve f_{Ti (Pc1)}, the injection amounts Q_{inject} of all the injection times Ti are also multiplied by the correction amount Δf_{d} to obtain a characteristic curve f_{Ti (Pc2)}′ which is corrected from the characteristic curve f_{Ti (Pc2)}.

Similarly, as for the other characteristic curves f_{Ti}, each injection amount Q_{inject} is multiplied by the correction amount Δf_{d} to obtain corrected characteristic curves f_{Ti}′. Thus, the Ti-Q characteristic can be corrected.

As described above, by obtaining the actual injection amount Q_{A} for one common rail pressure Pc_{A}, it is possible to correct all ranges of the Ti-Q characteristics. To be more specific, the ECU 80L is allowed to correct all ranges of the Ti-Q characteristics based on the correction of the characteristic curve f_{Ti}.

As for the Ti-Q characteristic of the eleventh embodiment, since the correlation equation k showing the correlation of the adjacent characteristic curves f_{Ti} is obtained in advance as described above, after one characteristic curve f_{Ti} is corrected, another characteristic curve f_{Ti} may be corrected by using the correlation equation k.

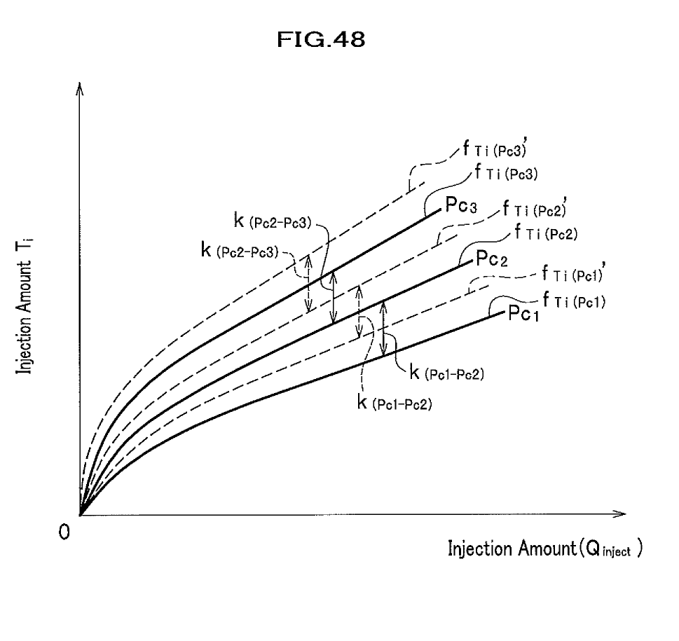

FIG. 48 is a graph for correcting the Ti-Q characteristic based on the correlation equation. In the case where, there are the characteristic curves f_{Ti (Pc1)}, f_{Ti (Pc2)} and f_{Ti (Pc3)} of which representative pressure values are the common rail pressures Pc₁, Pc₂ and Pc₃ as the Ti-Q characteristic as shown in FIG. 48, the operation for correcting the characteristic curve f_{Ti (Pc1)} to a characteristic curve f_{Ti (Pc1)}′, which is shown as a dashed line, is described.

As described above, in the eleventh embodiment, the correlation equation k_{(Pc1-Pc2)} showing the correlation of the characteristic curve f_{Ti (Pc1)} and the characteristic curve f_{Ti (Pc2)} is calculated in advance, and is stored in the storage unit 81 (see FIG. 44) of the ECU 80L. Similarly, the correlation equation k_{(Pc2-Pc3)} showing the correlation of the characteristic curve f_{Ti (Pc2)} and the characteristic curve f_{Ti (Pc3)} is obtained in advance, and is stored in the storage unit 81 of the ECU 80L.

Thus, the ECU 80L (see FIG. 44) can obtain a characteristic curve f_{Ti (Pc2)}′ which can be regarded as being corrected from the characteristic curve f_{Ti (Pc2)} by multiplying the characteristic curve f_{Ti (Pc1)}′ which is corrected from the characteristic curve f_{Ti (Pc1)} by the conversion factor kα which is calculated by the correlation equation k_{(Pc1-Pc2)} for each injection amount Q_{inject}. Further, the ECU 80L can obtain the characteristic curve f_{Ti (Pc3)}′ which can be regarded as being corrected from the characteristic curve f_{Ti (Pc3)} by multiplying the characteristic curve f_{Ti (Pc2)}′ by the conversion factor kα which is calculated by the correlation equation k_{(Pc2-Pc3)} for each injection amount Q_{inject}.

In short, the characteristic curve f_{Ti (Pc2)}′ can be obtained by multiplying the characteristic curve f_{T1(Pc1)}′ by the correlation equation k_{(Pc1-Pc2)}, and the characteristic curve f_{Ti (Pc3)}′ can be obtained by multiplying the characteristic curve f_{Ti(Pc2)}′ by the correlation equation k_{(Pc2-Pc3)}.

FIG. 48 is a graph showing the correction of the three characteristic curves f_{Ti}. Even if there are more than the three characteristic curves f_{Ti} for the Ti-Q characteristic, the ECU 80L (see FIG. 44) can correct all the characteristic curves f_{Ti} one by one, which allows to correct all the ranges of the Ti-Q characteristic.

As described above, the ECU 80L (see FIG. 44) is allowed to correct all the characteristic curves f_{Ti} of the Ti-Q characteristic, by using the correlation equation k which shows the correlation of the adjacent characteristic curves f_{Ti}. Thus, the ECU 80L can preferably correct the Ti-Q characteristic.

Thus, since the ECU 80L (see FIG. 44) of the eleventh embodiment can accurately calculate the orifice passing flow rate Q_{OR} based on the orifice differential pressure ΔP_{OR} of the orifice 75 (see FIG. 44), the ECU 80L can accurately calculate the actual injection amount Q_{A} of the injector 5A (see FIG. 44).

Therefore, the ECU 80L can accurately correct the Ti-Q characteristic based on the actual injection amount Q_{A}.

Thus, the injector 5A can accurately inject fuel of the target injection amount Q_{T} to a cylinder of the engine (not shown), which preferably suppresses the increase of the PM (particulate material), NOx or combustion noise.

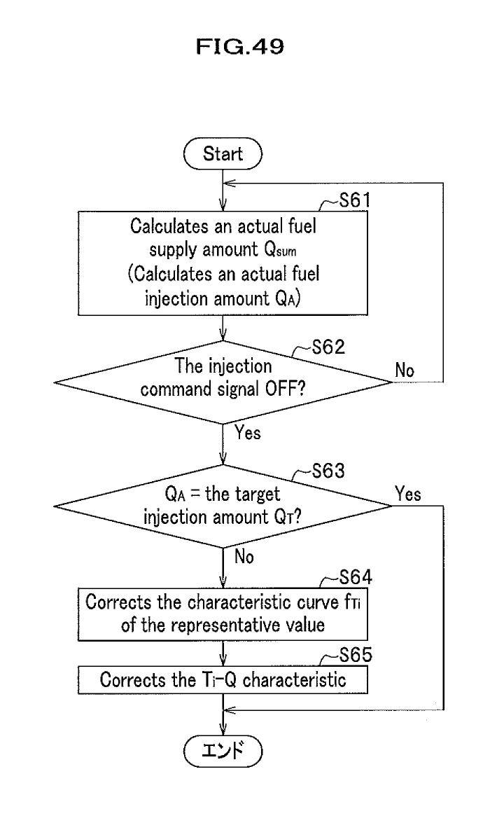

FIG. 49 is a flow chart showing the operational flow performed by the ECU 80L for correcting the Ti-Q characteristic. The operational flow performed by the ECU 80L (see FIG. 44) for correcting the Ti-Q characteristics is explained with reference to FIG. 49 (see FIGS. 44 to 48 as appropriate).

The operational flow performed by the ECU 80L for correcting the Ti-Q characteristic is just referred to as “correction operation”, hereinafter.

The correction operation may be incorporated in a subroutine of a program executed by the ECU 80L, and may be executed by the ECU 80L when the injection command signal for the injector 5A is turned “ON”. Thus, at the time when the correction operation is executed, the ECU 80L has already calculated the target injection amount Q_{T} based on the degree of throttle opening and the engine rotation speed.

The ECU 80L calculates the injection time Tᵢ based on the target injection amount Q_{T} and the common rail pressure Pc detected by the pressure sensor S_{Pc}.

The ECU 80L starts the correction operation when the injection command signal is turned “ON”, calculates the orifice passing flow rate Q_{OR} based on the orifice differential pressure ΔP_{OR} by using the equation (1), and calculates the actual fuel supply amount Q_{Sum} which is the orifice passing flow amount by time-integrating the orifice passing flow rate Q_{OR} (Step 61). As the injector 5A of the eleventh embodiment is a direct-type, the actual fuel supply amount Q_{Sum} can be regarded as the actual injection amount Q_{A} of the injector 5A. Thus, the ECU 80L calculates the actual injection amount Q_{A}.

By the time the injection command signal is turned “OFF” after the injection time Tᵢ is lapsed, the ECU 80L repeats the processing of Step 61 in which the orifice passing flow rate Q_{OR} is calculated. When the injection command signal is turned “OFF”, the ECU 80L compares the target injection amount Q_{T} with the calculated actual injection amount Q_{A} (Step 63).

More specifically, the ECU 80L calculates the orifice passing flow rate Q_{OR} until the injection time Tᵢ passes after the injection command signal is turned “ON”, and calculates the actual injection amount Q_{A} from the orifice passing flow rate Q_{OR} to be compared with the target injection amount Q_{T}.

If the actual injection amount Q_{A} and the target injection amount Q_{T} are equal (Step 63→Yes), the ECU 80L exits the correction operation. If the correction operation is executed by a subroutine, the ECU 80L returns to the execution of the main routine.

If the actual injection amount Q_{A} and the target injection amount Q_{T} are not equal (Step 63→No), the ECU 80L corrects the characteristic curve f_{Ti} whose representative pressure value is the closest to the common rail pressure Pc as shown in FIGS. 46A and 46B and 47 (Step 64).

Furthermore, the ECU 80L corrects all the characteristic curves f_{Ti} of the Ti-Q characteristic based on the corrected characteristic curve f_{Ti} as shown in FIG. 46A, 46B, 47 or 48. The ECU 80L corrects the Ti-Q characteristic (Step 45).

The above described correction of the Ti-Q characteristic is based on the characteristic change of the injector 5A. The ECU 80L can calculate the injection time Tᵢ which compensates the characteristic change of the injector 5A by referring to the corrected Ti-Q characteristic when calculating the injection time Tᵢ that corresponds to the target injection amount Q_{T}.

Thus, even if the seat surface 17a (see FIG. 2) is worn due to time-degradation, and the characteristic of the injector 5A is changed, the ECU 80L can accurately inject fuel of the target injection amount Q_{T} to a cylinder of the engine (not shown), which allows to preferably suppress the increase of the PM (particulate material), NOx or combustion noise.

In accordance with the eleventh embodiment, it is easy to accurately form the diameter of the opening of the orifice 75 (see FIG. 44), and the orifice differential, pressure ΔP_{OR} between the upstream side and the down stream side of the orifice 75 is greater than the differential pressure between the upstream side and the downstream side of the venturi constriction. Thus, the orifice passing flow rate Q_{OR} is easily calculated based on the orifice differential pressure ΔP_{OR} detected by the differential pressure sensor S_{dP} by using the equation (1).

In the case of the direct acting injector 5A (see FIG. 44), the actual injection amount Q_{A} can be readily calculated by time-integrating the orifice passing flow rate Q_{OR}, which allows to accurately calculate the actual, injection amount Q_{A}.

Even if the injectors 5A (see FIG. 44) are varied due to manufacturing tolerance, it is possible to calculate an actual injection amount Q_{A} that reflects the variation of the injectors 5A due to the manufacturing tolerance. Thus, the ECU 80L (see FIG. 44) can accurately correct the Ti-Q characteristic based on the calculated actual injection amount Q_{A} and the target injection amount Q_{T}.

As a result, the injector 5A can accurately inject fuel of the target injection amount Q_{T} to the cylinder of the engine (not shown), which allows to preferably suppress the increase of the PM (particulate material), NOx or combustion noise.

The orifice differential pressure ΔP_{OR} can be detected by the differential pressure sensor S_{dP} even if the pressure on the upstream side of the orifice is varied by the variation of the common rail pressure Pc, which allows the ECU 80L to accurately calculate the orifice passing flow rate Q_{OR}.

Thus, the ECU 80L can accurately calculate the actual injection amount Q_{A} even if the common rail pressure Pc is varied.

Therefore, even if the common rail pressure Pc is varied, the ECU 80L can accurately correct the Ti-Q characteristic.

The fuel injection of the injector 5A is generally multi-injection including “Pilot injection”, “Pre injection”, “After injection” and “Post injection” in order to reduce PM (particulate material), NOx or a combustion noise and to increase exhaust temperature or to activate catalyst by supplying a reducing agent.

If each injector can not inject fuel of the target injection amount Q_{T} in the multi-injection, a regulated value of an exhaust gas from the engine may not be kept.

Even if the seat surface 17a (see FIG. 2) is worn due to time-degradation, and the characteristic of the injector 5A is changed such that the injector can not inject fuel of the target injection amount Q_{T} (i.e. a defined amount of the actual injection amount Q_{A}), the ECU 80L can correct the Ti-Q characteristic to adapt to the characteristic change of the injector 5A by executing the correction operation, which allows the injector to inject fuel of the target injection amount Q_{T}.

As a result, it becomes easier to keep the regulated value of an exhaust gas even if requirement on hardware specifications, such as dimension tolerance of each part of the engine system, is relaxed. Especially, requirement on the hardware specification for injectors can be relieved, which contributes to reduction of the manufacturing cost of the engine system.

### Twelfth Embodiment

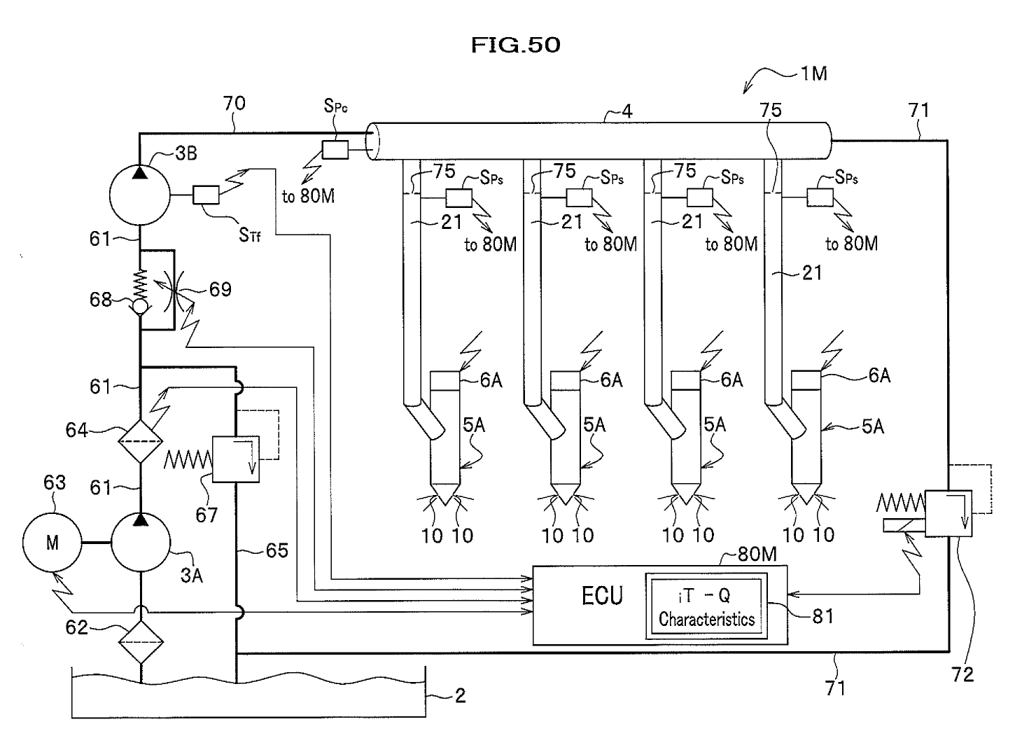

Next, a twelfth embodiment of the present invention is described in detail with reference to FIG. 50.

FIG. 50 is an illustration showing the entire configuration of an accumulator fuel injection device of the twelfth embodiment.

A fuel injection device 1M of the twelfth embodiment is different from the fuel injection device 1L shown in FIG. 44 in the following points: (1) a pressure sensor (fuel supply passage pressure sensor) S_{Ps} for detecting the pressure of the downstream side of the orifice 75 is provided instead of the differential pressure sensor S_{dP} which is provided in the high pressure fuel supply passage 21 for supplying fuel to the injector 5A attached to each cylinder of the engine and detects the pressure difference between the upstream side and the downstream side of the orifice 75; (2) an ECU (control unit) 80M is provided instead of the ECU 80L; and (3) the definition of the orifice differential pressure ΔP_{OR} which is used for calculating the orifice passing flow rate Q_{OR} of fuel in the ECU 80M is changed.

Components of the twelfth embodiment corresponding to those of the eleventh embodiment are assigned like reference numerals, and descriptions thereof will be omitted.

As shown in FIG. 50, pressure signals detected by the four pressure sensors S_{Ps} are input to the ECU 80M.

The function of the ECU 80M according to the twelfth embodiment is basically the same as that of the ECU 80L according to the eleventh embodiment, however, signals used by the ECU 80M to calculate the orifice passing flow rate Q_{OR} are different from those used in the eleventh embodiment.

In the eleventh embodiment, the orifice passing flow rate Q_{OR} is calculated based on the orifice differential pressure ΔP_{OR} by using the equation (1). In the twelfth embodiment, the orifice differential pressure ΔP_{OR} in the equation (1) is replaced by the pressure difference (Pc−Ps) between the common rail pressure Pc which is detected by the pressure sensor S_{Pc} and the pressure Ps on the downstream side of the orifice 75, which is detected by the pressure sensor S_{Ps}.

It is obvious that the pressure on the upstream side of orifice 75 in the high pressure fuel supply passage 21 is substantially equal to the common rail pressure Pc. Thus, even if the orifice differential pressure ΔP_{OR} in the equation (1) is replaced by the pressure difference (Pc−Ps), an orifice passing flow rate Q_{OR} of fuel (i.e. an actual injection amount) can be accurately calculated for each cylinder, and an actual injection amount Q_{A} of the injector 5A can be also calculated for each cylinder based on the orifice passing flow rate Q_{OR} in the twelfth embodiment, similarly to the eleventh embodiment.

The ECU 80M of the twelfth embodiment is allowed to accurately correct the Ti-Q characteristic based on the target injection amount Q_{T} and the actual injection amount Q_{A} by executing the correction operation shown in FIG. 49, similarly to the ECU 80L of the eleventh embodiment.

Thus, the injector 5A can accurately inject fuel of the target injection amount Q_{T} to a cylinder of the engine (not shown), which allows to preferably suppress the increase of PM (particulate material), NOx or a combustion noise.

Similarly to the eleventh embodiment, it becomes easier to keep the regulated value of an exhaust gas even if requirement on hardware specifications, such as dimension tolerance of each part of the engine system, is relaxed. Especially, requirement on the hardware specification for injectors can be relieved, which contributes to reduction of the manufacturing cost of the engine system.

Advantages of the twelfth embodiment which are the same as those of the eleventh embodiment are omitted, and thus refer to the advantages of the eleventh embodiment for them.

### Thirteenth Embodiment

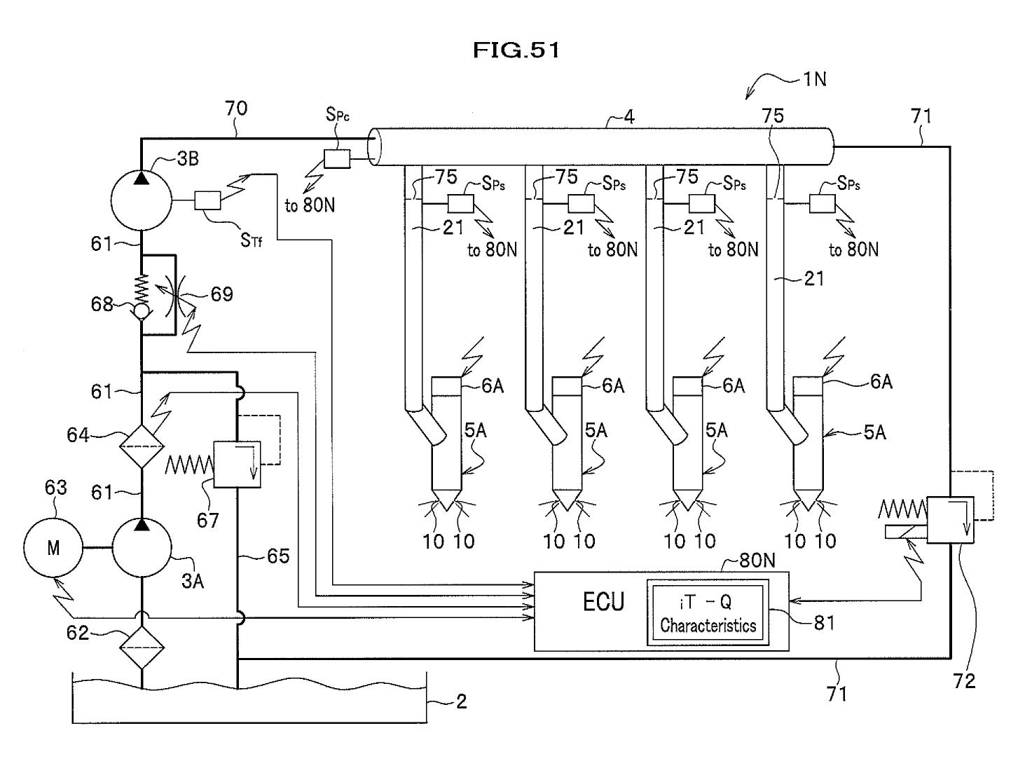

Next, a fuel injection device according to a thirteenth embodiment of the present invention is described in detail with reference to FIG. 51.

FIG. 51 is an illustration for showing an entire configuration of the accumulator fuel injection device of the thirteenth embodiment.

A fuel injection device 1N of the thirteenth embodiment is different from the fuel injection device 1M of the twelfth embodiment in the following points: (1) an ECU (control unit) 80N is provided instead of the ECU 80M; (2) a pressure sensor S_{Ps} is provided instead of the pressure sensor S_{Pc} for calculating the orifice passing flow rate Q_{OR}; and (3) a method performed by the ECU 80N for calculating the orifice passing flow rate Q_{OR} of fuel is changed from the method performed by the ECU 80M.

Components of the fuel injection device 1M of the thirteenth embodiment corresponding to those of the fuel injection device 1L of the twelfth embodiment are assigned like reference numerals, and descriptions thereof will be omitted.

As shown in FIG. 51, pressure signals detected by the four pressure sensors S_{Ps} are input to the ECU 80N.

The ECU 80N performs a filtering process on the pressure signals input from the pressure sensors S_{Ps} for cutting off a noise with a high frequency.

The pressure Ps on the downstream side of the orifice 75 on which the filtering process has been performed is refereed to as a pressure Ps_{fil}.

The ECU 80N of the thirteenth embodiment uses the pressure Ps_{fil} which is detected by the pressure sensor S_{Ps} on the downstream side of the orifice 75 and is filtering processed to calculate the orifice passing flow rate Q_{OR}. Then, the calculated orifice passing flow rate Q_{OR} is time-integrated to obtain the actual injection amount Q_{A} of the injector 5A.

The flow chart showing the control flow for calculating the actual injection amount Q_{A} in the thirteenth embodiment is the same as that of the third embodiment shown in FIG. 6, and the description thereof will be omitted.

The ECU 80N executes the control flow shown in FIG. 6 instead of Steps 61 and 62 in FIG. 49 when executing the correction operation, so that the actual injection amount Q_{A} is calculated.

In accordance with the thirteenth embodiment, the actual injection amount Q_{A} can be calculated by using the pressure value detected by the pressure sensor S_{Ps} which detects the pressure Ps on the downstream side of the orifice 75.

It is also possible to accurately calculate the actual injection amount Q_{A} for each cylinder, based on the equation (1) in which the pressure difference (P₀−Ps_{fil}) between the predetermined value P0 and the pressure Ps_{fil} is substituted for the orifice differential pressure ΔP_{OR} by using only the pressure signal from the pressure sensor S_{Ps} for detecting the pressure on the downstream side of the orifice 75.

Similarly to the eleventh embodiment and the twelfth embodiment, the ECU 80N can accurately correct the Ti-Q characteristic based on the target injection amount Q_{T} and the actual injection amount Q_{A}.

Thus, the injector 5A is allowed to inject fuel of the target injection amount Q_{T} to a cylinder of the engine (not shown), which allows to preferably suppress the increase of the PM (particulate material), NOx or a combustion noise.

Similarly to the eleventh embodiment, it becomes easier to keep the regulated value of an exhaust gas even if requirement on hardware specifications, such as dimension tolerance of each part of the engine system, is relaxed. Especially, requirement on the hardware specification for injectors can be relieved, which contributes to reduction of the manufacturing cost of the engine system.

Advantages of the thirteenth embodiment which are the same as those of the eleventh embodiment are omitted, and thus refer to the advantages of the eleventh embodiment for them.

### Fourteenth Embodiment

A fuel injection device of a fourteenth embodiment of the present invention is explained in detail with reference to FIGS. 11, 12A to 12D and 52.

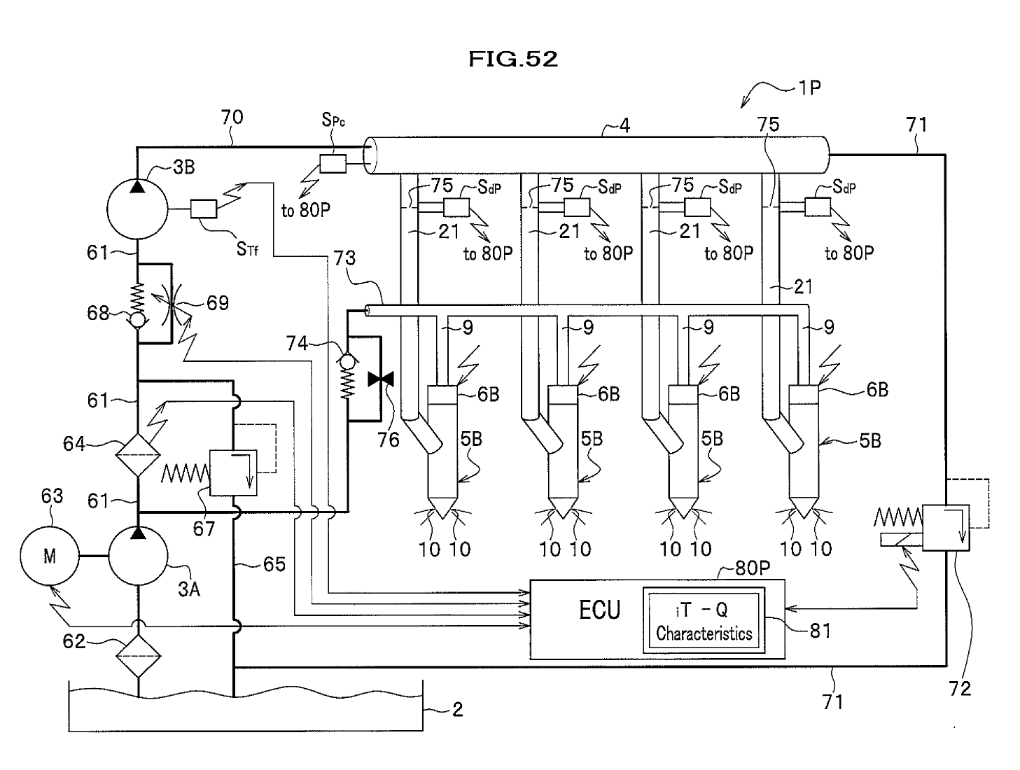

FIG. 52 is an illustration showing an entire configuration of an accumulator fuel injection device of the fourteenth embodiment. FIG. 11 is a conceptional configuration drawing of a back pressure fuel injection valve (injector) which is used in the accumulator fuel injection device according to the fourteenth embodiment.

The injector 5B, which is a back pressure fuel injection valve, is the same as the injector 5B of the fourth embodiment, which has been explained with reference to FIG. 11, and thus the description thereof will be omitted.

A fuel injection device 1P of the fourteenth embodiment differs from the fuel injection device 1L of the eleventh embodiment in that: (1) an injector 5B including an actuator 6B, which is a back pressure fuel injection valve, is used; (2) in accordance with (1), a drain passage 9 is connected to the injector 5B provided in each cylinder, and the drain passages 9 are further connected to a return fuel pipe 73, which is connected to the low pressure fuel supply passage 61 on the discharge side of the low pressure pump 3A via a flow controller in which a check valve 74 and the orifice 76 are connected in parallel; and (3) the fuel injection device 1P in the fourteenth embodiment is controlled by the ECU (control unit) 80P.

Components of the fourteenth embodiment corresponding to those of the eleventh embodiment are assigned like reference numerals, and descriptions thereof will be omitted.

A method for calculating the actual injection amount Q_{A} based on the orifice differential pressure ΔP_{OR} according to the fourteenth embodiment is the same as the method performed by the fuel injection device 1D of the fourth embodiment using the actual injection amount conversion factor γ, which has been defined by using FIGS. 12A to 12D and the equation (2).

Thus, similarly to the eleventh embodiment, the ECU 80P according to the fourteenth embodiment can execute the correction operation shown in FIG. 49 and accurately correct the Ti-Q characteristic based on the target injection amount Q_{T} and the actual injection amount Q_{A} even in the case of the fuel injection device 1P including the back pressure injector 5B.

Thus, similarly to the eleventh embodiment, the injector 5B can accurately inject fuel of the target injection amount Q_{T} to a cylinder of the engine (not shown), which allows to preferably suppress the increase of PM (particulate material), NOx or a combustion noise.

In accordance with the fourteenth embodiment, it is easy to accurately form the diameter of the opening of the orifice 75 (see FIG. 52), and the orifice differential pressure ΔP_{OR} between the upstream side and the down stream side of the orifice 75 is greater than the differential pressure between the upstream side and the down stream side of the venturi constriction. Thus, the orifice passing flow rate Q_{OR} is easily calculated based on the orifice differential pressure ΔP_{OR} detected by the differential pressure sensor S_{dP} by using the equation (1).

By calculating the orifice passing flow rate Q_{OR} based on the orifice differential pressure ΔP_{OR}, time-integrating the orifice passing flow rate Q_{OR}, and multiplying the value obtained by time-integrating the orifice passing flow rate Q_{OR} by the actual injection amount conversion factor γ, it is possible to accurately calculate an actual fuel supply amount to the injector 5B.

Even if the orifice passing flow amount Qₛᵤₘ, which is the summation of the back flow amount and the actual injection amount, is varied among the injectors 5B for the same injection command signal waveform due to the manufacturing tolerance of the injectors 5B, it is possible to calculate the actual fuel supply amounts that reflect the variation of the injectors 5B duo to the manufacturing tolerance. Thus, the ECU 80P (see FIG. 52) can accurately correct the Ti-Q characteristic based on the actual injection amount Q_{A} and the target injection amount Q_{T}.

As a result, the injector 5B (see FIG. 52) can accurately inject fuel of the target injection amount Q_{T} to a cylinder of the engine, which allows to preferably suppress the increase of PM (particulate material), NOx or a combustion noise.

Similarly to the eleventh embodiment, the ECU 80P (see FIG. 52) can detect the orifice differential pressure ΔP_{OR} by the differential pressure sensor S_{dP} even if the pressure on the upstream side of the orifice is varied by the variation of the common rail pressure Pc, which allows the ECU 80P (see FIG. 52) to accurately calculate the orifice passing flow rate Q_{OR}.

As described above, the ECU 80P can accurately calculate the actual injection amount Q_{A} even if the common rail pressure Pc is varied.

Thus, the ECU 80P can accurately correct the Ti-Q characteristic even if the common rail pressure Pc is varied.

The fuel injection of the injector 5A is generally multi-injection including “Pilot injection”, “Pre injection”, “After injection” and “Post injection” in order to reduce PM (particulate material), NOx or a combustion noise, to increase exhaust temperature or to activate catalyst by supplying a reducing agent.

If each injector can not inject fuel of the target injection amount Q_{T} in the multi-injection, a regulated value of an exhaust gas from the engine may not be kept.

Even if the seat surface 17a (see FIG. 11) is worn due to time-degradation over the long time of use, and the characteristic of the injector 5B is changed such that the injector can not inject a defined amount of the actual injection amount Q_{A}, the ECU 80P can correct the Ti-Q characteristic to adapt to the characteristic change of the injector 5B by executing the correction operation, which allows the injector to inject fuel of the target injection amount Q_{T}.

As a result, it becomes easier to keep the regulated value of an exhaust gas even if requirement on hardware specifications, such as dimension tolerance of each part of the engine system, is relaxed. Especially, requirement on the hardware specification for injectors can be relieved, which contributes to reduction of the manufacturing cost of the engine system.

Advantages of the fourteenth embodiment which are the same as those of the eleventh embodiment are omitted, and thus refer to the advantages of the eleventh embodiment for them.

In the fourteenth embodiment, the actual injection amount conversion factor γ which is used when calculating the actual injection amount Q_{A} from the orifice passing flow rate Q_{OR} is varied, however, it may be proximated to be a fixed value.

### Fifteenth Embodiment

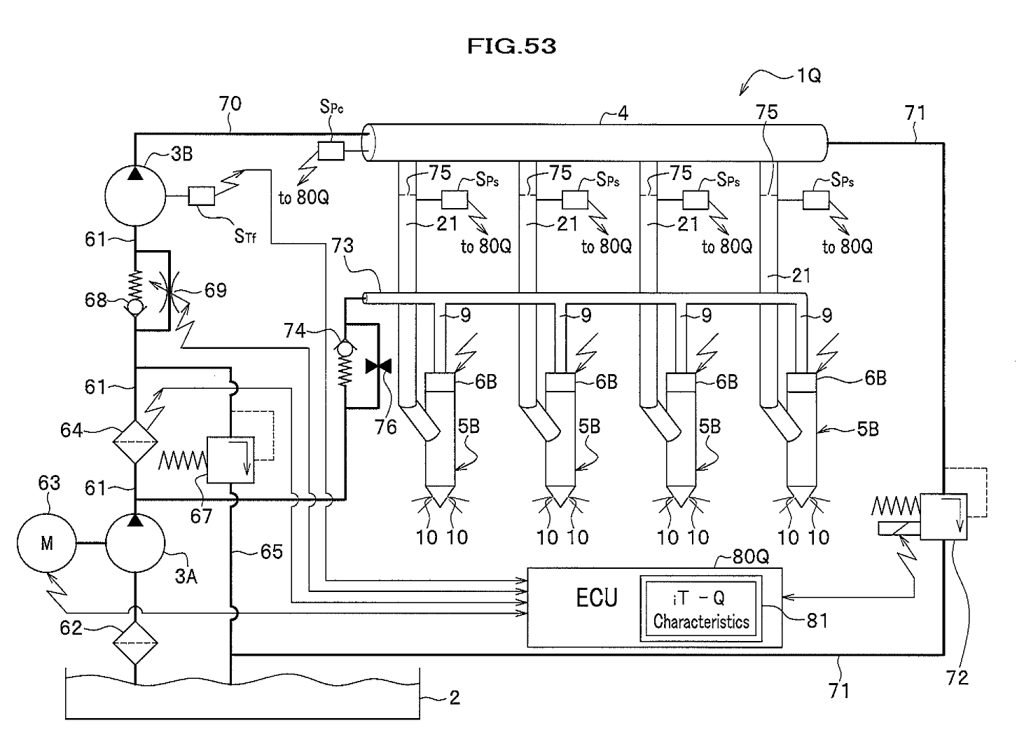

Next, a fuel injection device according to a fifteenth embodiment of the present invention is described in detail with reference to FIG. 53.

FIG. 53 is an illustration for showing an entire configuration of the accumulator fuel injection device of the fifteenth embodiment.

The fuel injection device 1Q differs from the fuel injection device 1P shown in FIG. 52 in that: (1) a pressure sensor S_{Ps} for detecting the pressure on the downstream side of the orifice 75 is provided instead of a differential pressure sensor S_{dP} for detecting the pressure difference between the upstream side and the downstream side of the orifice 75 which is provided in the high pressure fuel supply passage 21 for supplying fuel to the injector 5B attached to each cylinder of the engine; (2) an ECU (control unit) 80Q is provided instead of the ECU 80P; (3) the definition of the orifice differential pressure ΔP_{OR} which is used for calculating the orifice passing flow rate Q_{OR} of fuel in the ECU 80Q is changed.

In other words, the fifteenth embodiment uses the injector 5B, which is a back pressure fuel injection valve, instead of the injector 5A, which is a direct acting fuel injection valve, and is modified from the twelfth embodiment to be adapted to the injector 5B.

Components of the fifteenth embodiment corresponding to those of the fourteenth embodiment are assigned like reference numerals, and descriptions thereof will be omitted.

As shown in FIG. 53, pressure signals detected by the four pressure sensors S_{Ps} are input to the ECU 80Q.

The function of the ECU 80Q according to the fifteenth embodiment is basically the same as that of the ECU 80L according to the fourteenth embodiment, however, signals used by the ECU 80Q to calculate the orifice passing flow rate Q_{OR} are different from those used in the fourteenth embodiment.

In the fourteenth embodiment, the orifice passing flow rate Q_{OR} is calculated by using the equation (1). In the fifteenth embodiment, however, the orifice differential pressure ΔP_{OR} in the equation (1) is replaced by the pressure difference (Pc−Ps) between the common rail pressure Pc which is detected by the pressure sensor S_{Pc} and the pressure Ps on the downstream side of the orifice 75, which is detected by the pressure sensor S_{Ps}.

It is obvious that the pressure on the upstream side of the orifice 75 in each high pressure fuel supply passage 21 is substantially equal to the common rail pressure Pc. Thus, it is possible to accurately calculate an orifice passing flow rate Q_{OR} of fuel for each cylinder by using the equation (1) in which the orifice differential pressure ΔP_{OR} is replaced by the pressure difference (Pc−Ps) in the fifteenth embodiment, similarly to the fourteenth embodiment. Furthermore, it is also possible to calculate an actual injection amount Q_{A} by time-integrating the orifice passing flow rate Q_{OR}, and to calculate an actual injection amount for each cylinder and each injection command signal by multiplying the orifice passing flow amount Qₛᵤₘ by the actual injection amount conversion factor γ, which is calculated in accordance with the output pattern of the injection command signal.

The ECU 80Q according to the fifteenth embodiment, can accurately correct the Ti-Q characteristic based on the target injection amount Q_{T} and the actual injection amount, Q_{A} by executing the correction operation shown in FIG. 49, similarly to the ECU 80P of the fourteenth embodiment.

Thus, similarly to the twelfth embodiment, the injector 5B can accurately inject fuel of the target injection amount Q_{T} to a cylinder of the engine (not shown), which allows to preferably suppress the increase of PM (particulate material), NOx or a combustion noise.

The actual injection amount conversion factor γ may be stored in the storage unit 81 of ECU 80Q in the form of the correlation equation of signal parameters, similarly to the fourteenth embodiment.

Similarly to the twelfth embodiment, it becomes easier to keep the regulated value of an exhaust gas even if requirement on hardware specifications, such as dimension tolerance of each part of the engine system, is relaxed. Especially, requirement on the hardware specification for injectors can be relieved, which contributes to reduction of the manufacturing cost of the engine system.

Advantages of the fifteenth embodiment which are the same as those of the fourteenth embodiment are omitted, and thus refer to the advantages of the fourteenth embodiment for them.

### Sixteenth Embodiment

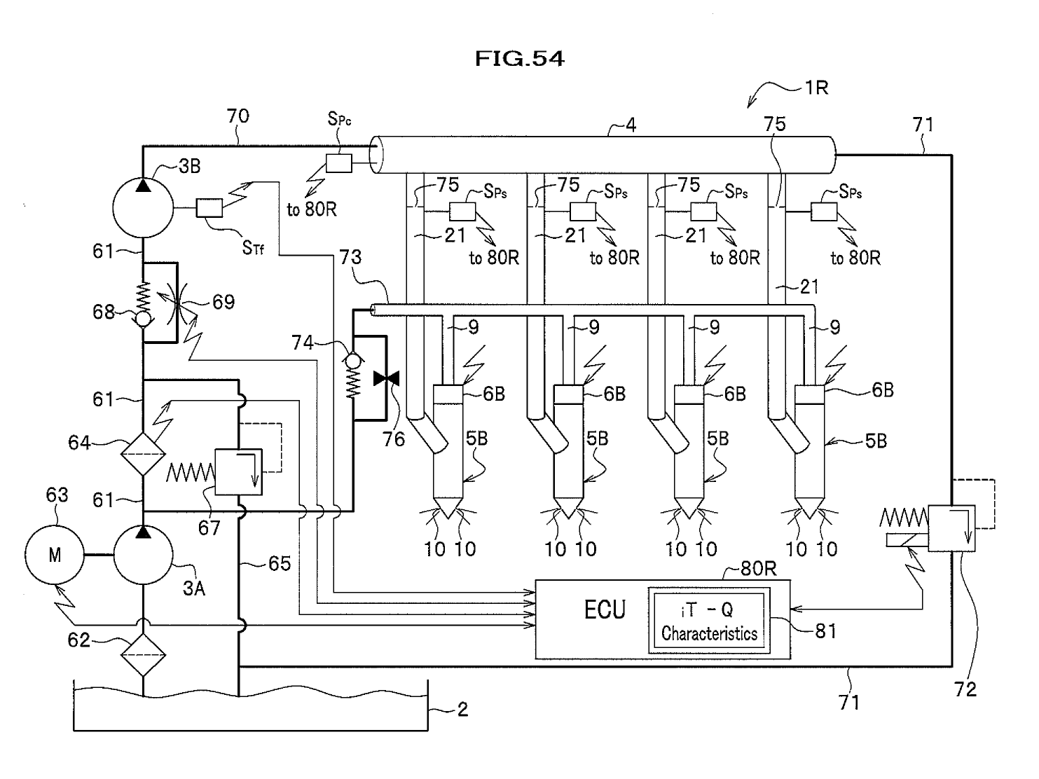

Next, a fuel injection device of a sixteenth embodiment of the present invention is described in detail with reference to FIG. 54.

FIG. 54 is an illustration for showing an entire configuration of the accumulator fuel injection device of the sixteenth embodiment.

A fuel injection device 1R of the sixteenth embodiment is different from the fuel injection device 1Q of the fifteenth embodiment in the following points: (1) an ECU (control unit) 80R is provided instead of the ECU 80Q; (2) a pressure sensor S_{Ps} is provided instead of the pressure sensor S_{Pc} for calculating an orifice differential pressure; and (3) a method performed by the ECU 80R for calculating the orifice passing flow rate Q_{OR} of fuel is changed from the method performed by the ECU 80Q.

In other words, the sixteenth embodiment uses the injector 5B, which is a back pressure fuel injection valve, instead of the injector 5A, which is a direct acting fuel injection valve, and is modified from the thirteenth embodiment to be adapted to the injector 5B.

Components of the sixteenth embodiment corresponding to those of the fifteenth embodiment are assigned like reference numerals, and descriptions thereof will be omitted.

As shown in FIG. 54, pressure signals detected by the four pressure sensors S_{Ps} are input to the ECU 80R.

The ECU 80R performs a filtering process on the pressure signals input from the pressure sensors S_{Ps} for cutting off a noise with a high frequency.

Hereinafter, the pressure PS on the downstream side of the orifice 75 which has been filtering processed is referred to as “pressure Ps_{fil}”.

The ECU 80R of the sixteenth embodiment calculates an orifice passing flow rate Q_{OR} by using the pressure Ps_{fil} which is detected by the pressure sensor S_{PS} on the downstream side of the orifice 75 and is filtering processed. Further, the ECU 80R calculates the actual injection amount Q_{A} based on the orifice passing flow rate Q_{OR}.

The flow chart showing the control flow for calculating the actual injection amount Q_{A} in the sixteenth embodiment is the same as that of the sixth embodiment shown in FIG. 15, and the description thereof will be omitted.

The ECU 80N executes the control flow shown in FIG. 15 instead of Steps 61 and 62 in FIG. 49 when executing the correction operation so that the actual injection amount Q_{A} is calculated.

The “ECU 80F” and the “injector 5A” in the explanation of the flow chart in FIG. 15 are read as the “ECU 80R” and the “injector 5B”, respectively.

After executing the processing until. Step 07, the ECU 80R refers to the storage unit 81 to obtain the actual injection amount conversion factor γ based on the injection command signal, set, in advance (Step 08A).

The actual injection amount conversion factor γ may be stored in the storage unit 81 of the ECU 80R in the form of the correlation equation of the signal, parameters, similarly to the fourteenth embodiment.

Next, the ECU 80R multiplies Q_{Sum} by the actual injection amount conversion factor γ to obtain the actual injection amount Q_{A} (Step 09).

The ECU 80R then executes the correction operation of Step 63 and the subsequent steps shown in FIG. 49 based on the calculated actual injection amount Q_{A}.

In accordance with the sixteenth embodiment, the orifice passing flow rate Q_{OR} can be calculated by using the pressure; value detected by the pressure sensor S_{Ps} which detects the pressure Ps on the downstream side of the orifice 75.

It is also possible to accurately calculate the orifice passing flow rate Q_{OR} for each cylinder based on the equation (1) in which the pressure difference (P₀−Ps_{fil}) between the predetermined value P0 and the pressure Ps_{fil} is substituted for the orifice differential pressure ΔP_{OR} by using only the pressure signal, from the pressure sensor S_{Ps} for detecting the pressure on the downstream side of the orifice 75.

Similarly to the fourteenth and fifteenth embodiments, the actual injection amount Q_{A} can be accurately calculated based on the calculated orifice passing flow rate Q_{OR}.

Thus, the ECU 80R can accurately correct the Ti-Q characteristic based on the target injection amount Q_{T} and the actual injection amount Q_{A}.

The injector 5B is allowed to inject fuel of the target injection amount Q_{T} to a cylinder of the engine (not shown), which allows to preferably suppress the increase of the PM (particulate material), NOx or a combustion noise, similarly to the thirteenth embodiment.

Similarly to the thirteenth embodiment, it becomes easier to keep the regulated value of an exhaust gas even if requirement on hardware specifications, such as dimension tolerance of each part of the engine system, is relaxed. Especially, requirement on the hardware specification for injectors can be relieved, which contributes to reduction of the manufacturing cost of the engine system.

Advantages of the sixteenth embodiment which are the same as those of the fourteenth embodiment are omitted, and thus refer to the advantages of the fourteenth embodiment for them.

In the fourteenth to sixteenth embodiments, the injector 5B, which is a back pressure fuel injection valve as shown in FIG. 11 is used, and the actuator 6B is a type of an actuator which moves the valve 35 by using the electromagnetic coil 34 to control the pressure of the back pressure chamber 7, however, an injector to be used is not limited to those described above. For example, an injector of the following configuration may be used: a control valve of a three-way valve structure is moved by using a piezoelectric stack to control the pressure of a back pressure chamber 7 provided above the nozzle needle 14 for injecting fuel or stopping the fuel injection.

In the configuration where the orifice 75 is provided to the side of the common rail 4 in the high pressure fuel supply passage 21, which supplies high pressure fuel to the direct acting injector 5A provided to the fuel injection device 1L shown in FIG. 44, it is possible to easily calculate an orifice passing flow rate Q_{OR} of fuel passing through the orifice 75 based on the pressure difference (orifice differential pressure ΔP_{OR}) of the upstream and downstream sides of the orifice 75.

Even if the common rail pressure Pc is varied, the orifice passing flow rate Q_{OR} calculated based on the orifice differential pressure ΔP_{OR} is less affected by the variation of the common rail pressure Pc, and thus the orifice passing flow rate Q_{OR} can be accurately calculated.

In the case of the direct acting injector 5A, since the actual injection amount Q_{A} is equal to the orifice passing flow rate Q_{OR}, the ECU 80L can calculate an accurate actual injection amount Q_{A} by detecting an accurate orifice differential pressure ΔP_{OR}.

Thus, the ECU 80L can accurately calculate an actual injection amount Q_{A} injected from the injector 5A by detecting the orifice differential pressure ΔP_{OR} of the orifice 75.

Therefore, the ECU 80L can accurately correct the Ti-Q characteristic based on the calculated target injection amount Q_{T} and the actual injection amount Q_{A}.

Thus, even if an actual injection amount Q_{A} of the injector 5A is changed by the characteristic change of the injector 5A due to, for example, variations of environment or driving conditions, or time degradation of the injector 5A, the ECU 80L can correct the Ti-Q characteristic such that the change of the actual injection amount Q_{A} can be absorbed. Then, the ECU 80L can set the injection time Tᵢ which corresponds to the target injection amount Q_{T} based on the corrected Ti-Q characteristic.

This allows the ECU 80L to reduce the deficiency and excess of the actual injection amount Q_{A} injected to each cylinder of the engine (not shown) even if the characteristic of the injector 5A is changed and an injection amount Q_{inject} in response to an injection time Tᵢ is changed. Thus, the embodiments advantageously enable to preferably suppress the increase of the PM (particulate material) of the engine (not shown), NOx or a combustion noise.

Even if the actual injection amounts Q_{A} of the injectors 5A are varied among the injectors 5A due to, for example, manufacturing tolerance, the ECU 80L can correct the Ti-Q characteristic for each injector 5A so that the variations of the actual injection amounts Q_{A} among the injectors 5A are absorbed. This realizes the fuel injection device 1L that can stably inject the actual injection amount Q_{A} which is equal to the target injection amount Q_{T}.

The configuration where the orifice 75 is provided to the side of the common rail 4 in the high pressure fuel supply passage 21, which supplies high pressure fuel to the back pressure injector 5B provided to the fuel injection device 1P shown in FIG. 52 has the same advantage as that of the configuration where the direct acting injector 5A (see FIG. 44) is provided, because it is possible to calculate the actual injection amount Q_{A} of the injector 5B based on the orifice passing flow rate Q_{OR}.

As described above, the present invention enables to preferably suppress the deficiency and excess of the actual injection amount regardless of the type of the injector, which allows to preferably suppress the increase of the PM (particulate material) of the engine, NOx or combustion noise.

In the eleventh to sixteenth embodiments, the injectors 5A, 5B directly injects fuel to the combustion chamber of each cylinder, however, embodiments are not limited to this. The present invention includes a configuration where the injectors 5A and 5B inject fuel in a subsidiary chamber (premixed space) which is formed adjacent to the combustion chamber of each cylinder, and a configuration where the injectors 5A and 5B inject fuel in the aspiration port of each cylinder. In these configurations, the advantages of the eleventh to sixteenth embodiments including can be also obtained.

### Seventeenth Embodiment

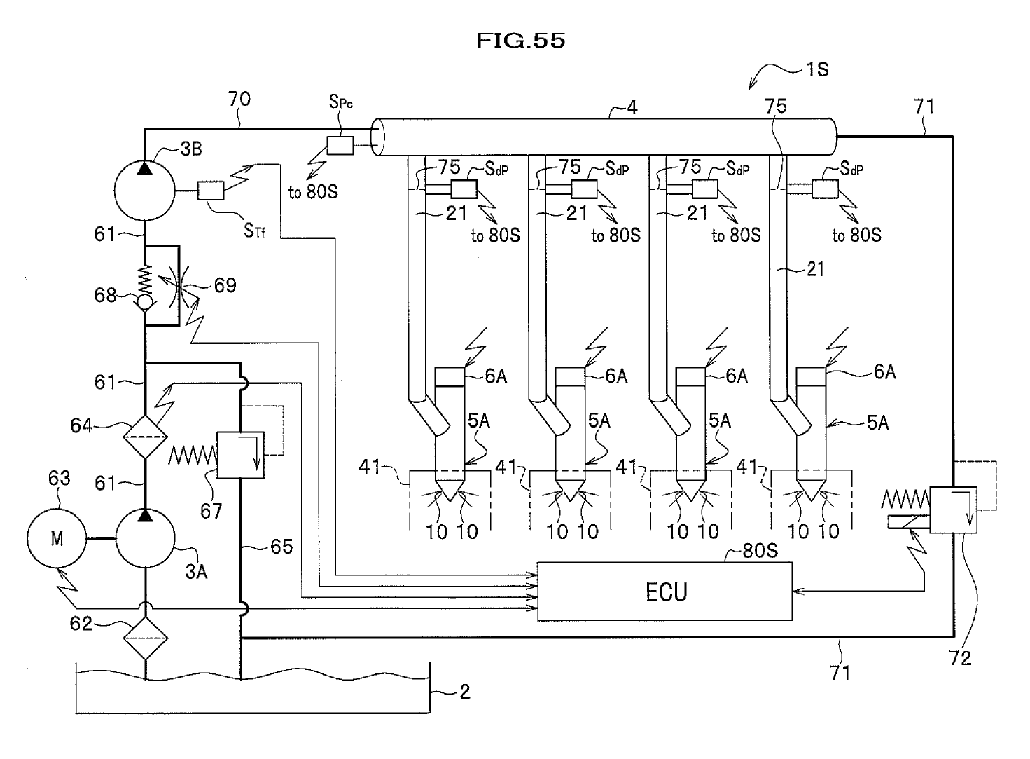

A fuel injection device according to a seventeenth embodiment of the present invention is described in detail below with reference to FIG. 55.

FIG. 55 is an entire configuration of an accumulator fuel injection device according to a seventeenth embodiment of the present invention. A fuel injection device 1S according to the seventeenth embodiment includes: a low pressure pump 3A (also called as a feed pump) driven by a motor 63 which is electronically controlled by an engine controlling device (control unit) 80S (hereinafter referred to as ECU 80S); a high pressure pump 3B (also called as a supply pump) mechanically driven by driving force taken out from the engine crank shaft; a common rail (fuel accumulation part) 4 to which high pressure fuel is supplied from the high pressure pump 3B; an injector (fuel injection valve) 5A for injecting the high pressure fuel into a combustion chamber of an internal combustion engine, such as 4 cylinder diesel engine (hereinafter referred to as an engine); and an actuator 6A incorporated in the injector 5A which is electronically controlled by the ECU 80S.

The low pressure pump 3A and the high pressure pump 3B are also referred to as a fuel pump.

The low pressure pump 3A and the motor 63 are incorporated in a fuel tank 2 together with a filter 62. The low pressure pump 3A and the motor 63 supplies fuel to the intake side of the high pressure pump 3B from the fuel tank 2 through the low pressure fuel supply passage 61. A flow regulating valve 69 incorporating a strainer 64 and a check valve 68 is arranged in series in the low pressure fuel supply passage 61 from the discharge side of the low pressure pump 3A to the intake side of the high pressure pump 3B. The strainer 64 includes a differential pressure sensor (not shown), and the signal of the differential pressure sensor is input to the ECU 80S so as to allow the ECU 80S to detect abnormalities of the low pressure pump 3A, the filter 62 and the strainer 64 (e.g. decrease in a low pressure fuel supply amount).

A return piping 65 which branches from a middle of the strainer 64 and the flow regulating valve 69 of the low pressure fuel supply passage 61 returns the excessive amount of fuel supply from the low pressure pump 3A to the fuel tank 2 via a pressure regulating valve 67.

The high pressure pump 3B is provided with a fuel temperature sensor S_{Tf} which detects the temperature of fuel to be discharged, and the signal of the fuel temperature sensor S_{Tf} is output to the ECU 80S.

The high pressure fuel that is discharged from the high pressure pump 3B to a discharge piping 70 is accumulated in the common rail 4, which is a kind of a surge tank for accumulating comparatively high pressure fuel. The common rail 4 is provided with a common rail pressure sensor (accumulation part pressure sensor) S_{Pc} for detecting the pressure Pc of the common rail 4 (hereinafter also referred to as common rail pressure Pc). The detection signal from the pressure sensor S_{Pc} is output to the ECU 80S. The ECU 80S controls the pressure of the common rail 4 to be a predetermined target pressure of from 30 MPa to 200 MPa based on an operating condition of a vehicle, such as an engine rotation speed Ne and a required torque Trqsol by adjusting the amount of fuel which is sucked in the high pressure pump 3 by the flow regulating valve 69 and releasing the pressure of the common rail 4 to the fuel tank 2 by controlling a pressure control valve 72 arranged in a return piping 71 which connects the common rail 4 and the fuel tank 2 if the common rail pressure Pc exceeds a target common rail pressure (which is described later) by a predetermined value.

The fuel tank 2, the filter 62, the low pressure pump 3A, the high pressure pump 3B, the low pressure fuel supply passage 61, the strainer 64, the return piping 65, the pressure regulating valve 67, the flow regulating valve 69, and the discharge piping 70 constitutes a fuel supply system. Specifically, the fuel tank 2, the filter 62, the low pressure pump 3A, the low pressure fuel supply passage 61, the strainer 64, the return piping 65, the pressure regulating valve 67 constitutes a low pressure part of the fuel supply system, and the high pressure pump 3B and the discharge piping 70 constitute a high pressure part of the fuel supply system.

The common rail 4 is configured to be communicated with the injectors 5A through high pressure fuel supply passages (fuel supply passages) 21 an orifice 75 is provided to the common rail 4 side of each of the four high pressure fuel supply passages 21. Pressure detection pipes which are respectively taken from the upstream side of the orifice 75 (the common rail 4 side) and the downstream side (the side far from the common rail 4) are connected to the differential pressure sensor S_{dP}. The differential pressure sensors S_{dP} detect the orifice differential pressures of the four high pressure fuel supply passages 21, respectively, whereby the fuel flow amount which has passed the orifice 75 of each pressure fuel supply passages 21 can be detected.

It is to be noted that the volume of a fuel passage including the high pressure fuel supply passage 21 that is lower than the orifice 75 and the fuel passage to a fuel injection port 10 inside the injector 5A (a fuel passage (not shown) in the injector 5A and an oil reservoir 20, which is provided around the nozzle needle) is designed to exceed the maximum actual fuel supply amount which is supplied through the high pressure fuel supply passage 21 for an explosion stroke among the cycles of aspiration, compression, explosion and exhaust in one cylinder, such as the maximum actual fuel supply amount required when the maximum torque is required by a fully-opened accelerator.

Here, the maximum actual fuel supply amount means summation of the fuel supply amount of each injection in the case of multi-injection.

It is obvious that the length of the high pressure fuel supply passages 21 to the injectors 5A of the cylinders of the engine is varied, and thus the position of the orifice 75 in the high pressure fuel supply passage 21 is determined in such a manner that the volume of each high pressure fuel supply passage 21 is the same with the enough volume of the fuel passage ensured as described above.

Hereinafter, the fuel injection amount, the target fuel injection amount, and the actual fuel injection amount are referred to as an “injection amount”, a “target injection amount” and an “actual injection amount”, respectively.

The injector 5A of the seventeenth embodiment is a direct acting injector (refer to FIG. 2 of Japanese Patent Application No. 2008-165383, which shows an example of the detailed configuration of the injector 5A).

Next, the engine controlling device (ECU 80S) used in the accumulator fuel injection device of the seventeenth embodiment is described with reference to FIGS. 55 to 58B.

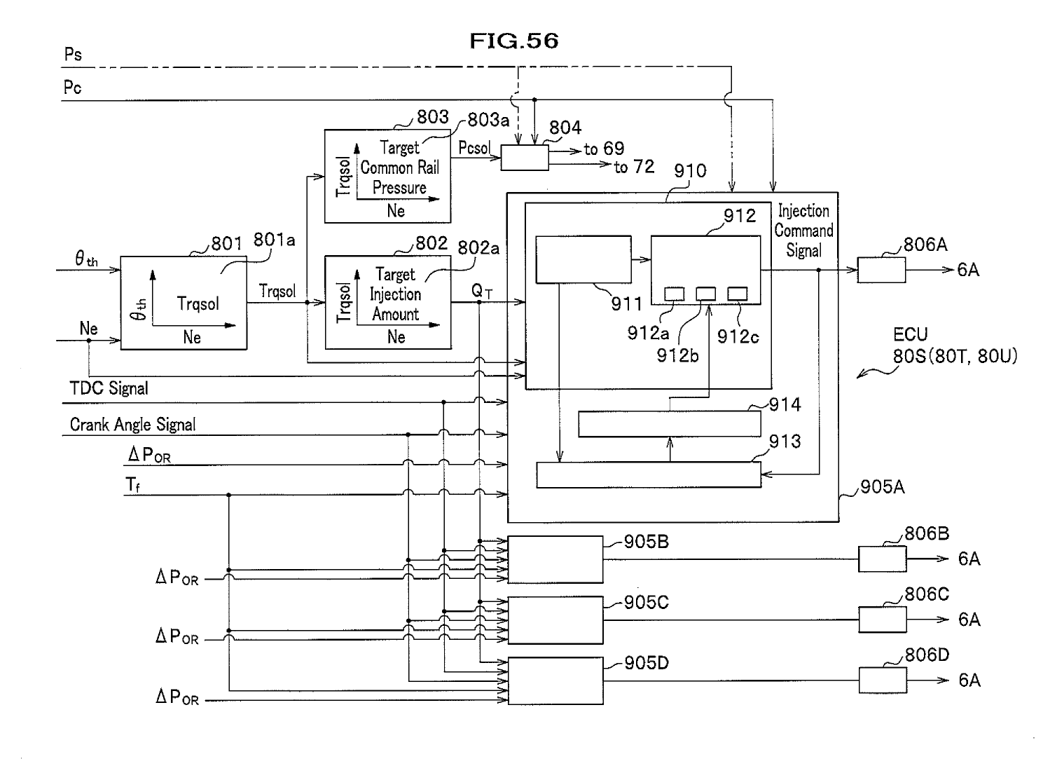

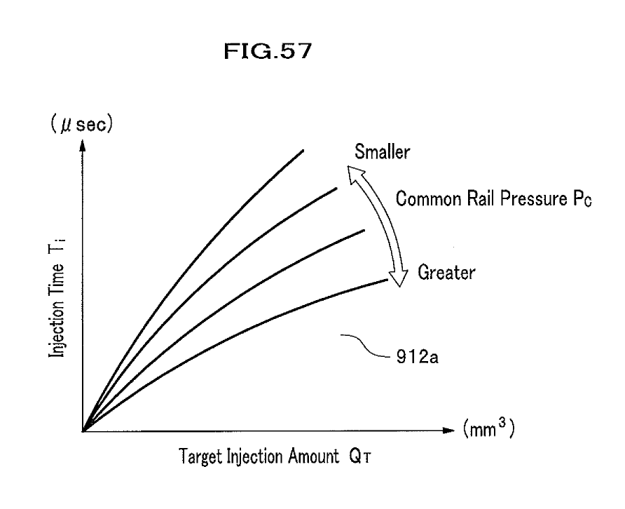

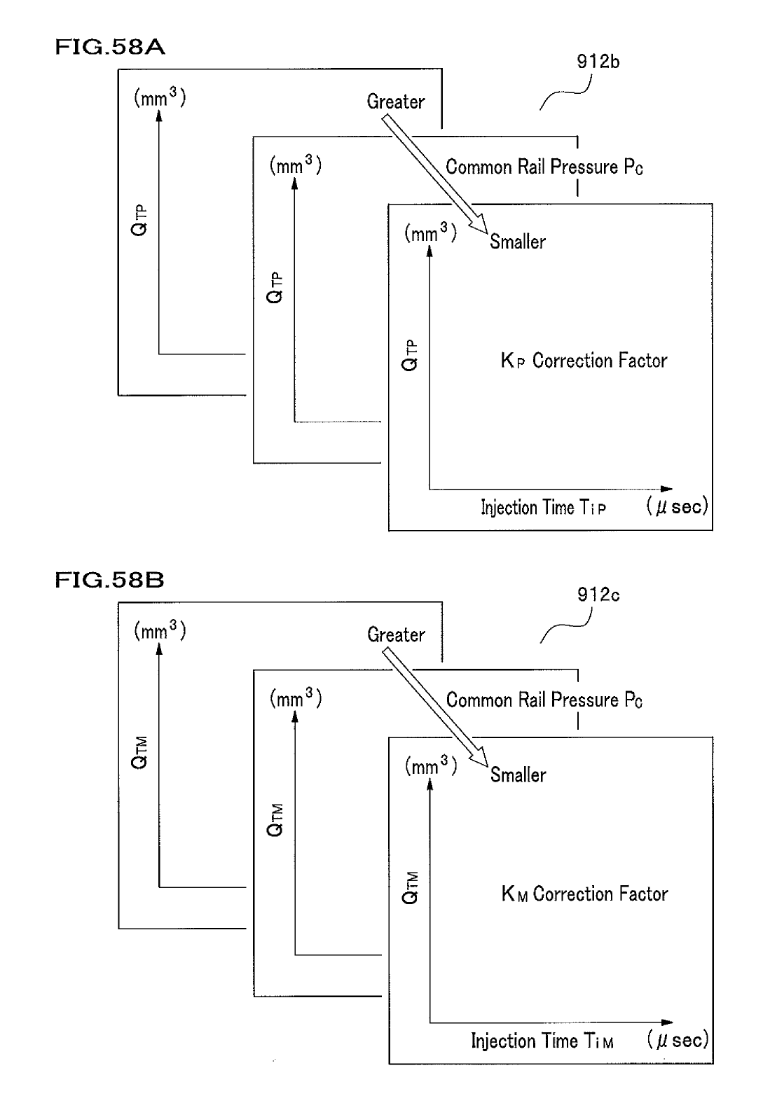

FIG. 56 is a functional block diagram of the engine controlling device used in the accumulator fuel injection device of the seventeenth embodiment. FIG. 57 is the conceptual graph of a two dimensional map for determining the injection time Tᵢ which corresponds to the target injection amount Q_{T}. FIGS. 58A and 58B are conceptual graphs of maps of a correction factor K₁ for obtaining the correction factor of the injection time, where a target injection amount, an injection time and a common rail pressure are taken as parameters. FIG. 58A is a conceptual graph of a three dimensional map of the correction factor for the Pilot fuel injection. FIG. 58B is a conceptual graph of a three dimensional map of the correction factor for the Main fuel injection.

The ECU 80S includes a micro computer (including a CPU, ROM, RAM, non-volatile memory such as a flash memory) (not shown), an interface circuit (not shown), and an actuator driving circuit 806 (806A to 806D in FIG. 55) for driving the actuator 6A. The micro computer electronically controls the actuator 6A by calculating an optimum fuel injection amount and an optimum injection timing based on signals from various sensors such as, an engine rotation speed sensor, a cylinder discriminating sensor, a crank angle sensor, a water temperature sensor, an intake air temperature sensor, an intake air pressure sensor, an accelerator (throttle) opening sensor, a fuel temperature sensor S_{Tf}, a common rail pressure sensor S_{Pc}, and a differential pressure sensor S_{dP}. A piezoelectric stack having a high response speed is used for the actuator 6A.

Preferably, a CPU of a high calculation speed, such as a multi core CPU is used as the CPU of the micro computer.

The ECU 80S may include a motor driving circuit for driving the motor 63, or the motor driving circuit may be provided outside of the ECU 80S.

Hereinafter, operations controlled by the micro computer of the ECU 80S are represented just as control of the ECU 80S. Hardware configurations of ECUs 80T to 80X in eighteenth to twenty-second embodiments which are described later are the same as that of the ECU 80S.

(Outline of Control of ECU 80G)

An outline of a basic processing performed by the ECU 80S for controlling the engine is shown in the functional block diagram in FIG. 56. A required torque calculation unit 801 calculates a required torque Trqsol based on the accelerator opening θₜₕ and the engine rotation speed Ne. A target injection amount calculation unit 802 calculates a target injection amount Q_{T} based on the engine rotation speed Ne and the calculated required torque Trqsol (a signal indicating the engine rotation speed Ne which is input to the target injection amount calculation unit 802 is omitted in FIG. 56). Injection control units 905A, 905B, 905C and 905D, each of which is provided to a cylinder 41 (see FIG. 55), selects a mode of injection of a multi-injection, and determines a target injection amount and an injection start instruction timing for the individual fuel injection, a corrected injection time which corresponds to the target injection amount Q_{T} and an injection finish instruction timing based on the engine rotation speed Ne, the calculated required torque Trqsol, the calculated target injection amount Q_{T}, a TDC signal, a crank angle signal, the common rail, pressure Pc detected from the common rail, pressure sensor S_{Pc} (see FIG. 20), and a fuel supply passage pressure Ps_{fil} detected by the fuel supply passage pressure sensor S_{Ps} provided in the high pressure fuel supply passage 21A. The ECU 80G sets the injection start instruction timing and the injection finish instruction timing, and outputs them to actuator driving circuits 806A, 806B, 806C, and 806D as the injection command signal to drive the actuator 6A of each injector 5A.

The injection control units 905A, 905B, 905C, 905D calculates the orifice passing flow amount by calculating and time-integrating the orifice passing flow rate based on a signal indicating the orifice differential pressure ΔP_{OR} from the differential pressure sensor S_{dP}(see FIG. 55) of the high pressure fuel supply passage 21 for each cylinder 41, a signal indicating the fuel temperature T_{f} from the fuel temperature sensor S_{Tf} (see FIG. 55). The injection control units 905A, 905B, 905C, 905D store the ratio of the target injection amount Q_{T} and the calculated orifice passing flow amount as a correction factor since the calculated orifice passing flow amount corresponds to the actual injection amount of the injector 5A. The injection control units 905A, 905B, 905C, 905D use the correction factor to correct the injection time when determining the injection time.

In the case of a multi-injection (e.g. fuel injection is divided into two phases of a Pilot fuel injection and a Main fuel injection), the target injection amount Q_{T} is divided into the target injection amount Q_{TP} of the Pilot fuel injection and the target injection amount Q_{TM} of the Main fuel injection, based on the required torque Trqsol and the engine rotation speed Ne, and the differential amount (Q_{TP}−Q_{AP}) of fuel between the target injection amount Q_{TP} and the actual injection amount Q_{AP}, of the Pilot fuel injection is added to the target injection amount Q_{TM} of the Main fuel injection, and then the corrected Main fuel injection is performed. As described above, since the injection control units 905A, 905B, 905C, 905D perform calculation and control for each cylinder 41, it is preferable to use a micro computer including a multicore type CPU having 5 or more cores, assigning one of the five cores to a function of controlling entire operation of the injection control units 905A, 905B, 905C, 905D, and each one of the remaining 4 cores to the operation of each injection control unit 905A, 905B, 905C, 905D in the case of the 4 cylinder engine.

Hereinafter, a case where fuel injection is divided into two-phases of the Pilot fuel injection and Main fuel injection is explained as an example of the multi-injection.

The detailed configurations and effects of the injection control units 905A, 905B, 905C, 905D are described later.

The engine rotation speed Ne, the required torque Trqsol and the common rail pressure Pc are also input to the injection control units 905B, 905C, 905D, however, they are omitted in FIG. 56 to simplify FIG. 56.

A common rail pressure calculation unit 803 calculates a target common rail pressure Pcsol based on the required torque Trqsol which is calculated in the required torque calculation unit 801 in the ECU 80S and the engine rotation speed Ne with reference to a two dimensional map 803a of the common rail pressure. A common rail pressure control unit 804 compares the calculated target common rail pressure Pcsol with a signal from the common rail pressure Pc, and outputs a control signal to the flow regulating valve 69 and the pressure control valve 72 to control the common rail pressure Pc to be equal to the target common rail pressure Pcsol.

The signal indicating engine rotation speed Ne to the common rail pressure calculation unit 803 is omitted.

More specifically, the ECU 80S electronically stores in its ROM a two dimensional map 801a that stores the optimum required torque Trqsol which is experimentally determined with respect to the accelerator opening θₜₕ and the engine rotation speed Ne, and a two dimensional map 802a that stores the optimum target injection amount Q_{T} which is experimentally determined with respect to the engine rotation speed Ne and the required torque Trqsol.

Similarly, the ECU 80G electronically stores in its ROM a two dimensional map 803a of a common rail pressure that stores the optimum target common rail pressure Pcsol which is experimentally determined with respect to the engine rotation speed Ne and the required torque Trqsol.

(Injection Control Unit)

Next, the injection control units 905A, 905B, 905C, 905D are described with reference to FIG. 56.

As shown in FIG. 56, the injection control units 905A, 905B, 905C, 905D include a multi-injection control unit 910, an actual fuel supply information detection unit (actual fuel supply information detection means) 913, and the actual fuel injection information detection unit (actual fuel injection information detection means) 914.

The multi-injection control unit 910 further includes a multi-injection mode control unit 911 and an individual injection information setting unit 912.

The multi-injection mode control unit 911 determines whether fuel injection is performed in two-phases, which are the Pilot fuel injection and the Main fuel injection, or in one phase, which is the Main fuel injection, based on, for example, the engine rotation speed Ne and the required torque Trqsol. Then, the multi-injection mode control unit 911 controls a method performed by the actual fuel supply information detection unit 913 for detecting actual fuel supply information in accordance with the selected injection mode (i.e. the multi-injection mode or one phase injection mode).

The individual injection information setting unit 912 performs the following process in response to the result of the process performed by the multi-injection mode control unit 911 for selecting the two-stage injection or the single-stage injection. If, for example, the two-stage injection is selected, the individual injection information setting unit 912 divides the target injection amount Q_{T} into the target injection amount Q_{TP} of the Pilot fuel injection and the target injection amount Q_{TM} of the Main fuel injection, and then sets the injection start instruction timing t_{SP} and the injection finish instruction timing t_{EP} of the Pilot fuel injection, and the injection start instruction timing t_{SM} and the injection finish instruction timing t_{EM} of the Main fuel injection based on the target injection amount Q_{T}, the TDC signal, the crank angle signal, the engine rotation speed Ne and the required torque Trqsol from the target injection amount calculation unit 802. Then, the individual injection information setting unit 912 outputs the injection command signal to the actuator driving circuit 806 (shown as 806A, 806B, 806C, 806D in FIG. 56) as well as the actual fuel supply information detection unit 913.

The individual injection information setting unit 912 includes the two dimensional map 912a as shown in FIG. 57 for determining the injection time Tᵢ of the ordinate which corresponds to the target injection amount Q_{T} of the abscissa, using the common rail pressure Pc as a parameter. In FIG. 57, the abscissa is taken as the target injection amount Q_{T}. It is to be noted that the target injection amount Q_{T} in FIG. 57 corresponds to the target injection amount Q_{T} calculated by the target injection amount calculation unit 802 shown in FIG. 56, or the target injection amount Q_{TP} of the Pilot fuel injection or the target injection amount Q_{TM} of the Main fuel injection, which are described later.

More specifically, the ECU 80S electronically stores in its ROM the two dimensional map 912a that stores the optimum injection time Tᵢ which is experimentally determined with respect to the target injection amount Q_{T} and the common rail pressure Pc.

The individual injection information setting unit 912 includes, as shown in FIG. 58A, a three dimensional map 912b of a correction factor K_{P} for correcting the injection time T_{iP} of the Pilot fuel injection, and the correction factor K_{P} can be newly stored in the map 912b of the correction factor K_{P} to update the map 912b. In the map 912b of the correction factor K_{P}, the target injection amount Q_{TP} and the injection time T_{iP} for the Pilot fuel injection and the common rail pressure Pc are used as parameters.

Furthermore, the individual injection information setting unit 912 includes, as shown in FIG. 58B, a three dimensional map 912c of a correction factor K_{M} for correcting the injection time T_{iM} of the Main fuel injection, and the correction factor K_{M} can be newly stored in the map 912c of the correction factor K_{M} to update the map 912c. In the map 912c of the correction factor K_{M}, the target injection amount Q_{TM} and the injection time T_{iM} for the Main fuel injection and the common rail pressure Pc are used as parameters.

More specifically, the ECU 80S electronically stores in its non-volatile memory the map 912b of the correction factor K_{P} that is set with respect to the injection time T_{iP} and the target injection amount Q_{TP} of the Pilot fuel injection and the common rail pressure Pc at default and the map 912c of the correction factor K_{M} that is set with respect to the injection time T_{iM} and the target injection amount Q_{TM} of the Main fuel injection and the common rail pressure Pc at default.

The map 912b of the correction factor K_{P} and the three dimensional map 912c of the correction factor K_{M} have the same data structure.

If the target injection amount Q_{TP} of the Pilot fuel injection, the injection time T_{iP} of the Pilot fuel injection and the common rail pressure Pc are all included in a predetermined three-dimensional unit space defined by predetermined ranges of the target injection amount Q_{TP}, the injection time T_{iP} and the common rail pressure Pc, the individual injection information setting unit 912 stores the ratio K_{P} between the target injection amount Q_{TP} of the Pilot fuel injection which is obtained by the individual injection information setting unit 912 and an actual injection amount Q_{AP} (described later) which is obtained by the actual fuel injection information detection unit 914 as a correction factor in time-series in the three-dimensional unit space by a predetermined number of the ratios K_{P}.

When the injection time T_{iP} of the Pilot fuel injection is calculated with reference to the two-dimensional map 912a storing the injection time corresponding to the target injection amount Q_{TP} of the Pilot fuel injection in the individual injection information setting unit 912, the individual injection information setting unit 912 obtains the moving average <K_{P}> of the correction factors K_{P} by referring to the three dimensional map 912b of the correction factor K_{P}, and multiplies the injection time T_{iP} by the moving average <K_{P}> of the correction factor K_{P} to obtain a corrected injection time T_{iP}(=T_{iP}×<K_{P}>) of the Pilot fuel injection.

Hereinafter, the moving average <K_{P}> of the correction factor K_{P} is referred to just as the “correction factor <K_{P}>”.

Similarly, if the target injection amount Q_{TM} of the Main fuel injection, the injection time T_{iM} of the Main fuel injection and the common rail pressure Pc are all included in a predetermined three-dimensional unit space defined by predetermined ranges of the target injection amount Q_{TM}, the injection time T_{iM} and the common rail pressure Pc, the individual injection information setting unit 912 stores the ratio K_{P} between the target injection amount Q_{TM} of the Main fuel injection which is obtained by the individual injection information setting unit 912 and the actual injection amount Q_{AM} (described later) which is obtained by the actual fuel injection information detection unit 914 as a correction factor in time-series in the three-dimensional unit space by a predetermined number of the ratios K_{M}.

When the injection time T_{iM} of the Main fuel injection is calculated with reference to the two-dimensional map 912a storing the injection time corresponding to the target injection amount Q_{TM} of the Main fuel injection in the individual injection information setting unit 912, the individual injection information setting unit 912 obtains the moving average <K_{M}> of the correction factors K_{M} by referring to the three dimensional map 912b of the correction factor K_{M}, and multiplies the injection time T_{iM} by the moving average <K_{M}> of the correction factor K_{M} to obtain a corrected injection time T_{iM}(=T_{iM}×<K_{M}>) of the Main fuel injection.

Hereinafter, the moving average <K_{M}> of the correction factor K_{M} is referred to just as the “correction factor <K_{M}>”.

Since the Pilot fuel injection is performed at the compression stroke at a crank angle substantially before TDC, while the Main fuel injection is performed at a crank angle around the TDC, there is a great pressure difference in the cylinder between the Pilot fuel injection and the Main fuel injection even if the common rail pressures Pc are equal in the Pilot fuel injection and the Main fuel injection, and the pressure difference may affect the values of the correction factors K_{P}, K_{M}. Therefore, the three dimensional map 912b of the correction factor K_{P} and the three dimensional map 912c of the correction factor K_{M} are separately prepared as described above.

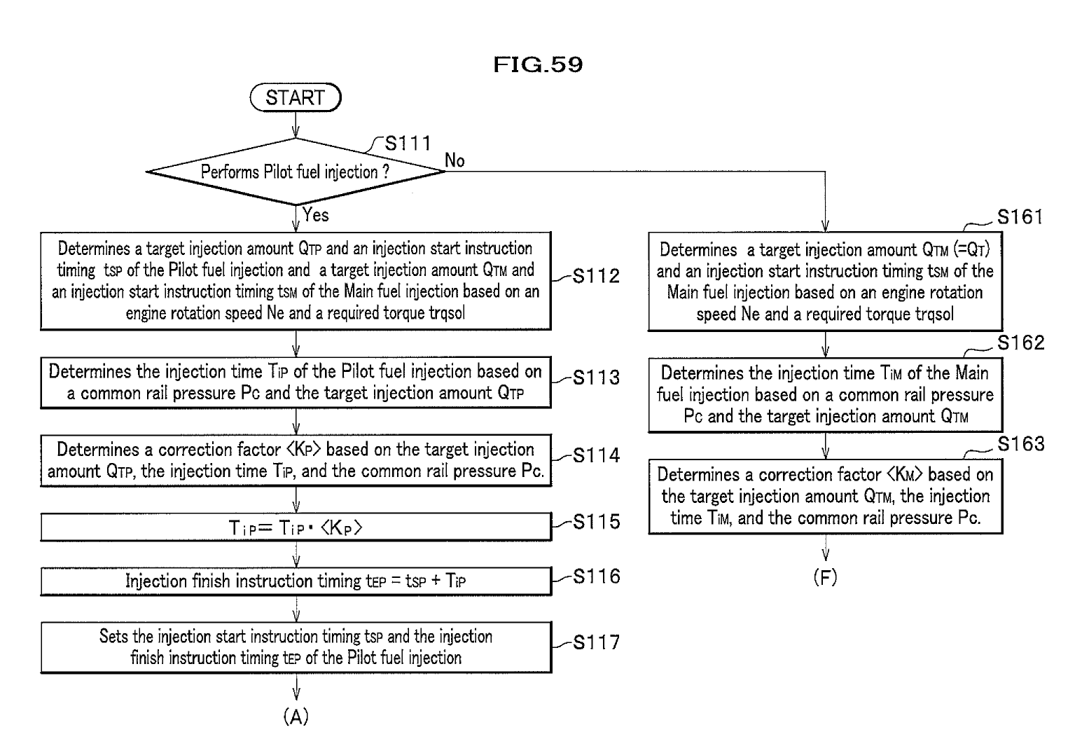

A method performed by the individual injection information setting unit 912 for updating the three dimensional map 912b of the correction factor K_{P} and the three dimensional map 912c of the correction factor K_{M} is described with reference to the flow chart shown in FIGS. 59 to 63.

The actual fuel supply information detection unit 913 detects the detection start timing t_{ORSP} and the detection finish timing t_{OREP} of the fuel flow passing the orifice 75 for the Pilot fuel injection based on a signal, indicating the orifice differential pressure ΔP_{OR} from the differential pressure sensor S_{dP} for the relevant cylinder 41 (see FIG. 55), calculates the orifice passing flow rate Q_{OR} based on a fuel temperature T_{f} from the fuel temperature sensor S_{Tf} and the orifice differential pressure ΔP_{OR}, and then time-integrates the orifice passing flow rate Q_{OR} to calculate an orifice passing flow amount Q_{Psum}.

Similarly to the Pilot injection, the actual fuel supply information detection unit 913 also detects the detection start timing t_{ORSM} and the detection finish timing t_{OREM} of the fuel flow passing the orifice 75 for the Main fuel injection based on a signal indicating the orifice differential pressure ΔP_{OR}, calculates the orifice passing flow rate Q_{OR} based on a fuel temperature T_{f} from the fuel temperature sensor S_{Tf} and the orifice differential pressure ΔP_{OR}, and then time-integrates the orifice passing flow rate Q_{OR} to calculate an orifice passing flow amount Q_{Msum}.

The actual fuel supply information detection unit 913 outputs the detection start timing t_{ORSP} and the detection finish timing t_{OREP} of the fuel flow passing the orifice 75 and the orifice passing flow amount Q_{Psum} for the Pilot fuel injection to the actual fuel injection information detection unit 914. The actual fuel supply information detection unit 913 also outputs the detection start timing t_{ORSM} and the detection finish timing t_{OREM} of the fuel flow passing the orifice 75 and the orifice passing flow amount Q_{Msum}, for the Main fuel injection to the actual fuel injection information detection unit 914.

The actual fuel injection information detection unit 914 converts the detection start timing t_{ORSP}, the detection finish timing t_{OREP}, the detection start timing t_{ORSM} and the detection finish timing t_{OREM} of the fuel flow passing the orifice 75 to the injection start timing, the injection finish timing of the Pilot fuel injection and the injection start timing and the injection finish timing of the Main fuel injection in the fuel injection port 10 of the injector 5A, respectively, sets the orifice passing flow amount Q_{Psum} as an actual injection amount Q_{AP} of the Pilot fuel injection, or sets the orifice passing flow amount, Q_{Msum} as an actual injection amount Q_{AM} of the Main fuel injection.

These converted data are input to the individual injection information setting unit 912 and used for correction as needed.

(Control Flow of Injection Control Unit)

Next, the injection control unit 905 (shown as 905A, 905B, 905C, 905D in FIG. 55) is described with reference to FIGS. 59 to 63. FIGS. 59 to 63 are flow charts showing a control process performed by the injection control units 905A, 905B, 905C, 905D for controlling fuel injection. The control process is executed by the injection control, units 905A, 905B, 905C, 905D with its execution timing being adjusted by each cylinder 41 (see FIG. 55) based on the TDC signal, and the crank angle signal.

Here, the control process for controlling fuel injection to the combustion chamber of one cylinder 41 is explained.

“Fuel injection information” of the Pilot fuel, injection is an inclusive term including the target injection amount Q_{TP}, the injection start instruction timing t_{SP}, the injection time T_{iP} and the injection finish instruction timing t_{EP} of the Pilot fuel injection. “Fuel injection information” of the Main fuel injection is an inclusive term including the target injection amount Q_{TM}, the injection start instruction timing t_{SM}, the injection time T_{iM} and the injection finish instruction timing t_{EM} of the Main fuel injection.

In Step 111, the multi-injection mode control unit 911 determines whether or not the Pilot fuel injection is performed. If the Pilot fuel, injection is performed (Yes), the processing proceeds to Step 112. If the Pilot fuel injection is not performed (No), the processing proceeds to Step 161.

In Step 112, the individual injection information setting unit 912 determines the target injection amount Q_{TP} and the injection start instruction timing t_{S1}, for the Pilot fuel injection, and the target injection amount Q_{TM} and the injection start instruction timing t_{SM} for the Main fuel injection based on the engine rotation speed Ne and the required torque Trqsol.

In Step 113, the individual injection information setting unit 912 determines the injection time T_{iP} of the Pilot fuel injection based on the common rail pressure Pc and the target injection amount Q_{TP} of the Pilot fuel injection determined in Step 112, with reference to the two-dimensional map 912a.

Next, in Step 114, the individual injection information setting unit 912 determines the correction factor <K_{P}> based on the target injection amount Q_{TP} and the injection time T_{iP} of the Pilot fuel injection and the common rail pressure Pc, with reference to the three dimensional map 912b. It is to be noted that pulsation of the common rail pressure Pc generated by fuel injection to other cylinders is fully stabilized to be substantially constant pressure at the time when the injection time T_{iP} of the Pilot fuel injection for own cylinder is determined in the case of the multi-injection in the 4 cylinder engine.

Especially, it is found out that the pulsation of the common rail pressure Pc and the pulsation of the pressure on the downstream side of the orifice 75 in the high pressure fuel supply passage 21 generated by fuel injection to other cylinders are more rapidly stabilized by providing the orifice 75 on the side of the common rail 4 in the high pressure fuel supply passage 21 (see FIG. 19 in Japanese Patent Application No. 2008-165383).

In Step 115, the individual injection information setting unit 912 calculates an injection time T_{iP} (T_{iP}=T_{iP}·<K_{P}>) of the Pi lot fuel injection which is corrected by executing the processing T_{iP}×<K_{P}>.

In Step 116, the individual injection information setting unit 912 calculates the injection finish instruction timing t_{EP} of the Pilot fuel injection by adding the injection start instruction timing t_{SP} determined in Step 112 and the corrected injection time T_{iP} of the Pilot fuel injection calculated in Step 115 (t_{EP}=t_{SP}+T_{iP}). In Step 117, the individual injection information setting unit 912 sets the injection start instruction timing t_{SP} and the injection finish instruction timing t_{EP} of the Pilot fuel injection. More specifically, the individual injection information setting unit 912 outputs, as the injection command signal, the injection start instruction timing t_{SP} and the injection finish instruction timing t_{EP} to the actuator driving circuit 806A and the actual fuel supply information detection unit 913. After executing the process in Step 117, the processing proceeds to Step 118, following the connector (A).

In Step 118, the actual fuel supply information detection unit 913 determines whether or not an injection start signal of the Pilot fuel injection is received from the injection command signal. If the injection start signal of the Pilot fuel injection is received (Yes), the processing proceeds to Step 119. If the injection start signal of the Pilot fuel injection is not received (No), the processing repeats Step 118. In Step 119, the actual fuel supply information detection unit 913 starts a timer t. In Step 120, the actual fuel supply information detection unit 913 resets the amount of fuel Q_{Psum} which passes the orifice 75 for the Pilot fuel injection (hereinafter referred to as an orifice passing flow amount Q_{Psum}) to be 0.0.

In Step 121, the actual fuel supply information detection unit 913 determines whether or not a positive orifice differential pressure ΔP_{OR} of being equal to or more than a predetermined threshold value is detected based on a signal indicating the orifice differential pressure ΔP_{OR} from the differential pressure sensor S_{dP}. If the positive orifice differential pressure ΔP_{OR} of being equal to or more than the predetermined threshold value is detected (Yes), the processing proceeds to Step 122. If the positive orifice differential pressure ΔP_{OR} of being equal to or more than the predetermined threshold value is not detected (No), the processing repeats Step 121.

The positive orifice differential pressure ΔP_{OR} used here is an orifice differential pressure ΔP_{OR} generated when fuel is flowed from the side of the common rail 4 to the side of the injector 5A. An orifice differential pressure ΔP_{OR} generated when this fuel flow is reversed is a negative orifice differential, pressure ΔP_{OR}.

The processing in Step 121 is to determine whether or not the orifice differential pressure ΔP_{OR} is more than just a noise detected by the differential pressure sensor S_{dP} and is generated by fuel injection.

If Yes is selected in Step 121, the actual fuel supply information detection unit 913 obtains the detection start timing t_{ORSP} of an orifice passing flow which is caused by the Pilot fuel injection by the timer t in Step 122.

Subsequently, the actual fuel supply information detection unit 913 calculates the orifice passing flow rate Q_{OR} (mm³/sec) from the orifice differential pressure ΔP_{OR} in Step 123.

The orifice passing flow rate Q_{OR} can be easily calculated from the orifice differential pressure ΔP_{OR} by using the equation (1).

In Step 124, the actual fuel supply information detection unit 913 time-integrates the orifice passing flow rate Q_{OR} as shown in the equation Q_{Psum}=Q_{Psum}+Q_{OR}·Δt.

In Step 125, the actual fuel supply information detection unit 913 determines whether or not a Pilot fuel injection finish signal is received from the injection command signal. If the Pilot fuel injection finish signal is received (Yes), the processing proceeds to Step 126. If the Pilot fuel injection finish signal is not received (No), the processing returns to Step 123 and repeats Steps 123 to 125. In Step 126, the actual fuel supply information detection unit 913 determines whether or not a negative orifice differential pressure ΔP_{OR} which is equal to or less than a predetermined threshold value is detected, based on the orifice differential pressure ΔP_{OR} from the differential pressure sensor S_{dP}.

If the negative orifice differential pressure ΔP_{OR} which is equal to or less than the predetermined threshold value is detected (Yes), the processing proceeds to Step 127. If the negative orifice differential pressure ΔP_{OR} which is equal to or less than the predetermined threshold value is not detected (No), the processing returns to Step 123 and repeats Steps 123 to 126.

The processing in Step 126 is to determine whether or not the orifice differential pressure ΔP_{OR} is more than just a noise detected by the differential pressure sensor S_{dP} and is generated by a reflection wave caused by the completion of fuel injection.

Processing of Steps 123 to 126 is performed at a period of a few μ seconds to dozens of μ seconds, for example, and Δt is a period at which the filtering-processed pressure Ps_{fil} is sampled, which is a few μ seconds to dozens of μ seconds.

If “Yes” is selected in Step 126, in Step 127, the actual fuel supply information detection unit 913 obtains the detection finish timing t_{OREP} of an orifice passing fuel flow associated with the completion of the Pilot fuel injection by the timer t, and outputs the detection start timing t_{ORSP} of the orifice passing fuel, flow obtained in Step 122, the detection finish timing t_{OREP} of the orifice passing fuel flow obtained in Step 127 and the orifice passing flow amount Q_{Psum} finally obtained by repeating Steps 123 to 126, to the actual fuel injection information detection unit 914.

The detection start timing t_{ORSP}, the detection finish timing t_{OREP}, and the orifice passing flow amount Q_{Psum} of the orifice passing fuel flow are also referred to as “actual fuel supply information”.

In Step 128, the actual fuel injection information detection unit 914 converts the detection start timing t_{ORSP} and the detection finish timing t_{OREP} of the orifice passing fuel flow into the injection start timing and the injection finish timing of the Pilot fuel injection, and sets the orifice passing flow amount Q_{Psum} as an actual injection amount Q_{AP} of the Pilot fuel injection. Then, the actual injection amount Q_{AP}, the injection start timing and the injection finish timing of the Pilot fuel injection are input to the individual injection information setting unit 912.

It is to be noted that the conversion of the detection start timing t_{ORSP} and the detection finish timing t_{OREP} of the orifice passing fuel flow into the injection start timing and the injection finish timing of the Pilot fuel injection can be easily performed by calculating an average flow velocity of the fuel flow based on an average value of the orifice passing flow rate Q_{OR} [symbol] Q_{Psum}/(t_{OREP}−t_{ORSP}) [symbol] and the cross-sectional area of the high pressure fuel supply passage 21 and considering the average flow velocity and the length of the fuel passage.

The actual injection amount Q_{AP}, the injection start timing and the injection finish timing of the Pilot fuel injection are referred to as “actual fuel injection information”.

In Step 129, the individual injection information setting unit 912 calculates the correction factor K_{P}(=Q_{TP}/Q_{AP}) and stores the correction factor K_{P} in the three dimensional map 912b of the correction factor to update the three dimensional map 912b.

In Step 130, the actual fuel supply information detection unit 913 resets the timer t. After Step 130, the processing proceeds to Step 131, following the connector (B).

In Step 131, the individual injection information setting unit 912 sets the injection start instruction timing t_{SM} of the Main fuel injection determined in Step 112. More specifically, the individual injection information setting unit 912 outputs the injection start instruction timing t_{SM} to the actuator driving circuit 806A and the actual fuel supply information detection unit 913 as the injection command signal.

Subsequently, in Step 132 the individual injection information setting unit 912 calculates a corrected target injection amount Q_{TM}* of the Main fuel injection [symbol] Q_{TM}*=Q_{TM}+(Q_{TP}−Q_{AP}) [symbol] based on the target injection amount Q_{TP} of the Pilot fuel injection, the target injection amount Q_{TM} of the Main fuel injection which are determined in Step 112 and the actual injection amount Q_{AP} of the Pilot fuel injection input from the actual fuel injection information detection unit 914 in Step 128.

In Step 133, the individual injection information setting unit 912 determines whether or not the deviation amount between the corrected target injection amount Q_{TM}* of the Main fuel, injection to the target injection amount Q_{TM} before correction which are expressed in percentage terms and in absolute value exceeds a predetermined threshold value ε₁.

If the deviation amount are equal to or greater than the predetermined threshold value ε₁ (Yes), the processing proceeds to Step 134. If the deviation amount is less than the predetermined threshold value ε₁ (No), the processing proceeds to Step 135.

The predetermined threshold value ε₁ here is a value corresponding to the measuring error of the actual, injection amount Q_{AP}. If the correction is the significant correction which is more than just a measuring error, which is represented as the predetermined threshold value ε₁, the corrected target injection amount Q_{TM}* of the Main fuel injection is used.

In Step 134, the individual injection information setting unit 912 replaces the target injection amount Q_{TM} of the Main fuel injection with the corrected Q_{TM}*.

In Step 135, the individual injection information setting unit 912 determines the injection time T_{iM} of the Main fuel injection based on the common rail pressure Pc* which is detected at the timing temporally near to the injection start instruction timing t_{SM} of the Main fuel injection set in Step 131 and the target injection amount Q_{TM} of the Main fuel injection set in Step 112 with reference to the two-dimensional map 912a.

Next, in Step 136, the individual injection information setting unit 912 determines the correction factor <K_{M}> based on the target injection amount Q_{TM}, the injection time T_{iM} and the common rail pressure Pc* which, is detected at the timing temporally near to the injection start instruction timing t_{SM} of the Main fuel injection, referring to the three dimensional map 912c.

The common rail pressure Pc* which is detected at the timing temporally near to the injection start instruction timing t_{SM} of the Main fuel injection is the common rail pressure Pc which is detected at the timing retroacted by a predetermined short time period (e.g. the operation cycle of a few μ seconds to dozens of μ seconds) from the injection start instruction timing t_{SM} in consideration of the operation cycle.

In Step 137, the individual injection information setting unit 912 calculates T_{iM}×<K_{M}> to obtain a corrected injection time T_{iM} (T_{iM}=T_{iM}·<K_{M}>) of the Main fuel injection. In Step 138, the individual injection information setting unit 912 calculates the injection finish instruction timing t_{EM} of the Main fuel injection by adding the injection start instruction timing t_{SM} set in Step 131 and the corrected injection time T_{iM} of the Main fuel injection which is calculated in Step 137 (t_{EM}=t_{SM}+T_{iM}). In Step 139, the individual injection information setting unit 912 sets the injection finish instruction timing t_{EM} of the Main fuel, injection. More specifically, the individual injection information setting unit 912 outputs the injection finish instruction timing t_{EM} to the actuator driving circuit 806A and the actual fuel supply information detection unit 913 as the injection command signal. After Step 139, the processing proceeds to Step 140, following the connector (C).

In Step 140, the actual fuel supply information detection unit 913 determines whether or not an injection start signal of the Main fuel injection is received from the injection command signal. If the injection start signal, of the Main fuel injection is received (Yes), the processing proceeds to Step 141. If the injection start signal of the Main fuel injection is not received (No), the processing repeats Step 140. In Step 141, the actual fuel supply information detection unit 913 starts a timer t. In Step 142, the actual fuel supply information detection unit 918 resets the orifice passing flow amount Q_{Msum} for the Main fuel injection to be 0.0.

In Step 143, the actual fuel supply information detection unit 913 determines whether or not a positive orifice differential pressure ΔP_{OR} of being equal to or more than a predetermined threshold value is detected based on a signal indicating the orifice differential pressure ΔP_{OR} from the differential pressure sensor S_{dP}. If the positive orifice differential pressure ΔP_{OR} of being equal to or more than the predetermined threshold value is detected (Yes), the processing proceeds to Step 144. If the positive orifice differential pressure ΔP_{OR} of being equal to or more than the predetermined threshold value is not detected (No), the processing repeats Step 143.

If Yes is selected in Step 143, the actual fuel supply information detection unit 913 obtains the detection start timing t_{ORSM} of an orifice passing flow which is caused by the Main fuel injection by the timer t in Step 144.

Subsequently, the actual fuel supply information detection unit 913 calculates the orifice passing flow rate Q_{OR} (mm³/sec) from the orifice differential pressure ΔP_{OR} in Step 145.

The orifice passing flow rate Q_{OR} can be easily calculated from the orifice differential pressure ΔP_{OR} by using the equation (1).

In Step 146, the actual fuel supply information detection unit 913 time-integrates the orifice passing flow rate Q_{OR} as shown in the equation Q_{Msum}=Q_{Msum}+Q_{OR}·Δt.

In Step 147, the actual fuel supply information detection unit 913 determines whether or not a Main fuel injection finish signal is received from the injection command signal. If the Main fuel injection finish signal is received (Yes), the processing proceeds to Step 145. If the Main fuel injection finish signal is not received (No), the processing returns to Step 145 and repeats Steps 145 to 147. In Step 148, the actual fuel supply information detection unit 913 determines whether or not a negative orifice differential pressure ΔP_{OR} which is equal to or less than a predetermined threshold value is detected, based on the orifice differential pressure ΔP_{OR} from the differential pressure sensor S_{dP}.

If the negative orifice differential pressure ΔP_{OR} which is equal to or less than the predetermined threshold value is detected (Yes), the processing proceeds to Step 149. If the negative orifice differential pressure ΔP_{OR} which is equal to or less than the predetermined threshold value is not detected (No), the processing returns to Step 145 and repeats Steps 145 to 148.

The processing in Step 148 is to determine whether or not the orifice differential pressure ΔP_{OR} is more than a noise detected by the differential pressure sensor S_{dP} and is generated by a reflection wave caused by the completion of fuel injection.

Processing of Steps 145 to 148 is performed at a period of a few μ seconds to dozens of μ seconds, for example, and Δt is a period at which the filtering-processed pressure Ps_{fil} is sampled, which is a few μ seconds to dozens of μ seconds.

If “Yes” is selected in Step 148, in Step 149, the actual fuel supply information detection unit 913 obtains the detection finish timing t_{OREM} of an orifice passing fuel flow associated with the completion of the Main fuel injection by the timer t, and outputs the detection start timing t_{ORSM} of the orifice passing fuel flow obtained in Step 144, the detection finish timing t_{OREM} of the orifice passing fuel flow obtained in Step 149 and the orifice passing flow amount Q_{Msum} finally obtained by repeating Steps 145 to 148, to the actual fuel injection information detection unit 914.

The detection start timing t_{ORSM}, the detection finish timing t_{OREM}, and the orifice passing flow amount Q_{Msum} of the orifice passing fuel flow are also referred to as “actual fuel supply information”.

In Step 150, the actual fuel injection information detection unit 914 converts the detection start timing t_{ORSM} and the detection finish timing t_{OREM} of the orifice passing fuel flow into the injection start timing and the injection finish timing of the Main fuel injection, and sets the orifice passing flow amount Q_{Msum} as an actual injection amount Q_{AM} of the Main fuel injection. Then, the actual injection amount Q_{AM}, the injection start timing and the injection finish timing of the Main fuel injection are input to the individual injection information setting unit 912.

It is to be noted that the conversion of the detection start timing t_{ORSM} and the detection finish timing t_{OREM} of the orifice passing fuel flow into the injection start timing and the injection finish timing of the Main fuel injection can be easily performed by calculating an average flow velocity of the fuel flow based on an average value of the orifice passing flow rate Q_{OR} [symbol] Q_{Msum}/(t_{OREM}−t_{ORSM}) [symbol] and the cross-sectional area of the high pressure fuel supply passage 21 and considering the average flow velocity and the length of the fuel passage.

The actual injection amount Q_{AM}, the injection start timing and the injection finish timing of the Main fuel injection are referred to as “actual fuel injection information”.

After Step 150, the processing proceeds to Step 151, following the connector (D).

In Step 151, the individual injection information setting unit 912 calculates the correction factor K_{M}(=Q_{TM}/Q_{AM}) and stores the correction factor K_{M} in the three dimensional map 912c of the correction factor to update the three dimensional map 912c.

In Step 152, the actual fuel supply information detection unit 913 resets the timer t, by which a series of operations for controlling the Pilot fuel injection and the Main fuel injection for one cylinder 41 (see FIG. 55) is completed.

If the processing proceeds to Step 161 from Step 111 (i.e. the Pilot fuel injection is not performed), the individual injection information setting unit 912 determines the target injection amount Q_{TM} (=Q_{T}) and the injection start instruction timing t_{SM} of the Main fuel injection based on the engine rotation speed Ne and the required torque Trqsol. Next, in Step 162, the individual injection information setting unit 912 obtains the injection time T_{iM} of the Main fuel injection based on the common rail pressure Pc and the target injection amount Q_{TM} of the Main fuel injection determined in Step 161, referring to the two-dimensional map 912a.

In Step 163, the individual injection information setting unit 912 determines the correction factor <K_{M}> based on the target injection amount Q_{TM}, the injection time T_{iM} and the common rail pressure Pc of the Main fuel injection, referring to the three dimensional map 912c. The processing then proceeds to Step 137, following the connector (F).

A method performed by the ECU 80S for correcting the Main fuel injection based on the actual injection information of the Pilot fuel injection for each cylinder is described with reference to FIGS. 55 and 64A to 64D.

FIGS. 64A to 64D are graphs for showing output patterns of the injection command signals of the Pilot fuel injection and the Main fuel injection for one cylinder, and the temporal variations of the fuel flow in the high pressure fuel supply passage 21. FIG. 64A is a graph showing output patterns of the injection command signals. FIG. 64B is a graph showing the temporal variation of the actual fuel injection rate of the injector. FIG. 64C is a graph showing the temporal variation of the orifice passing flow rate of fuel. FIG. 64D is a graph showing the temporal variations of the pressures on the upstream and downstream sides of the orifice.

In FIG. 64A, the injection command signal of the Main fuel injection having the timing t_{SM} as the injection start instruction timing, the timing t_{EM} as the injection finish instruction timing and the injection time T_{iM} is output after the injection command signal of the Pilot fuel injection having the timing t_{SP} as the injection start instruction timing, the timing t_{EP} as the injection finish instruction timing and the injection time T_{iP}.

The injection start instruction timing t_{SM}, the injection finish instruction timing t_{EM} and the injection time T_{iM} of the Main fuel injection of the injection command signal are also referred to as “subsequent fuel injection information”.

In response to the injection command signals, the injector 5A which is a direct acting fuel injection valve starts the Pi lot fuel injection at the timing t_{SP1}, which is a little delayed from the fuel injection start instruction timing t_{SP}, and completes the Pilot fuel injection at the timing t_{EP1}, which is delayed a little from the injection finish instruction timing t_{EP} as shown in FIG. 64B. The injector 5A which is a direct acting fuel injection valve starts the Main fuel injection at the timing t_{SM1}, which is a little delayed from the fuel injection start instruction timing t_{SM}, and completes the Main fuel injection at the timing t_{EM1}, which is delayed a little from the injection finish instruction timing t_{EM} as shown in FIG. 64B.

The actual injection amount Q_{AP} of the Pilot fuel injection is calculated by time-integrating the actual fuel injection rates during the period from the injection start instruction timing t_{SP1} to the injection finishing timing t_{EP1} of the Pilot fuel injection. The actual injection amount Q_{AM} of the Main fuel injection is calculated by time-integrating the actual fuel injection rates during the period from the injection start instruction timing t_{SM}, to the injection finishing timing t_{EM1} of the Main fuel injection.

The injection start timing t_{PS1}, the injection finishing timing t_{PE1} and the actual injection amount Q_{AP} are also referred to as “actual fuel injection information” of the Pilot fuel injection, and the injection start timing t_{SM1}, the injection finishing timing t_{EM1} and the actual injection amount Q_{AM} are also referred to as “actual fuel injection information” of the Main fuel injection.

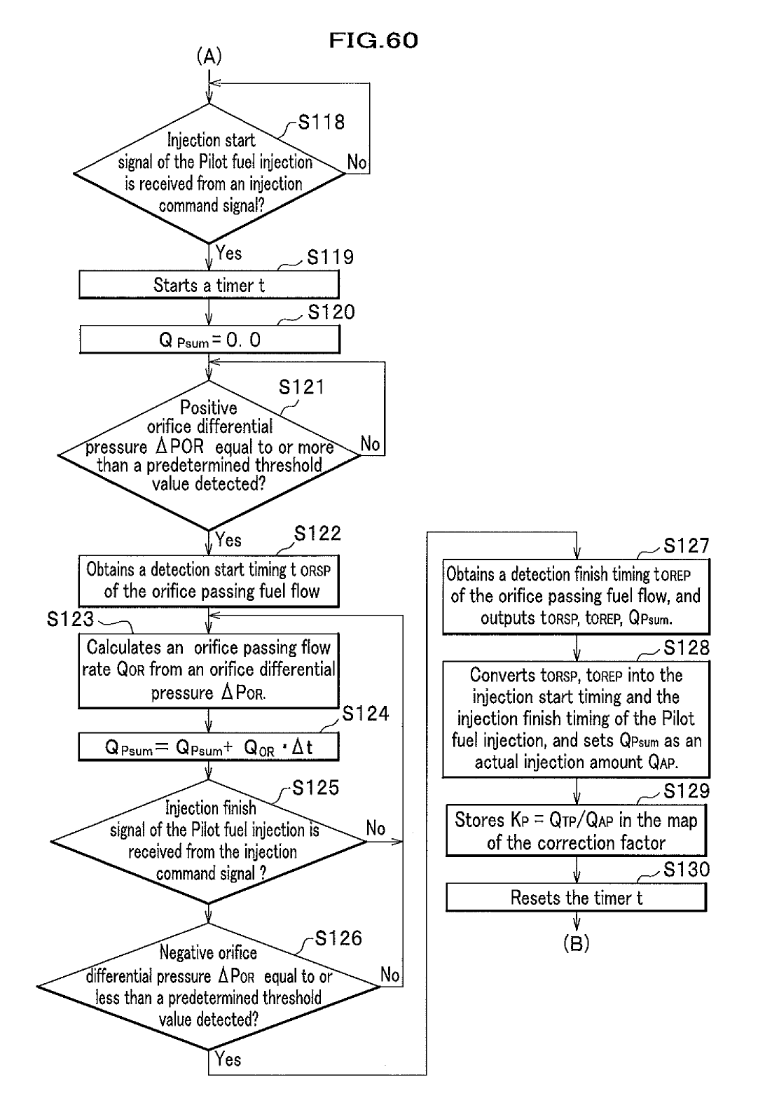

The flow rate of the fuel which passes the orifice 75 (the orifice passing flow rate Q_{OR}) caused by the Pilot fuel injection rises at the timing t_{SP2} (corresponding to the detection start timing t_{ORSP} of the orifice passing flow shown in the flow chart of FIG. 60), which is delayed a little from the injection start instruction timing t_{SP1} of the Pilot fuel injection by the volumes of a fuel passage (not shown) in the injector 5A (see FIG. 55) and the high pressure fuel supply passage 21 (see FIG. 55) as shown in FIG. 64C. Similarly, the orifice passing flow rate Q_{OR} returns to 0 at the timing t_{EP2} which is delayed from the timing t_{EP1} by the volumes of the fuel passage (not shown) in the injector 5A and the high pressure fuel supply passage 21 as shown in FIG. 64C.

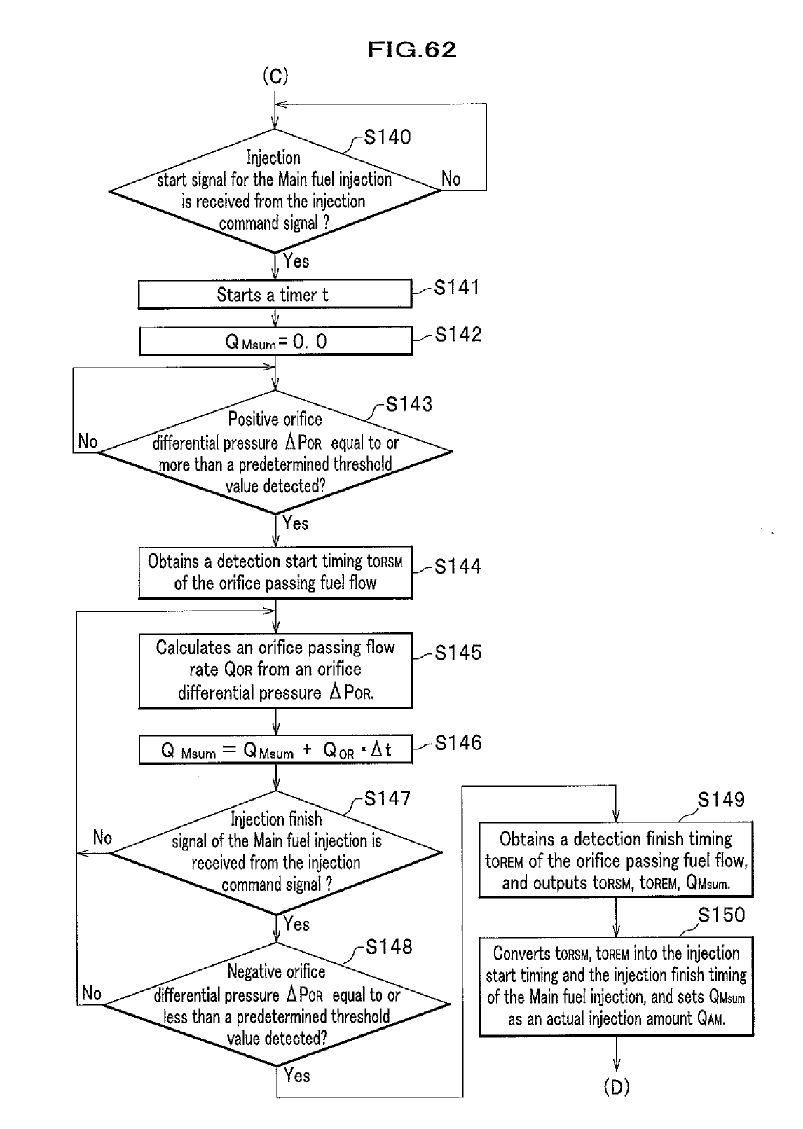

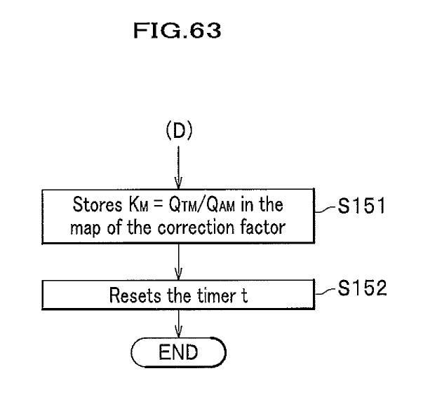

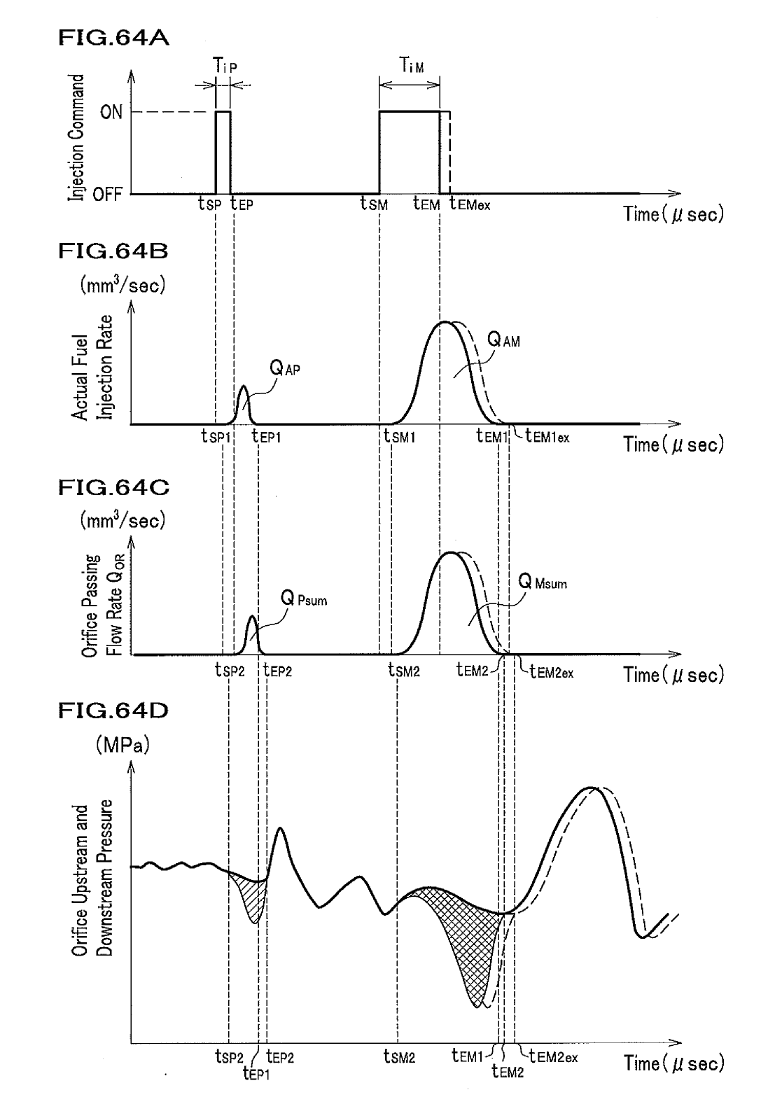

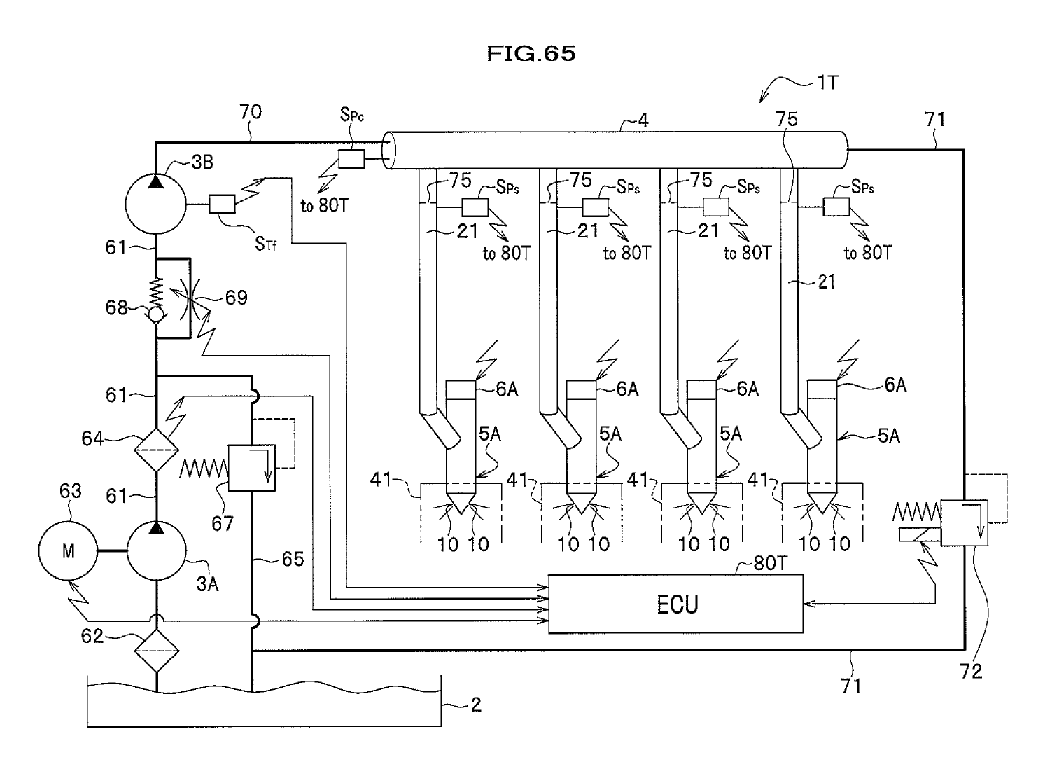

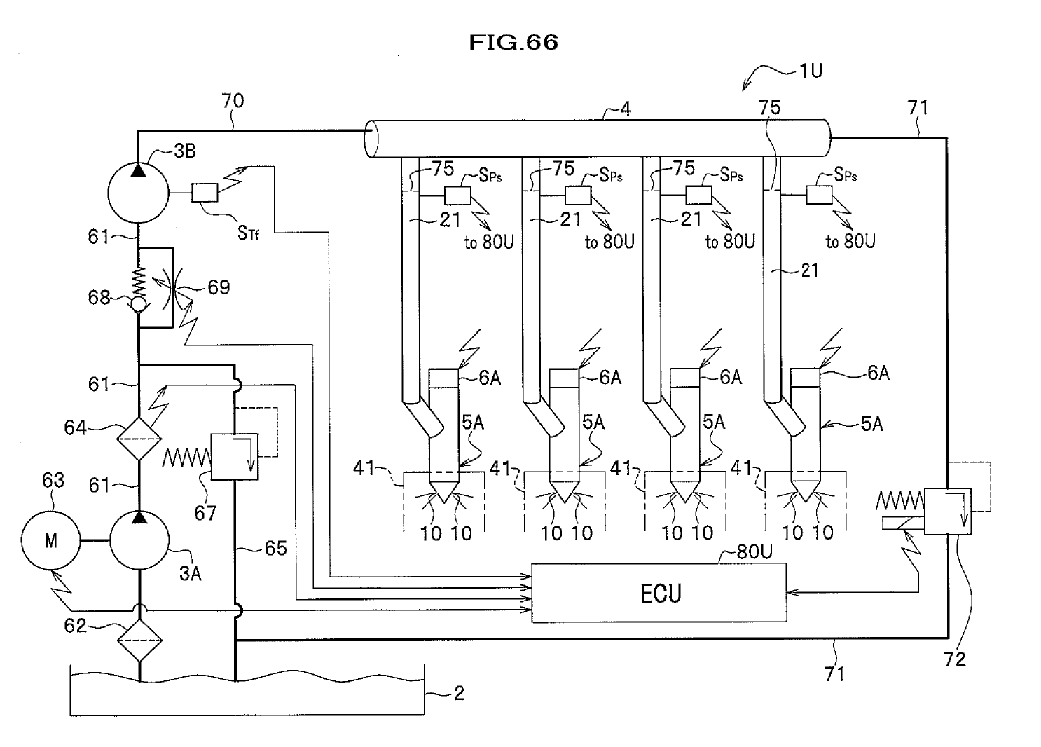

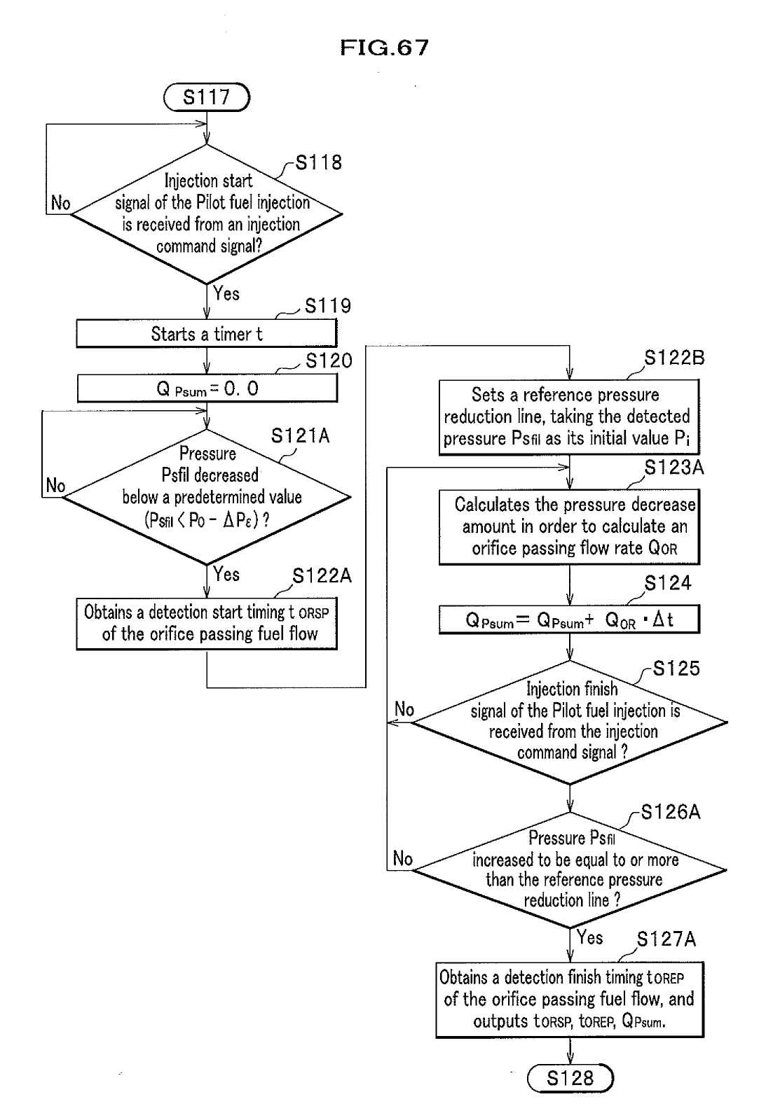

The orifice passing flow rate Q_{OR} of the Main fuel injection injector 5A rises at the timing t_{SM2} (corresponding to the detection start timing t_{ORSM} of the orifice passing flow shown in the flow chart of FIG. 62), which is delayed a little from the injection start instruction timing t_{SM1} of the Main fuel injection by the volumes of a fuel passage (not shown) in the injector 5A (see FIG. 55). Similarly, the orifice passing flow rate Q_{OR} returns to 0 at the timing t_{EM2} (corresponding to the detection finish timing t_{OREM} of the orifice passing flow shown in the flow chart of FIG. 62) which is delayed from the timing t_{EM1} by the volumes of the fuel passage (not shown) in the injector 5A and the high pressure fuel supply passage 21 as shown in FIG. 64C.

The timings t_{SP2} and t_{EP2} and the value obtained by time-integrating the orifice passing flow rate Q_{OR} during the time period from the timing t_{SP2} to the timing t_{EP2} (corresponding to the orifice passing flow amount Q_{Psum} of the flow chart of FIG. 60) are also referred to as “actual fuel supply information” of the Pilot fuel injection. The timings t_{SM2} and t_{EM2} and the value obtained by time-integrating the orifice passing flow rate Q_{OR} during the time period from the timing t_{SM2} to the timing t_{EM2} (corresponding to the orifice passing flow amount Q_{Msum} of the flow chart of FIG. 62) are also referred to as “actual fuel supply information” of the Main fuel injection.

Regarding the pressures of the upstream side and the down stream side of the orifice 75 corresponding to FIG. 64C, the orifice differential pressure ΔP_{OR} can be detected by the differential pressure sensor S_{dP} even if the pressure on the upstream side of the orifice is varied by the variation of the common rail pressure Pc as shown in FIG. 64D, which allows to accurately calculate the orifice passing flow rate Q_{OR}.

The area Q_{Psum} which is encompassed by the orifice passing flow rate Q_{OR} of the Pilot fuel injection shown in FIG. 64C corresponds to the area of the actual injection amount Q_{AP} shown in FIG. 64B and the area indicated by the diagonal lines in FIG. 64D in the case of the direct acting injector 5A.

The area Q_{Msum} encompassed by the orifice passing flow rate Q_{OR} of the Main fuel injection shown in FIG. 64C corresponds to the area of the actual injection amount Q_{AM} shown in FIG. 64B and the area indicated by the meshed pattern in FIG. 64D in the case of the direct acting injector 5A.

In accordance with the seventeenth embodiment, if the actual injection amount Q_{AP} of the Pilot fuel injection is smaller than the target injection amount Q_{TP}, the injection finish timing of the actual fuel injection rate of the Main fuel injection can be extended to t_{EM1ex} as shown in FIG. 64B by extending the injection time T_{iM} of the Main fuel injection of the injection command signal shown in FIG. 64A to the injection finish instruction timing t_{EMex}, which is shown by a dashed line, by the processing of Steps 132 to 135 of the flow chart. This allows to control the Main fuel injection so that the summation of the Pilot fuel injection amount and the Main fuel injection amount to be equal to the target injection amount Q_{T}.

The timing t_{EM2ex} in FIGS. 64C and 64D correspond to the injection finishing timing t_{EM1ex} of the actual fuel injection rate.

In contrast, if the actual injection amount Q_{AP} of the Pilot fuel injection is greater than the target injection amount Q_{TP}, the Main fuel injection can be controlled by shortening the injection time T_{iM} of the Main fuel injection by the processing of Steps 132 to 135 of the flow chart so that the summation of the Pilot fuel injection amount and the Main fuel injection amount is equal to the target injection amount Q_{T}.

As a result, the summation of the actual injection amounts of the Pilot fuel injection and the Main fuel injection (Q_{AP}+Q_{AM}), which contributes to the output torque of the cylinder 41 in a high ratio, can be controlled to be closer to the target injection amount Q_{T}, whereby the output control of the engine can be more accurately performed, and the engine vibration or the engine noise can be suppressed.

When determining the injection time T_{iM} of the Main fuel injection which follows the Pilot fuel injection, the common rail pressure Pc* which is detected at the timing temporally near to the injection start instruction timing t_{SM} of the Main fuel injection is used as shown in Step 135 of the flow chart, and the injection time T_{iM} of the Main fuel injection is not determined at the same time as the injection time T_{iP} of the Pilot fuel injection in Step 113 which is immediately after Step 112 in which the target injection amount Q_{T} is determined.

Thus, the disadvantage that the actual injection amount Q_{AM} of the Main fuel injection becomes different from the target injection amount Q_{TM} because the fuel supply passage pressure Ps or the common rail pressure Pc at the time of the Main fuel injection is different from the fuel supply passage pressure Ps or the common rail pressure Pc at the time when the injection time T_{iM} of the Main fuel injection is determined due to the variation of the fuel supply passage pressure Ps and the common rail pressure Pc in the Main fuel injection after the Pilot fuel injection as shown in FIGS. 85A and 85B, is improved

The injection time T_{iP} of the Pilot fuel injection is corrected by the correction factor K_{P}, which is the ratio between the target injection amount Q_{TP} and the actual injection amount Q_{AP} of the Pilot fuel injection, and the injection time T_{iM} of the Main fuel injection is corrected by the correction factor K_{M}, which is the ratio between the target injection amount Q_{TM} and the actual injection amount Q_{AM} of the Main fuel injection, as shown in Steps 114 and 115 and Steps 136, 137 and 163 of the flow chart, and the target injection amount Q_{TP} of the Pilot fuel injection and the target injection amount Q_{TM} of the Main fuel injection which are effectively corrected are used. Thus, it is possible to correct the variations of the output torque among the cylinders and secular changes in the injection characteristics of the injectors 5A or the actuators 6A, which allows to more accurately suppress the variations of the output torque among the cylinders.

More specifically, it is easy to accurately form the diameter of the opening of the orifice 75, and the orifice differential pressure ΔP_{OR} between the upstream side and the down stream side of the orifice 75 is greater than the differential pressure between the upstream side and the down stream side of the venturi constriction. Thus, the orifice passing flow rate Q_{OR} is easily calculated based on the orifice differential pressure ΔP_{OR} detected by the differential pressure sensor S_{dP} by using the equation (1). The actual fuel supply amount to the injector 5A can be also accurately calculated by calculating the orifice passing flow rate Q_{OR} from the orifice differential pressure ΔP_{OR}.

Even if the injectors 5A or actuators 6A are varied due to their manufacturing tolerance, it is possible to calculate an orifice passing flow rate Q_{OR} (i.e. the orifice passing flow amounts Q_{Psum}, Q_{Msum}) that reflects the variation of the injectors 5A due to the manufacturing tolerance. Thus, by correcting the injection time T_{iP}, T_{iM} (see FIGS. 3A to 3D) of the injection command signals of the Pilot fuel injection and the Main fuel injection from the ECU 80S to the injector 5A by the correction factors K_{P}, K_{M} based on the calculated orifice passing flow amounts Q_{Psum}, Q_{Msum}, respectively, it is possible to make the actual fuel supply amount to each cylinder 41 (see FIG. 55) to be equal.

As described above, it is possible to accurately control the actual injection amount for each cylinder 41, whereby the torque generated by each cylinder can be controlled more precisely.

The seventeenth embodiment is described using the two-stage injections of the Pilot fuel injection and the Main fuel injection as an example, however, embodiments of the present invention are not limited to this.

The fuel injection of the injector 5A is generally multi-injection including “Pilot injection”, “Pre injection”, “Main fuel injection”, “After injection” and “Post injection” in order to reduce PM (particulate material), NOx and a combustion noise and to increase exhaust temperature or to activate catalyst by supplying a reducing agent.

If an actual injection amount of such a multi-injection is not equal to a target amount calculated based on the operating condition of the engine, a regulated value of an exhaust gas from the engine may not be kept. In the seventeenth embodiment, even if the actual injection amount is varied by aging, the ECU 80S can control the actual fuel supply amount to be equal to the target amount by adjusting the injection time of the injection command signal since the actual injection amount can be accurately calculated based on the orifice differential pressure ΔP_{OR}.

The target injection amount of the subsequent fuel injection may be adjusted based on the actual injection amount of the preceding fuel injection in such a manner that the summation of the actual injection amounts of the Pilot fuel injection, the Pre fuel injection and the Main fuel injection is equal to the target injection amount Q_{T}. The differential fuel amount between the target injection amount Q_{T} and the summation of the actual injection amounts of the Pilot fuel injection and the Pre fuel injection may be divided and allocated to the target injection amount Q_{TM} of the Main fuel injection and the target injection amount Q_{TAft} of the After fuel injection.

As a result, it becomes easier to keep the regulated value of an exhaust gas even if requirement on hardware specifications, such as dimension tolerance of each part of the engine system, is relaxed. Especially, requirement on the hardware specification for injectors can be relieved, which contributes to reduction of the manufacturing cost of the engine system.

### Eighteenth Embodiment

Next, a fuel injection device according to an eighteenth embodiment of the present invention is described in detail with reference to FIG. 65.

FIG. 65 is an illustration for showing an entire configuration of the accumulator fuel injection device according to the eighteenth embodiment.

A fuel injection device 1T according to the eighteenth embodiment is different from the fuel injection device 1S according to the seventeenth embodiment in the following points: (1) a pressure sensor (fuel supply passage pressure sensor) S_{Ps} for detecting the pressure of the downstream side of the orifice 75 is provided instead of the differential pressure sensor S_{dP} which is provided in the high pressure fuel supply passage 21 for supplying fuel to the injector 5A attached to each cylinder 41 of the engine and detects the pressure difference between the upstream side and the downstream side of the orifice 75; (2) an ECU (control unit) 80T is provided instead of the ECU 80S; (3) the definition of the orifice differential pressure ΔP_{OR} which is used for calculating the orifice passing flow rate Q_{OR} of fuel in the ECU 80T is changed, and (4) a fuel supply passage pressure Ps* which is detected at the timing temporally near to the injection start instruction timing t_{SM} is used instead of the common rail pressure Pc* which is detected at the timing temporally near to the injection start instruction timing t_{SM} when determining the injection time T_{iM} of the Main fuel injection which follows the Pilot fuel injection.

Components of the eighteenth embodiment corresponding to those of the seventeenth embodiment are assigned like reference numerals, and descriptions thereof will be omitted.

As shown in FIG. 65, pressure signals detected by the four fuel supply passage pressure sensors S_{Ps} are input to the ECU 80T.

The function of the ECU 80T according to the eighteenth embodiment is basically the same as that of the ECU 80S according to the seventeenth embodiment, however, signals used by the ECU 80T to calculate the orifice passing flow rate Q_{OR} are different from those used in the seventeenth embodiment.

In the seventeenth embodiment, the orifice passing flow rate Q_{OR} is calculated by using the equation (1). In the eighteenth embodiment, the orifice differential pressure ΔP_{OR} in the equation (1) is replaced with the pressure difference (Pc−Ps) between the common rail pressure Pc which is detected by the pressure sensor S_{Pc} and the pressure Ps on the downstream side of the orifice 75, which is detected by the fuel supply passage pressure sensor S_{Ps}.

It is obvious that the pressure on the upstream side of orifice 75 in the high pressure fuel supply passage 21 is substantially equal to the common rail pressure Pc. Thus, even if the orifice differential pressure ΔP_{OR} in the equation (1) is replaced with the pressure difference (Pc−Ps), an orifice passing flow rate Q_{OR} of fuel (i.e. the actual injection amounts Q_{AP}, Q_{AM}) can be accurately calculated for each cylinder 41 and each injection command signal in the eighteenth embodiment, similarly to the seventeenth embodiment.

In the eighteenth embodiment, since the high pressure fuel supply passage 21 includes the fuel supply passage pressure sensor S_{Ps} on the downstream side of the orifice 75, the “common rail pressure Pc” is read as the “fuel supply passage pressure Ps” in Steps 113, 114, 162, 163 of the flow charts shown in FIGS. 59 to 63, and uses the fuel supply passage pressure Ps, and the “common rail pressure Pc* which is detected at the timing temporally near to the injection start instruction timing t_{SM}” is read as the “fuel supply passage pressure Ps* which is detected at the timing temporally near to the injection start instruction timing t_{SM}” in Steps 135 and 136, and uses the fuel supply passage pressure Ps* which is defected at the timing temporally near to the injection start instruction timing t_{SM} of the Main fuel injection.

In these Steps, it is possible to more accurately calculate and control the injection time T_{iP} and the correction factor <K_{P}> for the Pilot fuel injection and the injection time T_{iM} and the correction factor <K_{M}> for the Main fuel injection by using the fuel supply passage pressure Ps instead of the common rail pressure Pc.

Similarly to the seventeenth embodiment, the ECU 80T is allowed to obtain the actual injection amount of the preceding fuel injection and correct the actual injection amount of the subsequent fuel injection. The ECU 80T also enables to control the difference between the actual injection amount of the subsequent fuel injection and the target injection amount due to the variation of the fuel supply passage pressure Ps caused by the preceding fuel injection to be smaller.

It is also possible to control the actual injection amount to be equal to the target injection amount by adjusting the injection time of the injection command signal, thereby absorbing variations of the injection characteristics of the injectors 5A or the actuators 6A due to their manufacturing tolerance, and secular changes of the injection characteristics of the injectors 5A or the actuators 6A.

As a result, it becomes easier to keep the regulated value of an exhaust gas even if requirement on hardware specifications, such as dimension tolerance of each part of the engine system, is relaxed, similarly to the seventeenth embodiment. Especially, requirement on the hardware specification for injectors can be relieved, which contributes to reduction of the manufacturing cost of the engine system.

Advantages of the eighteenth embodiment which are the same as those of the seventeenth embodiment are omitted, and thus refer to the advantages of the seventeenth embodiment for them.

### Nineteenth Embodiment

Next, a fuel injection device according to a nineteenth embodiment of the present invention is described in detail with reference to FIG. 66.

FIG. 66 is an illustration for showing an entire configuration of the accumulator fuel injection device of the nineteenth embodiment.

A fuel injection device 1U of the nineteenth embodiment is different from the fuel injection device 1T of the eighteenth embodiment in the following points: (1) the common rail pressure sensor S_{Pc} for detecting the common rail pressure Pc is omitted (2) an ECU (control unit) 80U is provided instead of the ECU 80T; (3) a fuel supply passage pressure sensor S_{Ps} is provided instead of the common rail pressure sensor S_{Pc} for controlling the common rail, pressure Pc; and (4) a method performed by the ECU 80U for calculating the orifice passing flow rate Q_{OR} of fuel is changed from the method performed by the ECU 80T.

Components of the nineteenth embodiment corresponding to those of the eighteenth embodiment are assigned like reference numerals, and descriptions thereof will be omitted.

As shown in FIG. 66, pressure signals detected by the four fuel supply passage pressure sensors S_{Ps} are input to the ECU 80U.

The ECU 80U performs a filtering process on the pressure signals input from the fuel supply passage pressure sensors S_{Ps} for cutting off a noise with a high frequency.

The fuel supply passage pressure Ps on which the filtering process is performed is referred to as a pressure Ps_{fil}, hereinafter.

By filtering processing the pressure signal input from the fuel supply passage pressure sensor S_{Ps}, the pressure vibration of the pressure Ps_{fil} from the pressure sensor S_{Ps} becomes comparatively smaller at an “aspiration stroke” and “compression stroke” which follow the “explosion stroke” and “exhaust stroke” after a fuel injection is performed and completed in one cylinder based on signals from a crank angle sensor (not shown) and a cylinder discriminating sensor (not shown) and the injection command signal for each cylinder generated by the ECU 80U. The pressure Ps_{fil} from the fuel supply passage pressure sensor S_{Ps} in the state where its pressure vibration is comparatively smaller is substantially equal to the common rail pressure Pc.

The ECU 80U samples the pressure Ps_{fil} in the above described state where its pressure vibration is comparatively smaller and controls the pressure control valve 72 to control the common rail pressure Pc within a predetermined range.

Only one fuel supply passage pressure sensor S_{Ps} among the four fuel supply passage pressure sensors S_{Ps} may be representatively used for controlling the common rail pressure Pc in the case of the 4 cylinder engine used in the nineteenth embodiment, or all of the four fuel supply passage pressure sensors S_{Ps} may be used to generate four signals of which sampling timing is different, and the common rail pressure Pc may be set to be the average value of the four signals.

The function of the ECU 80U of the nineteenth embodiment is basically the same as that of the ECU 80T of the eighteenth embodiment except for the method for controlling the common rail pressure Pc. However, they are also different in that the orifice differential pressure used by the ECU 80U for calculating the orifice passing flow rate Q_{OR} of fuel is not based on the pressure difference detected by the differential pressure sensor S_{dP} or the common rail pressure sensors S_{Pc} and the fuel supply passage pressure sensor S_{Ps} as in the seventeenth or eighteenth embodiment, but based on only the signal from the pressure sensor S_{Ps} provided on the downstream side of the orifice 75.

In the nineteenth embodiment, the pressure Ps_{fil} sampled as above is used as the common rail pressure of the two-dimensional map 912a shown in FIG. 57. The pressure Ps_{fil} is used as the common rail pressure in the three dimensional maps 912b and 912c shown in FIGS. 58A and 58B.

Next, referring to FIGS. 67 to 70A and 70B, a method for calculating an orifice passing flow rate Q_{OR} (i.e. an actual injection amount) based on only the signal from the fuel supply passage pressure sensor S_{Ps} provided on the downstream side of the orifice 75 according to the nineteenth embodiment is described.

FIGS. 67 and 68 are flowcharts showing processing performed by the ECU 80U of the nineteenth embodiment for calculating the orifice passing flow rate Q_{OR} for one cylinder. The flow charts shown in FIGS. 67 and 68 show processing that is different from that of the flow chart of the eighteenth embodiment (i.e. the processing for obtaining the detection start timing of orifice passing fuel flow, calculating the orifice passing flow rate Q_{OR} or obtaining the detection finish timing of the orifice passing fuel flow based on the change of the fuel supply passage pressure Ps on the downstream side of the orifice 75 without using the orifice differential pressure ΔP_{OR}).

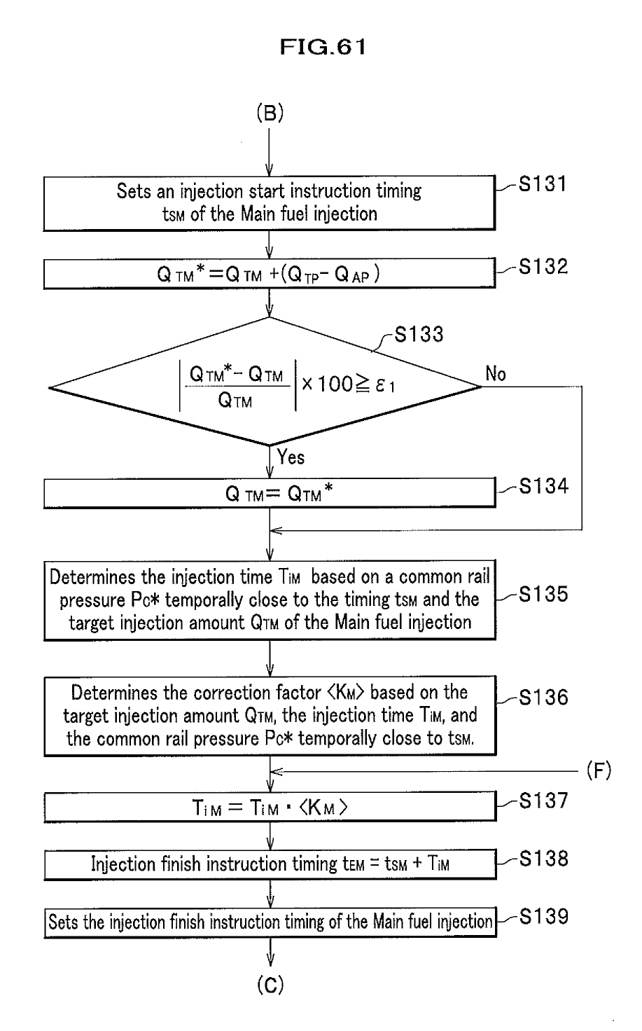

In the nineteenth embodiment, since the high pressure fuel supply passage 21 is provided with the fuel supply passage pressure sensor S_{Ps} on the downstream side of the orifice 75, the “common rail pressure Pc” in Steps 113, 114, 162 and 163 of the flow charts shown in FIGS. 59 to 63 is read as the “pressure Ps_{fil} obtained by filtering-processing the fuel supply passage pressure Ps” and the pressure Ps_{fil} is used, and the “common rail pressure Pc* detected at the timing temporally near to the t_{SM}” in Steps 135 and 136 of the flow chart shown in FIG. 61 is read as the “pressure Ps_{fil}* obtained by filtering-processing the fuel supply passage pressure Ps which is temporally near to the t_{SM}”, and the pressure Ps_{fil}* detected at the timing temporally near to the injection start instruction timing t_{SM} of the Main fuel injection is used in the nineteenth embodiment.

FIG. 69 is a graph for explaining a reference pressure reduction curve. As shown in FIG. 69, in the nineteenth embodiment, a reference pressure reduction line on the upstream side of the orifice 75 can be set as shown in FIG. 69 based on the experimental data that when the orifice differential pressure ΔP_{OR} becomes 0, which is caused by fuel flow after the fuel injection to the injector 5A, the pressure on the upstream side of the orifice 75 becomes always lower than the initial pressure before the fuel injection starts, and the longer the injection time is, the greater the amount of the pressure decrease becomes.

The above experimental data is also supported by the fact that the pressure decrease of the common rail pressure Pc caused by the fuel injection can be represented in the equations (4) and (5).

FIG. 69 is a graph for explaining the reference pressure reduction line, and exemplary shows a reference pressure reduction line x1 and a reference pressure reduction quadratic curve x2 as the reference pressure reduction line.

Pi represents the initial value of the fuel supply passage pressure Ps before the fuel injection starts, and is floating as described later. As the injection time Tᵢ gets longer, the decrease amount of the initial pressure Pi becomes larger as shown in FIG. 69.

FIGS. 70A to 70D are graphs showing an output pattern of the injection command signal for one cylinder and the temporal variations of fuel flow in the high pressure fuel supply passage. FIG. 70A is a graph for showing an output pattern of the injection command signal for one cylinder. FIG. 70B is a graph for showing the temporal variation of an actual fuel injection rate of the injector. FIG. 70C is a graph for showing the orifice passing flow rate of fuel. FIG. 70D is a graph for showing the temporal variation of the pressure decrease amount of the pressure on the downstream side of the orifice.

Firstly, the processing for obtaining the orifice passing flow detection start timing t_{ORSP}, calculating the orifice passing flow rate Q_{OR} and obtaining the orifice passing flow detection finish timing t_{OREP} based on the change in the fuel supply passage pressure Ps on the downstream side of the orifice 75 in the Pilot fuel injection is described.

In Step 118 of the flow chart shown in FIG. 67 that follows Step 117 of the flow chart shown in FIG. 59, the actual fuel supply information detection unit 913 determines whether or not an injection start signal of the Pilot fuel injection is received from the injection command signal. If the injection start signal of the Pilot fuel injection is received (Yes), the processing proceeds to Step 119. If the injection start signal of the Pilot fuel injection is not received (No), the processing repeats Step 118. In Step 119, the actual fuel supply information detection unit 913 starts a timer t. In Step 120, the actual fuel supply information detection unit 913 resets the orifice passing flow amount Q_{Psum} for the Pilot fuel injection to be 0.0.

In Step 121A, the actual fuel supply information detection unit 913 determines whether or not the filtering processed pressure Ps_{fil} on the downstream side of the orifice 75 which is detected by the fuel supply passage pressure sensor S_{Ps} is decreased below a predetermined value [symbol] (Ps_{fil}<P₀−ΔPε)? [symbol] . If it is decreased below the predetermined value (Yes), the processing proceeds to Step 122A. If it is not (No), the processing repeats Step 121A.

In FIG. 70D, the timing when the pressure Ps_{fil} on the downstream side is decreased below the predetermined value P0 by ΔPε is t_{SP2}.

The predetermined value P0 is set as follows: the fuel supply passage pressure Ps detected by the fuel supply passage pressure sensor S_{Ps} is filtering processed to remove a noise with a high frequency, such as a pressure pulsation caused by the filling operation of the high pressure pump 3B, a pressure pulsation caused by the propagation of the pressure vibration resulted from the injection operation of the injector 5B of other cylinders, and a pressure pulsation caused by a reflection wave of the injection operation of the injector 5B of the own cylinder, and the lowest value in the variation of the pressure that have been filtering-processed is set to be the predetermined value P0. The predetermined value P0 can be easily set by obtaining a predetermined pressure fluctuation of the fuel supply passage pressure Ps_{fil} by experiments in advance.

If Yes is selected in Step 121A, the actual fuel supply information detection unit 913 obtains the detection start timing t_{ORSP} of the orifice passing flow caused by the Pilot fuel injection by the timer t in Step 122A. In Step 122B, the actual fuel supply information detection unit 913 sets a reference pressure reduction line, taking the pressure Ps_{fil} at the detection start timing t_{ORSP} of the orifice passing flow obtained in Step 121A as the initial, value Pi, as shown in FIG. 70D

The initial, value Pi may be equal to the predetermined value (P₀−ΔPε). The initial value Pi may not be equal to the predetermined value (P₀−ΔPε) since the pressure Ps_{fil} sampled in the cycle next to the cycle in which the pressure Ps_{fil} is sampled in Step 121A may be used in Step 122B.

In Step 123A, the actual fuel supply information detection unit 913 calculates the amount of pressure decrease ΔPdown of the pressure Ps_{fil} from the reference pressure reduction line whose initial value is the initial value Pi in order to calculate the orifice passing flow rate Q_{OR}.

The definition of ΔPdown is shown in FIG. 70B.

The orifice passing flow rate Q_{OR} can be readily calculated by using the equation (1) in which the pressure decrease amount ΔPdown is substituted for ΔP_{OR}. In Step 124, the actual fuel supply information detection unit 913 time-integrates the orifice passing flow rate Q_{OR} as shown in Q_{Psum}=Q_{Psum}+Q_{OR}·Δt.

In Step 125, the actual fuel supply information detection unit 913 determines whether or not a signal indicating the finish of the Pilot fuel injection is received from the injection command signal. If the signal indicating the finish of the Pilot fuel injection is received (Yes), the processing proceeds to Step 126A. If the signal indicating the finish of the Pilot fuel injection is not received (No), the processing returns to Step 123A and repeats Steps 123A to 125.

In Step 126A, the actual fuel supply information detection unit 913 determines whether or not the filtering processed pressure Ps_{fil} on the downstream side of the orifice 75 exceeds the reference pressure reduction line. If it exceeds the reference pressure reduction line (Yes), the processing proceeds to Step 127A. If it does not (No), the processing returns to Step 123A, and repeats Steps 123A to 126A.

If “Yes” is selected in Step 126A, in Step 127A, the actual fuel supply information detection unit 913 obtains the detection finish timing t_{OREP} (corresponding to the timing t_{EP2} in FIG. 70D) of an orifice passing fuel flow caused by the completion of the Pilot fuel injection by the timer t, and outputs the detection start timing t_{ORSP} of the orifice passing fuel flow obtained in Step 122A, the detection finish timing t_{OREP} of the orifice passing fuel flow obtained in Step 127A and the orifice passing flow amount Q_{Psum} finally obtained by repeating Steps 123A to 126A, to the actual fuel injection information detection unit 914. The detection start timing t_{ORSP}, the detection finish timing t_{OREP}, and the orifice passing flow amount Q_{Psum} of the orifice passing fuel flow are also referred to as “actual fuel supply information”.

The orifice passing flow amount Q_{Psum} (i.e. actual injection amount Q_{AP}) corresponds to the dotted area which is encompassed by the reference pressure reduction line x1 and the curve indicating the pressure Ps_{fil} in FIG. 70D.

Next, the processing for obtaining the orifice passing flow detection start timing t_{ORSM}, calculating the orifice passing flow rate Q_{OR} and obtaining the orifice passing flow detection finish timing t_{ORSM} based on the change in the fuel supply passage pressure Ps on the downstream side of the orifice 75 in the Main fuel injection is described.

In Step 141 of the flow chart shown in FIG. 68 that follows Step 140 of the flow chart shown in FIG. 62, the actual fuel supply information defection unit 913 starts a timer t. In Step 142, the actual fuel supply information detection unit 913 resets the orifice passing flow amount Q_{Msum} for the Main fuel injection to be 0.0.

In Step 143A, the actual fuel supply information detection unit 913 determines whether or not the filtering processed pressure Ps_{fil} on the downstream side of the orifice 75 which is detected by the fuel supply passage pressure sensor S_{Ps} is decreased below a predetermined value [symbol] (Ps_{fil}<P₀−ΔPε)? [symbol] . If it is decreased below the predetermined value (Yes), the processing proceeds to Step 143A. If it is not (No), the processing repeats Step 143A.

The Ps_{fil}* used here is the pressure Ps_{fil} detected at the timing temporally near to the injection start instruction timing t_{SM} of the Main fuel injection, and ΔPε is the threshold value set in advance for determining whether or not a change in the pressure Ps_{fil} is more than a noise level.

If Yes is selected in Step 143A, the actual fuel supply information detection unit 913 obtains the detection start timing t_{ORSM} of the orifice passing flow caused by the Main fuel injection by the timer t in Step 144A. In Step 144B, the actual fuel supply information detection unit 913 sets a reference pressure reduction line, taking the pressure Ps_{fil} at the detection start timing t_{ORSM} of the orifice passing flow obtained in Step 143A as the initial value Pi.

The initial value Pi may be equal to the predetermined value (Ps_{fil}*−ΔPε). The initial value Pi may not be equal to the predetermined value (Ps_{fil}*−ΔPε) since the pressure Ps_{fil} sampled in the cycle next to the cycle in which the pressure Ps_{fil} is sampled in Step 143A may be used in Step 144B.

In Step 145A, the actual fuel supply information detection unit 913 calculates the amount of pressure decrease ΔPdown of the pressure Ps_{fil} from the reference pressure reduction line whose initial value is the initial value Pi in order to calculate the orifice passing flow rate Q_{OR}.

The definition of ΔPdown is shown in FIG. 70D.

The orifice passing flow rate Q_{OR} can be readily calculated by using the equation (1) in which the pressure decrease amount ΔPdown is substituted for the ΔP_{OR}. In Step 146, the actual fuel supply information detection unit 913 time-integrates the orifice passing flow rate Q_{OR} as shown in the equation Q_{Psum}=Q_{Psum}+Q_{OR}·Δt.

In Step 147, the actual fuel supply information detection unit 913 determines whether or not a signal indicating the finish of the Main fuel injection is received from the injection command signal. If the signal indicating the finish of the Main fuel injection is received (Yes), the processing proceeds to Step 148A. If the signal indicating the finish of the Main fuel injection is not received (No), the processing returns to Step 145A, and repeats Steps 145A to 147.

In Step 148A, the actual fuel supply information detection unit 913 determines whether or not the filtering processed pressure Ps_{fil} on the downstream side of the orifice 75 exceeds the reference pressure reduction line. If it exceeds the reference pressure reduction line (Yes), the processing proceeds to Step 149A. If it does not (No), the processing returns to Step 145A, and repeats Steps 145A to 148A.

If “Yes” is selected in Step 148A, in Step 149A, the actual fuel supply information detection unit 913 obtains the detection finish timing t_{OREM} of an orifice passing fuel flow caused by the completion of the Main fuel, injection by the timer t, and outputs the detection start timing t_{ORSM} of the orifice passing fuel flow obtained in Step 144A, the detection finish timing t_{OREM} of the orifice passing fuel flow obtained in Step 149A and the orifice passing flow amount Q_{Msum} finally obtained by repeating Steps 145A to 148A, to the actual fuel injection information detection unit 914. The detection start timing t_{ORSM}, the detection finish timing t_{OREM}, and the orifice passing flow amount Q_{Msum} of the orifice passing fuel flow are also referred to as “actual fuel supply information”.

If only the Main fuel injection is carried out without performing a multi-injection, in Step 143A, the following processing “the actual fuel supply information detection unit 913 determines whether or not the filtering processed pressure Ps_{fil} on the downstream side of the orifice 75 detected by the fuel supply passage pressure sensor S_{Ps} is decreased below the predetermined value [symbol] Ps_{fil}<P₀−ΔPε? [symbol] . If it is decreased below the predetermined value (P₀−ΔPε) (Yes), the processing proceeds to Step 144A. If it is not (No), the processing repeats Step 143A” is performed instead of the processing “the actual fuel supply information detection unit 913 determines whether or not the filtering processed pressure Ps_{fil} on the downstream side of the orifice 75 which is detected by the fuel supply passage pressure sensor S_{Ps} is decreased below a predetermined value [symbol] Ps_{fil}<Ps_{fil}*−ΔPε? [symbol] . If it is decreased below the predetermined value (Ps_{fil}*−ΔPε) (Yes), the processing proceeds to Step 143A. If it is not (No), the processing repeats Step 143A”.

In accordance with the nineteenth embodiment, it is possible to easily control the common rail pressure Pc by using the fuel supply passage pressure sensor S_{Ps} which detects the fuel supply passage pressure Ps on the downstream side of the orifice 75 even if the pressure sensor S_{Pc} which detects the common rail pressure Pc is omitted. This allows to reduce the cost of the fuel injection system.

It is also possible to accurately calculate the orifice passing flow amounts Q_{Psum}, Q_{Msum} (i.e. the actual injection amounts Q_{AP}, Q_{AM}) for each cylinder and each injection command signal by calculating the orifice passing flow rate Q_{OR} based on the equation (1) in which the pressure decrease amount ΔPdown(P₀−Ps_{fil}) is substituted for the orifice differential pressure ΔP_{OR} by using only the pressure signal from the fuel supply passage pressure sensor S_{Ps} for detecting the pressure on the downstream side of the orifice 75.

The ECU 80U is allowed to obtain, similarly to the eighteenth embodiment, the actual injection amount of the preceding fuel injection and correct the actual injection amount of the subsequent fuel injection. The ECU 80U also enables to control the difference between the actual injection amount of the subsequent fuel injection and the target injection amount due to the variation of the fuel supply passage pressure Ps caused by the preceding fuel injection to be smaller.

It is also possible to control the actual, injection amount to be equal to the target injection amount by adjusting the injection time of the injection command signal, thereby absorbing variations of the injection characteristics of the injectors 5A or the actuators 6A due to their manufacturing tolerance, and secular changes of the injection characteristics of the injectors 5A or the actuators 6A.

As a result, it becomes easier to keep the regulated value of an exhaust gas even if requirement on hardware specifications, such as dimension tolerance of each part of the engine system, is relaxed, similarly to the eighteenth embodiment. Especially, requirement on the hardware specification for injectors can be relieved, which contributes to reduction of the manufacturing cost of the engine system.

In the seventeenth to nineteenth embodiments, the injector 5A, which is the direct acting fuel injection valve, is used, and its actuator 6A is a type of actuator which directly moves the nozzle needle by using a piezoelectric stack that is formed by stacking piezoelectric elements in layers, however, the injector 5A is not limited to this configuration. For example, an injector using an electromagnetic coil as the actuator 6A may be used.

### Twentieth Embodiment

A fuel injection device of a twentieth embodiment of the present invention is described in detail below with reference to FIGS. 71 to 73.

FIG. 71 is an illustration showing an entire configuration of an accumulator fuel injection device of the twentieth embodiment. FIG. 72 is a functional block diagram of the engine controlling device used in the accumulator fuel injection device of the twentieth embodiment. FIG. 73 is a conceptual graph of the map of the back flow rate function of a back pressure injector.

A fuel injection device 1V of the twentieth embodiment differs from the fuel injection device 1S of the seventeenth embodiment in that: (1) an injector 5B which is a back pressure fuel injection valve including an actuator 6B is used; (2) in accordance with (1), a drain passage 9 is connected to the injector 5B provided in each cylinder, and the drain passages 9 are further connected to a return fuel pipe 73, which is connected to the low pressure fuel supply passage 61 (the low pressure part of the fuel supply system) on the discharge side of the low pressure pump 3A via a flow controller in which a check valve 74 and the orifice 76 is connected in parallel; and (3) the fuel injection device 1V in the twentieth embodiment is controlled by the ECU (control unit) 80V.

Components of the twentieth embodiment corresponding to those of the seventeenth embodiment are assigned like reference numerals, and descriptions thereof will be omitted.

The injector 5B of the twentieth embodiment is a well known injector, and uses a piezoelectric stack formed by stacking piezoelectric elements in layers as the actuator 6B to move a valve incorporated in the injector 5B, thereby opening the back pressure chamber (not shown) of the injector 5B to the side of the drain passage 9 or closing the back pressure chamber to indirectly move a nozzle needle (not shown).

It is to be noted that the injector 5B having a higher response speed can be realized by using the piezoelectric stack as the actuator 6B.

(Injection Control Unit)

As shown in FIG. 72, the ECU 80V of the twentieth embodiment has basically the same configuration as that of the ECU 80S of the seventeenth embodiment, however, the ECU 80V includes injection control units 905A′, 905B′, 905C′, 905D′ instead of the injection control units 905A, 905B, 905C, 905D.

Each of the injection control units 905A′, 905B′, 905C′, 905D′ includes a multi-injection control unit 910′, an actual fuel supply information detection unit 913′ and an actual fuel injection information detection unit 914′. The multi-injection control, unit 910′ further includes a multi-injection mode control unit 911 and an individual injection information setting unit 912′.

The individual injection information setting unit 912′ performs the following process based on the result of the process performed by the multi-injection mode control unit 911 for selecting the two-stage injection or the single-stage injection. If, for example, the two-stage injection is selected, the individual injection information setting unit 912 divides the target injection amount Q_{T} into the target injection amount Q_{TP} of the Pilot fuel injection and the target injection amount Q_{TM} of the Main fuel injection, and then sets the injection start instruction timing t_{SP} and the injection finish instruction timing t_{EP} of the Pilot fuel injection, and the injection start instruction timing t_{SM} and the injection finish instruction timing t_{EM} of the Main fuel injection based on the target injection amount Q_{T}, the TDC signal, the crank angle signal, the engine rotation speed Ne and the required torque Trqsol from the target injection amount calculation unit 802. Then, the individual injection information setting unit 912 outputs the injection command signal to the actuator driving circuit 806 (shown as 806A, 806B, 806C, 806D in FIG. 72) as well as the actual fuel supply information detection unit 913′.

The individual injection information setting unit 912′ includes a back flow rate function map 912d as well as the two-dimensional map 912a (see FIG. 57), the three dimensional map 912b (see FIG. 58A) and the three dimensional map 912c(see FIG. 58B).

The back flow rate function map 912d is a two-dimensional map of the common rail pressure Pc and the injection time Tᵢ as shown in FIG. 73 for obtaining the back flow rate function Q_{BF}(t), and a back flow rate function Q_{BF}(t) is exemplary shown in FIG. 73.

The back flow rate function Q_{BF}(t) is represented by a function of time (μ sec), which is taken along the abscissa, and the back flow rate Q_{BF} (mm³/sec), which is taken along the ordinate. The time period between the injection start instruction timing t_{S} and the injection finish instruction timing t_{E} of the injection command signal corresponds to the injection time Tᵢ, and the time period between the back flow start timing t_{SBF} when a back flow actually starts and the back flow finish timing t_{EBF} when the back flow finishes corresponds to a back flow time period T_{iBF}.

In the back pressure injector 5B, since an orifice passing flow amount is calculated by adding the back flow amount obtained by time-integrating the back flow rate function Q_{BF}(t) to the actual injection amount which is actually injected to the combustion chamber of the cylinder 41 from the fuel injection port 10 (see FIG. 71) of the injector 5B, an actual injection amount can not be obtained just by time-integrating the orifice passing flow rate Q_{OR}.

Thus, a back flow rate is also calculated by using the back flow rate function Q_{BF}(t) which is determined by the common rail pressure Pc and the injection time Tᵢ.

In the back flow rate function Q_{BF}(t), the back flow time period T_{iBF} becomes longer as the injection time Tᵢ gets longer, and the back flow rate becomes higher as the common rail pressure Pc gets higher. However, since the back flow flows from the back pressure chamber to the discharge side of the low pressure pump 3A via the drain passage 9 and a flow controller which connects the check valve 74 and the orifice 76 in parallel, the back flow environment is not so hard as in the environment of the injection to the combustion chamber, a secular change in the back flow rate is small. Thus, it is possible to ensure adequate accuracy of the back flow rate even if the back flow rate function map 912d is used which stores back flow data obtained by experiment in advance.

The actual fuel supply information detection unit 913′ detects the detection start timing t_{ORSP}, a fuel injection start detection timing t_{ORSiP} and the detection finish timing t_{OREP} of the fuel flow passing the orifice 75 for the Pilot fuel injection based on a signal indicating the orifice differential pressure ΔP_{OR} from the differential pressure sensor S_{dP} for the relevant cylinder 41 (see FIG. 71), calculates the orifice passing flow rate Q_{OR} based on a fuel temperature T_{f} from the fuel temperature sensor S_{Tf} and the orifice differential pressure ΔP_{OR}, and then time-integrates the orifice passing flow rate Q_{OR} to calculate an orifice passing flow amount Q_{Psum}. The actual fuel supply information detection unit 913′ obtains the back flow rate function Q_{BF}(t) from the back flow rate function map 912d and time-integrates the back flow rate Q_{BF}(t) at the time t to calculate the back flow amount Q_{BFsum}, and obtains the back flow finish timing t_{OREBF} of the orifice passing flow.

Similarly to the Pilot injection, the actual fuel supply information detection unit 913′ also detects the detection start timing t_{ORSM}, a fuel injection start detection timing t_{ORSiM} and the detection finish timing t_{OREM} of the fuel, flow passing the orifice 75 for the Main fuel injection based on a signal indicating the orifice differential pressure ΔP_{OR}, calculates the orifice passing flow rate Q_{OR} based on a fuel temperature T_{f} from the fuel, temperature sensor S_{Tf} and the orifice differential pressure ΔP_{OR}, and then time-integrates the orifice passing flow rate Q_{OR} to calculate an orifice passing flow amount Q_{Msum}.

The actual fuel supply information detection unit 913′ obtains the back flow rate function Q_{BF}(t) from the back flow rate function map 912d and time-integrates the back flow rate Q_{BF}(t) at the time t to calculate the back flow amount Q_{BFsum}, and obtains the back flow finish timing t_{OREBF} of the orifice passing flow.

The actual fuel supply information detection unit 913′ outputs the detection start timing t_{ORSP}, the fuel injection start detection timing t_{ORSiP}, the detection finish timing t_{OREP}, the back flow finish timing t_{OREBF}, the orifice passing flow amount Q_{Psum} and the back flow amount Q_{BFsum}, of the fuel flow passing the orifice 75 for the Pilot fuel injection to the actual fuel injection information detection unit 914. The actual fuel supply information detection unit 913 also outputs the detection start timing t_{ORSM}, the fuel injection start detection timing t_{ORsiM}, the back flow finish timing t_{OREBF}, the detection finish timing t_{OREM}, the orifice passing flow amount Q_{Msum} and the back flow amount Q_{BFsum} of the fuel flow passing the orifice 75 for the Main fuel injection to the actual fuel injection information detection unit 914.

The actual fuel injection information detection unit 914′ converts the detection start timing t_{ORSP}, the fuel injection start detection timing t_{ORSiP}, the back flow finish timing t_{ORBEF}, the detection finish timing t_{OREP} of the Pilot fuel injection to the back flow start timing of the injector 5B, the injection start timing of the Pilot fuel injection from the fuel injection port 10, the back flow finish timing, and the injection finishing timing of the Pilot fuel injection from the fuel injection port 10, respectively, and deduces the back flow amount Q_{BFsum} from the orifice passing flow amount Q_{Psum} to calculate an actual injection amount Q_{AP}.

The actual fuel injection information detection unit 914′ converts the detection start timing t_{ORSM}, the fuel injection start detection timing t_{ORSiM}, the back flow finish timing t_{OREBF}, the detection finish timing t_{OREM} of the Main fuel injection to the back flow start timing of the injector 5B, the injection start timing of the Main fuel injection from the fuel injection port 10, the back flow finish timing, and the injection finishing timing of the Main fuel injection from the fuel injection port 10, respectively, and deduces the back flow amount Q_{BFsum} from the orifice passing flow amount Q_{Msum} to calculate an actual injection amount Q_{AM}.

These converted data are input to the individual injection information setting unit 912′ and used for correction as needed.

A control flow for calculating an actual injection amount from an orifice passing flow rate Q_{OR} is described with reference to FIGS. 74 and 75. FIGS. 74 and 75 are flow charts showing the control operation for calculating an actual injection amount from an orifice passing flow rate Q_{OR}. In FIGS. 74 and 75, the Pilot fuel injection and the Main fuel injection are not discriminated and are represented as a generic form.

In the case of the Pilot fuel injection, the processing proceeds to Step 311 of the flow chart shown in FIG. 74 after Step 117 of the flow chart of the seventeenth embodiment shown in FIGS. 59 to 63, and further proceeds to Step 130 of the flow charts of the seventeenth embodiment shown in FIGS. 59 to 63 after Step 331 of the flow chart shown in FIG. 75.

In the case of the Main fuel injection, the processing proceeds to Step 311 of the flow chart shown in FIG. 74 after Step 139 of the flow charts of the seventeenth embodiment shown in FIGS. 59 to 63, and further proceeds to Step 152 of the flow charts of the seventeenth embodiment shown in FIGS. 59 to 63 after Step 331 of the flow chart shown in FIG. 75.

In the case of the Pilot fuel injection, the injection time Tᵢ, the orifice passing flow amount Qₛᵤₘ, and the detection start timing T_{ORS}, fuel injection start detection timing t_{ORSi}, detection finish timing T_{ORE} of the orifice passing flow, the fuel actual injection amount Q_{A} and the target injection amount Q_{T} in the flow charts shown in FIGS. 74 and 75 are read as the injection time T_{iP}, the orifice passing flow amount Q_{Psum}, and the detection start timing T_{ORSP}, fuel injection start detection timing t_{ORSiP} and detection finish timing T_{OREP} of the orifice passing flow, the actual injection amount Q_{AP} and the target injection amount Q_{TP} of the Pilot fuel injection, respectively. In the case of the Main fuel injection, the injection time Tᵢ, the orifice passing flow amount Qₛᵤₘ, and the detection start timing T_{ORS}, fuel injection start detection timing t_{ORSi}, detection finish timing T_{ORE} of the orifice passing flow, the fuel actual injection amount Q_{A} and the target injection amount Q_{T} in the flow charts shown in FIGS. 74 and 75 are read as the injection time T_{iM}, the orifice passing flow amount Q_{Msum}, and the detection start timing T_{ORSM}, fuel injection start detection timing t_{ORSiM} and detection finish timing T_{OREM} of the orifice passing flow, the actual injection amount Q_{AM} and the target injection amount Q_{TM} of the Main fuel injection, respectively.

Taking the case of the Pilot fuel injection as an example, the flow charts shown in FIGS. 74 and 75 are described. Terms in [ ] represents those used for the Pilot fuel injection.

If the processing proceeds to Step 311 after Step 117 of the flow charts of the seventeenth embodiment shown in FIGS. 59 to 63, the actual fuel supply information detection unit 913′ obtains the back flow rate function which corresponds to the common rail pressure Pc and the injection time Tᵢ [T_{iP}]. More specifically, the actual fuel supply information detection unit 913′ obtains the back flow start timing t_{SBE} when the back flow actually starts and the back flow time period T_{iBF} which are associated with the injection time Tᵢ [T_{iP}] shown in FIG. 73, as well as the back flow rate function Q_{BF}(t).

In Step 312, the actual fuel supply information detection unit 913′ determines whether or not an injection start signal of the fuel injection [Pilot fuel injection] is received from the injection command signal. If the injection start signal of the fuel injection [Pilot fuel injection] is received (Yes), the processing proceeds to Step 313. If the injection start signal of the fuel injection [Pilot fuel injection] is not received (No), the processing repeats Step 312. In Step 313, the actual fuel supply information detection unit 913 starts a timer t, and sets IFLAG to be 0.

IFLAG is a flag for determining whether or not an actual fuel injection to the combustion chamber is started after the back flow starts and is initially reset to be 0.0.

In Step 314, the actual fuel supply information detection unit 913′ resets the orifice passing flow amount Qₛᵤₘ [Q_{Psum}] and the back flow amount Q_{BFsum} for the fuel injection [Pilot fuel injection] to be 0.0.

In Step 315, the actual fuel supply information detection unit 913′ determines whether or not a positive orifice differential pressure ΔP_{OR} of being equal to or more than a predetermined threshold value is detected based on a signal indicating the orifice differential pressure ΔP_{OR} from the differential pressure sensor S_{dP}. If the positive orifice differential pressure ΔP_{OR} of being equal to or more than the predetermined threshold value is detected (Yes), the processing proceeds to Step 316. If the positive orifice differential pressure ΔP_{OR} of being equal to or more than the predetermined threshold value is not detected (No), the processing repeats Step 315.

The positive orifice differential pressure ΔP_{OR} used here is an orifice differential pressure ΔP_{OR} generated when fuel is flowed from the side of the common rail 4 to the side of the injector 5A. An orifice differential pressure ΔP_{OR} generated when this fuel flow is reversed is a negative orifice differential pressure ΔP_{OR}.

The processing in Step 315 is to determine whether or not the orifice differential pressure ΔP_{OR} is more than a noise detected by the differential pressure sensor S_{dP} and is generated by fuel injection.

If Yes is selected in Step 315, the actual fuel supply information detection unit 913′ obtains the detection start timing t_{ORS} [t_{ORSP}] of an orifice passing flow which is caused by the fuel injection [Pilot fuel injection] by the timer t in Step 316.

Subsequently, in Step 317, the actual fuel supply information detection unit 913′ sets the detection start timing t_{ORS} [t_{ORSP}] of the orifice passing fuel flow as the back flow start timing t_{SBF} of the back flow rate function Q_{BF}, (t) and calculates the back flow finish timing t_{OREBF}(=t_{ORS}+T_{iBF}) [(=t_{ORSP}+T_{iBF})]. This means that the back flow start timing t_{SBF} is matched to be the detection start timing t_{ORS} of the orifice passing fuel flow {(t_{SBF}=t_{ORS}) [t_{SBF}=t_{ORSP}]} with respect to the time axis t of the back flow rate function Q_{BF}(t).

Subsequently, the actual fuel supply information detection unit 913′ calculates the orifice passing flow rate Q_{OR} (mm³/sec) from the orifice differential pressure ΔP_{OR} in Step 318.

In Step 319, the actual fuel supply information detection unit 913′ time-integrates the orifice passing flow rate Q_{OR} as shown in the following equation Qₛᵤₘ=Qₛᵤₘ+Q_{OR}·Δt[Q_{Psum}=Q_{Psum}+Q_{OR}*Δt].

In Step S320, the actual fuel supply information detection unit 913′ time-integrates the back flow rate Q_{BF}(t) as shown in the following equation Q_{BFsum}=Q_{BFsum}+Q_{BF}(t)·Δt.

In Step 321, the actual fuel supply information detection unit 913′ determines whether or not IFLAG=0. If IFLAG=0 (Yes), the processing proceeds to Step 322. If IFLAG is not 0 (No), the processing proceeds to Step 325.

In Step 322, the actual fuel supply information detection unit 913′ determines whether or not the orifice passing flow rate Q_{OR} exceeds the back flow rate Q_{BF}(t). If the orifice passing flow rate Q_{OR} exceeds the back flow rate Q_{BF}(t), the processing proceeds to Step 323. If it is not (No), the processing proceeds to Step 325.

In Step 323, the actual fuel supply information detection unit 913′ obtains the fuel injection start detection timing t_{ORsi} [t_{ORSiP}] of the orifice passing fuel flow. In Step 324, the actual fuel supply information detection unit 913′ sets IFLAG=1.

More specifically, the fact that the orifice passing flow rate Q_{OR} exceeds the back flow rate Q_{BF}(t) means fuel injection from the fuel injection port 10 to the combustion chamber is started to be detected.

In Step 325, the actual fuel supply information detection unit 913′ determines whether or not a fuel injection finish signal of the fuel injection [Pilot fuel injection] is received from the injection command signal. If the fuel injection finish signal of the fuel injection [Pilot fuel injection] is received (Yes), the processing proceeds to Step 326. If the fuel injection finish signal of the fuel injection [Pilot fuel injection] is not received (No), the processing returns to Step 318, following the connector (I), and repeats Steps 318 to 325. In Step 326, the actual fuel supply information detection unit 913′ determines whether or not a negative orifice differential pressure ΔP_{OR} which is equal to or less than a predetermined threshold value is detected, based on the orifice differential pressure ΔP_{OR} from the differential pressure sensor S_{dP}.

If the negative orifice differential pressure ΔP_{OR} which is equal to or less than the predetermined threshold value is detected (Yes), the processing proceeds to Step 327. If the negative orifice differential pressure ΔP_{OR} which is equal to or less than the predetermined threshold value is not detected (No), the processing returns to Step 318 and repeats Steps 318 to 326.

The processing in Step 326 is to determine whether or not the orifice differential pressure ΔP_{OR} is more than a noise detected by the differential pressure sensor S_{dP} and is generated by a reflection wave caused by the completion of fuel, injection.

Processing of Steps 318 to 326 is performed at a period of a few to dozens of μ seconds, for example, and Δt is a period at which the filtering-processed pressure Ps_{fil} is sampled, which is a few to dozens of μ seconds.

If “Yes” is selected in Step 326, in Step 327, the actual fuel supply information detection unit 913′ obtains the detection finish timing t_{ORE} [t_{OREP}] of an orifice passing fuel flow associated with the completion of the fuel injection [Pilot fuel injection] by the timer t, and outputs the detection start timing t_{ORS} [t_{ORSP}] of the orifice passing fuel flow obtained in Step 316, the back flow finish timing t_{OREBF} obtained in Step 317, the fuel injection start detection timing t_{ORSi} [t_{ORsiP}] of the orifice passing fuel flow obtained in Step 323, the detection finish timing t_{ORE} [t_{OREP}] of the orifice passing fuel flow obtained in Step S327, and the orifice passing flow amount Q_{Psum} and the back flow amount Q_{BFsum} finally obtained by repeating Steps 318 to 326, to the actual fuel injection information detection unit 914′.

The detection start timing t_{ORS} [t_{ORSP}], the fuel, injection start detection timing t_{ORSi}. [t_{ORsiP}], the back flow finish timing t_{OREBF}, and the detection finish timing t_{ORE} [t_{OREP}] of the orifice passing fuel flow, and the orifice passing flow amount Qₛᵤₘ [Q_{Psum}] and the back flow amount Q_{BFsum} are also referred to as “actual fuel supply information”.

In Step 328, the actual fuel injection information detection unit 914′ converts the detection start timing t_{ORS} [t_{ORSP}], the back flow finish timing t_{OREBF}, the fuel injection start detection timing t_{ORSi} [t_{ORSiP}] and the detection finish timing t_{ORE} [t_{OREP}] of the orifice passing fuel flow into the back flow start, timing, the back flow finish timing, the injection start timing, and the injection finish timing, respectively.

In Step 329, the actual fuel injection information detection unit 914′ calculates an actual injection amount Q_{A} [Q_{AP}] (Q_{A}=Qₛᵤₘ−Q_{BFsum}, [Q_{AP}=Q_{Psum}−Q_{BFsum}]) by deducing the back flow amount Q_{BFsum} from the orifice passing flow amount Qₛᵤₘ [Q_{Psum}].

The actual injection amount, Q_{A} [Q_{AP}], the back flow start timing, the injection start timing, the back flow finish timing, and the injection finishing timing of the fuel injection [Pilot fuel, injection] are input to the individual injection information setting unit 912′.

It is to be noted that the above described conversion of the detection start timing t_{ORS} [t_{ORSP}], the back flow finish timing t_{OREBF}, the fuel injection start detection timing t_{ORSi} [t_{ORSiP}] and the detection finish timing t_{ORE} [t_{OREP}] of the orifice passing fuel flow into the back, flow start timing, the injection start timing, the back flow finish timing, and the injection finishing timing of the fuel injection the injection [Pilot fuel injection] can be easily performed by calculating an average flow velocity of the fuel flow based on an average value of the orifice passing flow rate Q_{OR} {Qₛᵤₘ/(t_{ORE}−t_{ORS}), [Q_{Psum}/(t_{OREP}−t_{ORSP})} and the cross-sectional area of the high pressure fuel supply passage 21 and considering the average flow velocity and the length of the fuel passage.

The actual injection amount, Q_{A} [Q_{AP}], the injection start timing and the injection finish timing of the fuel injection [Pilot fuel injection] are referred to as “actual fuel injection information”.

In Step 330, the individual injection information setting unit 912′ calculates the correction factor K(=Q_{T}/Q_{A}) [correction factor K_{P}(=Q_{TP}/Q_{AP})] and stores the correction factor K [K_{P}] in the three dimensional map 912b of the correction factor to update the three dimensional map 912b.

In Step 331, the actual fuel injection information detection unit 914′ resets IFLAG=0. Then, the processing proceeds to Step 130 of the flow chart shown in FIGS. 59 to 63.

The processing for the Main fuel injection is briefly described below. With replacement of readings described before, the processing proceeds to Step 311 from Step 139 of the flow chart shown in FIGS. 59 to 63, (an omission) and in Step 330 the individual injection information setting unit 912′ calculates the correction factor K(=QT/QA) [correction factor K_{M}(=Q_{TM}/Q_{AM})] and stores the correction factor K [K_{M}] in the three dimensional map 912c of the correction factor to update the three dimensional map 912c.

In Step 331, the actual fuel injection information detection unit 914′ resets IFLAG=0. Then, the processing proceeds to Step 152 of the flow chart shown in FIGS. 59 to 63.

A method performed by the ECU 80V for correcting the Main fuel injection based on the actual injection information of the Pilot fuel injection for each cylinder 41 is described with reference to FIGS. 71, 72 and 76A to 76D.

FIGS. 76A to 76D are graphs for showing an output pattern of the injection command signals of the Pilot fuel injection and the Main fuel injection for one cylinder, and the temporal variations of the fuel flow in the high pressure fuel supply passage. FIG. 76A is a graph showing an output pattern of the injection command signals. FIG. 76B is a graph showing the temporal variation of the actual fuel, injection rate and the back flow rate of the injector. FIG. 76C is a graph showing the temporal variation of the orifice passing flow rate of fuel. FIG. 76D is a graph showing the temporal variations of the pressures on the upstream and downstream sides of the orifice.

In FIG. 76A, the injection command signal of the Main fuel injection having the timing t_{SM} as the injection start instruction timing, the timing t_{EM} as the injection finish instruction timing and the injection time T_{iM} is output after the injection command signal of the Pilot fuel injection having the timing t_{SP} as the injection start instruction timing, the timing t_{EP} as the injection finish instruction timing and the injection time T_{iP}.

In response to the injection command signals, in the injector 5B, which is a back pressure fuel injection valve, the back flow start timing of the Pilot fuel injection is the timing t_{SPA}, which is a little delayed from the fuel injection start instruction timing t_{SP}, the injection start timing is the timing t_{SPB}, which is a little delayed from the timing t_{SPA}, and the injection finishing timing t_{EPB} comes after them. In the injector 5B, which is the back pressure fuel injection valve, the back flow start timing of the Main fuel injection is the timing t_{SMA}, which is a little delayed from the fuel injection start instruction timing t_{SM}, the injection start timing is the timing t_{SMB} which is a little delayed from the timing t_{SMA}, the back flow finish timing is the timing t_{EMA}, which is a little delayed from the injection finish instruction timing t_{EM}, and the injection finishing timing t_{EMB} comes after them.

The flow rate of the fuel which passes the orifice 75 (the orifice passing flow rate Q_{OR}) caused by the Pilot fuel injection rises at the timing t_{SP2}, which is delayed a little from the back flow start timing t_{SPA} of the Pilot fuel injection by the volumes of a fuel passage (not shown) in the injector 5B (see FIG. 71) and the high pressure fuel supply passage 21 (see FIG. 7D as shown in FIG. 76C. Similarly, the orifice passing flow rate Q_{OR} returns to 0 at the timing t_{EP2} which is delayed from the injection finishing timing t_{EPB} by the volumes of the fuel passage (not shown) in the injector 5B and the high pressure fuel supply passage 21 as shown in FIG. 76C.

Regarding the pressures of the upstream side and the down stream side of the orifice 75 corresponding to FIG. 76C, the orifice differential pressure ΔP_{OR} can be detected by the differential pressure sensor S_{dP} even if the pressure on the upstream side of the orifice is varied by the variation of the common rail pressure Pc as shown in FIG. 76D, which allows to accurately calculate the orifice passing flow rate Q_{OR}.

The area Q_{Psum} which is encompassed by the orifice passing flow rate Q_{OR} of the Pilot fuel injection shown in FIG. 76C corresponds to the summation of the area of the actual injection amount Q_{AP} and the area of the back flow amount Q_{BFsum} (i.e. Q_{Psum}) shown in FIG. 76B in the case of the back pressure injector 5B. The area Q_{Msum} encompassed by the orifice passing flow rate Q_{OR} of the Main fuel injection shown in FIG. 76C corresponds to the summation of the area of the actual injection amount Q_{AM} and the back flow amount Q_{BFsum} shown in FIG. 76B (i.e. Q_{Msum}). The Q_{Psum} and Q_{Msum} correspond to the shaded area and the area indicated by the meshed pattern in FIG. 76D, respectively in the case of the back pressure injector 5B.

It is obvious that the back flow amount Q_{BFsum} of the Pilot fuel injection is different from the back flow amount Q_{BFsum}, of the Main fuel injection.

In accordance with the twentieth embodiment, if the actual injection amount Q_{AP} of the Pilot fuel injection is smaller than the target injection amount Q_{TP}, the injection finish timing of the actual fuel injection rate of the Main fuel injection can be extended to t_{EMBex} as shown in FIG. 76B by extending the injection time T_{iM} of the Main fuel injection of the injection command signal shown in FIG. 76A to the injection finish instruction timing t_{EMex}, which is shown by a dashed line, by the processing of Steps 132 to 135 of the flow chart shown in FIG. 61. This allows to control the Main fuel injection so that the summation of the Pilot fuel injection amount and the Main fuel injection amount to be equal to the target injection amount Q_{T}.

The timing t_{EM2ex} in FIGS. 76C and 76D correspond to the injection finishing timing t_{EMBex} of the actual fuel injection rate.

In contrast, if the actual injection amount Q_{AP} of the Pilot fuel injection is greater than the target injection amount Q_{TP}, the Main fuel injection can be controlled by shortening the injection time T_{iM} of the Main fuel injection by the processing of Steps 132 to 135 of the flow chart so that the summation of the Pilot fuel injection amount and the Main fuel injection amount is equal to the target injection amount Q_{T}.

As a result, the summation of the actual injection amounts of the Pilot fuel injection and the Main fuel injection (Q_{AP}+Q_{AM}), which contributes to the output torque of the cylinder 41 in a high, ratio, can be controlled to be closer to the target injection amount Q_{T}, whereby the output control of the engine can be more accurately performed, and the engine vibration or the engine noise can be suppressed.

When determining the injection time T_{iM} of the Main fuel injection which follows the Pilot fuel injection, the common rail pressure Pc* which is detected at the timing temporally near to the injection start instruction timing t_{SM} of the Main fuel injection is used as shown in Step 135 of the flow chart in FIG. 61, and the injection time T_{iM} of the Main fuel injection is not determined at the same time as the injection time T_{iP} of the Pilot fuel injection in Step 113 which is immediately after Step 112 shown in FIG. 59 in which the target injection amount Q_{T} is determined.

Thus, the disadvantage that the actual injection amount Q_{AM} of the Main fuel injection becomes different from the target injection amount Q_{TM} because the fuel supply passage pressure Ps or the common rail pressure Pc at the time of the Main fuel injection becomes different from the fuel supply passage pressure Ps or the common rail pressure Pc at the time when the injection time T_{iM} of the Main fuel injection is determined due to the variation of the fuel supply passage pressure Ps and the common rail, pressure Pc in the Main fuel injection after the Pilot fuel injection as shown in FIG. 85B, is improved

Since the injection time T_{iP} of the Pilot fuel injection is corrected by the correction factor K_{P}, which is the ratio between the target injection amount Q_{TP} and the actual injection amount; Q_{AP} of the Pilot fuel injection, and the injection time T_{iM} of the Main fuel injection is corrected by the correction factor K_{M}, which is the ratio between the target injection amount Q_{TM} and the actual injection amount Q_{AM} of the Main fuel injection, as shown in Steps 114 and 115 and Steps 136, 137 of the flow chart, and the target injection amount Q_{TP} of the Pilot fuel injection and the target injection amount Q_{TM} of the Main fuel injection which are effectively corrected are used. Thus, it is possible to correct the variations of the output torque among the cylinders and secular changes in the injection characteristics of the injectors 5B or the actuators 6B, which allows to more accurately suppress the variations of the output torque among the cylinders.

More specifically, it is easy to accurately form the diameter of the opening of the orifice 75, and the orifice differential pressure ΔP_{OR} between the upstream side and the downstream side of the orifice 75 is greater than the differential pressure between the upstream side and the down stream side of the venturi constriction. Thus, the orifice passing flow rate Q_{OR} is easily calculated based on the orifice differential pressure ΔP_{OR} detected by the differential pressure sensor S_{dP} by using the equation (1).

It is also possible to calculate the orifice passing flow rate Q_{OR} from the orifice differential pressure ΔP_{OR} and to accurately calculate the orifice passing flow amounts Q_{Psum}, Q_{Msum}, which are actual fuel supply amounts to the injector 5B, and the back flow amount Q_{BFsum} by obtaining the back flow rate function Q_{BF}(t) and using the back flow rate Q_{BF}(t).

Even if the injectors 5B or actuators 6B are varied duo to their manufacturing tolerance, it is possible to calculate an orifice passing flow rate Q_{OR} (i.e. the orifice passing flow amounts Q_{Psum}, Q_{Msum}) that reflects the variation of the injectors 5B due to the manufacturing tolerance. Thus, actual injection amounts Q_{AP}, Q_{AM} can be calculated based on the calculated Q_{Psum}, Q_{Msum} and the back flow amount Q_{BFsum}. By correcting the injection time T_{iP}, T_{iM} (see FIGS. 3A to 3D) of the injection command signals of the Pilot fuel injection and the Main fuel injection from the ECU 80V to the injector 5B by the correction factors K_{P}, K_{M}, respectively, it is possible to make the actual fuel supply amount to each cylinder 41 (see FIG. 71) to be equal.

As described above, it is possible to accurately control the actual injection amount for each cylinder 41, whereby the torque generated by each cylinder can be controlled more precisely.

The twentieth embodiment is described using the two-stage injections of the Pilot fuel injection and the Main fuel injection as an example, however, embodiments of the present invention are not limited to this.

The fuel injection of the injector 5B is generally multi-injection including “Pilot injection”, “Pre injection”, “Main fuel injection”, “After injection” and “Post injection” in order to reduce PM (particulate material), NOx and a combustion noise and to increase exhaust temperature or to activate catalyst by supplying a reducing agent.

If an actual injection amount of such a multi-injection is not equal to a target amount calculated based on the operating condition of the engine, a regulated value of an exhaust gas from the engine may not be kept. In the twentieth embodiment, even if the actual injection amount is varied by aging, the ECU 80V can control the actual fuel supply amount to be equal to a target amount by adjusting the injection time of the injection command signal since the actual injection amount can be accurately calculated based on the orifice differential pressure ΔP_{OR}.

The target injection amount of the subsequent fuel injection may be adjusted based on the actual injection amount of the preceding fuel injection in such a manner that the summation of the actual injection amounts of the Pilot fuel injection, the Pre fuel injection and the Main fuel injection is equal to the target injection amount Q_{T}. The differential, fuel amount between the target injection amount Q_{T} and the summation of the actual injection amounts of the Pilot fuel injection and the Pre fuel injection may be divided and allocated to the target injection amount Q_{TM} of the Main fuel injection and the target injection amount Q_{TAft} of the After fuel injection.

As a result, it becomes easier to keep the regulated value of an exhaust gas even if requirement on hardware specifications, such as dimension tolerance of each part of the engine system, is relaxed. Especially, requirement on the hardware specification for injectors can be relieved, which contributes to reduction of the manufacturing cost of the engine system.

### Twenty-First Embodiment

Next, a fuel injection device according to a twenty-first embodiment of the present invention is described in detail with reference to FIG. 77.

FIG. 77 is an illustration for showing an entire configuration of the accumulator fuel injection device according to the twenty-first embodiment.

A fuel injection device 1W according to the twenty-first embodiment is different from the fuel injection device 1V according to the twentieth embodiment in the following points: (1) a pressure sensor (fuel supply passage pressure sensor) S_{Ps} for detecting the pressure of the downstream side of the orifice 75 is provided instead of the differential pressure sensor S_{dP} which is provided in the high pressure fuel supply passage 21 for supplying fuel to the injector 5B attached to each cylinder 41 of the engine and detects the pressure difference between the upstream side and the downstream side of the orifice 75; (2) an ECU (control unit) 80W is provided instead of the ECU 80V; (3) the definition of the orifice differential pressure ΔP_{OR} which is used for calculating the orifice passing flow rate Q_{OR} of fuel in the ECU 80V is changed, and (4) a fuel supply passage pressure Ps* which is detected at the timing temporally near to the injection start instruction timing t_{SM} is used instead of the common rail pressure Pc* which is detected at the timing temporally near to the injection start instruction timing t_{SM} when determining the injection time T_{iM} of the Main fuel injection which follows the Pilot fuel injection.

In other words, the twenty-first embodiment uses the injector 5B, which is a back pressure fuel injection valve, instead of the injector 5A, which is a direct acting fuel injection valve, and is modified from the eighteenth embodiment to be adapted to the injector 5B.

Components of the twenty-first embodiment corresponding to those of the twentieth embodiment are assigned like reference numerals, and descriptions thereof will be omitted.

As shown in FIG. 77, pressure signals detected by the four fuel supply passage pressure sensors S_{Ps} are input to the ECU 80W.

The function of the ECU 80W according to the twenty-first embodiment is basically the same as that of the ECU 80S according to the twentieth embodiment, however, signals used by the ECU 80W to calculate the orifice passing flow rate Q_{OR} are different from those used in the twentieth embodiment.

In the twentieth embodiment, the orifice passing flow rate Q_{OR} is calculated by using the equation (1). In the twenty-first embodiment, the orifice differential pressure ΔP_{OR} in the equation (1) is replaced with the pressure difference (Pc−Ps) between the common rail pressure Pc which is detected by the pressure sensor S_{Pc} and the pressure Ps on the downstream side of the orifice 75, which is detected by the fuel supply passage pressure sensor S_{Ps}.

It is obvious that the pressure on the upstream side of the orifice 75 in the high pressure fuel supply passage 21 is substantially equal to the common rail pressure Pc. Thus, even if the orifice differential pressure ΔP_{OR} in the equation (1) is replaced with the pressure difference (Pc−Ps), an orifice passing flow rate Q_{OR} of fuel and the actual injection amounts Q_{AP}, Q_{AM} can be accurately calculated, and the back flow amounts Q_{BFsum} can also be calculated by obtaining the back flow rate function Q_{BF}(t) in the twenty-first embodiment, similarly to the twentieth embodiment.

It is also possible to calculate an actual injection amount Q_{AP} by deducing the back flow amount Q_{BFsum} from the orifice passing flow amount Q_{Psum}, and an actual injection amount Q_{AM} by deducing the back flow amount Q_{BFsum} from the orifice passing flow amount Q_{Msum}.

More specifically, the actual injection amount Q_{AP}, Q_{AM} can be calculated for each cylinder 41 and each injection command signal. As a result, the ECU 80W can control the actual injection amount to be equal to the target fuel injection amount by adjusting the injection time of the injection command signal, similarly to the twentieth embodiment.

In the twenty-first embodiment, since the high pressure fuel supply passage 21 includes the fuel supply passage pressure sensor S_{Ps} on the downstream side of the orifice 75, the “common rail pressure Pc” is read as the “fuel supply passage pressure Ps” in Steps 113, 114, 162, 163 of the flow chart of FIGS. 59 to 63, and uses the fuel supply passage pressure Ps, and the “common rail pressure Pc* which is detected at the timing temporally near to the injection start instruction timing t_{SM}” is read as the “fuel supply passage pressure Ps* which is detected at the timing temporally near to the injection start instruction timing t_{SM}” In Steps 135 and 136 in FIGS. 74 and 75, and uses the fuel supply passage pressure Ps* which is detected at the timing temporally near to the injection start instruction timing t_{SM} of the Main fuel injection.

By using the fuel supply passage pressure Ps instead of the common rail pressure Pc in these Steps, it is possible to calculate an accurate injection time T_{iP} and correction factor <K_{P}> for the Pilot fuel injection and an accurate injection time T_{iM} and correction factor <K_{M}> for the Main fuel injection for controlling the injection.

Similarly to the twentieth embodiment, the ECU 80W is allowed to obtain the actual injection amount of the preceding fuel injection and correct the actual injection amount of the subsequent fuel injection. The ECU 80W also enables to control the difference between the actual injection amount of the subsequent fuel injection and the target injection amount due to the variation of the fuel supply passage pressure Ps caused by the preceding fuel injection to be smaller.

It is also possible to control the actual injection amount to be equal to the target, injection amount by adjusting the injection time of the injection command signal, thereby absorbing variations of the injection characteristics of the injectors 5B or the actuators 6B due to their manufacturing tolerance, and secular changes of the injection characteristics of the injectors 5B or the actuators 6B.

As a result, it, becomes easier to keep the regulated value of an exhaust gas even if requirement on hardware specifications, such as dimension tolerance of each part of the engine system, is relaxed, similarly to the twentieth embodiment. Especially, requirement on the hardware specification for injectors can be relieved, which contributes to reduction of the manufacturing cost of the engine system.

Advantages of the twenty-first embodiment which are the same as those of the twentieth embodiment are omitted, and thus refer to the advantages of the twentieth embodiment for them.

### Twenty-Second Embodiment

Next, a fuel injection device according to a twenty-second embodiment of the present invention is described in detail, with reference to FIG. 78.

FIG. 78 is an illustration for showing an entire configuration of the accumulator fuel injection device of the twenty-second embodiment.

A fuel injection device 1X of the twenty-second embodiment is different from the fuel injection device 1W of the twenty-first embodiment in the following points: (1) the common rail pressure sensor S_{Pc} for detecting the common rail pressure Pc is omitted (2) an ECU (control unit) 80X is provided instead of the ECU 80W; (3) a fuel supply passage pressure sensor S_{Ps} is provided instead of the common rail pressure sensor S_{Pc} for controlling the common rail, pressure Pc; and (4) a method performed by the ECU 80X for calculating the orifice passing flow rate Q_{OR} of fuel is changed from the method performed by the ECU 80W.

In other words, the twenty-second embodiment uses the injector 5B, which is a back pressure fuel injection valve, instead of the injector 5A, which is a direct acting fuel injection valve, and is modified from the nineteenth embodiment to be adapted to the injector 5B.

Components of the twenty-second embodiment corresponding to those of the twenty-first embodiment are assigned like reference numerals, and descriptions thereof will be omitted.

As shown in FIG. 78, pressure signals detected by the four fuel supply passage pressure sensors S_{Ps} are input to the ECU 80X.

The ECU 80X performs a filtering process for cutting off a noise with a high frequency on the pressure signals input from the fuel supply passage pressure sensors S_{Ps}.

The fuel supply passage pressure Ps on which the filtering process is performed is refereed to as a pressure Ps_{fil}, hereinafter.

By filtering processing the pressure signal input from the fuel supply passage pressure sensor S_{Ps}, the pressure vibration of the pressure Ps_{fil} from the pressure sensor S_{Ps} becomes comparatively smaller at an “aspiration stroke” and “compression stroke” which follows the “explosion stroke” and “exhaust stroke” after a fuel injection is performed and completed in one cylinder based on signals from a crank angle sensor (not shown) and a cylinder discriminating sensor (not shown) and the injection command signal for each cylinder generated by the ECU 80X. The pressure Ps_{fil} from the fuel supply passage pressure sensor S_{Ps} in the state where its pressure vibration is comparatively smaller is substantially equal to the common rail pressure Pc.

The ECU 80X samples the pressure Ps_{fil} in the above described state where its pressure vibration is comparatively smaller and controls the pressure control valve 72 to control the common rail pressure Pc within a predetermined range.

Only one fuel supply passage pressure sensor S_{Ps} among the four fuel supply passage pressure sensors S_{Ps} may be representatively used for controlling the common rail pressure Pc in the case of the 4 cylinder engine used in the twenty-second embodiment, or all of the four fuel supply passage pressure sensors S_{Ps} may be used to generate four signals of which sampling timing is different, and the common rail pressure Pc may be set to be the average value of the four signals.

The function of the ECU 80X of the twenty-second embodiment is basically the same as that of the ECU 80W of the twenty-first embodiment except for the method for controlling the common rail pressure Pc. However, they are also different in that the orifice differential pressure used by the ECU 80X for calculating the orifice passing flow rate Q_{OR} of fuel is not based on the pressure difference detected by the differential pressure sensor S_{dP} or the common rail pressure sensors S_{Pc} and the fuel supply passage pressure sensor S_{Ps} as in the twentieth or twenty-first embodiment, but based on only the signal from the pressure sensor S_{Ps} provided on the downstream side of the orifice 75.

In the twenty-second embodiment, the pressure Ps_{fil} sampled as above is used as the common rail pressure of the two-dimensional map 912a shown in FIG. 57. The pressure Ps_{fil} is used as the common rail pressure of the three dimensional maps 912b and 912c shown in FIGS. 58A and 58B.

Next, referring to FIGS. 79 to 84D, a method for calculating an orifice passing flow rate Q_{OR} (i.e. an actual injection amount) based on only the signal from the fuel supply passage pressure sensor S_{Ps} provided on the downstream side of the orifice 75 according to the nineteenth embodiment is described.

FIGS. 79 to 83 are flowcharts showing processing performed by the ECU 80X of the twenty-second embodiment for calculating an actual injection amount from the orifice passing flow rate Q_{OR} for one cylinder. The flow charts shown in FIGS. 79 to 83 show only processing that is different from that of the flow chart of the seventeenth embodiment (i.e. the processing for obtaining the detection start timing of orifice passing fuel flow, calculating the orifice passing flow rate Q_{OR} and obtaining the detection finish timing of the orifice passing fuel flow based on the change of the fuel supply passage pressure Ps on the downstream side of the orifice 75 without using the orifice differential pressure ΔP_{OR}, and the processing for calculating the orifice passing flow amounts Q_{Psum}, Q_{Msum} from the orifice passing flow rate Q_{OR}, calculating the back flow amount Q_{BFsum}, and calculating the actual injection amount Q_{AP}, Q_{AM} by deducing the back flow amounts Q_{BFsum}, from the orifice passing flow amounts Q_{Psum}, Q_{Msum}).

In the twenty-second embodiment, since the high pressure fuel supply passage 21 is provided with the fuel supply passage pressure sensor S_{Ps} on the downstream side of the orifice 75, the “common rail pressure Pc” in Steps 113, 114, 162 and 163 of the flow chart shown in FIGS. 59 to 63 is read as the “pressure Ps_{fil} obtained by filtering-processing the fuel supply passage pressure Ps” and the pressure Ps_{fil} is used.

FIGS. 84A to 84D are graphs showing an output pattern of the injection command signal for one cylinder and the temporal variations of fuel flow in the high pressure fuel supply passage. FIG. 84A is a graph for showing an output pattern of the injection command signal for one cylinder. FIG. 84B is a graph for showing the temporal variation of an actual fuel injection rate and a back flow rate of the injector. FIG. 84C is a graph for showing the orifice passing flow rate of fuel. FIG. 84D is a graph for showing the temporal variation of the pressure decrease amount of the pressure on the downstream side of the orifice.

Firstly, the processing for obtaining the orifice passing flow detection start timing t_{ORSP}, calculating the orifice passing flow rate Q_{OR} and obtaining the orifice passing flow detection finish timing t_{OREP} based on the change in the fuel supply passage pressure Ps on the downstream side of the orifice 75 in the Pilot fuel injection is described.

In Step 411 which follows Step 117, the actual fuel supply information detection unit 913′ obtains the back flow rate function that corresponds to the pressure Ps_{fil} and the injection time T_{iP} of the Pilot fuel injection. More specifically, the actual fuel supply information detection unit 913′ also obtains the back flow start timing t_{SBE} at which a back flow actually starts, and the back flow time period T_{iBF} based on the injection time T_{iP} (referred to as an injection time Tᵢ in FIG. 73) of the Pilot fuel injection shown in FIG. 73, as well as the back flow rate function Q_{BF}(t).

In Step 412, the actual fuel supply information defection unit 913′ determines whether or not an injection start signal of the Pilot fuel injection is received from the injection command signal. If the injection start signal of the Pilot fuel injection is received (Yes), the processing proceeds to Step 413. If the injection start signal of the Pilot fuel injection is not received (No), the processing repeats Step 412. In Step 413, the actual fuel supply information detection unit 913′ starts a timer t, and sets IFLAG to be 0.

IFLAG is a flag for determining whether or not an actual fuel injection to the combustion chamber is started after the back flow starts and is initially reset to be 0.0.

In Step 414, the actual fuel supply information detection unit 913′ resets the orifice passing flow amount Qₛᵤₘ, [Q_{Psum}] and the back flow amount Q_{BFsum} for the Pilot fuel injection to be 0.0.

In Step 415, the actual fuel supply information detection unit 913′ determines whether or not the filtering processed pressure Ps_{fil} on the downstream side of the orifice 75 which is detected by the fuel supply passage pressure sensor S_{Ps} is decreased below a predetermined value [symbol] (Ps_{fil}<P₀−ΔPε)? [symbol] . If it is decreased below the predetermined value (Yes), the processing proceeds to Step 416. If it is not (No), the processing repeats Step 415.

In FIG. 84D, the timing when the pressure Ps_{fil} on the downstream side is decreased below the predetermined value P0 is the timing t_{SP2}.

The predetermined value P0 is set as follows: the fuel supply passage pressure Ps detected by the fuel supply passage pressure sensor S_{Ps} is filtering processed to remove a noise with a high frequency, such as a pressure pulsation caused by the filling operation of the high pressure pump 3B, a pressure pulsation caused by the propagation of the pressure vibration resulted from the injection operation of the injector 5B of other cylinders, and a pressure pulsation caused by a reflection wave of the injection operation of the injector 5B of the own cylinder, and the lowest value in the variation of the pressure that have been filtering-processed is set to be the predetermined value P0. The predetermined value P0 can be obtained in advance by experiments.

If Yes is selected in Step 415, the actual fuel supply information detection unit 913′ obtains the detection start timing t_{ORSP} of an orifice passing flow which is caused by the Pilot fuel injection by the timer t in Step 416.

Subsequently, in Step 417, the actual fuel supply information detection unit 913′ sets the back flow start timing t_{SBF} of the back flow rate function Q_{BF}(t) as the detection start timing t_{ORSP} of the orifice passing fuel flow and calculates the back flow finish timing t_{OREBF} (=t_{ORSP}+T_{iBF}). This means that the back flow start timing t_{SBF} is matched to be the detection start timing t_{ORSP} of the orifice passing fuel flow (t_{SBF}=t_{ORSP}) with respect to the time axis t of the back flow rate function Q_{BF}(t).

In Step 418, the actual fuel supply information detection unit 913′ sets a reference pressure reduction line, taking the pressure Ps_{fil} at the detection start timing t_{ORSP} of the orifice passing flow obtained when “Yes” is selected in Step 415 as the initial value Pi, as shown in FIG. 84D.

The initial value Pi may be equal to the predetermined value (P₀−ΔPε). The initial value Pi may not be equal to the predetermined value (P₀−ΔPε) since the pressure Ps_{fil} sampled in the cycle next to the cycle in which the pressure Ps_{fil} is sampled in Step 415 may be used in Step 418.

In Step 419, the actual fuel supply information detection unit 913′ calculates the amount of pressure decrease ΔPdown of the pressure Ps_{fil} from the reference pressure reduction line whose initial value is the initial value Pi in order to calculate the orifice passing flow rate Q_{OR}. The definition of ΔPdown is shown in FIG. 84D.

The orifice passing flow rate Q_{OR} can be readily calculated by using the equation (1) in which the pressure decrease amount ΔPdown is substituted for ΔP_{OR}. In Step 420, the actual fuel supply information detection unit 913′ time-integrates the orifice passing flow rate Q_{OR} as shown in Q_{Psum}=Q_{Psum}+Q_{OR}·Δt.

In Step 421, the actual fuel supply information detection unit 913′ time-integrates the back flow rate Q_{BF}(t) as shown in the equation Q_{BFsum}=Q_{BFsum}+Q_{BF}(t) ·Δt. The processing proceeds to Step 422 after Step 421, following the connector (J). In Step 422, the actual fuel supply information detection unit 913′ determines whether or not IFLAG=0. If IFLAG=0 (Yes), the processing proceeds to Step 423. If it is not (No), the processing proceeds to Step 426.

In Step 423, the actual fuel supply information detection unit 913′ determines whether or not the orifice passing flow rate Q_{OR} exceeds the back flow rate Q_{BF}(t). If the orifice passing flow rate Q_{OR} exceeds the back flow rate Q_{BF}(t), the processing proceeds to Step 424. If it does not (No), the processing proceeds to Step 426.

In Step 424, the actual fuel supply information detection unit 913′ obtains the fuel injection start detection timing t_{ORSiP} of the orifice passing fuel flow. In Step 425, the actual fuel supply information detection unit 913′ sets IFLAG=1.

More specifically, the fact that the orifice passing flow rate Q_{OR} exceeds the back flow rate Q_{BF}(t) means fuel injection from the fuel injection port 10 (see FIG. 78) to the combustion chamber is started to be detected.

In Step 426, the actual fuel supply information detection unit 913′ determines whether or not a fuel injection finish signal of the Pilot fuel injection is received from the injection command signal. If the fuel injection finish signal of the Pilot fuel injection is received (Yes), the processing proceeds to Step 427. If the fuel injection finish signal of the Pilot fuel injection is not received (No), the processing returns to Step 419, following the connector (K), and repeats Steps 419 to 426.

In Step 427, the actual fuel supply information detection unit 913′ determines whether or not the filtering processed pressure Ps_{fil} on the downstream side of the orifice 75 exceeds the reference pressure reduction line. If the filtering processed pressure Ps_{fil} on the downstream side of the orifice 75 exceeds the reference pressure reduction line (Yes), the processing proceeds to Step 428. If it does not (No), the processing returns to Step 419, following the connector (K), and repeats Steps 419 to 427.

Processing of Steps 419 to 427 is performed at a period of a few to dozens of μ seconds, for example, and Δt is a period at which the filtering-processed pressure Ps_{fil} is sampled, which is a few to dozens of μ seconds.

If “Yes” is selected in Step 427, in Step 428 the actual fuel supply information detection unit 913′ obtains the detection finish timing t_{OREP} of an orifice passing fuel flow associated with the completion of the Pilot fuel injection by the timer t, and outputs the detection start timing t_{ORSP} of the orifice passing fuel flow obtained in Step 416, the back flow finish timing t_{OREBF} obtained in Step 417, the fuel, injection start detection timing t_{ORSiP} of the orifice passing fuel flow obtained in Step 424, the detection finish timing t_{OREP} of the orifice passing fuel, flow obtained in Step 428, and the orifice passing flow amount Q_{Psum} and the back flow amount Q_{BFsum} finally obtained by repeating Steps 419 to 427, to the actual fuel injection information detection unit 914′.

The detection start timing t_{ORSP}, the fuel injection start detection timing t_{ORSiP}, the back flow finish timing t_{OREBF}, and the detection finish timing t_{OREP} of the orifice passing fuel flow, and the orifice passing flow amount Q_{Psum} and the back flow amount Q_{BFsum} are also referred to as “actual fuel supply information”.

In Step 429, the actual fuel injection information detection unit 914′ converts the detection start timing t_{ORSP}, the back flow finish timing t_{OREBF}, the fuel injection start detection timing t_{ORSiP} and the detection finish timing t_{OREP} of the orifice passing fuel flow into the back flow start timing, the back flow finish timing, the injection start timing, and the injection finish timing, respectively.

In Step 430, the actual fuel injection information detection unit 914′ calculates an actual injection amount Q_{AP}(Q_{AP}=Q_{Psum}−Q_{BFsum}) by deducing the back flow amount Q_{BFsum} from the orifice passing flow amount Q_{Psum}.

The actual injection amount Q_{AP}, the back flow start timing, the injection start timing, the back flow finish timing, and the injection finishing timing of the Pilot fuel injection are input to the individual injection information setting unit 912′.

It is to be noted that the above described conversion of the detection start timing t_{ORSP}, the back flow finish timing t_{OREBF}, the fuel injection start detection timing t_{ORSiP} and the detection finish timing t_{OREP} of the orifice passing fuel flow into the back flow start timing, the injection start timing, the back flow finish timing, and the injection finishing timing of the Pilot fuel injection can be easily performed by calculating an average flow velocity of the fuel flow based on an average value of the orifice passing flow rate Q_{OR} {Q_{Psum}/(t_{OREP}−t_{ORSP})} and the cross-sectional area of the high pressure fuel supply passage 21 and considering the average flow velocity and the length of the fuel passage.

The actual injection amount Q_{AP}, the injection start timing and the injection finish timing of the Pilot fuel injection are referred to as “actual fuel injection information”.

In Step 431, the individual injection information setting unit 912′ calculates the correction factor K_{P}(=Q_{TP}/Q_{AP}) and stores the correction factor K_{P} in the three dimensional map 912b of the correction factor to update the three dimensional map 912b.

In Step 432, the actual fuel injection information detection unit 914′ resets IFLAG=0. Then, the processing proceeds to Step 130 of the flow chart shown in FIGS. 59 to 63.

Next, the processing for obtaining the orifice passing flow detection start timing t_{ORSM}, calculating the orifice passing flow rate Q_{OR}, obtaining the orifice passing flow detection finish timing t_{ORSM} and calculating an actual injection amount Q_{AM} based on the change in the fuel supply passage pressure Ps on the downstream side of the orifice 75 in the Main fuel injection is described.

If the processing proceeds to Step 450 after Step 134 of the flow charts shown in FIGS. 59 to 63, the individual injection information setting unit 912′ determines the injection time T_{iM} of the Main fuel injection based on the pressure Ps_{fil}* which is detected at the timing temporally near to the injection start instruction timing t_{SM} of the Main fuel injection set in Step 131 and the target injection amount Q_{TM} of the Main fuel injection, referring to the two-dimensional map 912a.

In Step 451, the actual fuel supply information detection unit 913′ obtains the back flow rate function which corresponds to the pressure Ps_{fil}* and the injection time T_{iM} of the Main fuel injection. More specifically, the actual fuel supply information detection unit 913′ obtains the back flow start timing t_{SBE} when the back flow actually starts and the back flow time period T_{iBF} which are associated with the injection time T_{iM} (referred to as the injection time Tᵢ in FIG. 73) shown in FIG. 73, as well as the back flow rate function Q_{BF}(t).

Next, in Step 452, the individual injection information setting unit 912′ determines the correction factor <K_{M}> based on the target injection amount Q_{TM}, the injection time T_{iM} and the pressure Ps_{fil}* which is detected at the timing temporally near to the injection start instruction timing t_{SM} of the Main fuel injection, referring to the three dimensional map 912c.

The pressure Ps_{fil}* which is detected at the timing temporally near to the injection start instruction timing t_{SM} of the Main fuel injection is the pressure Ps_{fil} which is detected at the timing retroacted by a predetermined short time period (e.g. the operation cycle of a few μ sec to dozens of μ seconds) from the injection start instruction timing t_{SM} in consideration of the operation cycle.

In Step 453, the individual injection information setting unit 912′ calculates T_{iM}×<K_{M}> to obtain a corrected injection time T_{iM} (T_{iM}=T_{iM}·<K_{M}>) of the Main fuel injection. In Step 454, the individual injection information setting unit 912′ calculates the injection finish instruction timing t_{EM} of the Main fuel injection by adding the injection start instruction timing t_{SM} set in Step 131 and the corrected injection time T_{iM} of the Main fuel injection which is calculated in Step 453 (t_{EM}=t_{SM}+T_{iM}). In Step 455, the individual injection information setting unit 912′ sets the injection finish instruction timing t_{EM} of the Main fuel injection. More specifically, the individual injection information setting unit 912′ outputs, as the injection command signal, the injection finish instruction timing t_{EM} to the actuator driving circuit 806A and the actual fuel supply information detection unit 913′.

In Step 456, the actual fuel supply information detection unit 913′ determines whether or not an injection start signal of the Main fuel injection is received from the injection command signal. If the injection start signal of the Main fuel injection is received (Yes), the processing proceeds to Step 457. If the injection start signal of the Main fuel injection is not received (No), the processing repeats Step 456. In Step 457, the actual fuel supply information detection unit 913′ starts a timer t, and sets IFLAG to be 0.

IFLAG is a flag for determining whether or not an actual fuel injection to the combustion chamber is started after the back flow starts and is initially reset to be 0.0.

In Step 458, the actual fuel supply information detection unit 913′ resets the orifice passing flow amount Q_{Msum} and the back flow amount Q_{BFsum} for the Main fuel injection to be 0.0.

In Step 459, the actual fuel supply information detection unit 913′ determines whether or not the filtering processed pressure Ps_{fil} on the downstream side of the orifice 75 which is detected by the fuel supply passage pressure sensor S_{Ps} is decreased below a predetermined value Ps_{fil}* [symbol] (Ps_{fil}<Ps_{fil}*−ΔPε)? [symbol] . If it is decreased below the predetermined value (Yes), the processing proceeds to Step 460, following the connector (L). If it is not (No), the processing repeats Step 459.

If Yes is selected in Step 459, the actual fuel supply information detection unit 913′ obtains the detection start timing t_{ORSM} of an orifice passing flow which is caused by the Main fuel injection by the timer t in Step 460. Subsequently, in Step 461, the actual fuel supply information detection unit 913′ sets the detection start timing t_{ORSM} of the orifice passing fuel flow as the back flow start timing t_{SBF} of the back flow rate function Q_{BF}(t) and calculates the back flow finish timing t_{OREBF} (=t_{ORSM}+T_{iBF}). This means that the back flow start timing t_{SBF} is matched to be the detection start timing t_{ORSM} of the orifice passing fuel flow (t_{SBF}=t_{ORSP}) with respect to the time axis t of the back flow rate function Q_{BF}(t).

In Step 462, the actual fuel supply information detection unit 913′ sets a reference pressure reduction line, taking the pressure Ps_{fil} at the detection start timing t_{ORSM} of the orifice passing flow obtained when “Yes” is selected in Step 459 as the initial value Pi.

The initial value Pi may be equal to the predetermined value (Ps_{fil}*−ΔPε). The initial value Pi may not be equal to the predetermined value (Ps_{fil}*−ΔPε) since the pressure Ps_{fil} sampled in the cycle next to the cycle in which the pressure P_{fil} is sampled in Step 459 may be used in Step 462.

In Step 463, the actual fuel supply information detection unit 913′ calculates the amount of pressure decrease ΔPdown of the pressure Ps_{fil} from the reference pressure reduction line whose initial value is the initial value Pi in order to calculate the orifice passing flow rate Q_{OR}. The definition of ΔPdown is shown in FIG. 84D.

The orifice passing flow rate Q_{OR} can be readily calculated by using the equation (1) in which the pressure decrease amount ΔPdown is substituted for ΔP_{OR}. In Step 464, the actual fuel supply information detection unit 913′ time-integrates the orifice passing flow rate Q_{OR} as shown in the equation Q_{Msum}=Q_{Msum}+Q_{OR}·Δt.

In Step 465, the actual fuel supply information detection unit 913′ time-integrates the back flow rate Q_{BF}(t) as shown in the equation Q_{BFsum}=Q_{BFsum}+Q_{BF}(t)·Δt.

In Step 466, the actual fuel supply information detection unit 913′ determines whether or not IFLAG=0. If IFLAG=0 (Yes), the processing proceeds to Step 467. If it is not (No), the processing proceeds to Step 470.

In Step 467, the actual fuel supply information detection unit 918′ determines whether or not the orifice passing flow rate Q_{OR} exceeds the back flow rate Q_{BF}(t). If the orifice passing flow rate Q_{OR} exceeds the back flow rate Q_{BF}(t), the processing proceeds to Step 468. If it does not (No), the processing proceeds to Step 470.

In Step 468, the actual fuel supply information detection unit 913′ obtains the fuel injection start detection timing t_{ORSiM} of the orifice passing fuel flow. In Step 469, the actual fuel supply information detection unit 913′ sets IFLAG=1.

More specifically, the fact that the orifice passing flow rate Q_{OR} exceeds the back flow rate Q_{BF}(t) means that fuel injection from the fuel injection port 10 to the combustion chamber is started to be detected.

In Step 470, the actual fuel supply information detection unit 913′ determines whether or not a fuel injection finish signal of the Main fuel injection is received from the injection command signal. If the fuel injection finish signal of the Main fuel injection is received (Yes), the processing proceeds to Step 463. If the fuel injection finish signal of the Main fuel injection is not received (No), the processing returns to Step 463, and repeats Steps 463 to 470.

In Step 471, the actual fuel supply information detection unit 913′ determines whether or not the filtering processed pressure Ps_{fil} on the downstream side of the orifice 75 exceeds the reference pressure reduction line. If the filtering processed pressure Ps_{fil} on the downstream side of the orifice 75 exceeds the reference pressure reduction line (Yes), the processing proceeds to Step 472, following the connector (M). If it does not (No), the processing returns to Step 463, and repeats Steps 463 to 470.

Processing of Steps 463 to 471 is performed at a period of a few to dozens of μ seconds, for example, and Δt is a period at which the filtering-processed pressure Ps_{fil} is sampled, which is a few to dozens of μ seconds.

If “Yes” is selected in Step 459, in Step 472, the actual fuel supply information detection unit 913′ obtains the detection finish timing t_{OREM} of an orifice passing fuel flow associated with the completion of the Main fuel injection by the timer t, and outputs the detection start timing t_{ORSM} of the orifice passing fuel flow obtained in Step 460, the back flow finish timing t_{OREBF} obtained in Step 461, the fuel injection start detection timing t_{ORSiM} of the orifice passing fuel flow obtained in Step 468, the detection finish timing t_{OREM} of the orifice passing fuel flow obtained in Step 472, and the orifice passing flow amount Q_{Msum} and the back flow amount, Q_{BFsum} finally obtained by repeating Steps 463 to 471, to the actual fuel injection information detection unit 914′.

The detection start timing t_{ORSM}, the fuel injection start detection timing t_{ORSiM}, the back flow finish timing t_{OREBF}, and the detection finish timing t_{OREM} of the orifice passing fuel flow, and the orifice passing flow amount Q_{Msum} and the back flow amount Q_{BFsum} are also referred to as “actual fuel supply information”.

In Step 473, the actual fuel injection information detection unit 914′ converts the detection start timing t_{ORSM}, the back flow finish timing t_{OREBF}, the fuel injection start detection timing t_{ORSiM} and the detection finish timing t_{OREM} of the orifice passing fuel flow into the back flow start timing, the back flow finish timing, the injection start timing, and the injection finish timing, respectively.

In Step 474, the actual fuel injection information detection unit 914′ calculates an actual injection amount Q_{AM}(Q_{AM}=Q_{Msum}−Q_{BFsum}) by deducing the back flow amount Q_{BFsum} from the orifice passing flow amount Q_{Msum}.

The actual injection amount Q_{AM}, the back flow start timing, the injection start timing, the back flow finish timing, and the injection finishing timing of the Main fuel injection are input to the individual injection information setting unit 912′.

It is to be noted that the above described conversion of the detection start timing t_{ORSM}, the back flow finish timing t_{OREBF}, the fuel, injection start detection timing t_{ORSiM} and the detection finish timing t_{OREM} of the orifice passing fuel flow into the back flow start timing, the injection start timing, the back flow finish timing, and the injection finishing timing of the Main fuel injection can be easily performed by calculating an average flow velocity of the fuel flow based on an average value of the orifice passing flow rate Q_{OR} {Q_{Msum}/(t_{OREM}−t_{ORSM})} and the cross-sectional, area of the high pressure fuel supply passage 21 and considering the average flow velocity and the length of the fuel passage.

The actual, injection amount Q_{AM}, the injection start timing and the injection finish timing of the Main fuel injection are referred to as “actual fuel injection information”.

In Step 475, the individual injection information setting unit 912′ calculates the correction factor K_{M}(=Q_{TM}/Q_{AM}) and stores the correction factor K_{M} in the three dimensional map 912c of the correction factor to update the three dimensional map 912c.

In Step 476, the actual fuel injection information detection unit 914′ resets IFLAG=0. Then, the processing proceeds to Step 152 of the flow chart shown in FIGS. 59 to 63.

If only the Main fuel injection is performed without performing a multi-injection, the processing proceeds to Step 164 from Step 163 of the flow chart shown in FIGS. 59 to 63. In Step 164, the actual fuel supply information detection unit 913′ obtains the back flow rate function that corresponds to the pressure Ps_{fil} and the injection time T_{iM} of the Main fuel injection. More specifically, the actual fuel supply information detection unit 913′ also obtains the back flow start timing t_{SBE} at which a back flow actually starts, and the back flow time period T_{iBF} based on the injection time T_{iM} (referred to as an injection time 7L in FIG. 73) of the Main fuel injection shown in FIG. 73, as well as the back flow rate function Q_{BF}(t). Then, the processing proceeds to Step 453.

In this case, the processing “the actual fuel supply information detection unit 913′ determines whether or not the filtering processed pressure Ps_{fil} on the downstream side of the orifice 75 which is detected by the fuel supply passage pressure sensor S_{Ps} is decreased below the predetermined value Ps_{fil}* [symbol] (Ps_{fil}<Ps_{fil}*−ΔPε)? [symbol] . If it is decreased below the predetermined value (Yes), the processing proceeds to Step 460, following the connector (L). If it is not (No), the processing repeats Step 459.” in Step 459 is replaced with the following processing “the actual fuel supply information detection unit 913′ determines whether or not the filtering processed pressure Ps_{fil} on the downstream side of the orifice 75 which is detected by the fuel supply passage pressure sensor S_{Ps} is decreased below a predetermined value P0 [symbol] (Ps_{fil}<P₀−ΔPε)? [symbol] . If it is decreased below the predetermined value (Yes), the processing proceeds to Step 460, following the connector (L). If it is not (No), the processing repeats Step 459.”

In accordance with the twenty-second embodiment, it is possible to easily control the common rail pressure Pc by using the fuel supply passage pressure sensor S_{Ps} which detects the fuel supply passage pressure Ps on the downstream side of the orifice 75 even if the pressure sensor S_{Pc} which detects the common rail pressure Pc is omitted. This allows to reduce the cost of the fuel injection system.

It is also possible to accurately calculate the orifice passing flow amounts Q_{Psum}, Q_{Msum} (i.e. the actual injection amounts Q_{AP}, Q_{AM}) for each cylinder and each injection command signal by calculating the orifice passing flow rate Q_{OR} based on the equation (1) in which the pressure decrease amount ΔPdown is substituted for the orifice differential pressure ΔP_{OR} by using only the pressure signal from the fuel supply passage pressure sensor S_{Ps} for detecting the pressure on the downstream side of the orifice 75.

The ECU 80X is allowed to obtain, similarly to the twenty-first embodiment, the actual injection amount of the preceding fuel injection and correct the actual injection amount of the subsequent fuel injection. The ECU 80U also enables to control the difference between the actual injection amount of the subsequent fuel injection and the target injection amount due to the variation of the fuel supply passage pressure Ps caused by the preceding fuel injection to be smaller.

It is also possible to control the actual injection amount to be equal to the target injection amount by adjusting the injection time of the injection command signal, thereby absorbing variations of the injection characteristics of the injectors 5B or the actuators 6B due to their manufacturing tolerance, and secular changes of the injection characteristics of the injectors 5B or the actuators 6B.

As a result, it becomes easier to keep the regulated value of an exhaust gas even if requirement on hardware specifications, such as dimension tolerance of each part of the engine system, is relaxed, similarly to the twenty-first embodiment. Especially, requirement on the hardware specification for injectors can be relieved, which contributes to reduction of the manufacturing cost of the engine system.

Advantages of the twenty-second embodiment which are the same as those of the twentieth embodiment are omitted, and thus refer to the advantages of the twentieth embodiment for them.

In the twentieth to twenty-second embodiments, the injector 5B, which is the back pressure fuel injection valve, is used, and its actuator 6B is a type of actuator which directly moves the nozzle needle by using a piezoelectric stack that is formed by stacking piezoelectric elements in layers, however, the injector 5B is not limited to this configuration. For example, an injector using an electromagnetic coil as the actuator 6B may be used.

In the twentieth to twenty-second embodiments, the back flow rate function Q_{BF}(t) is used with reference to the back flow rate function map 912d, which is a two-dimensional map of the common rail pressure Pc, the fuel supply passage pressure Ps or the pressure Ps_{fil} obtained by filtering processing the fuel supply passage pressure Ps and the injection time Tᵢ, however, embodiments are not limited to this. The back flow start timing t_{SBF}, the back flow time period T_{iBF}, the ratio γ between the actual injection amount of fuel, and the fuel supply amount to the injector 5B, which is the orifice passing flow amount, may be obtained from the back flow rate function map 912d.

In the case of the Pilot fuel injection, γ represents the ratio Q_{AP}/Q_{Psum}. In the case of the Main fuel injection, γ represents the ratio Q_{AM}/Q_{Msum}. These ratios may be experimentally obtained in advance and stored in the back flow rate function, map 912d as well as the back flow start timing t_{SBF}, the back flow time period T_{iBF}.

In the seventeenth to twenty-second embodiments, the control injection command signals generated by the ECUs 80S to 80X for controlling the fuel injection amount to the cylinder controls the fuel injection amount by the time duration of the injection command signal. In addition to the time duration of the injection command signal, the lift amount of the nozzle needle of the injectors 5A, 5B may be controlled by changing the height of the injection command signal.

In the seventeenth to twenty-second embodiments, the ratio K_{P} of the target injection amount Q_{TP} and the actual injection amount Q_{AP} of the Pilot fuel injection, and the ratio K_{M} of the target injection amount Q_{TM} and the actual, injection amount Q_{AM} of the Main fuel injection are used to correct the injection time T_{iP} of the Pilot fuel injection and the injection time T_{iM} of the Main fuel injection, however, embodiments are not limited to this. The injection time T_{iP} of the Pilot fuel injection corresponding to the target injection amount Q_{TP} of the Pilot fuel injection, and the injection time T_{iM} of the Main fuel, injection corresponding to the target injection amount Q_{TM} of the Main fuel injection may be corrected based on information on the injection start timing and the injection finishing timing of an actual fuel injection which are obtained by the actual fuel supply information detection unit 913 and the actual fuel injection information detection unit 914.

Furthermore, the individual injection information setting unit 912 may respectively compare the injection start instruction timing t_{SP} and the injection finish instruction timing t_{EP} for the Pilot fuel injection with the injection start timing and the injection finish timing of the Pilot fuel injection obtained by the actual fuel injection information detection unit 914 to observe a secular change in operation lag amounts of the injector 5A or the injector 5B. If the operation lag amount exceeds a predetermined reference value, the individual injection information setting unit 912 may correct the injection start instruction timing t_{SM} and the injection finish instruction timing t_{EM} of the Main fuel injection by the operation lag amount exceeding the predetermined reference value.

By correcting the injection start instruction timing t_{SM} and the injection finish instruction timing t_{EM} as described above, it is possible to control the Main fuel injection to actually start and finish at an appropriate crank angle, as well as the actual injection amount.

In the seventeenth to twenty-second embodiments, the Main fuel injection is controlled such that the target injection amount Q_{TM} of the Main fuel injection in the same cycle as that of the Pilot fuel injection in the cylinder 41 is corrected based on the difference between the actual injection amount Q_{AP} and the target injection amount Q_{TP} of the Pilot fuel injection, and the injection time T_{iM} of the Main fuel injection that corresponds to the corrected target injection amount Q_{TM} is set. However, embodiments are not limited to this.

In consideration of the limitation of the operation speed of the CPU that constitutes the ECU 80S, 80T, 80U, 80V, 80W, 80X, the Main fuel, injection may be controlled such that the target injection amount Q_{TM} of the Main fuel, injection at the cycle next to that of the Pilot fuel injection in the cylinder 41 is corrected, and the injection time T_{iM} of the Main fuel, injection corresponding to the corrected target injection amount Q_{TM} is set.

When the engine is rotating at a high speed in a normal condition, since the same accelerator opening θₜₕ and the engine rotation speed Ne are usually maintained in the continuous cycles in one cylinder 41, it is possible to accurately correct the subsequent fuel injection based on the result of the preceding fuel injection, similarly to the seventeenth to twenty-second embodiments.

Further, in the seventeenth to twenty-second embodiments including the modifications, the injectors 5A and 5B directly inject fuel into the combustion chamber of each cylinder, however, configurations of the present invention are not limited to this. The present invention also includes a configuration where the injectors 5A and 5B inject fuel in a subsidiary chamber (premixed space) which is formed adjacent to the combustion chamber of each cylinder, and a configuration where the injectors 5A and 5B inject fuel in the aspiration port of each cylinder. In these configurations, the advantages of the seventeenth to twenty-second embodiments can be also obtained.

The embodiments according to the present invention have been explained as aforementioned. However, embodiments of the present invention are not limited to those explanations, and those skilled in the art ascertain the essential characteristics of the present invention and can make the various modifications and variations to the present invention to adapt it to various usages and conditions without departing from the spirit and scope of the claims.

What is claimed is:

1. A fuel injection device comprising:
a fuel accumulation part for accumulating fuel delivered by a fuel pump in a pressure-accumulated state;
a fuel injection valve for supplying to a combustion chamber of a cylinder of an internal combustion engine the fuel which is supplied through one of a plurality of fuel supply passages branched from the fuel accumulation part to cylinders;
a control unit which outputs an injection command signal for injecting the fuel from the fuel injection valve;
an orifice provided in the fuel supply passage; and
a differential pressure sensor for detecting a pressure difference between upstream and downstream sides of the orifice provided in the fuel supply passage,
the control unit calculating an actual fuel supply amount which passes the orifice based on a signal from the differential pressure sensor.

2. A fuel injection device comprising:
a fuel accumulation part for accumulating fuel delivered by a fuel pump in a pressure-accumulated state;
a fuel injection valve for supplying to a combustion chamber of a cylinder of an internal combustion engine the fuel which is supplied through one of a plurality of fuel supply passages branched from the fuel accumulation part to cylinders;
a control unit which outputs an injection command signal for injecting the fuel from the fuel injection valve;
an accumulation part pressure sensor for detecting a pressure of the fuel accumulation part;
an orifice provided in the fuel supply passage; and
a fuel supply passage pressure sensor for detecting a pressure on a downstream side of the orifice provided in the fuel supply passage,
the control unit calculating an actual fuel supply amount which passes the orifice by calculating a pressure difference between upstream and downstream sides of the orifice based on signals from the accumulation part pressure sensor and the fuel supply passage pressure sensor.

3. A fuel injection device comprising:
a fuel accumulation part for accumulating fuel delivered by a fuel pump in a pressure-accumulated state;
a fuel injection valve for supplying to a combustion chamber of a cylinder of an internal combustion engine the fuel which is supplied through one of a plurality of fuel supply passages branched from the fuel, accumulation part to cylinders;
a control unit which outputs an injection command signal for injecting the fuel from the fuel injection valve;
an orifice provided in the fuel supply passage; and
a fuel supply passage pressure sensor for detecting a pressure on a downstream side of the orifice provided in the fuel supply passage,
the control unit detecting an amount of pressure decrease on the downstream side of the orifice caused by fuel injection from the fuel injection valve based on a signal from the fuel supply passage pressure sensor and calculating an actual fuel supply amount which passes the orifice based on the detected amount of the pressure decrease.

4. The fuel injection device according to claim 3, wherein the control unit calculates the actual fuel supply amount based on the amount of the pressure decrease during a period from a first timing at which the pressure decrease on the downstream side of the orifice is detected after a rise of the injection command signal for the fuel injection valve to a second timing at which the pressure on the downstream side of the orifice becomes equal to or more than a predetermined value after the first timing.

5. The fuel injection device according to claim 3, wherein the control unit:
stores in advance data of a reference pressure reduction line of which value is simply decreased as a time lapses;
obtains a first timing at which the pressure on the downstream side of the orifice is decreased to be equal to or less than a threshold value after a rise of the injection command signal for the fuel, injection valve;
obtains the pressure on the downstream side of the orifice at the first timing;
sets the reference pressure reduction line by taking the pressure on the downstream side of the orifice at the first timing as an initial value of the reference pressure reduction line;
obtains a second timing at which the pressure on the downstream side of the orifice is increased to be equal to or more than the set reference pressure reduction line after the first timing; and
calculates the actual fuel supply amount based on the amount of the pressure decrease during a period from the first timing to the second timing.

6. The fuel injection device according to claim 4, wherein the control unit filtering processes the signal from the fuel supply passage pressure sensor to remove a high frequency component, and detects the pressure decrease on the downstream side of the orifice based on the signal from which the high frequency component has been removed by the filtering-process.

7. The fuel injection device according to claim 1, wherein a volume of a fuel passage from the orifice provided in the fuel supply passage to a fuel injection port of the fuel injection valve of the cylinder is designed to be greater than the maximum actual fuel supply amount which is supplied at one time for the fuel injection valve.

8. The fuel injection device according to claim 1, wherein the fuel injection valve supplies all amount of fuel which is supplied through the fuel supply passage to the combustion chamber of the cylinder at the time of fuel injection, and the control unit calculates the actual fuel supply amount which passes the orifice as an actual fuel injection amount which is actually injected to the cylinder and controls the fuel injection based on the actual fuel injection amount.

9. The fuel injection device according to claim 1, wherein the fuel injection valve returns a part of the fuel which has been supplied through the fuel supply passage to a return fuel pipe to discharge the fuel to a low pressure part of a fuel supply system at the time of fuel injection, and
the control unit calculates, from the actual fuel supply amount that passes the orifice, an actual fuel injection amount which is actually supplied to the combustion chamber of the cylinder without returning to the return fuel pipe based on the actual fuel supply amount and a predetermined coefficient value, and controls the fuel injection based on the calculated actual fuel injection amount.

10. The fuel injection device according to claim 9, wherein the control unit stores in advance the predetermined coefficient values that are associated with at least patterns of the injection command signal, and sets an appropriate coefficient value from the stored predetermined coefficient, values with reference to at least the patterns of the injection command signal.

11. The fuel injection device according to claim 2, wherein at least one of the plurality of fuel supply passages includes an orifice and a fuel supply passage pressure sensor for detecting the pressure on the downstream side of the orifice and constitutes a first fuel supply passage for supplying the fuel to a first cylinder through the fuel injection valve, and another fuel supply passage among the plurality of the fuel supply passages other than the first fuel supply passage includes an orifice and constitutes a second fuel supply passage for supplying the fuel to a second cylinder through the fuel injection valve, and
the control unit:
calculates a pressure difference between upstream and downstream sides of the orifice in the first fuel supply passage based on signals from the accumulation part pressure sensor and the fuel supply passage pressure sensor;
calculates an actual fuel supply amount to the fuel injection valve of the first cylinder through the first fuel supply passage by using the calculated pressure difference;
detects, with the fuel supply passage pressure sensor, a pressure variation which is generated in the second fuel supply passage by supplying the fuel, to the fuel injection valve of the second cylinder through the second fuel supply passage and is propagated to the downstream side of the orifice of the first fuel supply passage through the fuel accumulation part;
calculates an amount of a pressure decrease on a downstream side of the orifice in the second fuel supply passage based on the detected pressure variation; and
calculates an actual fuel supply amount to the fuel injection valve of the second cylinder through the second fuel supply passage based on the calculated amount of the pressure decrease on the downstream side of the orifice in the second fuel supply passage.

12. The fuel injection device according to claim 3, wherein at least one of the plurality of fuel supply passages includes an orifice and a fuel supply passage pressure sensor for detecting the pressure on the downstream side of the orifice and constitutes a first fuel supply passage for supplying the fuel to a first cylinder through the fuel injection valve, and another fuel supply passage among the plurality of the fuel supply passages other than the first fuel supply passage includes an orifice and constitutes a second fuel supply passage for supplying the fuel to a second cylinder through the fuel injection valve, and
the control unit:
calculates an amount of pressure decrease on a downstream side of the orifice in the first fuel supply passage based on the signal from the fuel supply passage pressure sensor;
calculates an actual fuel supply amount to the fuel injection valve of the first cylinder through the first fuel supply passage by using the calculated amount of the pressure decrease;
detects, with the fuel supply passage pressure sensor, a pressure variation which is generated in the second fuel supply passage by supplying the fuel to the fuel injection valve of the second cylinder through the second fuel supply passage and is propagated to the downstream side of the orifice of the first fuel supply passage through the fuel accumulation part;
calculates an amount of a pressure decrease on a downstream side of the orifice in the second fuel supply passage based on the detected pressure variation; and
calculates an actual fuel supply amount to the fuel injection valve of the second cylinder through the second fuel supply passage based on the calculated amount of the pressure decrease on the downstream side of the orifice in the second fuel supply passage.

13. The fuel injection device according to claim 1, further comprising an accumulation part pressure sensor for detecting a pressure of the fuel accumulation part and a storage unit for storing data of a Ti-Q characteristic which represents a correlation of a fuel injection amount (Q_{inject}) from the fuel injection valve and an injection time (Tᵢ), wherein
the fuel injection valve supplies all amount of fuel which is supplied through the fuel supply passage to the combustion chamber of the cylinder at the time of fuel injection, and
the Ti-Q characteristic is represented as a characteristic curve which is represented as a polynomial equation obtained by regression analyzing data discretely measuring the correlation of the fuel injection amount (Q_{inject}) and the injection time (Tᵢ) at a representative pressure value representing the pressure of the fuel accumulation part, and wherein
the control unit sets a target injection amount of fuel to be injected from the fuel injection valve;
obtains a target injection time that corresponds to the target injection amount with reference to the characteristic curve based on the pressure of the fuel accumulation part detected by the accumulation part pressure sensor and the target injection amount;
calculates an actual fuel injection amount which is injected by the fuel injection valve during the target injection time based on the signal from the differential pressure sensor, and
corrects the Ti-Q characteristic if the actual fuel injection amount is different from the target injection amount.

14. The fuel injection device according to claim 2, further comprising a storage unit for storing data of a Ti-Q characteristic which represents a correlation of a fuel injection amount (Q_{inject}) from the fuel injection valve and an injection time (Tᵢ), wherein
the fuel injection valve supplies all amount of fuel which is supplied through the fuel supply passage to the combustion chamber of the cylinder at, the time of fuel injection, and
the Ti-Q characteristic is represented as a characteristic curve which is represented as a polynomial equation obtained by regression analyzing data discretely measuring the correlation of the fuel injection amount (Q_{inject}) and the injection time (Tᵢ) at a representative pressure value representing the pressure of the fuel accumulation part, and wherein
the control unit sets a target injection amount of fuel to be injected from the fuel injection valve;
obtains a target injection time that corresponds to the target injection amount with reference to the characteristic curve based on the pressure of the fuel accumulation part detected by the accumulation part pressure sensor and the target injection amount;
calculates a pressure difference between upstream and downstream sides of the orifice based on signals from the accumulation part pressure sensor and the fuel supply passage pressure sensor and calculates an actual fuel, injection amount which is injected by the fuel, injection valve during the target injection time based on the calculated pressure difference; and
corrects the Ti-Q characteristic if the actual fuel injection amount is different from the target injection amount.

15. The fuel injection device according to claim 3, further comprising an accumulation part pressure sensor for detecting a pressure of the fuel accumulation part and a storage unit for storing data of a Ti-Q characteristic which represents a correlation of a fuel injection amount (Q_{inject}) from the fuel injection valve and an injection time (Tᵢ), wherein
the fuel injection valve supplies a total amount of fuel which is supplied through the fuel supply passage to the combustion chamber of the cylinder at the time of fuel injection, and
the Ti-Q characteristic is represented as a characteristic curve which is represented as a polynomial equation obtained by regression analyzing data discretely measuring the correlation of the fuel injection amount (Q_{inject}) and the injection time (Tᵢ) at a representative pressure value representing the pressure of the fuel accumulation part, and wherein
the control unit sets a target injection amount of fuel to be injected from the fuel injection valve;
obtains a target injection time that corresponds to the target injection amount with reference to the characteristic curve based on the pressure of the fuel accumulation part detected by the accumulation part pressure sensor and the target injection amount,
detects the amount of the pressure decrease on the downstream side of the orifice caused by the fuel injection based on the signal from the fuel supply passage pressure sensor and calculates an actual fuel injection amount which is injected by the fuel injection valve during the target injection time based on the amount of the pressure decrease; and
corrects the Ti-Q characteristic if the actual fuel injection amount is different from the target injection amount.

16. The fuel injection device according to claim 1, further comprising an accumulation part pressure sensor for detecting a pressure of the fuel accumulation part and a storage unit for storing data of a Ti-Q characteristic which represents a correlation of a fuel injection amount (Q_{inject}) from the fuel injection valve and an injection time (Tᵢ), wherein
the fuel injection valve returns a part of the fuel which has been supplied through the fuel supply passage to a return fuel pipe to discharge the fuel to a low pressure part of a fuel supply system at the time of fuel injection, and
the Ti-Q characteristic is represented as a characteristic curve which is represented as a polynomial equation obtained by regression analyzing data discretely measuring the correlation of the fuel injection amount (Q_{inject}) and the injection time (Tᵢ) at a representative pressure value representing the pressure of the fuel accumulation part, and wherein
the control unit sets a target injection amount of fuel to be injected from the fuel injection valve;
obtains a target injection time that corresponds to the target injection amount with reference to the characteristic curve based on the pressure of the fuel accumulation part detected by the accumulation part pressure sensor and the target injection amount;
calculates an amount of fuel which has passed the orifice for the target injection time based on the signal from the differential pressure sensor and calculates, from the amount of fuel that has passed the orifice, an actual fuel injection amount which is actually supplied to the combustion chamber of the cylinder without returning to the return fuel pipe based on the amount of fuel that has passed the orifice and a predetermined coefficient value, and
corrects the Ti-Q characteristic if the actual fuel injection amount is different from the target injection amount.

17. The fuel injection device according to claim 2, further comprising a storage unit for storing data of a Ti-Q characteristic which represents a correlation of a fuel injection amount (Q_{inject}) from the fuel injection valve and an injection time (Tᵢ), wherein
the fuel injection valve returns a part of the fuel which has been supplied through the fuel supply passage to a return fuel pipe to discharge the fuel to a low pressure part of a fuel supply system at the time of fuel injection, and
the Ti-Q characteristic is represented as a characteristic curve which is represented as a polynomial equation obtained by regression analyzing data discretely measuring the correlation of the fuel injection amount (Q_{inject}) and the injection time (Tᵢ) at a representative pressure value representing the pressure of the fuel accumulation part, and wherein
the control unit sets a target injection amount of fuel to be injected from the fuel injection valve;
obtains a target injection time that corresponds to the target injection amount with reference to the characteristic curve based on the pressure of the fuel accumulation part detected by the accumulation part pressure sensor and the target injection amount;
calculates a pressure difference between upstream and downstream sides of the orifice based on signals from the accumulation part pressure sensor and the fuel supply passage pressure sensor, calculates an amount of fuel which has passed the orifice for the target injection time based on the pressure difference, and calculates, from the amount of fuel that has passed the orifice, an actual fuel injection amount which is actually supplied to the combustion chamber of the cylinder without returning to the return fuel pipe based on the amount of fuel that has passed the orifice and a predetermined coefficient value; and
corrects the Ti-Q characteristic if the actual fuel injection amount is different from the target injection amount.

18. The fuel injection device according to claim 3, further comprising an accumulation part pressure sensor for detecting a pressure of the fuel accumulation part and a storage unit for storing data of a Ti-Q characteristic which represents a correlation of a fuel injection amount (Q_{inject}) from the fuel injection valve and an injection time (Tᵢ), wherein
the fuel injection valve returns a part of the fuel which has been supplied through the fuel supply passage to a return fuel pipe to discharge the fuel to a low pressure part of a fuel supply system at the time of fuel injection, and
the Ti-Q characteristic is represented as a characteristic curve which is represented as a polynomial equation obtained by regression analyzing data discretely measuring the correlation of the fuel injection amount (Q_{inject}) and the injection time (Tᵢ) at a representative pressure value representing the pressure of the fuel accumulation part, and wherein
the control unit sets a target injection amount of fuel to be injected from the fuel injection valve;
obtains a target injection time that corresponds to the target injection amount with reference to the characteristic curve based on the pressure of the fuel accumulation part detected by the accumulation part pressure sensor and the target injection amount;
detects the amount of the pressure decrease on the downstream side of the orifice caused by the fuel injection based on the signal from the fuel supply passage pressure sensor, calculates an amount of the fuel which has passed the orifice for the target injection time based on the amount of the pressure decrease, and calculates, from the amount of the fuel that has passed the orifice, an actual fuel injection amount which is actually supplied to the combustion chamber of the cylinder without returning to the return fuel pipe based on the amount of the fuel that has passed the orifice and a predetermined coefficient value; and
corrects the Ti-Q characteristic if the actual fuel injection amount is different from the target injection amount.

19. The fuel injection device according to claim 1, wherein the fuel injection valve supplies all amount of fuel which is supplied through the fuel supply passage to the combustion chamber of the cylinder at the time of fuel injection, and the control unit:
sets the injection command signal for injecting the fuel from the fuel injection valve based on an operation condition of the internal combustion engine;
includes an actual fuel supply information detection unit for determining, based on the injection command signal, fuel injection information that includes at least an injection start timing and an injection finishing timing of the fuel injection valve, performing during a compression stroke or an expansion stroke of the cylinder of the internal combustion engine a multi-injection in which the fuel injection from the fuel injection valve is divided into a plurality of times of fuel injections, and for detecting actual fuel supply information on the fuel that has passed the orifice based on the signal from the differential pressure sensor, and
an actual fuel injection information detection unit for detecting actual fuel injection information based on the detected actual fuel supply information; and
determines the fuel injection information on a subsequent fuel injection that is performed later than a preceding fuel injection based on the actual fuel injection information of the preceding fuel injection which is performed relatively earlier than other fuel, injections of the plurality of times of the fuel injections.

20. The fuel injection device according to claim 2, wherein the fuel injection valve supplies ail amount of fuel, which is supplied through the fuel supply passage to the combustion chamber of the cylinder at the time of fuel injection, and the control unit:
sets the injection command signal for injecting the fuel from the fuel injection valve based on an operation condition of the internal combustion engine;
includes an actual fuel supply information detection unit for determining, based on the injection command signal, fuel, injection information that includes at least an injection start timing and an injection finishing timing of the fuel injection valve, performing during a compression stroke or an expansion stroke of the cylinder of the internal combustion engine a multi-injection in which the fuel injection from the fuel injection valve is divided into a plurality of times of fuel injections, and for detecting actual fuel supply information on the fuel that has passed the orifice based on the signals from the accumulation part pressure sensor and the fuel supply passage pressure sensor, and
an actual fuel injection information detection unit for detecting actual fuel injection information based on the detected actual fuel supply information; and
determines the fuel injection information on a subsequent fuel injection that is performed later than a preceding fuel injection based on the actual fuel injection information of the preceding fuel injection which is performed relatively earlier than other fuel injections of the plurality of times of the fuel injections.

21. The fuel injection device according to claim 3, wherein the fuel injection valve supplies all amount of fuel which is supplied through the fuel supply passage to the combustion chamber of the cylinder at the time of fuel injection, and the control unit:
sets the injection command signal for injecting the fuel from the fuel injection valve based on an operation condition of the internal combustion engine;
includes an actual fuel supply information detection unit for determining, based on the injection command signal, fuel injection information that includes at least an injection start timing and an injection finishing timing of the fuel injection valve, performing during a compression stroke or an expansion stroke of the cylinder of the internal combustion engine a multi-injection in which the fuel injection from the fuel injection valve is divided into a plurality of times of fuel injections, and for detecting the amount of the pressure decrease on the downstream side of the orifice caused by the fuel injection from the fuel injection valve based on the signal from the fuel supply passage pressure sensor, and calculates an actual fuel supply information on the fuel that has passed the orifice based on the amount of the pressure decrease, and
an actual fuel injection information detection unit for detecting actual fuel injection information based on the detected actual fuel supply information; and
determines the fuel injection information on a subsequent fuel injection that is performed later than a preceding fuel injection based on the actual fuel injection information of the preceding fuel injection which is performed relatively earlier than other fuel injections of the plurality of times of the fuel injections.

22. The fuel injection device according to claim 1, wherein the fuel injection valve returns, as a back flow, a part of the fuel which has been supplied through the fuel supply passage to a return fuel pipe to discharge the fuel to a low pressure part of a fuel supply system at the time of fuel injection, and the control unit:
sets the injection command signal for injecting the fuel from the fuel injection valve based on an operation condition of the internal combustion engine;
includes an actual fuel supply information detection unit for determining, based on the injection command signal, fuel injection information that includes at least an injection start timing and an injection finishing timing of the fuel injection valve, performing during a compression stroke or an expansion stroke of the cylinder of the internal combustion engine a multi-injection in which the fuel injection from the fuel injection valve is divided into a plurality of times of fuel injections, and for detecting actual fuel supply information on the fuel that has passed the orifice based on the signal from the differential pressure sensor, and
an actual fuel injection information detection unit for detecting actual fuel injection information based on the detected actual fuel supply information and back flow information on the back flow which is stored in advance; and
determines the fuel injection information on a subsequent fuel injection that is performed later than a preceding fuel injection based on the actual fuel injection information of the preceding fuel injection which is performed relatively earlier than other fuel injections of the plurality of times of the fuel injections.

23. The fuel injection device according to claim 2, wherein the fuel injection valve returns, as a back flow, a part of the fuel which has been supplied through the fuel supply passage to a return fuel pipe to discharge the fuel to a low pressure part of a fuel supply system at the time of fuel injection, and the control unit:
sets the injection command signal for injecting the fuel from the fuel injection valve based on an operation condition of the internal combustion engine;
includes an actual fuel supply information detection unit for determining, based on the injection command signal, fuel injection information that includes at least an injection start timing and an injection finishing timing of the fuel injection valve, performing during a compression stroke or an expansion stroke of the cylinder of the internal combustion engine a multi-injection in which the fuel injection from the fuel injection valve is divided into a plurality of times of fuel injections, and for detecting actual fuel supply information on the fuel that has passed the orifice based on the signals from the accumulation part pressure sensor and the fuel supply passage pressure sensor, and
an actual fuel injection information detection unit for detecting actual fuel injection information based on the detected actual fuel supply information and back flow information on the back flow which is stored in advance; and
determines the fuel injection information on a subsequent fuel injection that is performed later than a preceding fuel injection based on the actual fuel injection information of the preceding fuel injection which is performed relatively earlier than other fuel injections of the plurality of times of the fuel injections.

24. The fuel injection device according to claim 3, wherein the fuel injection valve returns, as a back flow, a part of the fuel which has been supplied through the fuel supply passage to a return fuel pipe to discharge the fuel to a low pressure part of a fuel supply system at the time of fuel injection, and the control unit:
sets the injection command signal for injecting the fuel from the fuel injection valve based on an operation condition of the internal combustion engine;
includes an actual fuel supply information detection unit for determining, based on the injection command signal, fuel injection information that includes at least an injection start timing and an injection finishing timing of the fuel injection valve, performing during a compression stroke or an expansion stroke of the cylinder of the internal combustion engine a multi-injection in which the fuel injection from the fuel injection valve is divided into a plurality of times of fuel injections, and for detecting the amount of the pressure decrease on the downstream side of the orifice caused by the fuel injection from the fuel injection valve based on the signal from the fuel supply passage pressure sensor, and calculates an actual fuel supply information on the fuel that has passed the orifice based on the amount of the pressure decrease, and
an actual fuel injection information detection unit for detecting actual fuel injection information based on the detected actual fuel supply information and back flow information on the back flow which is stored in advance; and
determines the fuel injection information on a subsequent fuel injection that is performed later than a preceding fuel injection based on the actual fuel injection information of the preceding fuel injection which is performed relatively earlier than other fuel injections of the plurality of times of the fuel injections.
